(19) United States
(12) Patent Application Publication
(10) Pub. No.: US 2025/0325020 A1
(43) Pub. Date: Oct. 23, 2025

(54) VAPING AND SMOKING DEVICE AND CAPSULES

(71) Applicant: N2B LIMITED, Limassol (CY)

(72) Inventor: Yossef Raichman, Limassol (CY)

(21) Appl. No.: 19/259,703

(22) Filed: Jul. 3, 2025

Related U.S. Application Data
(63) Continuation of application No. PCT/IB2024/050322, filed on Jan. 12, 2024.
Application No. PCT/IB2024/050322 is a continuation-in-part of application No. 18/211,849, filed on Jun. 20, 2023.
Application No. 18/211,849 is a continuation-in-part of application No. 18/303,627, filed on Apr. 20, 2023.
Application No. 18/303,627 is a continuation of application No. PCT/IB2023/052518, filed on Mar. 15, 2023.
(60) Provisional application No. 63/438,643, filed on Jan. 12, 2023.
(60) Provisional application No. 63/457,182, filed on Apr. 5, 2023.
(60) Provisional application No. 63/463,117, filed on May 1, 2023.
(60) Provisional application No. 63/468,418, filed on May 23, 2023.
(60) Provisional application No. 63/521,685, filed on Jun. 18, 2023.
(60) Provisional application No. 63/522,303, filed on Jun. 21, 2023.
(60) Provisional application No. 63/524,736, filed on Jul. 3, 2023.
(60) Provisional application No. 63/531,667, filed on Aug. 9, 2023.
(60) Provisional application No. 63/602,545, filed on Nov. 24, 2023.

(51) Int. Cl. A24D 1/20; A24D 1/02

(52) U.S. Cl. CPC A24D 1/20; A24D 1/02

(57) ABSTRACT

Apparatus and methods are described for use with a smoking device that includes first and second electrodes. A capsule includes a smoking material and metallic foil disposed around the smoking material. The metallic foil is configured to be heated via resistive heating by the electrodes driving a current into the metallic foil. A paper covering covers the metallic foil. In the circumferential direction of the capsule the paper covering is adhered to itself along a band of overlap, such as to form a cylindrical shape. The metallic foil does not overlap with itself, and there is a gap of less than 1 mm between two sides of the metallic foil. An inner lining strip is adhered to the two sides of the metallic foil so as to seal the capsule between the two sides of the metallic foil. Other applications are also described.

### CROSS-REFERENCES TO RELATED APPLICATIONS

The present application is a continuation of International Application No. PCT/IB2024/050322 to Raichman (published as WO 24/150183), filed Jan. 12, 2024, entitled “Vaping and Smoking Device and Capsules,” which:
(1) claims priority from and is a continuation-in-part of U.S. Ser. No. 18/211,849 to Raichman, filed Jun. 20, 2023, entitled “Vaping and smoking device and capsules,” which:
   (a) is a continuation-in-part of U.S. application Ser. No. 18/303,627 to Raichman, filed Apr. 20, 2023, which is a continuation of International application PCT/IB2023/052518 to Raichman, filed Mar. 15, 2023, entitled “Smoking capsule with flattened profile,” which claims the benefit of U.S. Provisional Patent Application 63/438,643 to Raichman, filed Jan. 12, 2023, entitled “Smoking device and capsule for use therewith;” and
   (b) claims the benefit of:
      U.S. Provisional Patent Application 63/457,182 to Raichman, filed Apr. 5, 2023, entitled “Smoking device with capsule detecting function,”
      U.S. Provisional Patent Application 63/463,117 to Raichman, filed May 1, 2023, entitled “Vaping and smoking device and capsules,”
      U.S. Provisional Patent Application 63/468,418 to Raichman, filed May 23, 2023, entitled “Vaping and smoking device and capsules,” and
      U.S. Provisional Patent Application 63/521,685 to Raichman, filed Jun. 18, 2023, entitled “Vaping and smoking device and capsules;” and
(2) claims priority from:
U.S. Provisional Patent Application 63/522,303 to Raichman, filed Jun. 21, 2023, entitled “Vaping and smoking device and capsules;”
U.S. Provisional Patent Application 63/524,736 to Raichman, filed Jul. 3, 2023, entitled “Vaping and smoking device and capsules;”

U.S. Provisional Patent Application 63/531,667 to Raichman, filed Aug. 9, 2023, entitled “Vaping and smoking device and capsules;” and

U.S. Provisional Patent Application 63/602,545 to Raichman, filed Nov. 24, 2023, entitled “Vaping and smoking device and capsules.” All of the above-referenced applications are incorporated herein by reference.

### FIELD OF EMBODIMENTS OF THE INVENTION

The present invention relates to methods and apparatus relating to smoking devices, and particularly apparatus and methods relating to vaping and heat-not-burn smoking devices.

### BACKGROUND

Heat-not-burn smoking devices (also known as “smokeless” devices) are devices that heat a smoking material that contains active agents (e.g., a plant material, such as tobacco and/or a cannabinoid-containing plant material (such as marijuana), or a non-plant material) without burning the smoking material. The user sucks in vaporized active agents that are generated. Such devices have become popular in recent years, and in particular some users who previously smoked traditional cigarettes have switched to using such products.

An electronic cigarette (also known as a “vaping device”) is an electronic device that generates vapors from a liquid material that typically contains one or more active agents, such as nicotine. The vapors are inhaled by a user, with the process commonly being referred to as “vaping.”

### SUMMARY OF EMBODIMENTS

In accordance with some applications of the present invention, a capsule is configured to be inserted in a smoking device. Typically, the capsule is a disposable capsule that is configured to be used during a single smoking session, whereas the smoking device is configured to be reusable. The capsule typically has the general structure (e.g., shape and size) of a traditional cigarette. Many users and manufacturers of such capsule and smoking devices have a preference for single-use capsules having the general structure of a traditional cigarette, due to (a) habitual preferences of the users, (b) habitual preferences of the manufacturers, (c) production lines of the manufacturers being best-equipped to manufacture such capsules relative to capsules that differ from traditional cigarettes, (d) single-use capsules being more hygienic than capsules that are designed for repeated use, and/or (c) additional reasons.

Typically, the capsule includes a first portion that contains a smoking material (that contains active agents) and a heating element. For some applications, the smoking material is a solid smoking material, e.g., a plant material, such as tobacco and/or a cannabinoid-containing plant material (such as marijuana). For some applications, the smoking material is a non-plant material that contains active agents. The smoking device is configured to heat the smoking material, such as to generate vapors containing active agents within the smoking material in a heat-not-burn manner. The user typically sucks the generated vapors out of a second portion of the capsule that functions as a mouthpiece.

For some applications, a capsule is provided for use with a liquid material that is configured to be vaporized by the above-described smoking device (or a different smoking device). For some applications, the liquid material includes vegetable glycerin, propylene glycol, nicotine, nicotine salt and/or additional taste and/or scent materials. Typically, for such applications, the capsule is a “vaping” capsule and the smoking device acts as a “vaping device.” Nevertheless, the device is referred to herein as a smoking device, since in some applications the device is also used with a capsule that is used for smoking (typically in a heat-not-burn manner), as described in the following paragraph.

For some applications, a single smoking device is configured for use with a first capsule type that contains a solid smoking material containing one or more active agents and for use with a second capsule type that contains a liquid material containing one or more active agents. When the capsule of the first capsule type is inserted into the smoking device, the smoking device is configured to vaporize one or more of the active agents contained within the solid smoking material by heating the capsule of the first capsule type, and when a capsule of the second capsule type is inserted into the smoking device, the smoking device is configured to vaporize at least some of the liquid vaping material by heating the capsule of the second capsule type. Alternatively, for some applications, respective smoking devices are configured for use with the capsule type that contains a solid smoking material containing one or more active agents, or for use with the capsule type that contains a liquid material containing one or more active agents.

It is noted that the smoking device is configured for use with each of the two capsule types separately at respective times. Thus, if in a first smoking session a user wishes to smoke from a solid smoking material (e.g., in a heat-not-burn manner) they would insert a capsule of the first capsule type into a capsule-receiving portion of the smoking device, and if in a separate smoking session they wish to vape from a liquid smoking material, they would insert a capsule of the second capsule type into the same capsule-receiving portion of the smoking device.

Typically, a heating element is built-in to the capsule, such that it is in direct contact with smoking material. For some applications, at least some of the heating element is embedded within the smoking material, as described in further detail hereinbelow. For some applications, the heating element comprises a metal material (such as metallic foil, e.g., stainless steel foil, nickel-titanium foil, titanium foil, copper foil, aluminum foil, steel foil), which is typically disposed within the capsule and/or is typically in direct contact with the smoking material, and that is heated via electrical resistive heating, as described in further detail hereinbelow. Alternatively or additionally, the heating element comprises one or more magnetically-heated materials that are susceptible to being heated by a magnetic field (such as, magnetic materials and/or ferromagnetic materials), which are typically disposed within the capsule and/or are typically in direct contact with smoking material and that are heated via magnetic induction, as described in further detail hereinbelow.

Typically, the capsule is an elongate capsule. For some applications, the capsule has a length of between 15 mm and 150 mm (e.g., between 50 mm and 90 mm).

For some applications, the smoking device includes two or more electrodes that are configured (a) to heat a heating element that is disposed within the capsule via electrical resistive heating, and/or (b) to apply mechanical pressure to the capsule in order to flatten all or part of the portion of the capsule that contains the smoking material.

For some applications, a liquid material is held within a reservoir that comprises an absorbent material with the liquid material absorbed therein. Typically, the absorbent material is solid and/or flexible, is capable of withstanding the high temperatures that might develop during the vaporization process, and is safe for human inhalation. For example, the absorbent material may include cotton, hemp, wool, plastic material, cellulose material, paper, woven or non-woven fabrics, threads, etc. (In other instances of an “absorbent material” being described in the present disclosure, the term “absorbent material” should be interpreted as including any one of the aforementioned types of material or a combination thereof.) For some such applications, a layer of material extends from the reservoir around the circumference of the capsule. For some applications, the layer of material is made of a similar absorbent material to the absorbent material disposed within the reservoir. Typically, the layer of material has a thickness of more than 0.1 mm (e.g., more than 0.2 mm), and/or less than 3 mm (e.g., less than 1 mm), for example between 0.1 mm and 3 mm, or between 0.2 mm and 1 mm. The layer of material is typically configured such that the liquid material flows from the reservoir along the layer of material via capillary forces. For some applications, metallic foil is disposed around the outside of the layer of material.

The metallic foil is typically heated via the electrodes (via resistive heating), in a generally similar manner to that described hereinabove. Typically, the metallic foil thereby heats and vaporizes the liquid material within the layer of material.

For some applications, a vaping capsule includes a housing that houses a reservoir of absorbent material that has the liquid material absorbed therein. Typically, the housing is an electrical insulator and is impermeable to the liquid material. Further typically, the housing defines one or more lateral windows. The absorbent material is configured such that the liquid material flows to the lateral windows via capillary forces. Typically, at the lateral windows the liquid material within the absorbent material is exposed to the metallic foil of the capsule, and the liquid material is thereby vaporized. Typically, the metallic foil contacts the electrodes at locations that are remote from each of the one or more lateral windows.

For some applications, a vaping capsule includes a housing that houses a reservoir of the liquid material. Typically, the housing is an electrical insulator and is impermeable to the liquid material. Further typically, the housing defines one or more lateral windows. For some applications, an absorbent material is disposed within the reservoir with the absorbent material extending from the reservoir to the one or more lateral windows, the absorbent material being configured to transport the liquid material from the reservoir to the one or more lateral windows via capillary forces. Typically, at the lateral windows the liquid material within the absorbent material is exposed to a metallic foil of the capsule, and the liquid material is thereby vaporized. Typically, the metallic foil contacts the electrodes at locations that are remote from each of the one or more lateral windows. Typically, the absorbent material is shaped such as to enhance capillary flow of the liquid material toward the lateral windows, in accordance with some applications of the present invention.

In accordance with respective applications, the vaping capsule is rigid or flexible. For some applications, the capsule is configured to be flattened, for example, using the techniques described hereinbelow. For example, the capsule may be flattened in order to enhance electrical contact between the electrodes and the metallic foil, by applying mechanical pressure to the capsule using the electrodes. For some applications, the capsule is flattened in order to generate a desired heating profile and/or a desired airflow profile. For some applications, the smoking device includes a non-contact temperature sensor (such as an infrared temperature sensor). For some such applications, the portion of the capsule at which the sensor is configured to sense the temperature (i.e., a portion of the capsule that is configured to be adjacent to the temperature sensor) is flattened such as to facilitate the temperature sensing (typically by creating a flat surface upon which to perform the temperature sensing). For some applications, the capsule is flattened in order to increase capillary flow through an absorbent material disposed within the capsule. It is noted that the aforementioned techniques associated with flattening a capsule are typically applicable to any one of the embodiments of capsules described herein.

There is therefore provided, in accordance with some applications of the present invention, apparatus for use with a first capsule type that contains a solid smoking material containing one or more active agents and for use with a second capsule type that contains a liquid material containing one or more active agents, the apparatus including:
a smoking device configured:
   when a capsule of the first capsule type is inserted into the smoking device, to vaporize one or more of the active agents contained within the solid smoking material by heating the capsule of the first capsule type; and
   when a capsule of the second capsule type is inserted into the smoking device, to vaporize at least some of the liquid vaping material by heating the capsule of the second capsule type.

In some applications, the smoking device includes a control component configured to detect whether a capsule of the first or second capsule type is currently disposed within the smoking device and to control heating of the capsule that is currently disposed within the smoking device responsively thereto.

In some applications, when either the capsule of the first or second capsule type is disposed within the smoking device, the smoking device includes a control component configured to:
receive an indication from a user indicating whether they wish to smoke the active agents in a first mode or a second mode;
in response to receiving an indication that the user wishes to smoke the active agents in the first mode, heat the smoking material to a vaporization temperature of the one or more active agents for a predefined period of time; and
in response to receiving an indication that the user wishes to smoke the active agents in the second mode, only heat the smoking material to the vaporization temperature while receiving an active input from the user that they wish for the smoking material to be heated.

In some applications, when either the capsule of the first or second capsule type is disposed within the smoking device, the smoking device is configured to flatten at least a portion of the capsule currently disposed within the smoking device.

In some applications, the smoking device is configured to flatten at least the portion of the capsule that is disposed within the smoking device such that the portion of the capsule defines a cross-sectional shape having a ratio of more than 2:1 between a long side of the cross-sectional shape and a short side of the cross-sectional shape.

In some applications, the smoking device includes mechanical elements that are configured to flatten at the portion of the capsule that is disposed within the smoking device by applying mechanical pressure to the capsule.

In some applications, when the capsule of the second capsule type is disposed within the smoking device, the smoking device is configured to drive the liquid material toward a region within the capsule at which the liquid material is vaporized by flattening the portion of the capsule.

In some applications, the smoking device further includes a temperature sensor and a control component configured to determine a temperature of the solid smoking material within the capsule of the first capsule type or the liquid material within the capsule of the second capsule type based upon the temperature detected by the temperature sensor.

In some applications, the control component is configured to control heating of the solid smoking material within the capsule of the first capsule type or the liquid material within the capsule of the second capsule type in response to the determined temperature of the solid smoking material within the capsule of the first capsule type or the liquid material within the capsule of the second capsule type.

In some applications, the control component is configured to control heating of the solid smoking material within the capsule of the first capsule type or the liquid material within the capsule of the second capsule type such as to maintain the solid smoking material within the capsule of the first capsule type or the liquid material within the capsule of the second capsule type within a predefined temperature range.

In some applications, the smoking device includes two or more electrodes that are configured to heat the solid smoking material within the capsule of the first capsule type or the liquid material within the capsule of the second capsule type by generating resistive heating within the capsule by driving a current through a portion of the capsule.

In some applications, the smoking device includes a mechanism configured to bring the electrodes into pressurized contact with a capsule that is currently disposed within the smoking device, in order to enhance electrical contact between the electrodes and the capsule.

In some applications, capsules of each of the first and second capsule types include a metallic foil surrounding the solid smoking material or the liquid material respectively, and the electrodes are configured to drive the current through the metallic foils of the capsule of the first capsule type and the capsule of the second capsule type.

In some applications, capsules of each of the first and second capsule types are elongate capsules, during the heating of the solid smoking material within the capsule of the first capsule type or the liquid material within the capsule of the second capsule type, the smoking device is configured to house the capsule of the first capsule type or the capsule of the second capsule type such that airflow through the capsule is substantially along a length of the capsule, and a first one of the electrodes is configured to drive a current toward a second one of the electrodes along a length of more than 5 mm in an axial direction along a length of the capsule.

In some applications, the first one of the electrodes is configured to drive the current toward the second one of the electrodes along a length of more than 15 mm in the axial direction along the length of the capsule.

In some applications, the smoking device includes a coil that is configured to heat the solid smoking material within the capsule of the first capsule type or the liquid material within the capsule of the second capsule type by generating a magnetic field such as to heat the capsule via magnetic induction.

In some applications, the coil is configured to be flattened while at least part of the portion of the capsule that contains the smoking material is disposed within the coil.

In some applications, the coil is shaped to define a non-circular cross-sectional shape, and the smoking device is configured to flatten a part at least a portion of the capsules of each of the first and second capsule types prior to the portions of the capsules of each of the first and second capsule types being introduced to within the coil.

In some applications, the smoking device is configured to receive capsules of each of the first and second capsule types that are cylindrically-shaped elongate capsules having lengths of between 15 mm and 150 mm.

In some applications, the smoking device is configured to receive cylindrically-shaped elongate capsules having lengths of between 50 mm and 90 mm.

There is further provided, in accordance with some applications of the present invention, apparatus for use with a smoking device, the apparatus including:
a capsule including:
   a smoking material containing one or more active agents;
   one or more heating elements disposed within the capsule, the one or more heating elements being configured to vaporize one or more of the active agents from within the smoking material, by the one or more heating elements being heated by the smoking device; and
   a collapse-prevention element disposed along an axis of a portion of the capsule that contains the smoking material, the collapse-prevention element being configured to prevent the portion of the capsule that contains the smoking material from collapsing when mechanical pressure is applied to the portion of the capsule that contains the smoking material.

In some applications, the smoking material includes a plant-based smoking material, the one or more of the active agents being configured to be vaporized from within the plant-based smoking material by the plant-based smoking material being heated.

In some applications, the smoking material includes a liquid material, one or more of the active agents being configured to be vaporized from within the liquid material by the liquid material being vaporized.

In some applications, at least part of the portion of the capsule that contains the smoking material is configured to be flattened by the smoking device and the collapse-prevention element is configured to prevent the portion of the capsule that contains the smoking material from collapsing when at least part of the portion of the capsule that contains the smoking material is flattened by the smoking device.

In some applications, the collapse-prevention element is configured to diffuse one or more chemicals. In some applications, the collapse-prevention element includes a phase-change material that is configured to prevent the temperature of the smoking material from exceeding the phase-change temperature of the phase-change material. In some applications, the collapse-prevention element is configured to absorb chemicals that are generated by pyrolysis of the smoking material.

In some applications, the capsule includes two or more cylindrical collapse-prevention elements disposed at respective ends of a portion of the capsule that contains the smoking material, the collapse-prevention elements being configured to prevent the portion of the capsule that contains the smoking material from collapsing when mechanical pressure is applied to the portion of the capsule that contains the smoking material.

In some applications, the collapse-prevention element is configured to facilitate adequate airflow through the capsule by preventing the portion of the capsule that contains the smoking material from collapsing when mechanical pressure is applied to the portion of the capsule that contains the smoking material.

In some applications, the one or more heating elements include one or more magnetically-heated materials that are susceptible to being heated by a magnetic field.

In some applications, the capsule is manufactured such as to define a cross-sectional shape having a ratio of more than 2:1 between a long side of the cross-sectional shape and a short side of the cross-sectional shape.

In some applications, the smoking device includes two or more electrodes, and the one or more heating elements include a metallic foil that is configured to be heated via resistive heating via the two or more electrodes.

In some applications, the collapse-prevention element is configured to facilitate electrical contact between the two or more electrodes and the metallic foil by preventing the portion of the capsule that contains the smoking material from collapsing when mechanical pressure is applied to the portion of the capsule that contains the smoking material.

In some applications, the metallic foil has a thickness of between 1 micron and 20 microns. In some applications, the metallic foil has a thickness of between 3 microns and 10 microns.

In some applications, at least a portion of the capsule is configured to be flattened by the smoking device prior to the one or more heating elements being heated by the smoking device. In some applications, the capsule has a circular cross-sectional shape and is configured to be flattened to define a non-circular cross-sectional shape.

In some applications, the capsule is configured to be flattened such as to define a cross-sectional shape having a ratio of more than 2:1 between a long side of the cross-sectional shape and a short side of the cross-sectional shape.

In some applications, the one or more heating elements include one or more magnetically-heated materials that are susceptible to being heated by a magnetic field.

In some applications, the portion of the capsule that is configured to be flattened by the smoking device is configured to be inserted into a coil that has a non-circular cross-sectional shape.

In some applications, the portion of the capsule is configured to be flattened by the smoking device is configured to be flattened while the portion of the capsule is disposed within a coil.

In some applications, the one or more heating elements include a metallic foil that is configured to be heated via resistive heating.

In some applications, the smoking device includes two or more electrodes that are configured to drive an electrical current through the metallic foil, and the capsule is configured to be flattened by the two or more electrodes.

In some applications, the collapse-prevention element is shaped as at least one rod that extends axially along a longitudinal axis of the portion of the capsule that contains the smoking material. In some applications, the rod has a diameter of between 0.5 mm and 5 mm. In some applications, the rod extends along only part of the portion of the capsule that contains the smoking material. In some applications, the collapse-prevention element is shaped as two or more rods. In some applications, the smoking device includes two or more electrodes that are configured to drive an electrical current into the capsule, and at locations at which the electrodes are configured to come into contact with the capsule, the rod includes radially-protruding portions having a greater diameter than at other locations along the rod.

In some applications, the collapse-prevention element is shaped as at least one tube that extends axially along a longitudinal axis of the portion of the capsule that contains the smoking material. In some applications, the tube contains one or more chemicals that are configured to be released from the tube during heating of the smoking material.

In some applications, the capsule includes a mouthpiece, and the tube is configured to collect vaporized active agents generated by the heating of the smoking material and direct the vapors toward the mouthpiece.

In some applications, the capsule includes an elongate capsule having a length of between 15 mm and 150 mm. In some applications, the elongate capsule has a length of between 50 mm and 90 mm.

There is further provided, in accordance with some applications of the present invention, apparatus for use with a smoking device, the apparatus including:

a capsule including:

a smoking material containing one or more active agents;
one or more heating elements disposed within the capsule the one or more heating elements being configured to vaporize one or more of the active agents from within the smoking material, by the one or more heating element being heated by the smoking device; and
two or more cylindrical collapse-prevention elements disposed at respective ends of a portion of the capsule that contains the smoking material, the collapse-prevention elements being configured to prevent the portion of the capsule that contains the smoking material from collapsing when mechanical pressure is applied to the portion of the capsule that contains the smoking material.

In some applications, the smoking material includes a plant-based smoking material, the one or more of the active agents being configured to be vaporized from within the plant-based smoking material by the plant-based smoking material being heated.

In some applications, the smoking material includes a liquid material, one or more of the active agents being configured to be vaporized from within the liquid material by the liquid material being vaporized.

In some applications, at least part of the portion of the capsule that contains the smoking material is configured to be flattened by the smoking device and the cylindrical collapse-prevention elements are configured to prevent the portion of the capsule that contains the smoking material from collapsing when at least part of the portion of the capsule that contains the smoking material is flattened by the smoking device.

In some applications, the capsule further includes a rod-shaped collapse-prevention element disposed along a portion of the capsule that contains the smoking material, the rod-shaped collapse-prevention element being configured to prevent the portion of the capsule that contains the smoking material from collapsing when mechanical pressure is applied to the portion of the capsule that contains the smoking material.

In some applications, the capsule further includes a tube-shaped collapse-prevention element disposed along a portion of the capsule that contains the smoking material, the tube-shaped collapse-prevention element being configured to prevent the portion of the capsule that contains the smoking material from collapsing when mechanical pressure is applied to the portion of the capsule that contains the smoking material.

In some applications, the cylindrical collapse-prevention elements are configured to facilitate adequate airflow through the capsule by preventing the portion of the capsule that contains the smoking material from collapsing when mechanical pressure is applied to the portion of the capsule that contains the smoking material.

In some applications, the one or more heating elements include one or more magnetically-heated materials that are susceptible to being heated by a magnetic field.

In some applications, the capsule is manufactured such as to define a cross-sectional shape having a ratio of more than 2:1 between a long side of the cross-sectional shape and a short side of the cross-sectional shape.

In some applications, the smoking device includes two or more electrodes, and the one or more heating elements include a metallic foil that is configured to be heated via resistive heating via the two or more electrodes.

In some applications, the cylindrical collapse-prevention elements are configured to facilitate electrical contact between the two or more electrodes and the metallic foil by preventing the portion of the capsule that contains the smoking material from collapsing when mechanical pressure is applied to the portion of the capsule that contains the smoking material.

In some applications, the metallic foil has a thickness of between 1 micron and 20 microns. In some applications, the metallic foil has a thickness of between 3 microns and 10 microns.

In some applications, at least a portion of the capsule is configured to be flattened by the smoking device prior to the one or more heating elements being heated by the smoking device. In some applications, the capsule has a circular cross-sectional shape and is configured to be flattened to define a non-circular cross-sectional shape.

In some applications, the capsule is configured to be flattened such as to define a cross-sectional shape having a ratio of more than 2:1 between a long side of the cross-sectional shape and a short side of the cross-sectional shape.

In some applications, the one or more heating elements include one or more magnetically-heated materials that are susceptible to being heated by a magnetic field.

In some applications, the portion of the capsule is configured to be inserted into a coil that has a non-circular cross-sectional shape.

In some applications, the portion of the capsule is configured to be flattened while the portion of the capsule is disposed within a coil.

In some applications, the one or more heating elements include a metallic foil that is configured to be heated via resistive heating.

In some applications, the smoking device includes two or more electrodes that are configured to drive an electrical current through the metallic foil, and the capsule is configured to be flattened by the two or more electrodes.

In some applications, the capsule includes an elongate capsule having a length of between 15 mm and 150 mm. In some applications, the elongate capsule has a length of between 50 mm and 90 mm.

There is further provided, in accordance with some applications of the present invention, apparatus for use with a smoking device including an infrared temperature sensor, the apparatus including:
a capsule including:
   a smoking material containing one or more active agents;
   a metallic foil disposed around at least a portion of the smoking material, the metallic foil being configured to vaporize one or more of the active agents from within the smoking material, by the metallic foil being heated by the smoking device via resistive heating; and
   a coating disposed around at least a portion of the metallic foil at which the infrared temperature sensor is configured to detect a temperature of the capsule, the coating having an emissivity value of at least 0.5.

In some applications, the smoking material includes a plant-based smoking material, the one or more of the active agents being configured to be vaporized from within the plant-based smoking material by the plant-based smoking material being heated.

In some applications, the smoking material includes a liquid material, one or more of the active agents being configured to be vaporized from within the liquid material by the liquid material being vaporized.

In some applications, the coating has an emissivity value of at least 0.95.

There is further provided, in accordance with some applications of the present invention, apparatus for use with a smoking device including an infrared temperature sensor, the apparatus including:
a capsule including:
   a smoking material containing one or more active agents;
   a metallic foil disposed around at least a portion of the smoking material, the metallic foil being configured to vaporize one or more of the active agents from within the smoking material, by the metallic foil being heated by the smoking device via resistive heating; and
   at least a portion of the metallic foil at which the infrared temperature sensor the infrared temperature sensor is configured to detect a temperature of the capsule the metallic foil being treated such as to have an emissivity value of at least 0.5.

In some applications, the portion of the metallic foil is treated such as to have an emissivity value of at least 0.95.

In some applications, the smoking material includes a plant-based smoking material, the one or more of the active agents being configured to be vaporized from within the plant-based smoking material by the plant-based smoking material being heated.

In some applications, the smoking material includes a liquid material, one or more of the active agents being configured to be vaporized from within the liquid material by the liquid material being vaporized.

There is further provided in accordance with some applications of the present invention, apparatus for use with a smoking device including an infrared temperature sensor, the apparatus including:
a capsule including:
   a smoking material containing one or more active agents;
   one or more resistive elements, the resistive elements being configured to provide an electrical resistance profile to the capsule that provides identifying information regarding the capsule.

In some applications, the smoking material includes a plant-based smoking material, the one or more of the active agents being configured to be vaporized from within the plant-based smoking material by the plant-based smoking material being heated.

In some applications, the smoking material includes a liquid material, one or more of the active agents being configured to be vaporized from within the liquid material by the liquid material being vaporized.

There is further provided, in accordance with some applications of the present invention, apparatus for use with a smoking device that includes at least first and second electrodes, the apparatus including:
a capsule including:
   a smoking material containing one or more active agents; and
   metallic foil surrounding the smoking material, the metallic foil being configured to be heated via resistive heating by the electrodes driving a current into the metallic foil; and
   a paper covering that covers the metallic foil, the paper covering defining openings via which the electrodes are configured to make electrical contact with the metallic foil.

In some applications, the smoking material includes a plant-based smoking material, the one or more of the active agents being configured to be vaporized from within the plant-based smoking material by the plant-based smoking material being heated.

In some applications, the smoking material includes a liquid material, one or more of the active agents being configured to be vaporized from within the liquid material by the liquid material being vaporized.

In some applications, the metallic foil is shaped such that at least a portion of the metallic foil is embedded within the smoking material.

In some applications, the metallic foil includes a plurality of regions, each of the regions having a respective, different electrical resistance profile, such that upon a given current being driven through the metallic foil each of the regions heats to a respective, different temperature.

In some applications, the capsule further includes a collapse-prevention element configured to facilitate electrical contact between the electrodes and the metallic foil, by preventing the capsule from collapsing.

In some applications, the capsule further includes an electrical-contact coating that coats the metallic foil at locations at which the electrodes are configured to contact the capsule.

In some applications, the metallic foil has a first configuration at locations at which the electrodes are configured to contact the metallic foil, and a second configuration along a region in which the metallic foil surrounds the smoking material that is between the locations at which the electrodes are configured to contact the metallic foil.

In some applications, the capsule further includes an inner lining that lines an inside of the metallic foil, the inner lining being configured to diffuse heat that is generated by the metallic foil.

In some applications, the smoking device includes one or more batteries, and an overall resistance to the current that is provided by the capsule is configured to substantially match an internal resistance of the one or more batteries of the smoking device.

In some applications, the paper covering is adhered to itself along a band of overlap, such as to form a cylindrical shape and such that the metallic foil forms a band of overlap having an inner layer of metallic foil and an outer layer of metallic foil, and an electrically insulating material is disposed along the band of overlap, to isolate the inner layer of the metallic foil from the electrodes. In some applications, the paper covering is adhered to itself along a band of overlap, such as to form a cylindrical shape and such that the metallic foil forms a band of overlap having an inner layer of metallic foil and an outer layer of metallic foil, and the metallic foil is treated along the band of overlap, in order to increase resistance of the metallic foil along the band of overlap.

In some applications, the capsule is shaped to define a cross-sectional shape having a ratio of more than 2:1 between a long side of the cross-sectional shape and a short side of the cross-sectional shape.

In some applications, at least a portion of the capsule is configured to be flattened by the smoking device prior to the one or more heating elements being heated by the smoking device. In some applications, the capsule has a circular cross-sectional shape and is configured to be flattened to define a non-circular cross-sectional shape. In some applications, the capsule is configured to be flattened such as to define a cross-sectional shape having a ratio of more than 2:1 between a long side of the cross-sectional shape and a short side of the cross-sectional shape.

In some applications, the capsule includes an elongate capsule having a length of between 15 mm and 150 mm. In some applications, the elongate capsule has a length of between 50 mm and 90 mm.

In some applications, the capsule is configured such that airflow through the capsule is substantially in an axial direction along a length of the capsule.

In some applications, the metallic foil is configured to be heated via resistive heating by the first electrode driving a current to the second electrode along a length of more than 5 mm in an axial direction along the metallic foil. In some applications, the capsule is configured such that airflow through the capsule is substantially in the axial direction along a length of the capsule. In some applications, the metallic foil is configured to be heated via resistive heating by the first electrode driving a current to the second electrode along a length of more than 15 mm in the axial direction along the metallic foil.

In some applications, the metallic foil has a thickness of between 1 micron and 20 microns. In some applications, the metallic foil has a thickness of between 3 microns and 10 microns.

There is further provided, in accordance with some applications of the present invention, apparatus for use with a smoking device that includes at least first and second electrodes, the apparatus including:
a capsule including:
   a smoking material containing one or more active agents; and
   metallic foil surrounding the smoking material, the metallic foil being configured to be heated via resistive heating by the electrodes driving a current into the metallic foil, the metallic foil including a plurality of regions along its length, each of the regions having a respective, different electrical resistance profile, such that upon a given current being driven through the metallic foil each of the regions heats to a respective, different temperature.

In some applications, the smoking material includes a plant-based smoking material, the one or more of the active agents being configured to be vaporized from within the plant-based smoking material by the plant-based smoking material being heated.

In some applications, the smoking material includes a liquid material, one or more of the active agents being configured to be vaporized from within the liquid material by the liquid material being vaporized.

In some applications, the metallic foil is shaped such that at least a portion of the metallic foil is embedded within the smoking material.

In some applications, the capsule further includes a collapse-prevention element configured to facilitate electrical contact between the electrodes and the metallic foil, by preventing the capsule from collapsing.

In some applications, the capsule further includes an electrical-contact coating that coats the metallic foil at locations at which the electrodes are configured to contact the capsule.

In some applications, the metallic foil has a first configuration at locations at which the electrodes are configured to contact the metallic foil, and a second configuration along a region in which the metallic foil surrounds the smoking material that is between the locations at which the electrodes are configured to contact the metallic foil.

In some applications, the capsule further includes an inner lining that lines an inside of the metallic foil, the inner lining being configured to diffuse heat that is generated by the metallic foil.

In some applications, the smoking device includes one or more batteries, and an overall resistance to the current that is provided by the capsule is configured to substantially match an internal resistance of the one or more batteries of the smoking device.

In some applications, the capsule further includes a paper covering that covers the metallic foil, the paper covering being adhered to itself along a band of overlap, such as to form a cylindrical shape and such that the metallic foil forms a band of overlap having an inner layer of metallic foil and an outer layer of metallic foil, and an electrically insulating material is disposed along the band of overlap, to isolate the inner layer of the metallic foil from the electrodes.

In some applications, the capsule further includes a paper covering that covers the metallic foil, the paper covering being adhered to itself along a band of overlap, such as to form a cylindrical shape and such that the metallic foil forms a band of overlap having an inner layer of metallic foil and an outer layer of metallic foil, and the metallic foil is treated along the band of overlap, in order to increase resistance of the metallic foil along the band of overlap.

In some applications, the capsule is shaped to define a cross-sectional shape having a ratio of more than 2:1 between a long side of the cross-sectional shape and a short side of the cross-sectional shape.

In some applications, the capsule further includes a paper covering that covers the metallic foil, the paper covering defining openings via which the electrodes are configured to make electrical contact with the metallic foil.

In some applications, the capsule is configured for use with a smoking device that includes respective temperature sensors that are configured to detect temperatures of the respective regions along the metallic foil.

In some applications, at least a portion of the capsule is configured to be flattened by the smoking device prior to the one or more heating elements being heated by the smoking device. In some applications, the capsule has a circular cross-sectional shape and is configured to be flattened to define a non-circular cross-sectional shape. In some applications, the capsule is configured to be flattened such as to define a cross-sectional shape having a ratio of more than 2:1 between a long side of the cross-sectional shape and a short side of the cross-sectional shape.

In some applications, the capsule includes an elongate capsule having a length of between 15 mm and 150 mm. In some applications, the elongate capsule has a length of between 50 mm and 90 mm.

In some applications, the capsule is configured such that airflow through the capsule is substantially in an axial direction along a length of the capsule.

In some applications, the metallic foil is configured to be heated via resistive heating by the first electrode driving a current to the second electrode along a length of more than 5 mm in an axial direction along the metallic foil. In some applications, the capsule is configured such that airflow through the capsule is substantially in the axial direction along a length of the capsule. In some applications, the metallic foil is configured to be heated via resistive heating by the first electrode driving a current to the second electrode along a length of more than 15 mm in the axial direction along the metallic foil.

In some applications, the metallic foil has a thickness of between 1 micron and 20 microns. In some applications, the metallic foil has a thickness of between 3 microns and 10 microns.

In some applications, each of the regions along the length of the metallic foil includes a respective, different material that is configured to be vaporized by heating of the metallic foil.

In some applications, the capsule is configured for use with a smoking device that is configured to receive an input from a user indicating a preferred mix of vapors of the user, and to heat the respective regions along the length of the metallic foil to respective, different temperatures responsively thereto.

There is further provided, in accordance with some applications of the present invention, apparatus for use with a smoking device that includes at least first and second electrodes, the apparatus including:
a capsule including:
   a smoking material containing one or more active agents; and
   metallic foil surrounding the smoking material, the metallic foil being configured to be heated via resistive heating by the electrodes driving a current into the metallic foil; and
   a collapse-prevention element configured to facilitate electrical contact between the electrodes and the metallic foil, by preventing the capsule from collapsing.

In some applications, the smoking material includes a plant-based smoking material, the one or more of the active agents being configured to be vaporized from within the plant-based smoking material by the plant-based smoking material being heated.

In some applications, the smoking material includes a liquid material, one or more of the active agents being configured to be vaporized from within the liquid material by the liquid material being vaporized.

In some applications, the metallic foil includes a plurality of regions, each of the regions having a respective, different electrical resistance profile, such that upon a given current being driven through the metallic foil each of the regions heats to a respective, different temperature.

In some applications, the metallic foil is shaped such that at least a portion of the metallic foil is embedded within the smoking material.

In some applications, the capsule further includes an electrical-contact coating that coats the metallic foil at locations at which the electrodes are configured to contact the capsule.

In some applications, the metallic foil has a first configuration at locations at which the electrodes are configured to contact the metallic foil, and a second configuration along a region in which the metallic foil surrounds the smoking material that is between the locations at which the electrodes are configured to contact the metallic foil.

In some applications, the capsule further includes an inner lining that lines an inside of the metallic foil, the inner lining being configured to diffuse heat that is generated by the metallic foil.

In some applications, the smoking device includes one or more batteries, and an overall resistance to the current that is provided by the capsule is configured to substantially match an internal resistance of the one or more batteries of the smoking device.

In some applications, the capsule further includes a paper covering that covers the metallic foil, the paper covering being adhered to itself along a band of overlap and such that the metallic foil forms a band of overlap having an inner layer of metallic foil and an outer layer of metallic foil, such as to form a cylindrical shape, and an electrically insulating material is disposed along the band of overlap, to isolate the inner layer of the metallic foil from the electrodes.

In some applications, the capsule further includes a paper covering that covers the metallic foil, the paper covering being adhered to itself along a band of overlap, such as to form a cylindrical shape and such that the metallic foil forms a band of overlap having an inner layer of metallic foil and an outer layer of metallic foil, and the metallic foil is treated along the band of overlap, in order to increase resistance of the metallic foil along the band of overlap.

In some applications, the capsule is shaped to define a cross-sectional shape having a ratio of more than 2:1 between a long side of the cross-sectional shape and a short side of the cross-sectional shape.

In some applications, the capsule further includes a paper covering that covers the metallic foil, the paper covering defining openings via which the electrodes are configured to make electrical contact with the metallic foil.

In some applications, the collapse-prevention element is configured to diffuse one or more chemicals. In some applications, the collapse-prevention element includes a phase-change material that is configured to prevent the temperature of the smoking material from exceeding the phase-change temperature of the phase-change material. In some applications, the collapse-prevention element is configured to absorb chemicals that are generated by pyrolysis of the smoking material. In some applications, the collapse-prevention element includes two or more cylindrical collapse-prevention elements disposed at respective ends of the portion of the capsule that contains the smoking material.

In some applications, at least a portion of the capsule is configured to be flattened by the smoking device prior to the one or more heating elements being heated by the smoking device. In some applications, the capsule has a circular cross-sectional shape and is configured to be flattened to define a non-circular cross-sectional shape. In some applications, the capsule is configured to be flattened such as to define a cross-sectional shape having a ratio of more than 2:1 between a long side of the cross-sectional shape and a short side of the cross-sectional shape.

In some applications, the capsule includes an elongate capsule having a length of between 15 mm and 150 mm. In some applications, the elongate capsule has a length of between 50 mm and 90 mm.

In some applications, the capsule is configured such that airflow through the capsule is substantially in an axial direction along a length of the capsule.

In some applications, the metallic foil is configured to be heated via resistive heating by the first electrode driving a current to the second electrode along a length of more than 5 mm in an axial direction along the metallic foil. In some applications, the capsule is configured such that airflow through the capsule is substantially in the axial direction along a length of the capsule. In some applications, the metallic foil is configured to be heated via resistive heating by the first electrode driving a current to the second electrode along a length of more than 15 mm in the axial direction along the metallic foil.

In some applications, the collapse-prevention element is shaped as at least one rod that extends axially along a longitudinal axis of the portion of the capsule that contains the smoking material. In some applications, the rod has a diameter of between 0.5 mm and 5 mm. In some applications, the rod extends along only part of the portion of the capsule that contains the smoking material. In some applications, the collapse-prevention element is shaped as two or more rods. In some applications, the smoking device includes two or more electrodes that are configured to drive an electrical current into the capsule, and at locations at which the electrodes are configured to come into contact with the capsule, the rod includes radially-protruding portions having a greater diameter than at other locations along the rod.

In some applications, the collapse-prevention element is shaped as at least one tube that extends axially along a longitudinal axis of the portion of the capsule that contains the smoking material. In some applications, the tube contains one or more chemicals that are configured to be released from the tube during heating of the smoking material. In some applications, the capsule includes a mouthpiece, and the tube is configured to collect vaporized active agents generated by the heating of the smoking material and direct the vapors toward the mouthpiece.

In some applications, the metallic foil has a thickness of between 1 micron and 20 microns. In some applications, the metallic foil has a thickness of between 3 microns and 10 microns.

There is further provided, in accordance with some applications of the present invention, apparatus for use with a smoking device that includes at least first and second electrodes and one or more batteries, the apparatus including:
a capsule including:
   a smoking material containing one or more active agents; and
   metallic foil surrounding the smoking material, the metallic foil being configured to be heated via resistive heating by the electrodes driving a current into the metallic foil, an overall resistance to the current that is provided by the capsule being configured to substantially match an internal resistance of the one or more batteries of the smoking device.

In some applications, the smoking material includes a plant-based smoking material, the one or more of the active agents being configured to be vaporized from within the plant-based smoking material by the plant-based smoking material being heated.

In some applications, the smoking material includes a liquid material, one or more of the active agents being configured to be vaporized from within the liquid material by the liquid material being vaporized.

In some applications, the capsule further includes a collapse-prevention element configured to facilitate electrical contact between the electrodes and the metallic foil, by preventing the capsule from collapsing.

In some applications, the metallic foil includes a plurality of regions, each of the regions having a respective, different electrical resistance profile, such that upon a given current being driven through the metallic foil each of the regions heats to a respective, different temperature.

In some applications, the metallic foil is shaped such that at least a portion of the metallic foil is embedded within the smoking material.

In some applications, the capsule further includes an electrical-contact coating that coats the metallic foil at locations at which the electrodes are configured to contact the capsule.

In some applications, the metallic foil has a first configuration at locations at which the electrodes are configured to contact the metallic foil, and a second configuration along a region in which the metallic foil surrounds the smoking material that is between the locations at which the electrodes are configured to contact the metallic foil.

In some applications, the capsule further includes an inner lining that lines an inside of the metallic foil, the inner lining being configured to diffuse heat that is generated by the metallic foil.

In some applications, the capsule further includes a paper covering that covers the metallic foil, the paper covering being adhered to itself along a band of overlap, such as to form a cylindrical shape and such that the metallic foil forms a band of overlap having an inner layer of metallic foil and an outer layer of metallic foil, and an electrically insulating material being disposed along the band of overlap, to isolate the inner layer of the metallic foil from the electrodes.

In some applications, the capsule further includes a paper covering that covers the metallic foil, the paper covering being adhered to itself along a band of overlap, such as to form a cylindrical shape and such that the metallic foil forms a band of overlap having an inner layer of metallic foil and an outer layer of metallic foil, and the metallic foil is treated along the band of overlap, in order to increase resistance of the metallic foil along the band of overlap.

In some applications, the capsule is shaped to define a cross-sectional shape having a ratio of more than 2:1 between a long side of the cross-sectional shape and a short side of the cross-sectional shape.

In some applications, the capsule further includes a paper covering that covers the metallic foil, the paper covering defining openings via which the electrodes are configured to make electrical contact with the metallic foil.

In some applications, at least a portion of the capsule is configured to be flattened by the smoking device prior to the one or more heating elements being heated by the smoking device. In some applications, the capsule has a circular cross-sectional shape and is configured to be flattened to define a non-circular cross-sectional shape. In some applications, the capsule is configured to be flattened such as to define a cross-sectional shape having a ratio of more than 2:1 between a long side of the cross-sectional shape and a short side of the cross-sectional shape.

In some applications, the capsule includes an elongate capsule having a length of between 15 mm and 150 mm. In some applications, the elongate capsule has a length of between 50 mm and 90 mm.

In some applications, the capsule is configured such that airflow through the capsule is substantially in an axial direction along a length of the capsule.

In some applications, the metallic foil is configured to be heated via resistive heating by the first electrode driving a current to the second electrode along a length of more than 5 mm in an axial direction along the metallic foil. In some applications, the capsule is configured such that airflow through the capsule is substantially in the axial direction along a length of the capsule. In some applications, the metallic foil is configured to be heated via resistive heating by the first electrode driving a current to the second electrode along a length of more than 15 mm in the axial direction along the metallic foil.

In some applications, the metallic foil has a thickness of between 1 micron and 20 microns. In some applications, the metallic foil has a thickness of between 3 microns and 10 microns.

There is further provided, in accordance with some applications of the present invention, apparatus for use with a smoking device that includes at least first and second electrodes, the apparatus including:
a capsule including:
   a smoking material containing one or more active agents; and
   metallic foil surrounding the smoking material, the metallic foil being configured to be heated via resistive heating by the electrodes driving a current into the metallic foil; and
   an electrical-contact coating that coats the metallic foil at locations at which the electrodes are configured to contact the capsule.

In some applications, the smoking material includes a plant-based smoking material, the one or more of the active agents being configured to be vaporized from within the plant-based smoking material by the plant-based smoking material being heated.

In some applications, the smoking material includes a liquid material, one or more of the active agents being configured to be vaporized from within the liquid material by the liquid material being vaporized.

In some applications, the electrical-contact coating coats an outside of the metallic foil. In some applications, the electrical-contact coating coats an inside of the metallic foil. In some applications, the electrical-contact coating has a lower resistance than a resistance of the metallic foil. In some applications, the electrical-contact coating is configured to prevent generation of hotspots at the locations at which the electrodes are configured to contact the capsule. In some applications, the electrical-contact coating includes a ring-shaped coating at each of the locations at which the electrodes are configured to contact the capsule. In some applications, an edge of the electrical-contact coating is zigzagged at a side at which the coating contacts the metallic foil to thereby conduct electrical current to the metallic foil in a uniform manner.

In some applications, the capsule further includes a collapse-prevention element configured to facilitate electrical contact between the electrodes and the metallic foil, by preventing the capsule from collapsing.

In some applications, the metallic foil includes a plurality of regions, each of the regions having a respective, different electrical resistance profile, such that upon a given current being driven through the metallic foil each of the regions heats to a respective, different temperature.

In some applications, the metallic foil is shaped such that at least a portion of the metallic foil is embedded within the smoking material.

In some applications, the metallic foil has a first configuration at locations at which the electrodes are configured to contact the metallic foil, and a second configuration along a region in which the metallic foil surrounds the smoking material that is between the locations at which the electrodes are configured to contact the metallic foil.

In some applications, the capsule further includes an inner lining that lines an inside of the metallic foil, the inner lining being configured to diffuse heat that is generated by the metallic foil.

In some applications, the smoking device includes one or more batteries, and an overall resistance to the current that is provided by the capsule is configured to substantially match an internal resistance of the one or more batteries of the smoking device.

In some applications, the capsule further includes a paper covering that covers the metallic foil, the paper covering being adhered to itself along a band of overlap, such as to form a cylindrical shape and such that the metallic foil forms a band of overlap having an inner layer of metallic foil and an outer layer of metallic foil, and an electrically insulating material is disposed along the band of overlap, to isolate the inner layer of the metallic foil from the electrodes.

In some applications, the capsule further includes a paper covering that covers the metallic foil, the paper covering being adhered to itself along a band of overlap, such as to form a cylindrical shape and such that the metallic foil forms a band of overlap having an inner layer of metallic foil and an outer layer of metallic foil, and the metallic foil is treated along the band of overlap, in order to increase resistance of the metallic foil along the band of overlap.

In some applications, the capsule is shaped to define a cross-sectional shape having a ratio of more than 2:1 between a long side of the cross-sectional shape and a short side of the cross-sectional shape.

In some applications, the capsule further includes a paper covering that covers the metallic foil, the paper covering defining openings via which the electrodes are configured to make electrical contact with the metallic foil.

In some applications, at least a portion of the capsule is configured to be flattened by the smoking device prior to the one or more heating elements being heated by the smoking device. In some applications, the capsule has a circular cross-sectional shape and is configured to be flattened to define a non-circular cross-sectional shape. In some applications, the capsule is configured to be flattened such as to define a cross-sectional shape having a ratio of more than 2:1 between a long side of the cross-sectional shape and a short side of the cross-sectional shape.

In some applications, the capsule includes an elongate capsule having a length of between 15 mm and 150 mm. In some applications, the elongate capsule has a length of between 50 mm and 90 mm.

In some applications, the capsule is configured such that airflow through the capsule is substantially in an axial direction along a length of the capsule.

In some applications, the metallic foil is configured to be heated via resistive heating by the first electrode driving a current to the second electrode along a length of more than 5 mm in an axial direction along the metallic foil. In some applications, the capsule is configured such that airflow through the capsule is substantially in the axial direction along a length of the capsule. In some applications, the metallic foil is configured to be heated via resistive heating by the first electrode driving a current to the second electrode along a length of more than 15 mm in the axial direction along the metallic foil.

In some applications, the metallic foil has a thickness of between 1 micron and 20 microns. In some applications, the metallic foil has a thickness of between 3 microns and 10 microns.

There is further provided, in accordance with some applications of the present invention, apparatus for use with a smoking device that includes at least first and second electrodes, the apparatus including:
a capsule including:
   a smoking material containing one or more active agents; and
   metallic foil surrounding the smoking material, the metallic foil being configured to be heated via resistive heating by the electrodes driving a current into the metallic foil; and
   an inner lining that lines an inside of the metallic foil, the inner lining being configured to diffuse heat that is generated by the metallic foil.

In some applications, the smoking material includes a plant-based smoking material, the one or more of the active agents being configured to be vaporized from within the plant-based smoking material by the plant-based smoking material being heated.

In some applications, the smoking material includes a liquid material, one or more of the active agents being configured to be vaporized from within the liquid material by the liquid material being vaporized.

In some applications, the inner lining includes polyimide. In some applications, the inner lining is configured to diffuse heat that is generated by the metallic foil across the smoking material, thereby preventing hotspots from being generated within the smoking material. In some applications, the inner lining is configured to provide mechanical strength to the capsule, such as to reduce a likelihood of the capsule tearing as a result of mechanical pressure being applied to the capsule. In some applications, the electrodes are configured to apply mechanical pressure to the capsule, and the inner lining is disposed at regions of the capsule that are configured to be compressed by the electrodes.

In some applications, the inner lining is configured to diffuse one or more chemicals. In some applications, the inner lining includes a phase-change material that is configured to prevent the temperature of the smoking material from exceeding the phase-change temperature of the phase-change material. In some applications, the inner lining is configured to absorb chemicals that are generated by pyrolysis of the smoking material.

In some applications, the capsule further includes a collapse-prevention element configured to facilitate electrical contact between the electrodes and the metallic foil, by preventing the capsule from collapsing.

In some applications, the metallic foil includes a plurality of regions, each of the regions having a respective, different electrical resistance profile, such that upon a given current being driven through the metallic foil each of the regions heats to a respective, different temperature.

In some applications, the metallic foil is shaped such that at least a portion of the metallic foil is embedded within the smoking material.

In some applications, the capsule further includes an electrical-contact coating that coats the metallic foil at locations at which the electrodes are configured to contact the capsule.

In some applications, the metallic foil has a first configuration at locations at which the electrodes are configured to contact the metallic foil, and a second configuration along a region in which the metallic foil surrounds the smoking material that is between the locations at which the electrodes are configured to contact the metallic foil.

In some applications, the smoking device includes one or more batteries, and an overall resistance to the current that is provided by the capsule is configured to substantially match an internal resistance of the one or more batteries of the smoking device.

In some applications, the capsule further includes a paper covering that covers the metallic foil, the paper covering being adhered to itself along a band of overlap, such as to form a cylindrical shape and such that the metallic foil forms a band of overlap having an inner layer of metallic foil and an outer layer of metallic foil, and an electrically insulating material is disposed along the band of overlap, to isolate the inner layer of the metallic foil from the electrodes.

In some applications, the capsule further includes a paper covering that covers the metallic foil, the paper covering being adhered to itself along a band of overlap, such as to form a cylindrical shape and such that the metallic foil forms a band of overlap having an inner layer of metallic foil and an outer layer of metallic foil, and the metallic foil is treated along the band of overlap, in order to increase resistance of the metallic foil along the band of overlap.

In some applications, the capsule is shaped to define a cross-sectional shape having a ratio of more than 2:1 between a long side of the cross-sectional shape and a short side of the cross-sectional shape.

In some applications, the capsule further includes a paper covering that covers the metallic foil, the paper covering defining openings via which the electrodes are configured to make electrical contact with the metallic foil.

In some applications, at least a portion of the capsule is configured to be flattened by the smoking device prior to the one or more heating elements being heated by the smoking device. In some applications, the capsule has a circular cross-sectional shape and is configured to be flattened to define a non-circular cross-sectional shape. In some applications, the capsule is configured to be flattened such as to define a cross-sectional shape having a ratio of more than 2:1 between a long side of the cross-sectional shape and a short side of the cross-sectional shape.

In some applications, the capsule includes an elongate capsule having a length of between 15 mm and 150 mm. In some applications, the elongate capsule has a length of between 50 mm and 90 mm.

In some applications, the capsule is configured such that airflow through the capsule is substantially in an axial direction along a length of the capsule.

In some applications, the metallic foil is configured to be heated via resistive heating by the first electrode driving a current to the second electrode along a length of more than 5 mm in an axial direction along the metallic foil. In some applications, the capsule is configured such that airflow through the capsule is substantially in the axial direction along a length of the capsule. In some applications, the metallic foil is configured to be heated via resistive heating by the first electrode driving a current to the second electrode along a length of more than 15 mm in the axial direction along the metallic foil.

In some applications, the metallic foil has a thickness of between 1 micron and 20 microns. In some applications, the metallic foil has a thickness of between 3 microns and 10 microns.

There is further provided, in accordance with some applications of the present invention, apparatus for use with a smoking device that includes at least first and second electrodes, the apparatus including:
a capsule including:
   a smoking material containing one or more active agents; and
   metallic foil surrounding the smoking material, the metallic foil being configured to be heated via resistive heating by the electrodes driving a current into the metallic foil; and
   a paper covering that covers the metallic foil,
   the paper covering being adhered to itself along a band of overlap, such as to form a cylindrical shape and such that the metallic foil forms a band of overlap having an inner layer of metallic foil and an outer layer of metallic foil, and
   an electrically insulating material being disposed along the band of overlap, to isolate the inner layer of the metallic foil from the electrodes.

In some applications, the smoking material includes a plant-based smoking material, the one or more of the active agents being configured to be vaporized from within the plant-based smoking material by the plant-based smoking material being heated.

In some applications, the smoking material includes a liquid material, one or more of the active agents being configured to be vaporized from within the liquid material by the liquid material being vaporized.

In some applications, the electrically insulating material includes an adhesive that is used to adhere the paper covering to itself along the band of overlap. In some applications, the electrically insulating material includes polyimide.

In some applications, the metallic foil is shaped such that at least a portion of the metallic foil is embedded within the smoking material.

In some applications, the metallic foil includes a plurality of regions, each of the regions having a respective, different electrical resistance profile, such that upon a given current being driven through the metallic foil each of the regions heats to a respective, different temperature.

In some applications, the capsule further includes a collapse-prevention element configured to facilitate electrical contact between the electrodes and the metallic foil, by preventing the capsule from collapsing.

In some applications, the capsule further includes an electrical-contact coating that coats the metallic foil at locations at which the electrodes are configured to contact the capsule.

In some applications, the metallic foil has a first configuration at locations at which the electrodes are configured to contact the metallic foil, and a second configuration along a region in which the metallic foil surrounds the smoking material that is between the locations at which the electrodes are configured to contact the metallic foil.

In some applications, the capsule further includes an inner lining that lines an inside of the metallic foil, the inner lining being configured to diffuse heat that is generated by the metallic foil.

In some applications, the smoking device includes one or more batteries, and an overall resistance to the current that is provided by the capsule is configured to substantially match an internal resistance of the one or more batteries of the smoking device.

In some applications, the paper covering defines openings via which the electrodes are configured to make electrical contact with the metallic foil.

In some applications, the metallic foil is treated along the band of overlap, in order to increase resistance of the metallic foil along the band of overlap.

In some applications, the capsule is shaped to define a cross-sectional shape having a ratio of more than 2:1 between a long side of the cross-sectional shape and a short side of the cross-sectional shape.

In some applications, at least a portion of the capsule is configured to be flattened by the smoking device prior to the one or more heating elements being heated by the smoking device. In some applications, the capsule has a circular cross-sectional shape and is configured to be flattened to define a non-circular cross-sectional shape. In some applications, the capsule is configured to be flattened such as to define a cross-sectional shape having a ratio of more than 2:1 between a long side of the cross-sectional shape and a short side of the cross-sectional shape.

In some applications, the capsule includes an elongate capsule having a length of between 15 mm and 150 mm. In some applications, the elongate capsule has a length of between 50 mm and 90 mm.

In some applications, the capsule is configured such that airflow through the capsule is substantially in an axial direction along a length of the capsule.

In some applications, the metallic foil is configured to be heated via resistive heating by the first electrode driving a current to the second electrode along a length of more than 5 mm in an axial direction along the metallic foil. In some applications, the capsule is configured such that airflow through the capsule is substantially in the axial direction along a length of the capsule. In some applications, the metallic foil is configured to be heated via resistive heating by the first electrode driving a current to the second electrode along a length of more than 15 mm in the axial direction along the metallic foil.

In some applications, the metallic foil has a thickness of between 1 micron and 20 microns. In some applications, the metallic foil has a thickness of between 3 microns and 10 microns.

There is further provided, in accordance with some applications of the present invention, apparatus for use with a smoking device that includes at least first and second electrodes, the apparatus including:
a capsule including:
   a smoking material containing one or more active agents; and
   metallic foil surrounding the smoking material, the metallic foil being configured to be heated via resistive heating by the electrodes driving a current into the metallic foil; and
   a paper covering that covers the metallic foil,
   the paper covering being adhered to itself along a band of overlap, such as to form a cylindrical shape and such that the metallic foil forms a band of overlap having an inner layer of metallic foil and an outer layer of metallic foil, and
   the metallic foil being treated along the band of overlap, in order to increase resistance of the metallic foil along the band of overlap.

In some applications, the smoking material includes a plant-based smoking material, the one or more of the active agents being configured to be vaporized from within the plant-based smoking material by the plant-based smoking material being heated.

In some applications, the smoking material includes a liquid material, one or more of the active agents being configured to be vaporized from within the liquid material by the liquid material being vaporized.

In some applications, the metallic foil defines slits along the band of overlap, in order to increase resistance of the metallic foil along the band of overlap.

In some applications, the metallic foil is shaped such that at least a portion of the metallic foil is embedded within the smoking material.

In some applications, the metallic foil includes a plurality of regions, each of the regions having a respective, different electrical resistance profile, such that upon a given current being driven through the metallic foil each of the regions heats to a respective, different temperature.

In some applications, the capsule further includes a collapse-prevention element configured to facilitate electrical contact between the electrodes and the metallic foil, by preventing the capsule from collapsing.

In some applications, the capsule further includes an electrical-contact coating that coats the metallic foil at locations at which the electrodes are configured to contact the capsule.

In some applications, the metallic foil has a first configuration at locations at which the electrodes are configured to contact the metallic foil, and a second configuration along a region in which the metallic foil surrounds the smoking material that is between the locations at which the electrodes are configured to contact the metallic foil.

In some applications, the capsule further includes an inner lining that lines an inside of the metallic foil, the inner lining being configured to diffuse heat that is generated by the metallic foil.

In some applications, the smoking device includes one or more batteries, and an overall resistance to the current that is provided by the capsule is configured to substantially match an internal resistance of the one or more batteries of the smoking device.

In some applications, the paper covering defines openings via which the electrodes are configured to make electrical contact with the metallic foil.

In some applications, an electrically insulating material is disposed along the band of overlap, to isolate an inner layer of the metallic foil from the electrodes.

In some applications, the capsule is shaped to define a cross-sectional shape having a ratio of more than 2:1 between a long side of the cross-sectional shape and a short side of the cross-sectional shape.

In some applications, at least a portion of the capsule is configured to be flattened by the smoking device prior to the one or more heating elements being heated by the smoking device. In some applications, the capsule has a circular cross-sectional shape and is configured to be flattened to define a non-circular cross-sectional shape. In some applications, the capsule is configured to be flattened such as to define a cross-sectional shape having a ratio of more than 2:1 between a long side of the cross-sectional shape and a short side of the cross-sectional shape.

In some applications, the capsule includes an elongate capsule having a length of between 15 mm and 150 mm. In some applications, the elongate capsule has a length of between 50 mm and 90 mm.

In some applications, the capsule is configured such that airflow through the capsule is substantially in an axial direction along a length of the capsule.

In some applications, the metallic foil is configured to be heated via resistive heating by the first electrode driving a current to the second electrode along a length of more than 5 mm in an axial direction along the metallic foil. In some applications, the capsule is configured such that airflow through the capsule is substantially in the axial direction along a length of the capsule. In some applications, the metallic foil is configured to be heated via resistive heating by the first electrode driving a current to the second electrode along a length of more than 15 mm in the axial direction along the metallic foil.

In some applications, the metallic foil has a thickness of between 1 micron and 20 microns. In some applications, the metallic foil has a thickness of between 3 microns and 10 microns.

There is further provided, in accordance with some applications of the present invention, apparatus for use with a capsule that contains a smoking material containing one or more active agents, the apparatus including:
a smoking device configured to vaporize one or more of the active agents from within the smoking material by heating the smoking material, the smoking device including:
   two or more sensors, each of which is configured to detect a temperature of the capsule at the same location along a length of the capsule as each other.

In some applications, the smoking device is configured for use with a capsule that contains a plant-based smoking material and the smoking device is configured vaporize one or more of the active agents from within the plant-based smoking material by heating the plant-based smoking material.

In some applications, the smoking device is configured for use with a capsule that contains a liquid material and the smoking device is configured to vaporize one or more of the active agents from within the liquid material by vaporizing the liquid material.

In some applications, the sensors are configured to be placed on respective sides of the capsule. In some applications, the sensors include infrared temperature sensors. In some applications, the sensors include thermocouple sensors. In some applications, the sensors include contact sensors that are configured to contact the smoking material. In some applications, the sensors are configured to move axially along a length of the capsule.

In some applications, the smoking device includes a control component configured to:
receive an indication from a user indicating whether they wish to smoke the active agents in a first mode or a second mode;
in response to receiving an indication that the user wishes to smoke the active agents in the first mode, heat the smoking material to a vaporization temperature of the one or more active agents for a predefined period of time; and
in response to receiving an indication that the user wishes to smoke the active agents in the second mode, only heat the smoking material to the vaporization temperature while receiving an active input from the user that they wish for the smoking material to be heated.

In some applications, the control component is configured to preheat the smoking material to a temperature that is below the vaporization temperature of the one or more active agents, prior to receiving the indication from the user indicating whether they wish to smoke the active agents in the first mode or the second mode. In some applications, the control component is configured to preheat the smoking material to the temperature that is below the vaporization temperature of the one or more active agents automatically, in response to the capsule being inserted into the smoking device. In some applications, the control component is configured to preheat the smoking material to the temperature that is below the vaporization temperature of the one or more active agents, in response to an input from the user.

In some applications, the apparatus further includes a control component configured to determine a temperature of the smoking material at the location along the length of the capsule based upon the temperatures detected by each of the sensors. In some applications, the control component is configured to determine an average temperature of the smoking material at the location along the length of the capsule based upon the temperatures detected by each of the sensors. In some applications, the control component is configured to determine a maximum temperature of the smoking material at the location along the length of the capsule based upon the temperatures detected by each of the sensors. In some applications, the control component is configured to determine a minimum temperature of the smoking material at the location along the length of the capsule based upon the temperatures detected by each of the sensors. In some applications, the control component is configured to determine a temperature range of the smoking material at the location along the length of the capsule based upon the temperatures detected by each of the sensors. In some applications, based upon the temperatures detected by each of the sensors, the control component is configured to determine that the temperature detected by a first one of the sensors is indicative of a fault with the first one of the sensors, and, in response thereto, the control component is configured to determine the temperature of the smoking material based upon the temperature detect by a second one of the sensors.

In some applications, the control component is configured to control heating of the smoking material in response to the determined temperature of the smoking material. In some applications, the control component is configured to control heating of the smoking material such as to maintain the smoking material within a predefined temperature range.

In some applications, the smoking device includes:
two or more electrodes that are configured to heat the smoking material by generating resistive heating within the capsule by driving a current through a portion of the capsule; and
a control component that is configured to detect an amount of current that must be applied to the capsule in order to maintain the smoking material at a substantially constant temperature and to thereby detect that the user has puffed the smoking device.

In some applications, the control component is configured to determine a parameter of the puff. In some applications, the control component is configured to determine a length of the puff. In some applications, the control component is configured to determine a depth of the puff. In some applications, the control component is configured to determine an amount of one or more of the active agents that has been vaporized from the capsule by monitoring a number of puffs and parameters of the puffs that have been taken from the capsule.

There is further provided, in accordance with some applications of the present invention, apparatus for use with a capsule that contains a smoking material containing one or more active agents, the apparatus including:
a smoking device configured to vaporize one or more of the active agents from within the smoking material by heating the smoking material, the smoking device including:
   one or more sensors configured to detect temperature of the smoking material within the capsule and configured to be moveable axially along a length of the capsule.

In some applications, the smoking device is configured for use with a capsule that contains a plant-based smoking material and the smoking device is configured vaporize one or more of the active agents from within the plant-based smoking material by heating the plant-based smoking material.

In some applications, the smoking device is configured for use with a capsule that contains a liquid material and the smoking device is configured to vaporize one or more of the active agents from within the liquid material by vaporizing the liquid material.

In some applications, the sensor includes an infrared temperature sensor. In some applications, the sensor includes a thermocouple sensor. In some applications, the sensor includes a contact sensor that is configured to contact the smoking material.

In some applications, the smoking device includes two or more electrodes that are configured to heat the smoking material by driving a current through the capsule, and the two or more electrodes are configured to configured to be moveable axially along the length of the capsule together with the one or more sensors. In some applications, the smoking device includes a motor and a rail and the motor is configured to move the one or more sensors axially along the length of the capsule by sliding the one or more sensors along the rail.

In some applications, the smoking device includes a control component configured to:
receive an indication from a user indicating whether they wish to smoke the active agents in a first mode or a second mode;
in response to receiving an indication that the user wishes to smoke the active agents in the first mode, heat the smoking material to a vaporization temperature of the one or more active agents for a predefined period of time; and
in response to receiving an indication that the user wishes to smoke the active agents in the second mode, only heat the smoking material to the vaporization temperature while receiving an active input from the user that they wish for the smoking material to be heated.

In some applications, the control component is configured to preheat the smoking material to a temperature that is below the vaporization temperature of the one or more active agents, prior to receiving the indication from the user indicating whether they wish to smoke the active agents in the first mode or the second mode. In some applications, the control component is configured to preheat the smoking material to the temperature that is below the vaporization temperature of the one or more active agents automatically, in response to the capsule being inserted into the smoking device. In some applications, the control component is configured to preheat the smoking material to the temperature that is below the vaporization temperature of the one or more active agents, in response to an input from the user.

In some applications, the sensor includes two or more sensors, each of which is configured to detect a temperature of the capsule at the same location along a length of the capsule as each other, at a given time. In some applications, the sensors are configured to be placed on respective sides of the capsule. In some applications, the apparatus further includes a control component configured to determine a temperature of the smoking material at the location along the length of the capsule based upon the temperatures detected by the sensors. In some applications, the control component is configured to determine an average temperature of the smoking material at the location along the length of the capsule based upon the temperatures detected by each of the sensors. In some applications, the control component is configured to determine a maximum temperature of the smoking material at the location along the length of the capsule based upon the temperatures detected by each of the sensors. In some applications, the control component is configured to determine a minimum temperature of the smoking material at the location along the length of the capsule based upon the temperatures detected by each of the sensors. In some applications, the control component is configured to determine a temperature range of the smoking material at the location along the length of the capsule based upon the temperatures detected by each of the sensors. In some applications, based upon the temperatures detected by each of the sensors the control component is configured to determine that the temperature detected by a first one of the sensors is indicative of a fault with the first one of the sensors, and, in response thereto, the control component is configured to determine the temperature of the smoking material based upon the temperature detect by a second one of the sensors.

In some applications, the apparatus further includes a control component configured to determine a temperature of the smoking material based upon the temperature detected by the sensor. In some applications, the control component is configured to control heating of the smoking material in response to the determined temperature of the smoking material. In some applications, the control component is configured to control heating of the smoking material such as to maintain the smoking material within a predefined temperature range.

In some applications, the smoking device includes:
two or more electrodes that are configured to heat the smoking material by generating resistive heating within the capsule by driving a current through a portion of the capsule; and
a control component that is configured to detect an amount of current that must be applied to the capsule in order to maintain the smoking material at a substantially constant temperature and to thereby detect that the user has puffed the smoking device.

In some applications, the control component is configured to determine a parameter of the puff. In some applications, the control component is configured to determine a length of the puff. In some applications, the control component is configured to determine a depth of the puff. In some applications, the control component is configured to determine an amount of one or more of the active agents that has been vaporized from the capsule by monitoring a number of puffs and parameters of the puffs that have been taken from the capsule.

There is further provided, in accordance with some applications of the present invention, apparatus for use with a capsule that contains a smoking material containing one or more active agents, the apparatus including:
a smoking device configured to vaporize one or more of the active agents from within the smoking material by heating the smoking material, the smoking device including a control component configured to:
   receive an indication from a user indicating whether they wish to smoke the active agents in a first mode or a second mode;
   in response to receiving an indication that the user wishes to smoke the active agents in the first mode, heat the smoking material to a vaporization temperature of the one or more active agents for a predefined period of time; and
   in response to receiving an indication that the user wishes to smoke the active agents in the second mode, heat the smoking material to the vaporization temperature only while receiving an active input from the user that they wish for the smoking material to be heated.

In some applications, the smoking device is configured for use with a capsule that contains a plant-based smoking material and the smoking device is configured vaporize one or more of the active agents from within the plant-based smoking material by heating the plant-based smoking material.

In some applications, the smoking device is configured for use with a capsule that contains a liquid material and the smoking device is configured to vaporize one or more of the active agents from within the liquid material by vaporizing the liquid material.

In some applications, the control component is configured, in response to receiving an indication that the user wishes to smoke the active agents in the first mode, to heat the smoking material to the vaporization temperature for a predefined period of time that is between 60 seconds and 600 seconds.

In some applications, the smoking device includes a button configured to be pressed by a user, and the control component is configured such that:
the user pressing the button for a duration that is less than a threshold duration, is interpreted by the control component that the user wishes to smoke the active agents in the second mode; and
the user pressing the button for a duration that is more than the threshold duration, is interpreted by the control component that the user wishes to smoke the active agents in the first mode.

In some applications, the control component is configured to preheat the smoking material to a temperature that is below the vaporization temperature of the one or more active agents, prior to receiving the indication from the user indicating whether they wish to smoke the active agents in the first mode or the second mode. In some applications, the control component is configured to preheat the smoking material to the temperature that is below the vaporization temperature of the one or more active agents automatically, in response to the capsule being inserted into the smoking device. In some applications, the control component is configured to preheat the smoking material to the temperature that is below the vaporization temperature of the one or more active agents, in response to an input from the user.

In some applications, the smoking device includes a button configured to be pressed by a user, and the control component is configured such that:
the user pressing the button for a duration that is less than a threshold duration, is interpreted by the control component that the user wishes to smoke the active agents in the first mode; and
the user pressing the button for a duration that is more than the threshold duration, is interpreted by the control component that the user wishes to smoke the active agents in the second mode.

In some applications, the threshold duration is between 0 and 2 seconds.

In some applications, the smoking device is configured such that during a smoking session, the user can switch from the first mode to the second mode by pressing the button for more than the threshold duration.

In some applications, the smoking device is configured such that during a smoking session, the user can switch from the second mode to the first mode by pressing the button for less than the threshold duration.

In some applications, the smoking device is configured to:
flatten at least part of a portion of the capsule that contains the smoking material; and
vaporize one or more of the active agents from within the smoking material by heating the smoking material while at least part of the portion of the capsule that contains the smoking material is in a flattened configuration.

In some applications, the smoking device includes roller wheels that are configured to flatten at least part of the portion of the capsule that contains the smoking material upon the capsule being inserted into the smoking device. In some applications, the smoking device includes a funnel that is configured to flatten at least part of the portion of the capsule that contains the smoking material upon the capsule being inserted into the smoking device. In some applications, the smoking device includes mechanical elements that are configured to flatten at least part of the portion of the capsule that contains the smoking material by applying mechanical pressure to the capsule.

In some applications, the smoking device is configured to flatten the at least part of the portion of the capsule that contains the smoking material such that the part of the portion of the capsule that contains the smoking material defines a cross-sectional shape having a ratio of more than 2:1 between a long side of the cross-sectional shape and a short side of the cross-sectional shape. In some applications, the smoking device is configured to flatten the at least part of the portion of the capsule that contains the smoking material such that the part of the portion of the capsule that contains the smoking material defines a cross-sectional shape having a ratio of more than 3:1 between a long side of the cross-sectional shape and a short side of the cross-sectional shape. In some applications, the smoking device is configured to flatten the at least part of the portion of the capsule that contains the smoking material such that the part of the portion of the capsule that contains the smoking material defines a cross-sectional shape having a ratio of more than 4:1 between a long side of the cross-sectional shape and a short side of the cross-sectional shape. In some applications, the smoking device is configured to flatten the at least part of the portion of the capsule that contains the smoking material such that the part of the portion of the capsule that contains the smoking material defines a cross-sectional shape having a ratio of more than 6:1 between a long side of the cross-sectional shape and a short side of the cross-sectional shape.

In some applications, the smoking device includes two or more electrodes that are configured to heat the smoking material by generating resistive heating within the capsule by driving a current through a portion of the capsule. In some applications, the electrodes are configured to move axially along a length of the capsule. In some applications, the smoking device includes a mechanism configured to bring the electrodes into pressurized contact with the capsule, in order to enhance electrical contact between the electrodes and the capsule.

In some applications, the capsule includes an elongate capsule, during the heating of the smoking material, the smoking device is configured to house the capsule such that airflow through the capsule is substantially along a length of the elongate capsule, and a first one of the electrodes is configured to drive the current toward a second one of the electrodes along a length of more than 5 mm in an axial direction along a length of the capsule. In some applications, the first one of the electrodes is configured to drive the current toward the second one of the electrodes along a length of more than 15 mm in the axial direction along a length of the capsule.

In some applications, the smoking device is configured to receive a capsule that includes a metallic foil surrounding the smoking material, and the electrodes are configured to drive a current through the metallic foil. In some applications, the smoking device is configured to receive a capsule that includes a metallic foil surrounding the smoking material and a paper covering that covers the metallic foil and the electrodes are needle shaped and are configured to make electrical contact with the metallic foil by piercing through the paper covering.

In some applications, the smoking device includes a coil that is configured to heat the smoking material by generating a magnetic field such as to heat the capsule via magnetic induction. In some applications, the coil is configured to be flattened while at least part of the portion of the capsule that contains the smoking material is disposed within the coil. In some applications, the coil is shaped to define a non-circular cross-sectional shape even before part of the portion of the capsule that contains the smoking material is introduced to within the coil, and the smoking device is configured to flatten the part of the portion of the capsule that contains the smoking material prior to the part of the portion of the capsule that contains the smoking material being introduced to within the coil.

In some applications, the smoking device is configured to receive a cylindrically-shaped elongate capsule having a length of between 15 mm and 150 mm. In some applications, the smoking device is configured to receive a cylindrically-shaped elongate capsule having a length of between 50 mm and 90 mm.

There is further provided, in accordance with some applications of the present invention, apparatus for use with a capsule that contains a smoking material containing one or more active agents, the apparatus including:
a smoking device configured to vaporize one or more of the active agents from within the smoking material by heating the smoking material, the smoking device including:
   roller wheels that are configured to change a shape of the capsule upon the capsule being inserted into the smoking device.

In some applications, the smoking device is configured for use with a capsule that contains a plant-based smoking material and the smoking device is configured vaporize one or more of the active agents from within the plant-based smoking material by heating the plant-based smoking material.

In some applications, the smoking device is configured for use with a capsule that contains a liquid material and the smoking device is configured to vaporize one or more of the active agents from within the liquid material by vaporizing the liquid material.

There is further provided, in accordance with some applications of the present invention, apparatus for use with a capsule that contains a smoking material containing one or more active agents, the apparatus including:
a smoking device configured to vaporize one or more of the active agents from within the smoking material by heating the smoking material, the smoking device including:
   a funnel that is configured to change a shape of the capsule upon the capsule being inserted into the smoking device.

In some applications, the smoking device is configured for use with a capsule that contains a plant-based smoking material and the smoking device is configured vaporize one or more of the active agents from within the plant-based smoking material by heating the plant-based smoking material.

In some applications, the smoking device is configured for use with a capsule that contains a liquid material and the smoking device is configured to vaporize one or more of the active agents from within the liquid material by vaporizing the liquid material.

There is further provided, in accordance with some applications of the present invention, apparatus for use with a capsule that contains a smoking material containing one or more active agents, the apparatus including:
a smoking device configured to receive the capsule, the smoking device including:
   two or more electrodes that are configured to:
      vaporize one or more of the active agents from within the smoking material by heating the smoking material, by driving a current into a portion of the capsule; and
      move axially along a length of the capsule.

In some applications, the smoking device is configured for use with a capsule that contains a plant-based smoking material and the smoking device is configured vaporize one or more of the active agents from within the plant-based smoking material by heating the plant-based smoking material.

In some applications, the smoking device is configured for use with a capsule that contains a liquid material and the smoking device is configured to vaporize one or more of the active agents from within the liquid material by vaporizing the liquid material.

In some applications, the smoking device is configured to receive a cylindrically-shaped capsule, and the smoking device includes a cylindrically-shaped insertion port configured to receive the cylindrically-shaped capsule and a non-cylindrical housing configured to house at least part of a portion of the capsule that contains the smoking material, while the smoking material is heated.

In some applications, the smoking device includes a mechanism configured to bring the electrodes into pressurized contact with the capsule, in order to enhance electrical contact between the electrodes and the capsule.

In some applications, the smoking device includes one or more sensors configured to detect temperature of the smoking material within the capsule, and the one or more sensors are configured to configured to be moveable axially along the length of the capsule together with the two or more electrodes.

In some applications, the smoking device includes a motor and a rail and the motor is configured to move the two or more electrodes axially along the length of the capsule by sliding the two or more electrodes along the rail.

In some applications, the smoking device includes a control component configured to:
receive an indication from a user indicating whether they wish to smoke the active agents in a first mode or a second mode;
in response to receiving an indication that the user wishes to smoke the active agents in the first mode, heat the smoking material to a vaporization temperature of the one or more active agents for a predefined period of time; and
in response to receiving an indication that the user wishes to smoke the active agents in the second mode, only heat the smoking material to the vaporization temperature while receiving an active input from the user that they wish for the smoking material to be heated.

In some applications, the control component is configured to preheat the smoking material to a temperature that is below the vaporization temperature of the one or more active agents, prior to receiving the indication from the user indicating whether they wish to smoke the active agents in the first mode or the second mode. In some applications, the control component is configured to preheat the smoking material to the temperature that is below the vaporization temperature of the one or more active agents automatically, in response to the capsule being inserted into the smoking device. In some applications, the control component is configured to preheat the smoking material to the temperature that is below the vaporization temperature of the one or more active agents, in response to an input from the user.

In some applications, the smoking device is configured to receive a capsule that includes a metallic foil surrounding the smoking material, and the electrodes are configured to drive a current through the metallic foil. In some applications, the smoking device is configured to receive a capsule that includes a metallic foil surrounding the smoking material and a paper covering that covers the metallic foil and the electrodes are needle shaped and are configured to make electrical contact with the metallic foil by piercing through the paper covering.

In some applications, the smoking device is configured to receive an elongate capsule, during the heating of the smoking material, the smoking device is configured to house the capsule such that airflow through the capsule is substantially along a length of the elongate capsule, and a first one of the electrodes is configured to drive the current toward a second one of the electrodes along a length of more than 5 mm in an axial direction along a length of the capsule. In some applications, the first one of the electrodes is configured to drive the current toward the second one of the electrodes along a length of more than 15 mm in the axial direction along a length of the capsule.

In some applications, the smoking device is configured to receive a cylindrically-shaped elongate capsule having a length of between 15 mm and 150 mm. In some applications, the smoking device is configured to receive a cylindrically-shaped elongate capsule having a length of between 50 mm and 90 mm.

In some applications, the electrodes are configured to change a shape of the capsule upon the capsule being inserted into the smoking device, by exerting mechanical pressure upon the capsule. In some applications, the electrodes are configured to flatten at least a part of a portion of the capsule that contains the smoking material such that the part of the portion of the capsule that contains the smoking material defines a cross-sectional shape having a ratio of more than 2:1 between a long side of the cross-sectional shape and a short side of the cross-sectional shape. In some applications, the electrodes are configured to flatten at least a part of a portion of the capsule that contains the smoking material such that the part of the portion of the capsule that contains the smoking material defines a cross-sectional shape having a ratio of more than 3:1 between a long side of the cross-sectional shape and a short side of the cross-sectional shape. In some applications, the electrodes are configured to flatten at least a part of a portion of the capsule that contains the smoking material such that the part of the portion of the capsule that contains the smoking material defines a cross-sectional shape having a ratio of more than 4:1 between a long side of the cross-sectional shape and a short side of the cross-sectional shape. In some applications, the electrodes are configured to flatten at least a part of a portion of the capsule that contains the smoking material such that the part of the portion of the capsule that contains the smoking material defines a cross-sectional shape having a ratio of more than 6:1 between a long side of the cross-sectional shape and a short side of the cross-sectional shape.

In some applications, the smoking device is configured to flatten at least part of a portion of the capsule that contains the smoking material. In some applications, the smoking device includes roller wheels that are configured to flatten at least part of the portion of the capsule that contains the smoking material upon the capsule being inserted into the smoking device. In some applications, the smoking device includes a funnel that is configured to flatten at least part of the portion of the capsule that contains the smoking material upon the capsule being inserted into the smoking device. In some applications, the smoking device includes mechanical elements that are configured to flatten at least part of the portion of the capsule that contains the smoking material by applying mechanical pressure to the capsule.

There is further provided, in accordance with some applications of the present invention, apparatus for use with a capsule that contains a smoking material containing one or more active agents, the smoking material being covered with a metallic foil and a paper covering, the apparatus including:
a smoking device configured to receive the capsule, the smoking device including:
   two or more electrodes that are configured to vaporize one or more of the active agents from within the smoking material by heating the smoking material, by driving a current into the metallic foil,
   the two or more electrodes being needle shaped and being configured to make electrical contact with the metallic foil by piercing through the paper covering.

In some applications, the smoking device is configured for use with a capsule that contains a plant-based smoking material and the smoking device is configured vaporize one or more of the active agents from within the plant-based smoking material by heating the plant-based smoking material.

In some applications, the smoking device is configured for use with a capsule that contains a liquid material and the smoking device is configured to vaporize one or more of the active agents from within the liquid material by vaporizing the liquid material.

In some applications, the smoking device is configured to receive a cylindrically-shaped capsule, and the smoking device includes a cylindrically-shaped insertion port configured to receive the cylindrically-shaped capsule and a non-cylindrical housing configured to house at least part of a portion of the capsule that contains the smoking material, while the smoking material is heated.

In some applications, the electrodes are configured to move axially along a length of the capsule.

In some applications, the smoking device includes a mechanism configured to bring the electrodes into pressurized contact with the capsule, in order to enhance electrical contact between the electrodes and the capsule.

In some applications, the smoking device includes a control component configured to:
receive an indication from a user indicating whether they wish to smoke the active agents in a first mode or a second mode;
in response to receiving an indication that the user wishes to smoke the active agents in the first mode, heat the smoking material to a vaporization temperature of the one or more active agents for a predefined period of time; and
in response to receiving an indication that the user wishes to smoke the active agents in the second mode, only heat the smoking material to the vaporization temperature while receiving an active input from the user that they wish for the smoking material to be heated.

In some applications, the control component is configured to preheat the smoking material to a temperature that is below the vaporization temperature of the one or more active agents, prior to receiving the indication from the user indicating whether they wish to smoke the active agents in the first mode or the second mode. In some applications, the control component is configured to preheat the smoking material to the temperature that is below the vaporization temperature of the one or more active agents automatically, in response to the capsule being inserted into the smoking device. In some applications, the control component is configured to preheat the smoking material to the temperature that is below the vaporization temperature of the one or more active agents, in response to an input from the user.

In some applications, the smoking device is configured to receive an elongate capsule, during the heating of the smoking material, the smoking device is configured to house the capsule such that airflow through the capsule is substantially along a length of the elongate capsule, and a first one of the electrodes is configured to drive the current toward a second one of the electrodes along a length of more than 5 mm in an axial direction along a length of the capsule. In some applications, the first one of the electrodes is configured to drive the current toward the second one of the electrodes along a length of more than 15 mm in the axial direction along the length of the capsule.

In some applications, the smoking device is configured to receive a cylindrically-shaped elongate capsule having a length of between 15 mm and 150 mm. In some applications, the smoking device is configured to receive a cylindrically-shaped elongate capsule having a length of between 50 mm and 90 mm.

In some applications, the electrodes are configured to change a shape of the capsule upon the capsule being inserted into the smoking device, by exerting mechanical pressure upon the capsule. In some applications, the electrodes are configured to flatten at least a part of a portion of the capsule that contains the smoking material such that the part of the portion of the capsule that contains the smoking material defines a cross-sectional shape having a ratio of more than 2:1 between a long side of the cross-sectional shape and a short side of the cross-sectional shape. In some applications, the electrodes are configured to flatten at least a part of a portion of the capsule that contains the smoking material such that the part of the portion of the capsule that contains the smoking material defines a cross-sectional shape having a ratio of more than 3:1 between a long side of the cross-sectional shape and a short side of the cross-sectional shape. In some applications, the electrodes are configured to flatten at least a part of a portion of the capsule that contains the smoking material such that the part of the portion of the capsule that contains the smoking material defines a cross-sectional shape having a ratio of more than 4:1 between a long side of the cross-sectional shape and a short side of the cross-sectional shape. In some applications, the electrodes are configured to flatten at least a part of a portion of the capsule that contains the smoking material such that the part of the portion of the capsule that contains the smoking material defines a cross-sectional shape having a ratio of more than 6:1 between a long side of the cross-sectional shape and a short side of the cross-sectional shape.

In some applications, the smoking device is configured to flatten at least part of a portion of the capsule that contains the smoking material. In some applications, the smoking device includes roller wheels that are configured to flatten at least part of the portion of the capsule that contains the smoking material upon the capsule being inserted into the smoking device. In some applications, the smoking device includes a funnel that is configured to flatten at least part of the portion of the capsule that contains the smoking material upon the capsule being inserted into the smoking device. In some applications, the smoking device includes mechanical elements that are configured to flatten at least part of the portion of the capsule that contains the smoking material by applying mechanical pressure to the capsule.

There is further provided, in accordance with some applications of the present invention, apparatus for use with a capsule that contains a smoking material containing one or more active agents, the smoking material being covered with a metallic foil, the apparatus including:
a smoking device configured to receive the capsule, the smoking device including:
   two or more electrodes that are configured to vaporize one or more of the active agents from within the smoking material by heating the smoking material, by driving a current into the metallic foil; and
   a control component configured to periodically drive a test current through the electrodes and detect whether a capsule is disposed within the smoking device based upon a response to the test current.

In some applications, when a capsule is disposed within the smoking device, the control component is further configured to:
drive a further test current through the electrodes;
measure resistance between the electrodes in response to the test current; and
in response thereto, detect at least one fault selected from the group consisting of: a fault within a capsule, a fault with the smoking device, and a fault with electrical contact between the electrodes and the capsule.

In some applications, when a capsule is disposed within the smoking device, the control component is further configured to:
drive a further test current through the electrodes;
measure a change in temperature of a portion of the capsule in response to the test current; and
in response thereto, detect at least one fault selected from the group consisting of: a fault within a capsule, a fault with the smoking device, and a fault with electrical contact between the electrodes and the capsule.

In some applications, the smoking device is configured for use with a capsule that contains a plant-based smoking material and the smoking device is configured vaporize one or more of the active agents from within the plant-based smoking material by heating the plant-based smoking material.

In some applications, the smoking device is configured for use with a capsule that contains a liquid material and the smoking device is configured to vaporize one or more of the active agents from within the liquid material by vaporizing the liquid material.

In some applications, the control component is configured to detect that there is no capsule disposed within the smoking device is response to the test current not flowing from a first one of the electrodes to a second one of the electrodes.

In some applications, the control component is configured to detect that there is a capsule disposed within the smoking device is response to the test current flowing, with a given resistance profile, from a first one of the electrodes to a second one of the electrodes.

There is further provided, in accordance with some applications of the present invention, apparatus for use with a capsule that contains a smoking material containing one or more active agents, the smoking material being covered with a metallic foil, the apparatus including:
a smoking device configured to receive the capsule, the smoking device including:
   two or more electrodes that are configured to vaporize one or more of the active agents from within the smoking material by heating the smoking material, by driving a current into the metallic foil; and
   a control component configured to:
      drive a test current through the electrodes;
      measure resistance between the electrodes in response to the test current; and
      in response thereto, detect at least one fault selected from the group consisting of: a fault within a capsule, a fault with the smoking device, and a fault with electrical contact between the electrodes and the capsule.

In some applications, the control component is further configured to:
drive a further test current through the electrodes;
measure a change in temperature of a portion of the capsule in response to the test current; and
in response thereto, detect at least one fault selected from the group consisting of: a fault within a capsule, a fault with the smoking device, and a fault with electrical contact between the electrodes and the capsule.

In some applications, the control component is further configured to periodically drive a further test current through the electrodes, and detect whether a capsule is disposed within the smoking device based upon a response to the test current.

In some applications, the smoking device is configured for use with a capsule that contains a plant-based smoking material and the smoking device is configured vaporize one or more of the active agents from within the plant-based smoking material by heating the plant-based smoking material.

In some applications, the smoking device is configured for use with a capsule that contains a liquid material and the smoking device is configured to vaporize one or more of the active agents from within the liquid material by vaporizing the liquid material.

There is further provided, in accordance with some applications of the present invention, apparatus for use with a capsule that contains a smoking material containing one or more active agents, the smoking material being covered with a metallic foil, the apparatus including:
a smoking device configured to receive the capsule, the smoking device including:
   two or more electrodes that are configured to vaporize one or more of the active agents from within the smoking material by heating the smoking material, by driving a current into the metallic foil; and
   a control component configured to:
      drive a test current through the electrodes;
      measure a change in temperature of a portion of the capsule in response to the test current; and
   in response thereto, detect at least one fault selected from the group consisting of: a fault within a capsule, a fault with the smoking device, and a fault with electrical contact between the electrodes and the capsule.

In some applications, the control component is further configured to:
drive a further test current through the electrodes;
measure resistance between the electrodes in response to the test current; and
in response thereto, detect at least one fault selected from the group consisting of: a fault within a capsule, a fault with the smoking device, and a fault with electrical contact between the electrodes and the capsule.

In some applications, the control component is further configured to periodically drive a further test current through the electrodes, and detect whether a capsule is disposed within the smoking device based upon a response to the test current.

In some applications, the smoking device is configured for use with a capsule that contains a plant-based smoking material and the smoking device is configured vaporize one or more of the active agents from within the plant-based smoking material by heating the plant-based smoking material.

In some applications, the smoking device is configured for use with a capsule that contains a liquid material and the smoking device is configured to vaporize one or more of the active agents from within the liquid material by vaporizing the liquid material.

The present invention will be more fully understood from the following detailed description of applications thereof, taken together with the drawings, in which:

### BRIEF DESCRIPTION OF THE DRAWINGS

FIGS. 1A, 1B, 1C, and 1D are schematic illustrations of a capsule (FIGS. 1A-1B), a smoking device (FIG. 1C), and the capsule inserted in the smoking device (FIG. 1D), in accordance with some applications of the present invention;

FIGS. 2A, 2B, 2C, and 2D are schematic illustrations of isometric views and end views of the capsule, with a portion of the capsule that contains smoking material and a heating element having a shape that is flattened relative to a traditional cigarette, such that it has an elliptical cross-sectional shape (FIG. 2A), a rectangular cross-sectional shape (FIG. 2B), a pill-shaped cross-sectional shape (FIG. 2C), or a racetrack-shaped cross-sectional shape (FIG. 2D), in accordance with some applications of the present invention;

FIGS. 3A, 3B, and 3C are schematic illustrations of, respectively, a capsule having a circular cross-section, a capsule that has been flattened by having pressure applied to the capsule at discrete locations along its length, and a capsule that has been flattened along the entire length of the portion of the capsule that contains smoking material and a heating element, in accordance with some applications of the present invention;

FIGS. 4A, 4B, and 4C are schematic illustrations of electrodes being placed in electrical contact with a heating element of a capsule, in accordance with some applications of the present invention;

FIG. 4D is a schematic illustration of electrodes that include needle contacts that are configured to pierce a paper covering and directly contact a heating element of a capsule, in accordance with some applications of the present invention;

FIG. 5 is a schematic illustration of a heating element that includes folds, in accordance with some applications of the present invention;

FIGS. 6A and 6B are schematic illustrations of a capsule that includes a heating element that penetrates into smoking material, in accordance with some applications of the present invention;

FIGS. 7A, 7B, 7C and 7D are schematic illustrations of a capsule that includes one or more magnetic heating elements, in accordance with some applications of the present invention;

FIGS. 8A and 8B are schematic illustrations of one or more sensors for sensing the temperature of the smoking material within a capsule, in accordance with some applications of the present invention;

FIG. 8C is a schematic illustration of a capsule that includes a portion that is disposed in the vicinity of a temperature sensor, the portion being covered, coated, and/or treated such as to be non-reflective or to have a high emissivity value, in accordance with some applications of the present invention;

FIG. 8D is a schematic illustration of two or more sensors being used to detect the temperature of the smoking material within capsule at the same location along the length of the capsule as each other, in accordance with some applications of the present invention;

FIGS. 9A, 9B, and 9C are schematic illustrations of a capsule including a collapse-prevention element, in accordance with some applications of the present invention;

FIGS. 10A and 10B are schematic illustrations of a capsule including a collapse-prevention element, in accordance with some alternative applications of the present invention;

FIGS. 11A and 11B are schematic illustrations of a capsule including a collapse-prevention element, in accordance with some additional applications of the present invention;

FIG. 12 is a schematic illustration of a capsule including a collapse-prevention element, in accordance with some additional applications of the present invention;

FIG. 13 is a schematic illustration of a capsule including a collapse-prevention element, in accordance with some further applications of the present invention;

FIG. 14 is a schematic illustration of a capsule including a collapse-prevention element, in accordance with some additional applications of the present invention;

FIGS. 15A and 15B are schematic illustrations of a capsule including a collapse-prevention element, in accordance with some further applications of the present invention;

FIGS. 16A and 16B are schematic illustrations of a capsule including a collapse-prevention element, in accordance with some additional applications of the present invention;

FIG. 17 is a schematic illustration of a capsule including one or more stoppers, in accordance with some applications of the present invention;

FIGS. 18A, 18B, and 18C are schematic illustrations of a capsule including a mouthpiece, in accordance with some applications of the present invention;

FIGS. 18D, 18E, and 18F are schematic illustrations of respective views of a capsule with a multi-purpose mouthpiece, in accordance with some applications of the present invention;

FIGS. 19A and 19B are schematic illustrations of a paper covering and heating element of a capsule, in accordance with some applications of the present invention;

FIGS. 20A, 20B, and 20C are schematic illustrations of a capsule including an electrical contact coating at a region at which the capsule is configured to contact electrodes, in accordance with some applications of the present invention;

FIGS. 21A, 21B, and 21C are schematic illustrations of the capsule, the capsule including a region that surrounds the smoking material, at which a foil heating element has greater resistance than the resistance of the foil at the region at which the capsule is configured to contact electrodes, in accordance with some applications of the present invention;

FIGS. 22A, 22B, 22C and 22D are schematic illustrations of a covering material of a capsule that includes an inner lining, in accordance with some applications of the present invention;

FIGS. 23A, 23B, 23C, 23D, 23E, and 23F are schematic illustrations of a covering material of a capsule that includes adhesive and/or additional material at a band of overlap of the covering material, in accordance with some applications of the present invention;

FIGS. 24A and 24B are schematic illustrations of a covering material of a capsule with slits formed in conducting elements at a band of overlap of the covering material, in accordance with some applications of the present invention;

FIGS. 25A, 25B, and 25C are schematic illustrations of a capsule that includes one or more identifying features, in accordance with some applications of the present invention;

FIG. 26 is a schematic illustration of a smoking device with its cover removed (for illustrative purposes), in accordance with some applications of the present invention;

FIGS. 27A, 27B, 27C, 27D, 27E, and 27F are schematic illustrations of mechanical elements for flattening a portion of a capsule, in accordance with some applications of the present invention;

FIG. 28 is a schematic illustration of a smoking device that includes electrodes and/or mechanical elements that are configured to move axially relative to a capsule, in accordance with some applications of the present invention;

FIGS. 29A and 29B are schematic illustrations of a smoking device that includes a mechanism that is configured to bring electrodes and/or mechanical elements into pressurized contact with a capsule, in accordance with some applications of the present invention;

FIGS. 29C and 29D are schematic illustrations of a smoking device that includes a mechanism that is configured to bring electrodes and/or mechanical elements into pressurized contact with a capsule, in accordance with some further applications of the present invention;

FIGS. 30A and 30B are schematic illustrations of a coil of a smoking device that is configured to be flattened by mechanical elements, in accordance with some applications of the present invention;

FIGS. 31A, 31B, 31C, and 31D are schematic illustrations of a coil of a smoking device that is pre-shaped in a flattened configuration, in accordance with some applications of the present invention;

FIGS. 32A and 32B are schematic illustrations of a coil of a smoking device, in accordance with some applications of the present invention;

FIG. 33 is a schematic illustration of a capsule being heated, while the capsule is in a non-flattened, cylindrical shape, in accordance with some applications of the present invention;

FIG. 34 is a flowchart showing steps that are performed by a smoking device, in accordance with some applications of the present invention;

FIGS. 35A, 35B, and 35C are schematic illustrations of respective views of a capsule for use with a liquid material that is configured to be vaporized by a smoking device, the capsule including a layer of absorbent material, in accordance with some applications of the present invention;

FIGS. 36A and 36B are schematic illustrations of respective views of a capsule for use with a liquid material that is configured to be vaporized by a smoking device, the capsule including a layer of absorbent material with holes therethrough, in accordance with some applications of the present invention;

FIGS. 37A and 37B are schematic illustrations of respective views of a capsule for use with a liquid material that is configured to be vaporized by a smoking device, the capsule including a reservoir of the liquid material absorbed within an absorbent material, only portions of the absorbent material being configured to be heated, in accordance with some applications of the present invention;

FIGS. 38A and 38B are schematic illustrations of respective views of a capsule for use with a liquid material that is configured to be vaporized by a smoking device, the capsule including a reservoir of the liquid material absorbed within an absorbent material, the absorbent material defining airflow channels along its perimeter, in accordance with some applications of the present invention;

FIGS. 39A and 39B are schematic illustrations of a capsule for use with a liquid material that is configured to be vaporized by a smoking device, the capsule including a layer of absorbent material having a non-uniform thickness, in accordance with respective applications of the present invention;

FIGS. 40A and 40B are schematic illustrations of respective views of a capsule for use with a liquid material that is configured to be vaporized by a smoking device, the capsule including a reservoir that contains the liquid material, in accordance with some applications of the present invention;

FIGS. 41A, 41B, and 41C are schematic illustrations of respective views of a capsule for use with a liquid material that is configured to be vaporized by a smoking device, the capsule including a capillary-force-delivery element configured to deliver the liquid material to a heating element, in accordance with some applications of the present invention;

FIGS. 42A, 42B, and 42C are schematic illustrations of respective views of a capsule for use with a liquid material that is configured to be vaporized by a smoking device, the capsule including a capillary-force-delivery element configured to deliver the liquid material to an internal heating element disposed within the capsule, in accordance with some applications of the present invention;

FIGS. 43A, 43B, 43C, and 43D are schematic illustrations of respective views of a capsule for use with a liquid material that is configured to be vaporized by a smoking device, the capsule including a capillary-force-delivery element configured to deliver the liquid material to an internal heating element, in accordance with some applications of the present invention;

FIGS. 44A, 44B, 44C, and 44D are schematic illustrations of respective views of a capsule for use with a liquid material that is configured to be vaporized by a smoking device, the capsule including a capillary-force-delivery element configured to deliver the liquid material to an internal heating element, in accordance with some alternative applications of the present invention;

FIGS. 45A, 45B, 45C, and 45D are schematic illustrations of respective views of a capsule for use with a liquid material that is configured to be vaporized by a smoking device, the capsule including a capillary-force-delivery element configured to deliver the liquid material to an internal heating element and including a reusable portion and a disposable portion, in accordance with some applications of the present invention;

FIGS. 46A and 46B are schematic illustrations of respective views of a capsule for use with a liquid material that is configured to be vaporized by a smoking device, the capsule including a capillary-force-delivery element configured to deliver the liquid material to an internal heating element and the capsule defining an opening in close proximity to the heating element, in accordance with some applications of the present invention;

FIGS. 47A and 47B are schematic illustrations of respective views of a capsule for use with a liquid material that is configured to be vaporized by a smoking device, the capsule including a capillary-force-delivery element configured to deliver the liquid material to an internal heating element and the capsule defining an opening in close proximity to the heating element and the capsule including a reusable portion and a disposable portion, in accordance with some applications of the present invention;

FIGS. 48A and 48B are schematic illustrations of respective views of a capsule for use with a liquid material that is configured to be vaporized by a smoking device, the capsule including a housing disposed around the absorbent material that has the liquid material absorbed therein, the housing being an electrical insulator and defining one or more lateral windows, in accordance with some applications of the present invention;

FIGS. 49A and 49B are schematic illustrations of respective views of a capsule for use with a liquid material that is configured to be vaporized by a smoking device, the capsule including a housing disposed around a reservoir containing the liquid material, the housing being an electrical insulator and defining one or more lateral windows, in accordance with some alternative applications of the present invention;

FIGS. 50A and 50B are schematic illustrations of respective views of a capsule for use with a liquid material that is configured to be vaporized by a smoking device, the capsule including a housing disposed around a reservoir containing the liquid material, the housing being an electrical insulator and defining one or more lateral windows, in accordance with some applications of the present invention;

FIGS. 51A, 51B, and 51C are schematic illustrations of respective views of a smoking device that includes a housing and a flap that is openable with respect to the housing, with the flap in an open position, in accordance with some applications of the present invention;

FIGS. 51D, 51E, and 51F are schematic illustrations of respective views of the smoking device of FIGS. 52A-52C, with the flap in a closed position, in accordance with some applications of the present invention;

FIGS. 52A, 52B, and 52C are schematic illustrations of respective views of a smoking device that includes a housing and a flap that is openable with respect to the housing, with the flap in an open position, in accordance with some additional applications of the present invention;

FIGS. 52D and 52E are schematic illustrations of respective views of the smoking device of FIGS. 52A-52C with the flap in a closed position, in accordance with some applications of the present invention;

FIGS. 53A, 53B, and 53C are schematic illustrations of respective views of a smoking device that includes a housing and a flap that is openable with respect to the housing, with the flap in an open position, in accordance with some additional applications of the present invention;

FIGS. 53D and 53E are schematic illustrations of respective views of the smoking device of FIGS. 53A-53C, with the flap in a closed position, in accordance with some applications of the present invention;

FIGS. 54A, 54B, and 54C are schematic illustrations of respective views of a smoking device that includes a housing and a flap that is openable with respect to the housing, with the flap in an open position, in accordance with some additional applications of the present invention;

FIGS. 54D and 54E, which are schematic illustrations of respective views of the smoking device of FIGS. 54A-54C, with the flap in a closed position, in accordance with some applications of the present invention;

FIGS. 55A and 55B are schematic illustrations of respective views of a smoking device that includes a housing and a cover that is reversibly couplable to the housing, with the cover decoupled from the housing, in accordance with some applications of the present invention;

FIGS. 55C and 55D are schematic illustrations of respective views of the smoking device of FIGS. 55A-55B with the cover coupled to the housing, in accordance with some applications of the present invention;

FIGS. 56A, 56B, 56C, and 56D are schematic illustrations of electrodes, electrical contacts, and/or mechanical elements that are configured to flatten a capsule, in accordance with some applications of the present invention;

FIGS. 57A, 57B, 57C, and 57D are schematic illustrations of hinged electrodes, in accordance with some applications of the present invention;

FIGS. 58A, 58B, 58C, and 58D are schematic illustrations of electrodes and electrical contacts that are configured to electrically contact each other via a conductive spring, in accordance with some applications of the present invention;

FIGS. 59A, 59B and 59C are schematic illustrations of respective views of a capsule that includes metallic foil surrounding smoking material, the metallic foil being shaped to define lateral winged projections that are configured to contact electrodes of the smoking device, in accordance with some applications of the present invention;

FIG. 60 is a schematic illustration of a configuration of electrodes that are configured to drive a current laterally across a capsule, in accordance with some applications of the present invention;

FIGS. 61A, 61B, and 61C are schematic illustrations of respective views of a smoking device that includes a housing, a flap that is openable with respect to the housing, and magnets, in accordance with some applications of the present invention;

FIGS. 62A, 62B, and 62C are schematic illustrations of capsules that are configured to facilitate sensing of when a user has placed a mouthpiece of the capsule within their mouth, in accordance with some applications of the present invention;

FIGS. 63A and 63B are schematic illustrations of spring electrodes configured to be disposed around the circumference of a capsule-receiving chamber of a smoking device at two or more axial locations, in accordance with some applications of the present invention;

FIGS. 64A and 64B are schematic illustrations of spring electrodes disposed around the circumference of a capsule-receiving chamber of a smoking device at two or more axial locations, in accordance with some applications of the present invention;

FIGS. 65A and 65B are schematic illustrations of a capsule disposed within a capsule-receiving chamber of a smoking device, in accordance with some applications of the present invention;

FIGS. 66A, 66B, and 66C are schematic illustrations of a capsule-receiving chamber of a smoking device, in accordance with some applications of the present invention;

FIG. 67 is a schematic illustration of metallic foil of a capsule, in accordance with some applications of the present invention; and

FIGS. 68A, 68B, 68C, and 68D are schematic illustrations of a capsule, in accordance with some applications of the present invention.

### DETAILED DESCRIPTION OF EMBODIMENTS

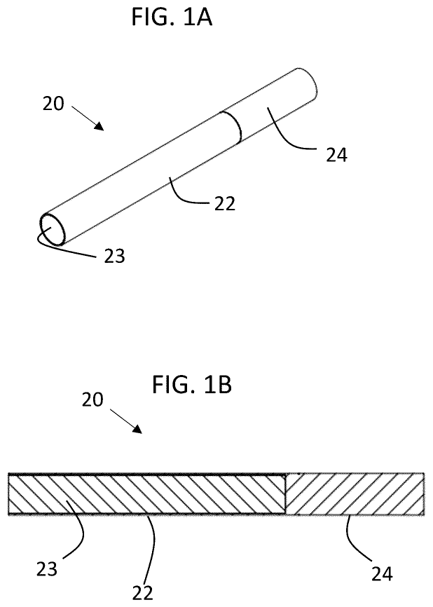

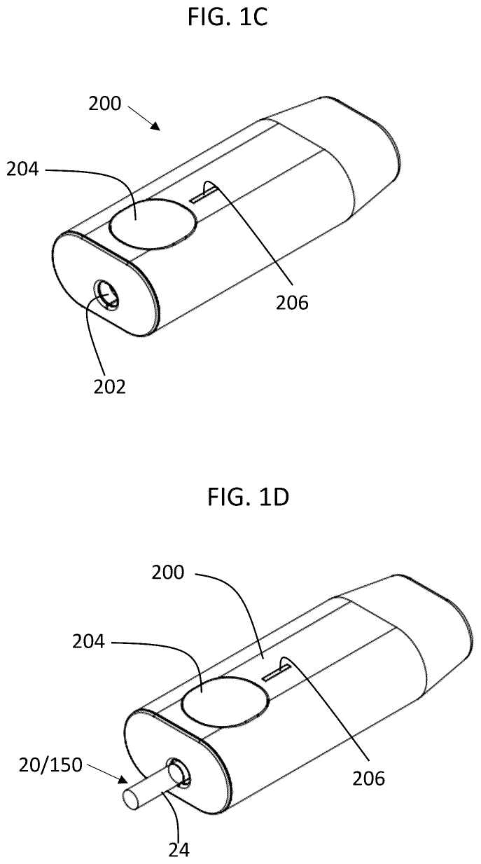

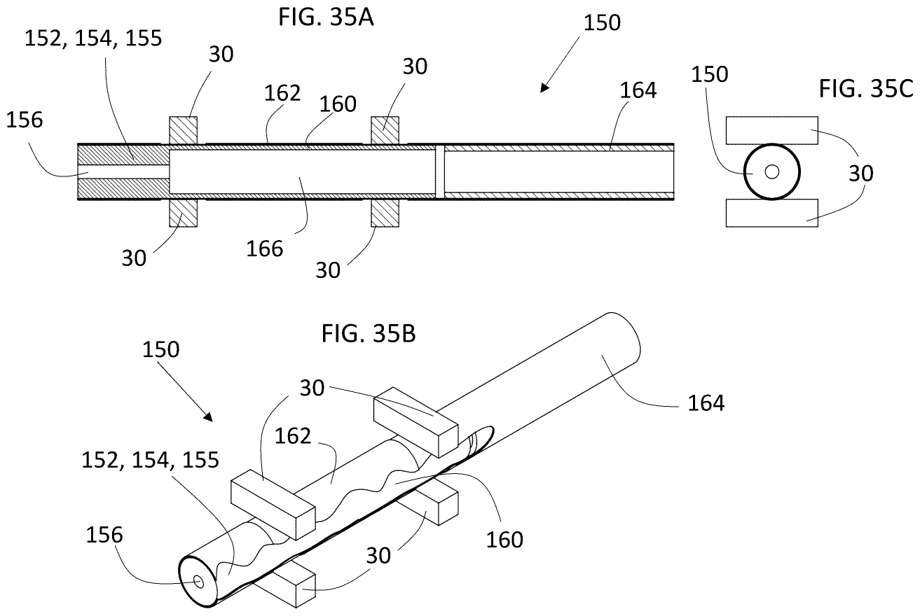

Reference is now made to FIGS. 1A, 1B, 1C, and 1D, which are schematic illustrations of a capsule 20 (FIGS. 1A-1B), a smoking device 200 (FIG. 1C), and the capsule inserted in the smoking device (FIG. 1D), in accordance with some applications of the present invention. (It is noted that the term “smoking device” is used herein to describe device 200, since this terminology is used in the art. However, device 200 may also be referred to as a “vaping device.” For some applications, as indicated in FIG. 1D, the smoking device is configured to be used with both capsule 20 (which typically contains a solid matter smoking material, such as a plant material, that contains active agents) and with a capsule 150 (which typically contains a liquid material that contains active agents and that is configured to be vaporized), capsule 150 being as described hereinbelow with reference to FIGS. 35A-50B, for example. Typically, at any given time, the smoking device is used with either capsule 20 or with capsule 150. For some applications, the smoking device uses similar techniques to heat the plant material within capsule 20 (such as to release active agents from the plant material|) and to heat the liquid material within capsule 150 (such as to vaporize the liquid material), as is described in further detail hereinbelow.

Typically, capsule 20 is a disposable capsule that is configured to be used during a single smoking session, whereas the smoking device is configured to be reusable. Capsule 20 typically has the general structure (e.g., shape and/or size) of a traditional cigarette. Many users and manufacturers of such capsule and smoking devices have a preference for single-use capsules having the general structure of a traditional cigarette, due to (a) habitual preferences of the users, (b) habitual preferences of the manufacturers, (c) production lines of the manufacturers being best-equipped to manufacture such capsules relative to capsules that differ from traditional cigarettes, (d) single-use capsules being more hygienic than capsules that are designed for repeated use, and/or (c) additional reasons.

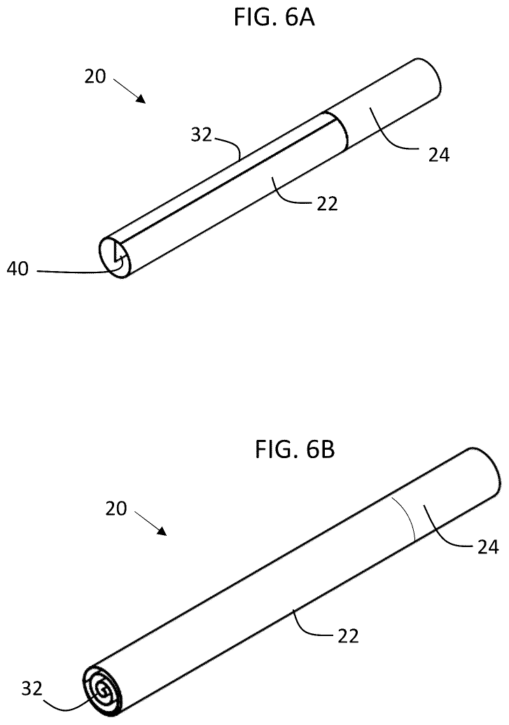

Typically, capsule 20 includes a first portion 22 that contains a smoking material 23 (that contains active agents) and a heating element (as described in further detail hereinbelow). Smoking material 23 is typically a plant material, such as tobacco and/or a cannabinoid-containing plant material (such as marijuana). For some applications, the smoking material is a non-plant material that contains active agents. (It is noted that, in some of the figures (e.g., FIGS. 6A-7D, 9A-9B, and 10B-14), the smoking material is not schematically illustrated (e.g., using hatching or shading), for illustrative purposes. However, all of the figures showing a capsule should be interpreted to be showing a capsule that contains smoking material.) The capsule is typically inserted into a slot 202 within smoking device 200. Smoking device 200 is configured to heat the smoking material, such as to generate vapors containing active agents within the smoking material in a heat-not-burn manner. The user typically sucks the generated vapors out of a second portion 24 of the capsule that functions as a mouthpiece.

As described hereinabove in the Background, heat-not-burn smoking devices (also known as “smokeless” devices) are devices that heat a smoking material without burning (i.e., pyrolyzing) the smoking material. The user sucks in vaporized active agents that are generated. An important element in heat-not-burn smoking devices is the time that it takes to heat the smoking material and the uniformity of the heating. The time that it takes to heat up the smoking material is defined by the following equation:

$$t = Q * d / ( K * A * Δ T ) \qquad [ Equation 1 ]$$

where
t is the time taken to heat the smoking material,
Q is the quantity of heat transferred to the smoking material,
d is the distance from the location at which the heat is generated to the smoking material that is being heated,
K is the constant that defines the heat conduction of the smoking material (which is relatively low for smoking materials as they are relatively non-conductive), and any other material between the heating element and the smoking material,
A is the area of contact between the heating element and the smoking material, and
T is temperature change that is applied at the heating element.

There are several challenges to heating up smoking material in a heat-not-burn process, including the following:
low heat conduction of the smoking material (i.e., a low value of K in Equation 1);
a limited temperature to which the heating element can be heated in order to avoid pyrolysis (i.e., burning) of the smoking material (i.e., a low value of ΔT in Equation 1);
many designs of heating-elements-capsule combinations providing a relatively small area of contact between the heating elements and the smoking material (i.e., a low value of A in Equation 1), particularly if the capsule is designed to have the general shape of a traditional cigarette;
in order to provide the appearance and feel of a traditional cigarette, there may be a heat-insulating material (e.g., paper) between the heating element and the smoking material (thereby further decreasing K in Equation 1), for example, if heating is applied by a heating element that is disposed within the smoking device outside the capsule;
the distance from the heating element to the smoking material that is located toward the radial center of the capsule is relatively large (i.e., a high value of d in Equation 1).

In accordance with some applications of the present invention, apparatus and methods are provided that (a) provide a relatively large area of contact between the heating element and the smoking material (i.e., A in Equation 1), and (b) provide a relatively small distance between the heating element and the smoking material even at the radial center of the capsule (i.e., d in Equation 1), while (c) providing the user with a capsule having the same general structure as a traditional cigarette.

Typically, the heating element is built-in to the capsule, such that it is in direct contact with smoking material 23. For some applications, at least some of the heating element is embedded within the smoking material, as described in further detail hereinbelow. For some applications, the heating element comprises a metal material (such as metallic foil, e.g., stainless steel foil, nickel-titanium foil, titanium foil, copper foil, aluminum foil, steel foil), which is typically disposed within the capsule and/or is typically in direct contact with the smoking material, and that is heated via electrical resistive heating, as described in further detail hereinbelow. Alternatively or additionally, the heating element comprises one or more magnetically-heated materials that are susceptible to being heated by a magnetic field (such as, magnetic materials and/or ferromagnetic materials), which are typically disposed within the capsule and/or are typically in direct contact with smoking material and that are heated via magnetic induction, as described in further detail hereinbelow.

Typically, the capsule is an elongate capsule. For some applications, the elongate capsule has a length of between 15 mm and 150 mm (e.g., between 50 mm and 90 mm). For some applications, the capsule has the same general structure as a traditional cigarette, but differs from the general structure of a cigarette in that the capsule is provided to the user with at least a portion of the capsule having a shape that is flattened relative to a traditional cigarette (e.g., such that it has an elliptical, rectangular, pill-shaped, or racetrack-shaped cross-sectional shape). Typically, by being flattened, the smoking material that is disposed toward the radial center of the capsule is disposed closer to the heating element than if the capsule had a circular cross section with a similar cross-sectional area, as described in further detail hereinbelow. Alternatively, the capsule is provided to the user with a circular cross-section shape, typically having a diameter of between 4 mm and 12 mm (e.g., between 5 and 8.5 mm). Typically, for such applications, although the capsule is provided to the user with the capsule having a circular cross-sectional shape, at least a portion of the capsule is flattened upon being inserted into the smoking device (e.g., such that it has an elliptical, rectangular, pill-shaped, or racetrack-shaped cross-sectional shape), such that the smoking material that was disposed toward the radial center of the capsule is disposed closer to the heating element than it would have been before being flattened, as described in further detail hereinbelow.

In general, any references to the cross-sectional shape of a capsule and dimensions thereof in the present disclosure, including the claims, should be interpreted as referring to the radial cross-section of the capsule (i.e., the cross-section of a plane that is perpendicular to the longitudinal axis of the capsule), unless otherwise specified. Thus, in all instances, unless otherwise specified the term “cross-sectional shape” as used with reference to the capsule could be replaced with the term “radial cross-sectional shape.”

It is further noted that, in general the use of the term “cylindrical” and related terms with reference to the capsule or portions of the smoking device that are used with the capsule should be interpreted as referring to a shape that has a circular radial cross-section, and the term “non-cylindrical” and related terms when used in a similar context should be interpreted as referring to a shape that has a non-circular radial cross-section, e.g., an elliptical radial cross-section. It is yet further noted that the use of the term “flattened” and related terms with reference to the capsule or portions of the smoking device that are used with the capsule should be interpreted as referring to a radial cross-sectional shape that is flattened relative to a circular cross-sectional shape.

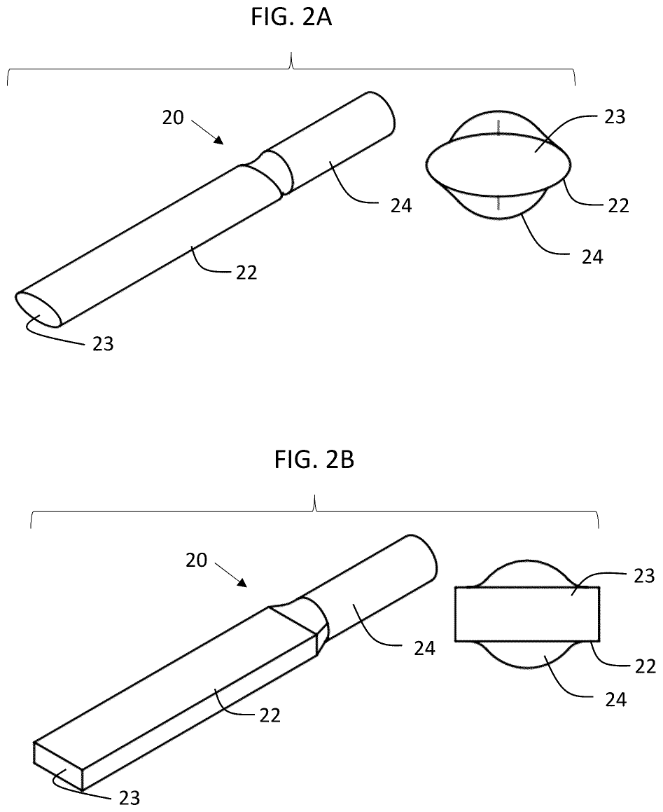

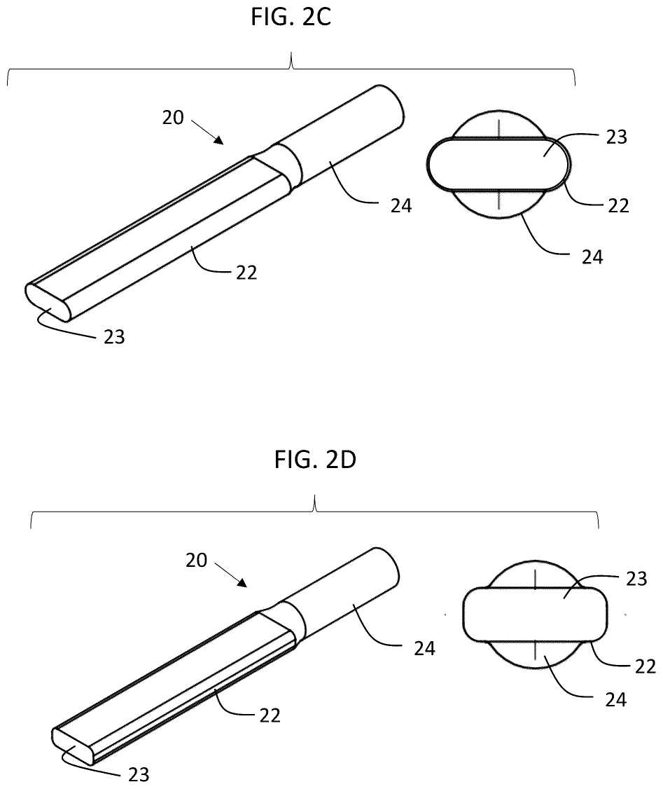

Reference is now made to FIGS. 2A, 2B, 2C, and 2D, which are schematic illustrations of isometric views and end views of capsule 20, with a portion 22 of the capsule that contains the smoking material and the heating element having a shape that is flattened relative to a traditional cigarette, such that it has an elliptical cross-sectional shape (FIG. 2A), a rectangular cross-sectional shape (FIG. 2B), a pill-shaped cross-sectional shape (FIG. 2C), or a racetrack-shaped cross-sectional shape (FIG. 2D). (Each of FIGS. 2A-2D shows an isometric view and an end view of the capsule.) Typically, portion 24 of the capsule that serves as the mouthpiece has a circular cross-sectional shape. As described hereinabove, for some applications, the capsule is provided to the user with portion 22 of the capsule having a shape that is flattened relative to a traditional cigarette. Alternatively, the capsule is provided to the user with portion 22 of the capsule having a circular cross-sectional shape, but all or part of portion 22 of the capsule is flattened upon being inserted into the smoking device. For some applications, at least a part of portion 22 is flattened such that a ratio between the long side of the cross-sectional shape and the short side of the cross-sectional shape is greater than 2:1, 3:1, 4:1, or 6:1. Typically, the heating elements are disposed at least along the long sides of portion 22, such that the distance between the heating elements and the smoking material is less than if portion 22 had a circular cross-sectional shape with a similar perimeter.

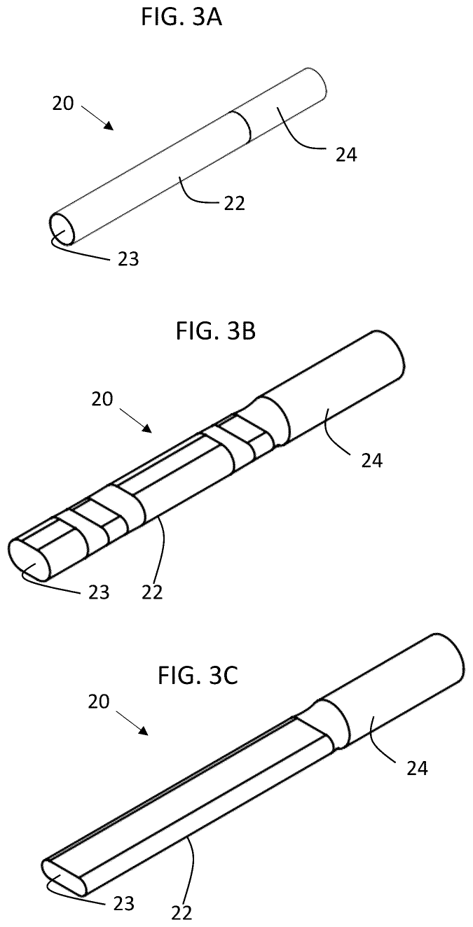

Reference is now made to FIGS. 3A, 3B, and 3C, which are schematic illustrations of respectively, a capsule having a circular cross-section, a capsule that has been flattened by having mechanical pressure applied to the capsule at discrete locations along its length, and a capsule that has been flattened along the entire length of portion 22, in accordance with some applications of the present invention. For some applications the capsule is flattened by smoking device 200. For some applications, smoking device 200 includes two or more electrodes that are configured (a) to heat a heating element that is disposed within the capsule via electrical resistive heating, and (b) to apply mechanical pressure to the capsule in order to flatten at least part of portion 22 of the capsule. For some applications, the electrodes apply mechanical pressure at discrete locations along its length (as indicated in FIG. 3B). For some applications, the electrodes apply mechanical pressure along the entire length of portion 22 (as indicated in FIG. 3C).

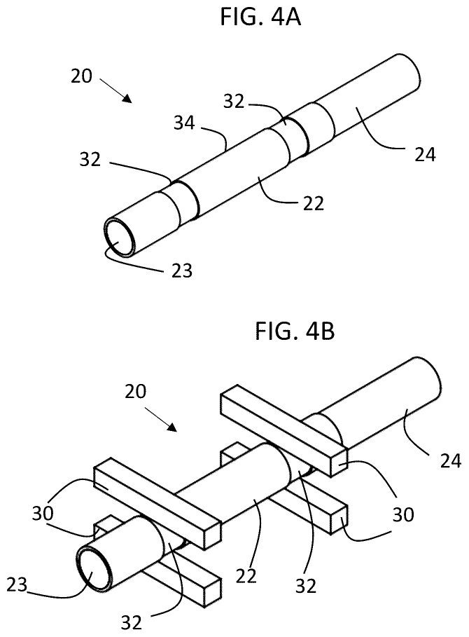

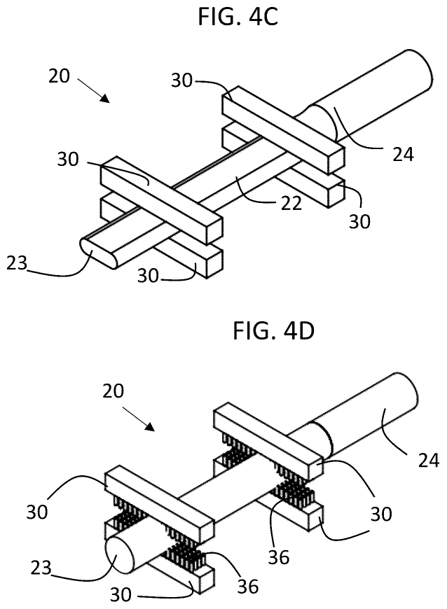

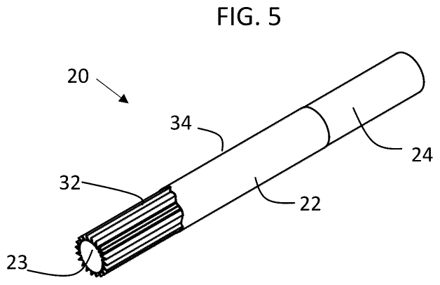

Reference is now made to FIGS. 4A, 4B, and 4C, which are schematic illustrations of electrodes 30 being placed in electrical contact with a heating element 32 of capsule 20, in accordance with some applications of the present invention. As described hereinabove, typically, the heating element is built-in to the capsule, such that it is in direct contact with smoking material. Also as described hereinabove, the capsule is typically configured to be disposable and for use in a single smoking session. Thus, problems associated with repeated use of heating elements, such as a build-up of dirt and/or impurities, as well as wear-and-tear due to repeated heating and/or mechanical interactions, are avoided. For some applications, the heating element comprises a metallic material, which is typically disposed within the capsule and/or is typically in direct contact with the smoking material, and that is heated via electrical resistive heating. For some applications, the heating element is a metallic foil (e.g., stainless steel foil, nickel-titanium foil, titanium foil, copper foil, aluminum foil, steel foil) that typically is in direct contact with, and surrounds, the smoking material within portion 22 of capsule 20. For some applications, the foil has a thickness of more than 1 micron (e.g., more than 3 microns) and/or less than 20 microns (e.g., less than 10 microns), for example, 1-20 microns, or 3-10 microns. Typically, a current is applied along the length of portion 22 (e.g. with a positive electrode at the first end and a negative electrode at the second end, or vice versa) and airflow is parallel to the direction of the current flow. For some applications, a current is applied along the metallic foil along a length of portion 22 that is greater than 5 mm, e.g., greater than 15 mm. Typically, the metallic foil is flexible such that it is configured to be flattened by mechanical flattening elements, as described in further detail hereinbelow.

It is noted that since heating element 32 is typically a metallic foil, element 32 is also sometimes referred to as “metallic foil 32” or “foil 32.”

As described hereinabove, it is typically desirable for capsule 20 to have the general structure of a traditional cigarette. Typically, the heating element extends along the entire length of the smoking-material-containing portion of the capsule. For some applications, the heating element only extends along a portion of the length and/or the circumference of the smoking-material-containing portion of the capsule, as described in further detail hereinbelow. For some applications, the capsule includes a paper covering 34, and the heating element 32 (which is typically as described hereinabove) is printed and/or is adhered to the paper covering. Typically, at the locations at which the electrodes contact the capsule, the heating element is exposed to the electrodes, such as to make direct electrical contact with the electrodes. For example, as shown in FIGS. 4A and 4B, at the locations at which the electrodes contact the capsule, the heating element is not covered with paper covering 34. As shown in FIG. 4C and as described hereinabove, for some applications, the electrodes apply mechanical pressure to portion 22 of the capsule, such as to flatten at least part of portion 22 of the capsule.

Referring to FIG. 4D, for some applications, the electrodes include needle contacts 36 that are configured to pierce the paper covering and directly contact the heating element.

For some applications, an electrically-conducting material is absorbed into the paper covering in order to facilitate electrical contact between the electrodes and the heating element. Alternatively or additionally, an electrically-conducting material passes through the paper from the heating element to contacts that directly contact the electrodes.

For some applications, the capsule includes a thermally-insulating material layer within at least a portion of the capsule, in order to reduce heat loss via the walls of the capsule.

Reference is now made to FIG. 5, which is a schematic illustration of heating element 32, the heating element including folds (e.g., zigzagging or undulating folds), in accordance with some applications of the present invention. Typically, by including folds, the area of contact between the heating element and the smoking material is increased relative to if it did not include folds. For some applications, by including folds, the heating element is shaped to define ribs that penetrate into the smoking material, thereby (a) increasing the area of contact between the heating element and the smoking material, and/or (b) decreasing the maximum distance between the heating element and the smoking material. For some applications, a folded heating element as shown in FIG. 5 is combined with one or more of the techniques described with reference to FIGS. 4A-D.

Reference is now made to FIGS. 6A and 6B, which are schematic illustrations of capsule 20, the capsule including a heating element 32 that penetrates into the smoking material. As described hereinabove, for some applications, the heating element is a metal foil (e.g., stainless steel foil, nickel-titanium foil, titanium foil, copper foil, aluminum foil, steel foil) that typically is in direct contact with, and surrounds, the smoking material within portion 22 of capsule 20. For some applications, the foil has a thickness of more than 1 micron (e.g., more than 3 microns) and/or less than 20 microns (e.g., less than 10 microns), for example, 1-20 microns, or 3-10 microns. Typically, a current is applied along the length of portion 22 (e.g. with a positive electrode at the first end and a negative electrode at the second end, or vice versa) and airflow is parallel to the direction of the current flow. For some applications, a current is applied along the metallic foil along a length of portion 22 in an axial direction along the metallic foil (i.e., along a direction that is parallel to the longitudinal axis of the capsule) that is greater than 5 mm, e.g., greater than 15 mm. For some applications, the foil is shaped and disposed within the capsule such that a flap 40 of the heating element penetrates into the smoking material, as shown in FIG. 6A. For some applications, the foil has a spiral shape that spirals through the smoking material, as shown in FIG. 6B. For some applications, by penetrating into the smoking material, the heating element (a) increases the area of contact between the heating element and the smoking material, and/or (b) decreases the maximum distance between the heating element and the smoking material.

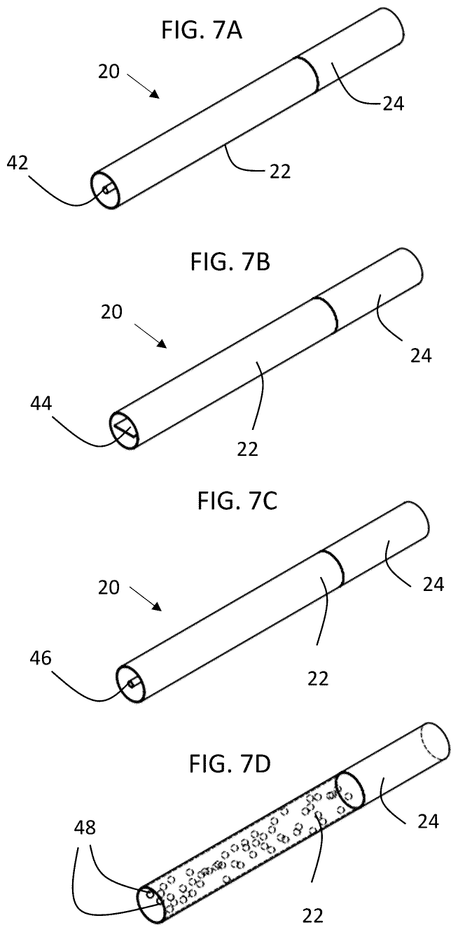

Reference is now made to FIGS. 7A, 7B, 7C and 7D, which are schematic illustrations of capsule 20, the capsule including one or more magnetic heating elements, in accordance with some applications of the present invention. As described hereinabove, typically, the heating element is built-in to the capsule, such that it is in direct contact with smoking material. For some applications, at least some of the heating element is embedded within the smoking material. For some applications, the heating element comprises one or more magnetically-heated materials (i.e., materials that are susceptible to being heated by a magnetic field (such as, magnetic materials and/or ferromagnetic materials)), which are typically disposed within the capsule and/or are typically in direct contact with smoking material, and that are heated via magnetic induction. For some applications smoking device 200 includes a coil that is configured to generate an electromagnetic field, as described in further detail hereinbelow. The coil is configured to heat the magnetically-heated material within the capsule via magnetic induction. In accordance with some applications, the magnetically-heated material is configured as a magnetically-heated rod 42 that is disposed along the length of a portion of the capsule (as shown in FIG. 7A), a magnetically-heated strip 44 that is disposed along the length of a portion of the capsule (as shown in FIG. 7B), a magnetically-heated tube 46 that is disposed along a portion of the length of the capsule (shown in FIG. 7C), and/or a plurality of magnetically-heated particles 48 (e.g., balls or beads) that are dispersed within the smoking material (as shown in FIG. 7D). Alternatively or additionally, a magnetically-heated material is disposed around the smoking material (e.g., underneath a paper covering), in a similar manner to that described with reference to the metallic foil that is heated via electrical resistive heating. For some applications, there is no magnetically-heated material disposed around the smoking material. Typically for applications in which the capsule includes one or more magnetically-heated materials, the smoking material is covered with a covering material that does not attenuate with an electromagnetic field that is generated by the smoking device (e.g., by a coil of the smoking device). For some such applications, the smoking material is covered with a paper covering as described in further detail hereinbelow. For some applications, the smoking material is covered with a cover which is itself a magnetically-heated material (e.g., a metallic foil). Typically, at least part of portion 22 is configured to be flattened by the smoking device (or to be provided to the user in a flattened shape). Typically, the material with which the smoking material is covered is flexible, such as to allow portion 22 to be flattened.

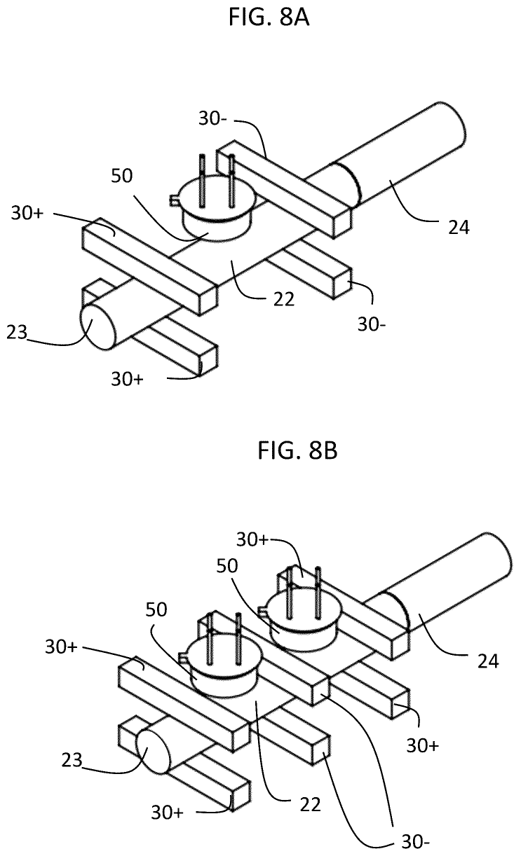

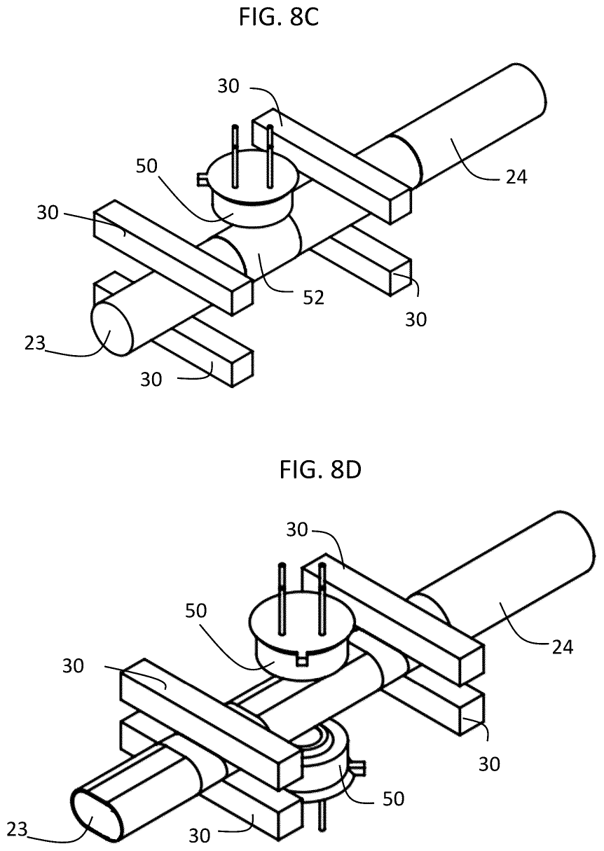

Reference is now made to FIGS. 8A and 8B, which are schematic illustrations of one or more sensors 50 for sensing the temperature of the smoking material within a capsule, in accordance with some applications of the present invention. FIGS. 8A and 8B show the sensors being used to sense the temperature of smoking material of a capsule that is being heated via electrical resistive heating of a heating element by electrodes 30. However, the sensors are typically also used with a capsule that is heated via magnetic induction, mutatis mutandis.

As described hereinabove, typically in order to heat smoking material via electrical resistive heating, a current is applied along the length of portion 22 of the capsule (e.g. with a positive electrode at the first end and a negative electrode at the second end, or vice versa) and airflow is parallel to the direction of the current flow. For some applications, the current is applied along the entire length of the heating element using a single pair of electrodes (or a respective single pair of electrodes along each side of the capsule), as shown in FIG. 8A. Alternatively, respective electrode pairs apply current along respective portions of the length of the heating element, as shown in FIG. 8B. (In FIGS. 8A and 8B, the electrodes are denoted to be positive and negative using reference numerals 30+ and 30− respectively, by way of example. The charges of the electrodes could be reversed.) For some applications, a current is applied along the metallic foil along a length of portion 22 in an axial direction along the metallic foil (i.e., along a direction that is parallel to the longitudinal axis of the capsule) that is greater than 5 mm, e.g., greater than 15 mm. For some applications, control of each portion of the heating element may thereby be controlled separately. For some such applications, respective portions along the length of the heating element are heated to respective, different temperatures. For some such applications, respective materials are vaporized by the respective portions of the heating element. For example, one portion may contain smoking material, while another portion may include materials that provide flavor to the vapor. For some applications, the user selects a type of vapor according to their preferences and the respective portions along the length of the heating element are heated accordingly (e.g., according to different temperature profiles). Typically, for applications in which respective electrode pairs apply current along respective portions along the length of the heating element (as shown in FIG. 8B), a respective temperature sensor is configured to detect the temperature of portions of the smoking material that are disposed within respective portions along the length of the heating element.

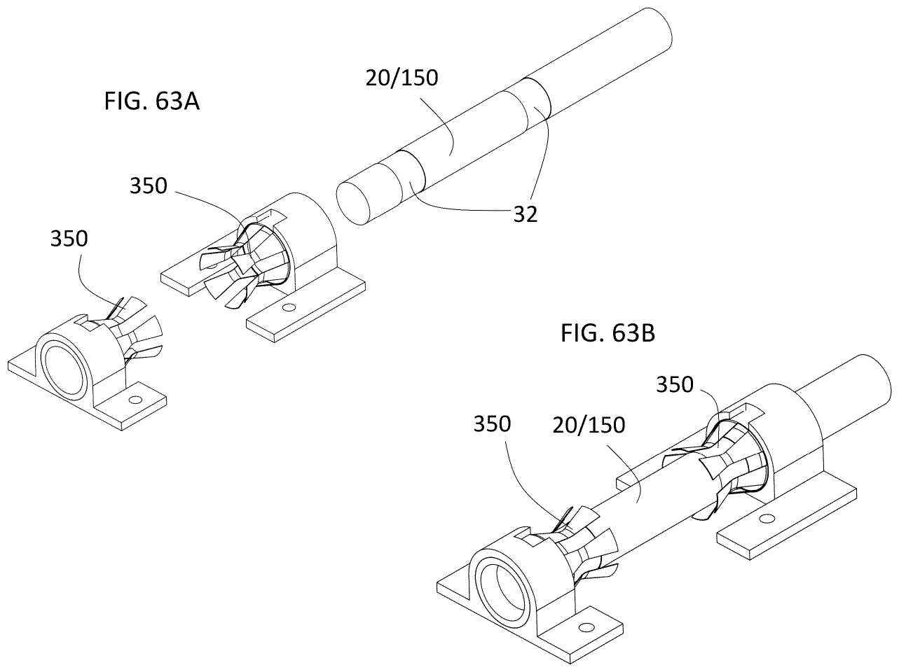

For some applications, one or more of the techniques described in the above paragraph is used in conjunction with electrodes that are configured as shown in other figures, for example, electrodes that include needle contacts 36 (shown in FIG. 4D) and/or spring electrodes 350 (shown in FIGS. 63A-66C).

Reference is now made to FIG. 8C, which is a schematic illustration of a capsule that includes a portion 52 that is disposed in the vicinity of temperature sensor 50, portion 52 being covered, coated, and/or treated such as to be non-reflective or to have a high emissivity value (e.g., emissivity of at least 0.5, or at least 0.95), in accordance with some applications of the present invention. Typically, sensor 50 is configured to sense the temperature of the smoking material without extracting any heat from the smoking material. For some applications, sensor 50 is a contact sensor that contacts the smoking material in order to measure the temperature of the smoking material. Typically, sensor 50 is a non-contact sensor that measures the temperature of the smoking material without contacting the smoking material. For some applications, the temperature sensor is a thermal camera and/or a thermocouple sensor that senses the overall resistance of the capsule (or a portion thereof) and thereby derives the temperature of the capsule. For some applications, the sensor is an infrared temperature sensor that is configured to detect the temperature of the smoking material by detecting infrared thermal radiation from the smoking material (and typically without contacting the smoking material).

As described hereinabove, typically the capsule includes a heating element that is metallic and that surrounds the smoking material. Typically, the heating element comprises a reflective material. For some applications, in order to facilitate an accurate determination of the temperature of the smoking material using the infrared temperature sensor, the capsule is configured to be non-reflective, or to have a high emissivity value, at the location at which the sensor detects the temperature of the capsule. For example, the capsule is covered or coated with a non-reflective material, or with a material (e.g., polyimide tape, paper, or another thin material with high thermal conductivity and high emissivity) having a high emissivity value (e.g., emissivity of at least 0.5, or at least 0.95), at that location. For some applications, the capsule is treated (e.g., via chemical treatment, sand-blasting, etching, coloring, knurling, and/or oxidation), such that the capsule is configured to be non-reflective, or to have a high emissivity value (e.g., emissivity of at least 0.5, or at least 0.95), at the location at which the sensor detects the temperature of the capsule. Reference is now made to FIG. 8D, which is a schematic illustration of two or more sensors 50 being used to detect temperature of the smoking material within capsule 20 at the same location along the length of the capsule as each other, in accordance with some applications of the present invention. For some applications, the sensors are placed on respective sides of the capsule. For some such applications, an average temperature of the smoking material is determined based upon the temperatures detected by each of the sensors. For some applications, a temperature range across the smoking material is determined, a maximum temperature of the smoking material is determined, and/or a minimum temperature of the smoking material is determined, based on the temperatures detected by each of the sensors. For some applications, the temperature of the smoking material is detected using the temperature that is detected by only one of the sensors, for example, if the temperature detected by the other sensor (or another indication from the other sensor) indicates that the other sensor is faulty, is dirty, has come into contact with the capsule, is detecting the temperature from a region of overlap of the cover of the capsule, etc.

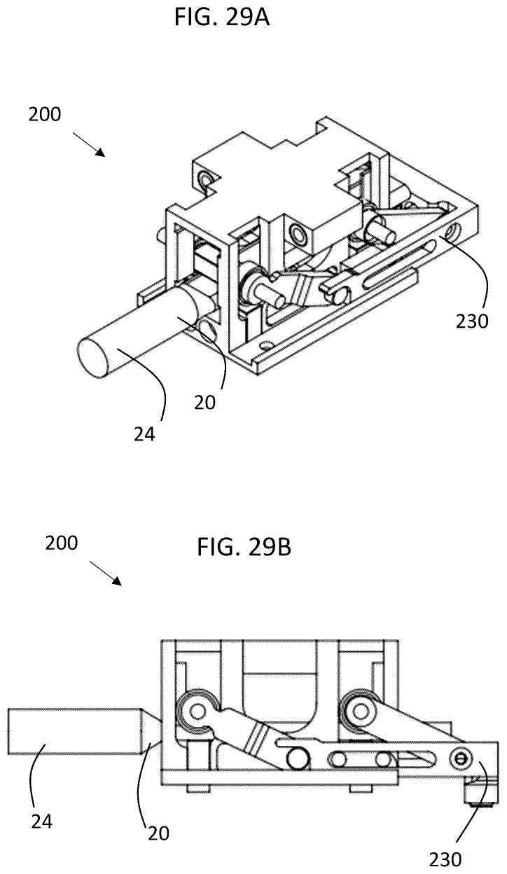

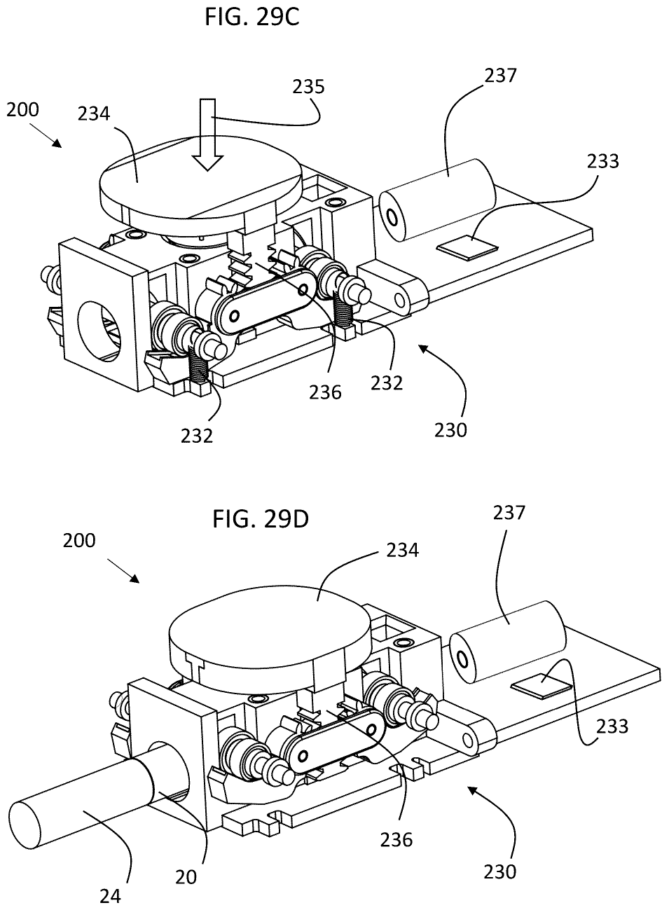

For some applications, the temperature detected by the sensors described with reference to any one of FIGS. 8A-8D is used as feedback in response to which heating of the heating element is controlled. Typically, the heating of the heating element is controlled such as to maintain the smoking material within a predefined temperature range, at which the active agents within the smoking material are vaporized but the smoking material is not pyrolyzed. For some applications, a control component 233 (e.g., a control chip and/or a control microprocessor, shown in FIGS. 29C and 29D) within the smoking device is configured to detect that a user has puffed the smoking device (and/or a parameter of the puff, such as length of puff and/or depth of puff) based on the temperature of the smoking material that is detected by the sensor. Typically, the sensor detects the amount of current that must be applied to the heating element in order to maintain the smoking material at a constant (or substantially constant) temperature and thereby detects that the user has puffed the smoking device (and/or determines a parameter of the puff, such as length of puff and/or depth of puff).

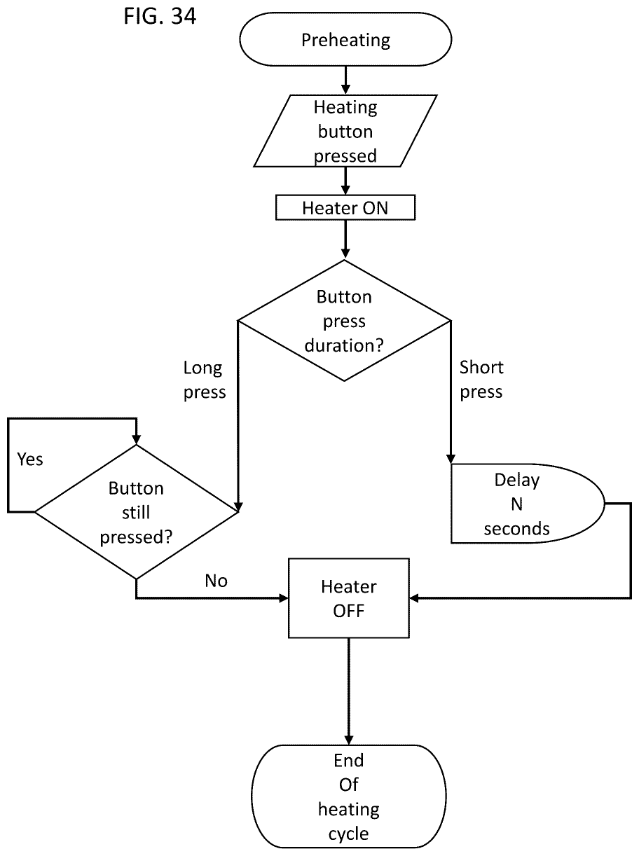

For some applications, upon insertion of a capsule into the smoking device (or in response to being activated in a different manner, e.g. by the push of a button), the smoking device preheats the capsule to below the vaporization temperature of the smoking material, as described in further detail hereinbelow with reference to FIG. 34. Subsequently, in response to detecting that the user has puffed from the smoking device (or in response to being activated in a different manner, e.g. by the push of a button), the control component heats the smoking material to its vaporization temperature. For some applications, during the use of a given capsule, the control component detects the number of puffs, the lengths of the puffs, and/or the depths of the puffs that the user has taken from the capsule. For some such applications, the control component prevents the capsule from being heated, in response to detecting an indication that more than a given amount of the active agent has been vaporized. In this manner, the smoking device is configured to provide a metered dose of an active agent to the user. Alternatively or additionally, in this manner, the smoking device is configured to prevent further use of a capsule once the further use is likely to cause unwanted flavors, pyrolysis of the smoking material, etc. For some applications, the smoking device is configured to receive an input indicating the type of capsule that is placed in the device (and/or is configured to detect this automatically, as described in further detail hereinbelow), and is configured to control the heating of the smoking material in the above-described manner in response thereto.

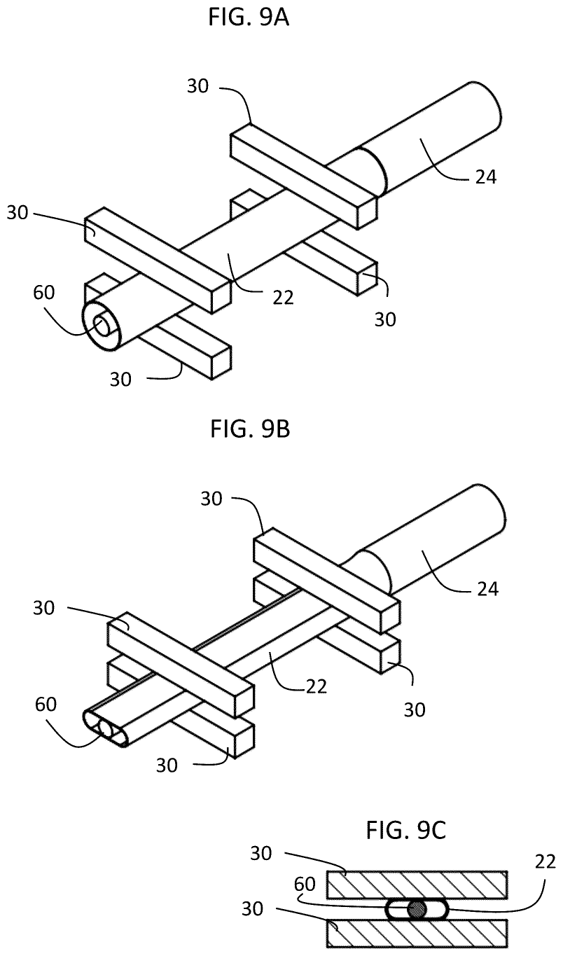

Reference is now made to FIGS. 9A, 9B, and 9C, which are schematic illustrations of capsule 20, the capsule including a collapse-prevention element 60, in accordance with some applications of the present invention. As shown in FIGS. 9A-9C, the collapse-prevention element is shaped as a rod that extends axially along the longitudinal axis of portion 22 of the capsule. For some applications, the rod has a diameter of more than 0.5 (e.g., less than 2 mm) and/or less than 5 mm (e.g., less than 3 mm), e.g., 0.5-5 mm, or 2-3 mm. The collapse-prevention element is configured to prevent portion 22 of the capsule from collapsing when mechanical pressure is applied to portion 22 in order to flatten portion 22 of the capsule. It is noted that, in the absence of a collapse-prevention element, portion 22 of the capsule is susceptible to collapsing or becoming crushed, since the smoking material, the heating element, and the paper covering are typically all soft, non-rigid materials. By contrast, the rod is typically rigid and holds portion 22 of the capsule open at least to the diameter of the rod. Typically, the diameter of the rod defines the thickness of portion 22 when the capsule is in its flattened configuration. By defining the thickness of the portion 22 when the capsule is in its flattened configuration, the rod ensures that there is adequate airflow through portion 22. In addition, the rod ensures that there is good electrical contact between the electrodes and the heating element, by ensuring that the heating element is held in contact with the electrodes.

FIG. 9A shows the capsule before mechanical pressure has been applied to portion 22 by electrodes 30, and FIGS. 9B-9C show the capsule after mechanical pressure has been applied to portion 22. As shown in FIGS. 9B-9C, the rod holds open portion 22, such that the thickness of portion 22 when the capsule is in its flattened configuration is defined by the diameter of the rod.

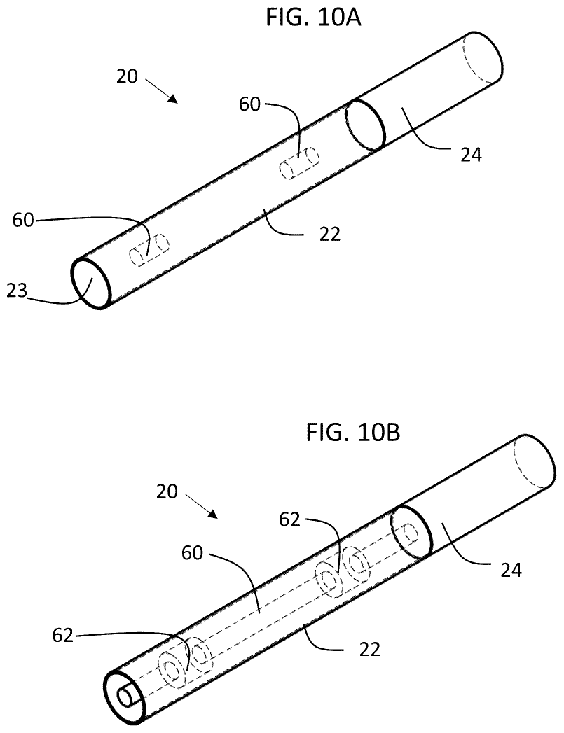

It is noted that, for some applications, the rod does not extend along the entire length of portion 22 of the capsule. For example, the rod may only be disposed along a portion of the length of portion 22 within which the heating element is configured to contact the electrodes. For some applications, two or more rods are disposed within respective regions at which the heating element is configured to contact the electrodes, along the length of portion 22 of the capsule, as shown in FIG. 10A.

For some applications, the rod is a solid rod. As described above, typically the rod is rigid. For some applications, the rod is flexible, but it has a greater rigidity than the smoking material. Typically, the rod is made of a material that can withstand being heated to the temperatures to which the smoking material is heated. In accordance with respective applications, the rod is made of wood, metal, and/or a polymeric material, such as polyether ether ketone (PEEK). For some applications, the rod is made of a natural or smoking material, such as wood, tobacco, and/or hemp. For some applications, the rod is configured to diffuse one or more chemicals, such as flavoring, pharmaceuticals, and/or a vapor-generating chemical, such as glycerol. For some applications, the rod includes a phase-change material that is configured to prevent the temperature of the smoking material from exceeding the phase-change temperature of the phase-change material. Typically, the phase-change material is selected such as to prevent the temperature of the smoking material from exceeding a temperature at which the smoking material pyrolyzes. For some applications, the phase-change material is selected such as to maintain the temperature of the smoking material within an optimal range for vaporization and/or taste. For some applications the rod is configured to absorb chemicals that are generated by pyrolysis of the smoking material and/or other material within the capsule, such as nitric oxide and/or carbon monoxide. As noted above, the collapse-prevention element is not necessarily a rod, and the scope of the present disclosure includes collapse-prevention elements having different structure as would be apparent to a person of ordinary skill in the art, and as described hereinbelow. Typically, the configurations of the rod that are described above are applicable to any type of collapse-prevention element, mutatis mutandis.

Reference is now made to FIGS. 10A and 10B, which are schematic illustrations of capsule 20, the capsule including a collapse-prevention element 60, in accordance with some applications of the present invention. With reference to FIG. 10A, and as described hereinabove, for some applications, the collapse-prevention element includes two or more rods are disposed within respective regions at which the heating element is configured to contact the electrodes, along the length of portion 22 of the capsule. With reference to FIG. 10B, for some applications, the rod has a non-uniform diameter. For example, as shown, at the location at which the electrodes are configured to come into contact with the capsule, the rod includes radially-protruding portions 62 having a greater diameter (typically, in order to ensure good electrical contact between the heating element and the electrodes), whereas at other locations, the rod has a smaller diameter.

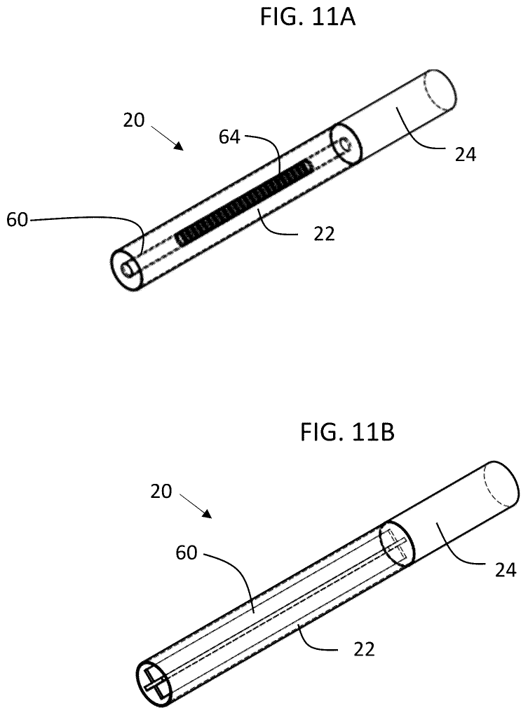

Reference is now made to FIGS. 11A and 11B, which are schematic illustrations of capsule 20, the capsule including a collapse-prevention element 60, in accordance with some applications of the present invention. For some applications, collapse-prevention element is a tube that contains chemicals (such as flavoring, pharmaceuticals, and/or a vapor-generating chemical (such as glycerol) in liquid, solid, gaseous, and/or gel form) that are released from the tube during heating of the smoking material. For example, a portion 64 of the tube may be fenestrated (as shown in FIG. 11A), or it may include a membrane or slits, via which the chemicals are released. For some applications, the collapse-prevention element 60 is a tube that serves one or more additional functions. For example, along at least portion 64 of its length it may be hollow and it may define openings (such as holes or slits) that are configured to collect the vaporized active agents and direct them toward the mouthpiece. As shown in FIG. 11B, for some applications, the collapse-prevention element has a cross-shaped cross-sectional shape, such that (a) the collapse-prevention element holds open portion 22 of the capsule to a great enough thickness, but (b) the collapse-prevention element does not occupy as much of the volume of portion 22 as it would if it were to have a different shape, thereby leaving a greater volume within portion 22 to be occupied by the smoking material.

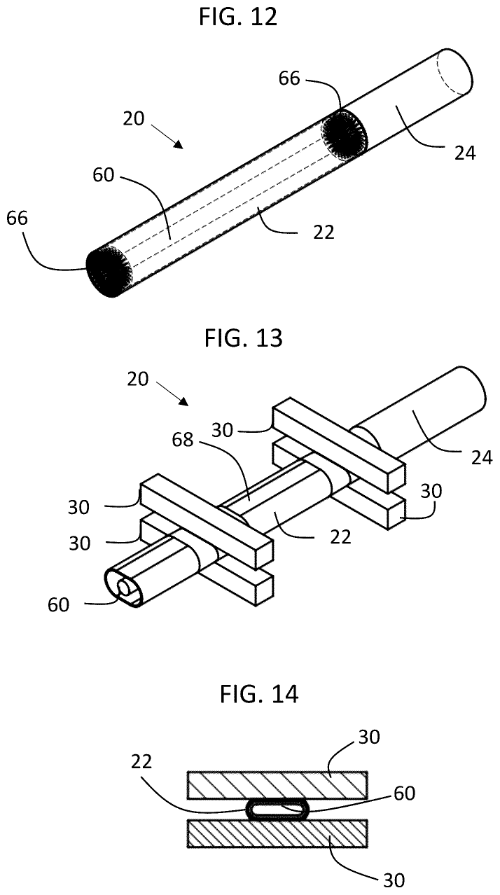

Reference is now made to FIG. 12, which is a schematic illustration of capsule 20, the capsule including a collapse-prevention element 60, in accordance with some applications of the present invention. For some applications, disc-shaped or cylindrical structures 66 are disposed at one or both of the ends of the collapse-prevention element, as shown in FIG. 12. For some applications, structures 66 are configured to center the collapse-prevention element within portion 22 of the capsule. For some applications, structures 66 are configured to perform additional functions, such as to hold the collapse-prevention element in place, to prevent the smoking material from falling out of the capsule, and/or to hold the smoking material in place while allowing sufficient airflow through the capsule.

Reference is now made to FIG. 13, which is a schematic illustration of capsule 20, the capsule including a collapse-prevention element 60, in accordance with some applications of the present invention. For some applications, the collapse-prevention element is configured to act as a heating element that is configured to be heated by the electrodes via electrical resistive heating. For example, when the electrodes flatten portion 22 of the capsule, the electrodes may be configured to become electrically connected to a conductive portion of the collapse-prevention element. For example, the mechanical pressure of the electrodes may be configured to bring an electrical contact 68 of portion 22 of the capsule (which is described hereinabove) into contact with a metallic coating that is disposed on the collapse-prevention element.

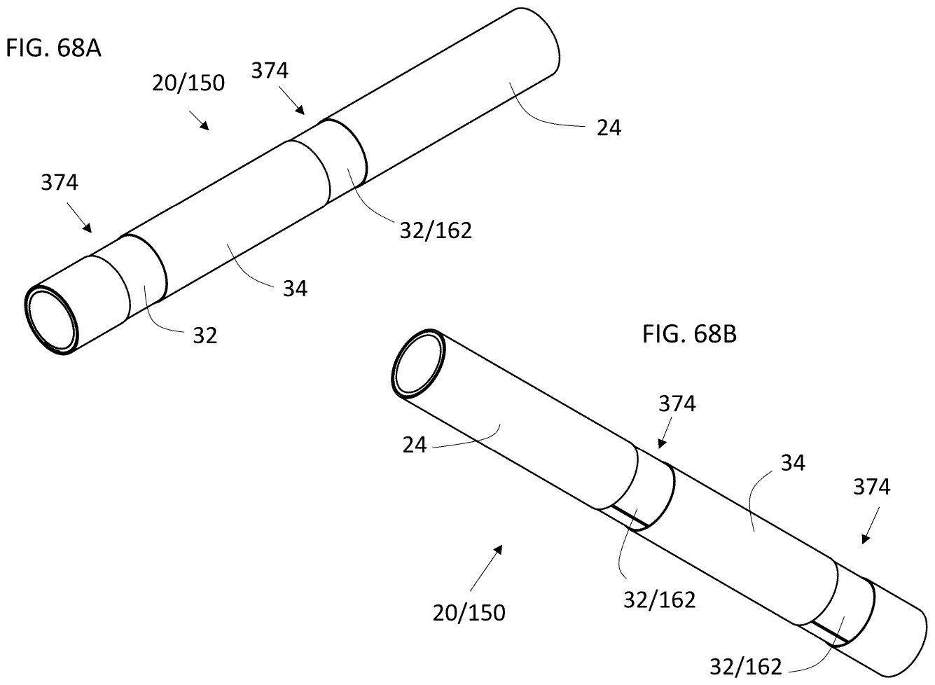

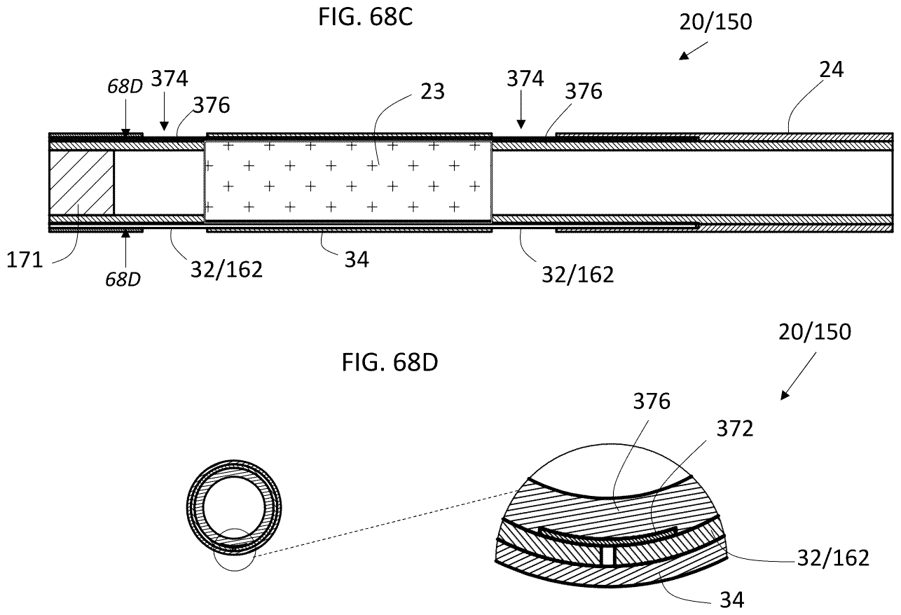

Reference is now made to FIG. 14, which is a schematic illustration of capsule 20, the capsule including a collapse-prevention element 60, in accordance with some applications of the present invention. For some applications the collapse-prevention element is a tube, e.g., a hollow, flexible tube, as shown in FIG. 14. The smoking material is disposed inside the tube and the tube typically adds rigidity to portion 22, thereby preventing it from collapsing when mechanical pressure is applied to portion 22 in order to flatten portion 22 of the capsule. Typically, the tube thereby ensures that there is adequate airflow through portion 22 and that there is good electrical contact between the electrodes and the heating element, by ensuring that the heating element is held in contact with the electrodes. For some applications, the capsule includes collapse-prevention elements that are configured to act in this manner and that are disposed at the regions at which the electrodes are configured to contact the capsule but not at other regions of the capsule that contain smoking material (e.g., as shown in FIG. 68C).

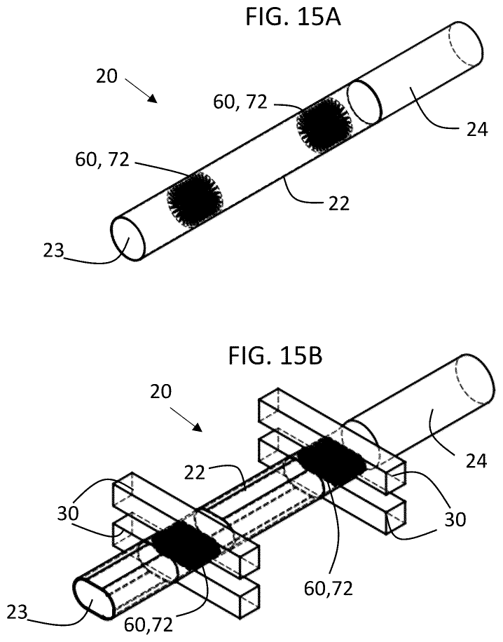

Reference is now made to FIGS. 15A and 15B, which are schematic illustrations of capsule 20, the capsule including a collapse-prevention element 60, in accordance with some applications of the present invention. FIG. 15A shows capsule 20 in a non-compressed configuration and FIG. 15B shows the capsule in a compressed configuration with mechanical pressure having been applied to the capsule by electrodes 30 (or a different mechanical flattening element), in order to flatten the capsule. For some applications, the collapse-prevention element is a spongy, or foam, disc-shaped or cylindrical element 72 that is disposed at one or both ends of portion 22 of the capsule. For some applications, the shape and/or material of element 72 is similar to that of a cigarette filter. Typically, element 72 is configured to allow airflow therethrough and is configured to maintain a given minimum thickness even when mechanical pressure is applied to element 72. Element 72 thereby ensures that there is adequate airflow through portion 22 and that there is good electrical contact between the electrodes and the heating element, by ensuring that the heating element is held in contact with the electrodes. For some applications, a cylindrical element is disposed at each end of portion 22, with a predefined quantity of smoking material disposed between the two cylindrical elements. For some applications, since there is a predefined quantity of smoking material disposed between the two cylindrical elements, the capsule is configured to provide a metered dose of an active agent to the user. For some such applications, the smoking device is configured to detect tampering with the capsule, to ensure that the dose that is being provided to the user has not been tampered with.

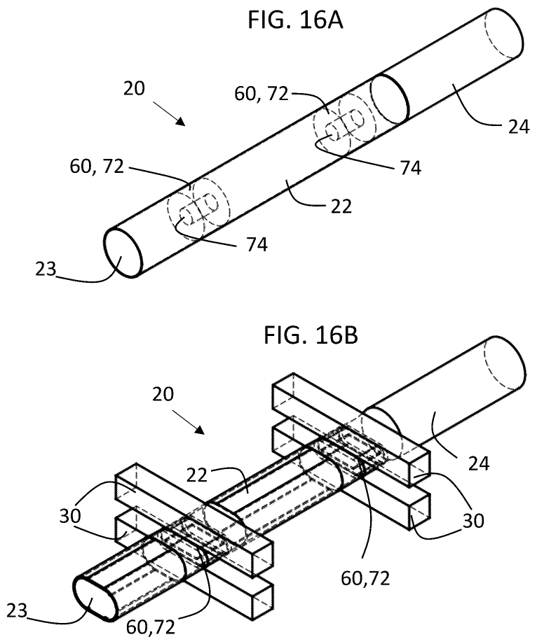

Reference is now made to FIGS. 16A and 16B, which are schematic illustrations of capsule 20, the capsule including a collapse-prevention element 60, in accordance with some applications of the present invention. As described with reference to FIGS. 15A and 15B, for some applications, the collapse-prevention element is a spongy or foam disc-shaped or cylindrical element 72 that is disposed at one or both ends of portion 22 of the capsule. For some applications, the shape and/or material of element 72 is similar to that of a cigarette filter. For some applications, element 72 defines a lumen 74 therethrough. The lumen is typically configured to allow airflow through element 72 even when element 72 has been compressed. (In FIG. 16B, lumen 74 is not visible. However, as stated, the lumen is typically configured to allow airflow through element 72 even when element 72 has been compressed.)

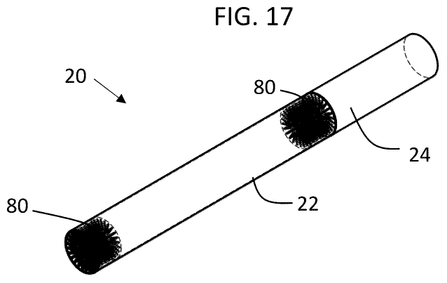

Reference is now made to FIG. 17, which is a schematic illustration of capsule 20, the capsule including one or more stoppers 80, in accordance with some applications of the present invention. For some applications, the stoppers are spongy or foam, disc-shaped or cylindrical elements that are disposed at one or both ends of portion 22 of the capsule. For some applications, the shape and/or material of each of the stoppers is similar to that of a cigarette filter. Typically, the stoppers are configured to prevent the smoking material from being dislodged from within the capsule (which can result in the smoking material itself entering the user's mouth and/or can lower the efficiency of the device). The stoppers are typically configured to allow airflow through the capsule while preventing the smoking material from becoming dislodged. For some applications, the stoppers include holes that are configured to allow airflow through the stoppers. For some applications, at least one of the stoppers is configured to adjust the airflow resistance of the capsule, for example, to make it similar to the airflow resistance of a traditional combustion cigarette.

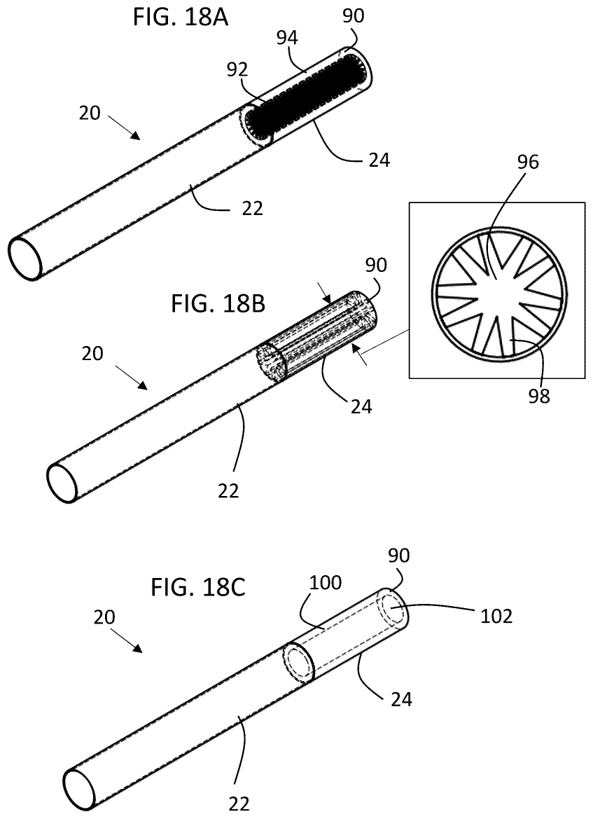

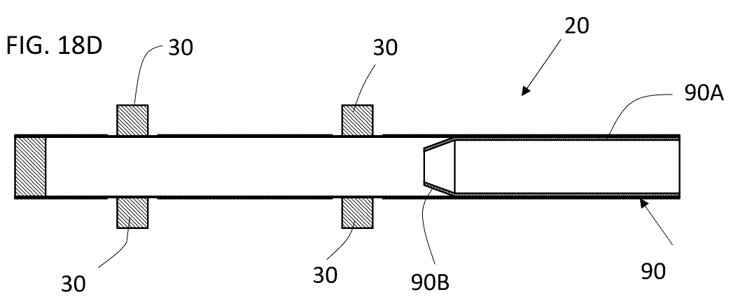

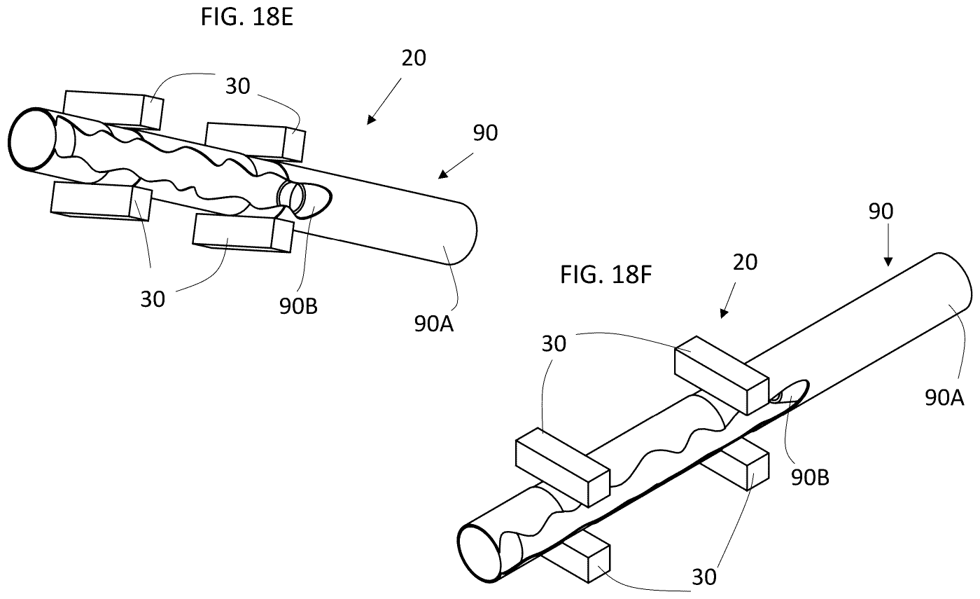

Reference is now made to FIGS. 18A, 18B, and 18C, which are schematic illustrations of capsule 20 including a mouthpiece 90, in accordance with some applications of the present invention. As described hereinabove, typically portion 24 of the capsule defines mouthpiece 90. Typically, the user sucks the vapors from the capsule via the mouthpiece. Typically, the mouthpiece is configured to prevent at least some of the heat from the heated portion of the capsule from reaching the user's mouth. For some applications, the mouthpiece includes flavoring agents. For some applications, the mouthpiece filters the vapors. For some applications, the mouthpiece cools the vapors. With reference to FIG. 18A, for some applications, the mouthpiece includes a spongy or foam disc-shaped or cylindrical element 92 that is typically similar to that of a cigarette filter, and which is covered with paper 94. With reference to FIG. 18B, for some applications, the mouthpiece comprises a tube 96 that has spokes 98 (e.g., plastic spoke or metal spokes) that are configured to cool the vapors. With reference to FIG. 18C, for some applications, the mouthpiece comprises a hollow tube 100 that defines a lumen 102 that is configured to allow airflow therethrough.

Reference is now made to FIGS. 18D, 18E, and 18F, which are schematic illustrations of respective views of capsule 20 with mouthpiece 90, the mouthpiece serving a number of purposes, in accordance with some applications of the present invention. Each of FIGS. 18D-18F shows the capsule disposed between electrodes 30. FIG. 18E shows a cross-sectional view of the capsule and FIGS. 18E and 18F show respective oblique views of the capsule with some of the covering layers peeled away for illustrative purposes. For some applications, the mouthpiece includes a first portion 90A that is shaped cylindrically via which a user is configured to draw vaporized active agents from the capsule into a mouth of the user, and a second portion 90B shaped as a cone with a narrow end of the cone adjacent to the smoking material such as to prevent solid matter (such as the smoking material and/or debris generated from the heating) from passing from the capsule into the user's mouth. For some applications, the mouthpiece is made of paper (e.g., card) that is shaped to define the first and second portions of the mouthpiece. For some applications, the second end of the mouthpiece is shaped such that the diameter of the opening through the mouthpiece at the narrow end of the cone is between 1 mm and 3 mm. (As described hereinabove, typically, the diameter of the capsule itself (and the first portion of the mouthpiece) is between 4 mm and 12 mm (e.g., between 5 and 8.5 mm).) For some applications, the second portion of the mouthpiece is sized such as to provide a desired level of resistance to airflow through the mouthpiece.

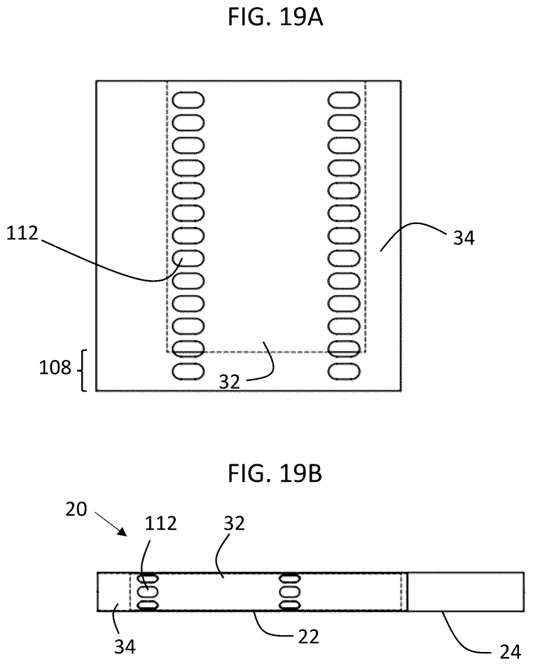

Reference is now made to FIGS. 19A and 19B, which are schematic illustrations of the paper covering 34 and heating element 32 of capsule 20, in accordance with some applications of the present invention. FIG. 19A shows the paper covering and metallic foil (acting as heating element 32) in a flattened configuration before smoking material has been inserted and the paper covering has formed a cylindrical housing for the smoking material. FIG. 19B shows the paper covering and the foil as configured after smoking material has been inserted and the paper covering has formed a cylindrical housing for the smoking material.

As described hereinabove, for some applications, the heating element comprises a metallic material, which is typically disposed within the capsule and/or is typically in direct contact with the smoking material, and that is heated via electrical resistive heating. For some applications, the heating element is a metal foil (e.g., stainless steel foil, nickel-titanium foil, titanium foil, copper foil, aluminum foil, steel foil) that typically is in direct contact with, and surrounds, the smoking material within portion 22 of capsule 20. For some applications, the foil has a thickness of more than 1 micron (e.g., more than 3 microns) and/or less than 20 microns (e.g., less than 10 microns), for example, 1-20 microns, or 3-10 microns. Typically, a current is applied along the length of portion 22 (e.g. with a positive electrode at the first end and a negative electrode at the second end, or vice versa) and airflow is parallel to the direction of the current flow. For some applications, a current is applied along the metallic foil along a length of portion 22 in an axial direction along the metallic foil (i.e., along a direction that is parallel to the longitudinal axis of the capsule) that is greater than 5 mm, e.g., greater than 15 mm. Typically, it is desirable for capsule 20 to have the general structure of a traditional cigarette. For some applications, the heating element extends along the entire length of the smoking-material-containing portion of the capsule. Alternatively, the heating element only extends along a portion of the length and/or the circumference of the smoking-material-containing portion of the capsule. For some applications, the heating element 32 (which is typically as described hereinabove) is printed and/or is adhered to the paper covering. Typically, at the locations at which the electrodes contact the capsule, the heating element is exposed to the electrodes, such as to make direct electrical contact with the electrodes.

As shown in FIGS. 19A-9B, for some applications, the foil is adhered to the paper covering along only part of the length of portion 22 of the capsule. For some applications, the foil is not adhered to the paper covering around the full circumference of portion 22. For some applications, the paper covering is adhered to itself along a band 108 of overlap, such as to form a cylindrical shape (i.e., there is a band 108 of overlap of the paper covering, in order to stick the paper covering to itself and form a closed cylinder). For some such applications, there is no foil within the band of overlap (e.g., as described hereinbelow with reference to FIGS. 68A-8D). Alternatively, the paper covering is adhered to itself along a band of overlap, such as to form a cylindrical shape and such that the metallic foil forms a band of overlap having an inner layer of metallic foil and an outer layer of metallic foil. For some applications, the paper covering defines openings 112 (e.g., holes or slits), in order to provide direct electrical contact between the electrodes and the foil.

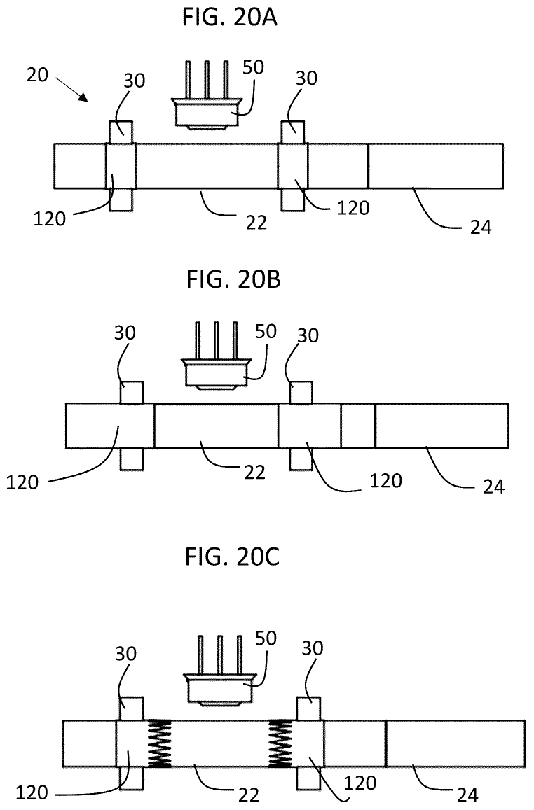

Reference is now made to FIGS. 20A, 20B, and 20C, which are schematic illustrations of capsule 20, the capsule including an electrical contact coating 120 at a region at which the capsule is configured to contact electrodes 30, in accordance with some applications of the present invention. For some applications, at a region at which the capsule is configured to contact electrodes 30, the capsule is coated with coating 120, which is configured to enhance the electrical contact between the electrode and the heating element. For example, the coating may be a gold or a copper coating, and may be an inner and/or an outer coating. For some applications, the coating has a lower resistance than that of metallic foil 32. Typically the coating extends until a region at which it is desirable for the heating element to be heating via electrical resistive heating. For some applications, the overall resistance of coating as well as that of the heating element is configured to provide a desired overall resistance, by configuring the materials, the thickness, and/or treatments that are applied to the coatings and/or to the heating element, as described in further detail hereinbelow. For example, the overall resistance may be configured to control the amount of heat that is generated, and/or to draw current from batteries of the smoking device in an efficient manner. For some applications, the overall resistance is set such as to substantially match the internal resistance of the (one or more) batteries of the smoking device, such that current is drawn from batteries of the smoking device in an efficient manner.

For some applications, the coating is configured to prevent the generation of hotspots at the region at which the capsule is configured to contact electrodes 30. For example, if there is suboptimal contact between an electrode and the heating element this can lead to the generation of a hotspot at the region at which the capsule is configured to contact electrodes 30, which can cause pyrolysis of the smoking material at the hotspot, and/or can lead to inadequate heating of the heating element. Typically, coating 120 is configured to prevent such hotspots from occurring.

For some applications, the coating is applied in a ring shape, as shown in FIGS. 20A and 20B. Alternatively, the coating is applied in a different shape. For example, the coating may have a zigzagged edge on the side at which the coating contacts the metallic foil (as shown in FIG. 20C), in order to conduct electrical current to the heating element in a uniform manner.

For some applications, the coating extends around the full circumference of the capsule, such that the coating diffuses the current, which is applied to the capsule by electrodes, uniformly around the circumference of the capsule. For some such applications, the smoking device includes only a single pair of electrodes disposed on one side of the capsule, rather than having a plurality of pairs of electrodes that are disposed at respective circumferential locations around the capsule. For some such applications, the smoking device includes a pair of electrodes disposed on one side of the capsule and a pair of mechanical elements that are configured to apply mechanical pressure to the capsule on the other side of the capsule.

For some applications, the capsule has a structure as shown in FIGS. 19A-9B, with the metallic foil being exposed via openings in the paper covering, and coating 120 is disposed outside the paper covering over the regions of the paper covering that define the openings. Thus, the coating electrically couples the electrodes to the metallic foil via the openings in the paper covering.

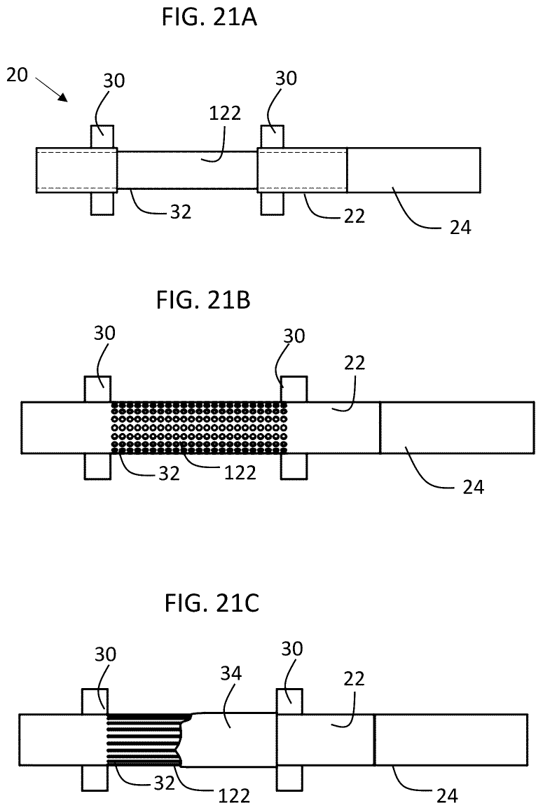

Reference is now made to FIGS. 21A, 21B, and 21C, which are schematic illustrations of capsule 20, the capsule including a region 122 that surrounds the smoking material, at which the metallic foil heating element has greater resistance than the resistance of the foil at the region at which the capsule is configured to contact electrodes 30, in accordance with some applications of the present invention. For some applications (as an alternative or in addition to coating the capsule at the region at which the capsule is configured to contact electrodes 30, as described with reference to FIGS. 20A-20C), at the region at which the capsule is configured to contact electrodes 30, the foil is made thick enough to provide good electrical contact with the electrodes as well as relatively low resistance. However, within region 122, the foil has different characteristics in order to increase its resistance such as to lead to adequate resistive heating to heat the smoking material. For example, within region 122, the foil may be thinner than at the region at which the capsule is configured to contact electrodes 30, in order to increase its resistance within region 122, as shown in FIG. 21A. Alternatively or additionally, within region 122, the foil may be etched (e.g., to create openings (e.g., holes or slits) in the foil), in order to increase its resistance within region 122, as shown in FIG. 21B. Further alternatively or additionally, within region 122, the foil may have openings (e.g., holes or slits) cut from it, in order to increase its resistance within region 122, as shown in FIG. 21C. Typically, even at locations at which the foil defines openings (e.g., holes or slits), paper covering 34 does not define openings, as indicated in FIG. 21C. In this manner, the paper covering cover blocks radial airflow into the capsule, such that there is no (or minimal) radial airflow into the capsule, and substantially all of the airflow is along the axial direction. Alternatively, the openings within the foil are not covered, such as to allow radial airflow into the capsule.

For some applications, the metallic foil heating element is configured to provide a desired overall resistance, by configuring the materials, the thicknesses, and/or treatments that are applied to the foil. For example, the overall resistance may be configured to control the amount of heat that is generated, and/or to draw current from batteries of the smoking device in an efficient manner. For some applications, the overall resistance is set such as to match the internal resistance of the (one or more) batteries of the smoking device, such that current is drawn from batteries of the smoking device in an efficient manner.

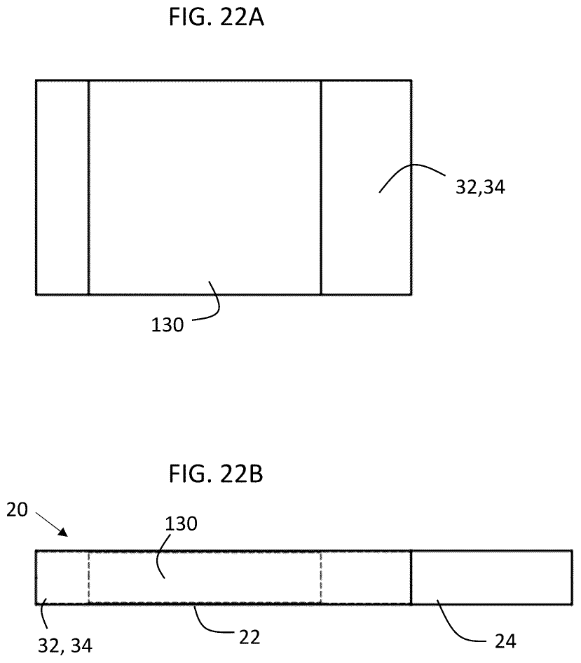

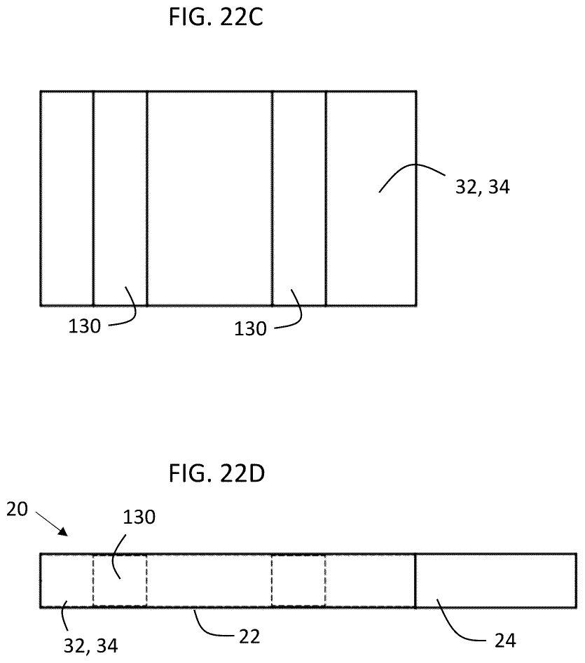

Reference is now made to FIGS. 22A, 22B, 22C and 22D, which are schematic illustrations of a covering material of capsule 20 (e.g., paper covering 34 and/or heating element 32), the covering material including an inner lining 130, in accordance with some applications of the present invention. Typically, the inner lining is flexible and is configured to diffuse heat that is generated by the heating element. For example, the inner lining may include polyimide. Typically, the inner lining acts as a barrier between the heating element and the smoking material, such that if heat is not evenly generated across the heating element and/or if there are hotspots, the inner lining diffuses the heat across the smoking material. For some applications, the inner lining extends along a length of the capsule within which the smoking material is disposed, e.g., as shown in FIGS. 22A-22B. For some applications, the inner lining is configured to add to the mechanical strength of the capsule, for example to prevent the capsule from tearing as a result of mechanical pressure that is applied to the capsule by electrodes 30. For some such applications, the inner lining is disposed at regions of the capsule that are configured to be compressed by the electrodes, as shown in FIGS. 22C-22D.

For some applications, the inner lining is configured to diffuse one or more chemicals, such as flavoring, pharmaceuticals, and/or a vapor-generating chemical, such as glycerol. For some applications, the inner lining includes a phase-change material that is configured to prevent the temperature of the smoking material from exceeding the phase-change temperature of the phase-change material. Typically, the phase-change material is selected such as to prevent the temperature of the smoking material from exceeding a temperature at which the smoking material pyrolyzes. For some applications, the phase-change material is selected such as to maintain the temperature of the smoking material within an optimal range for vaporization and/or taste. For some applications the inner lining is configured to absorb chemicals that are generated by pyrolysis of the smoking material and/or other material within the capsule, such as nitric oxide and/or carbon monoxide.

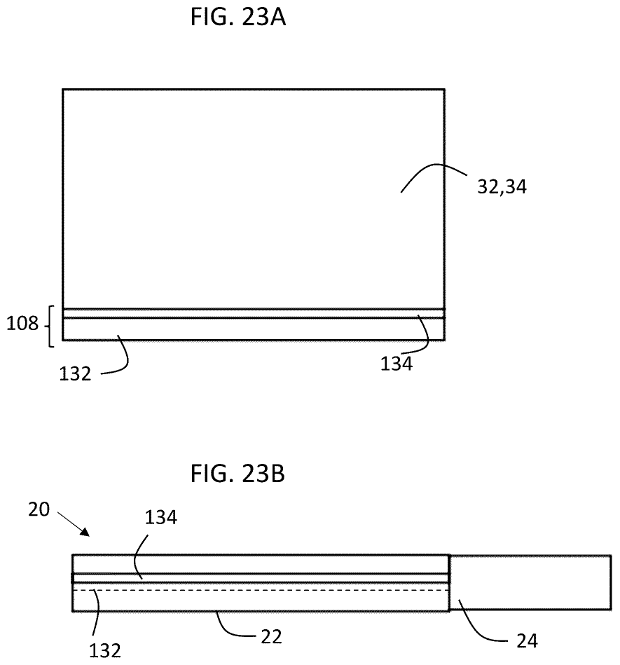

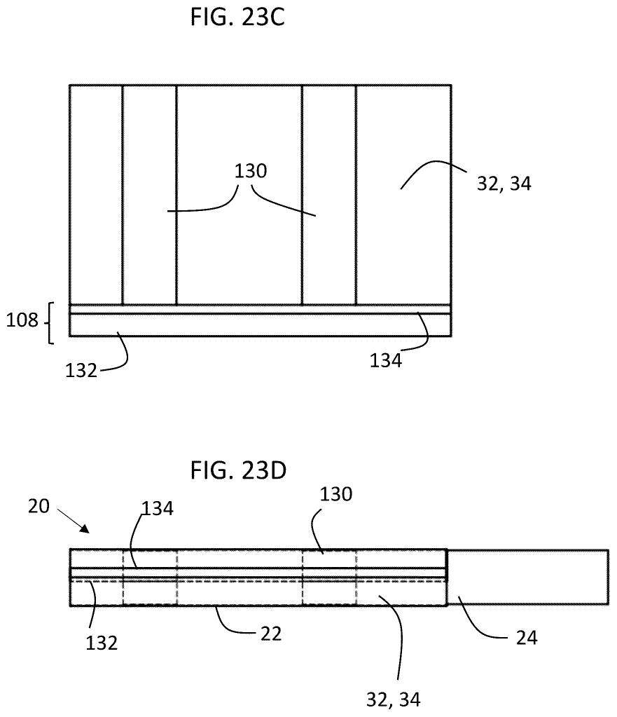

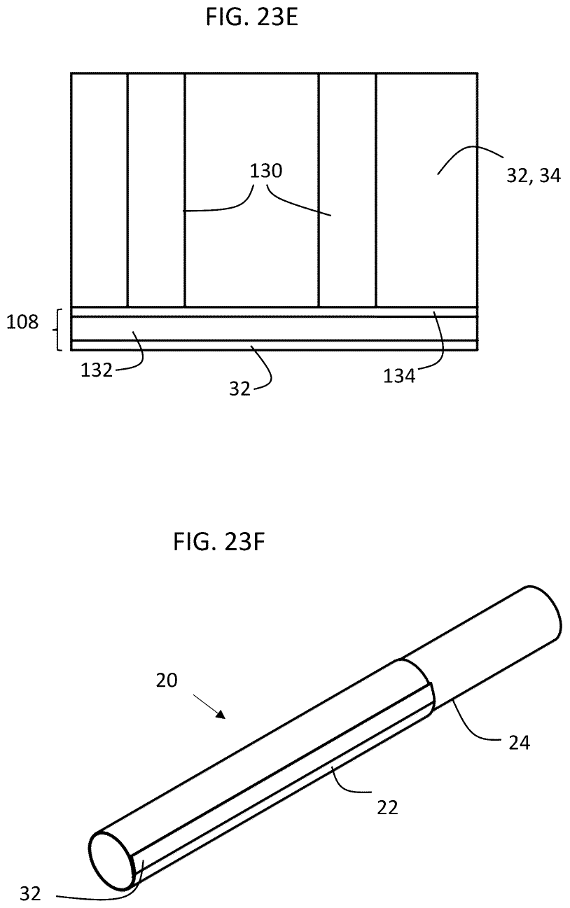

Reference is now made to FIGS. 23A, 23B, 23C, and 23D, which are schematic illustrations of a covering material of capsule 20 (e.g., paper covering 34 and/or heating element 32), the covering material including adhesive 132 and/or additional material at band 108 of overlap of the covering material, in accordance with some applications of the present invention. For some applications, the covering material is adhered to itself at the band of overlap in order to form a cylindrical shape that encases the smoking material (and/or additional elements, as described herein). For example, the adhesive may be liquid adhesive and/or double-sided adhesive. For some applications, the covering material is treated at the band of overlap in order to adhere it to itself (e.g., a UV treatment, or welding). For some applications, the covering material is treated so as to form a cylindrical shape even without having a band of overlap, e.g., via extrusion. For some applications, at least a portion of the covering material includes inner lining 130 as shown in FIGS. 23C and 23D, with the inner lining typically being as described above.

For some applications, at the band of overlap, the metallic foil and/or other conducting elements (e.g., conductive coatings) may be doubled. For some applications, the paper covering is adhered to itself along a band of overlap, such as to form a cylindrical shape and such that the metallic foil forms a band of overlap having an inner layer of metallic foil and an outer layer of metallic foil. In some cases, this can generate hotspots. For some applications, in order to prevent this, an adhesive is used that is an electrical insulator, such that the electrodes only apply current to the outer layer of the conducting elements (e.g. the metallic foil), but the inner layer of the conducting elements (e.g. the metallic foil) is electrically isolated from the electrodes. For some applications, an additional insulating material 134 (e.g., liquid polyimide) is added along at least a portion of the band of overlap.

Reference is now made to FIGS. 23E and 23F, which are schematic illustrations of a covering material of capsule 20 (e.g., paper covering 34 and/or heating element 32), the covering material including adhesive 132 and/or additional material at band 108 of overlap of the covering material, in accordance with some applications of the present invention. The configuration of the covering material shown in FIGS. 23E-23F is generally similar to that shown in FIGS. 23C-D, except that in the configuration shown in FIGS. 23E-23F, there is a small band of heating element 32 (i.e., the metallic foil) which is configured to overlap with an inner layer of the heating element, when the covering material is made to overlap with itself such as to form a cylindrical shape. By being configured in this manner, even if one of the electrode pairs of the smoking device coincides with band 108 of overlap of the covering material, the electrodes still pass a current into the metallic foil at that circumferential location. Typically, in such cases, the electrode pair will drive the current into the outer layer of the metallic foil, which will then transfer the current to the inner layer of the metallic foil.

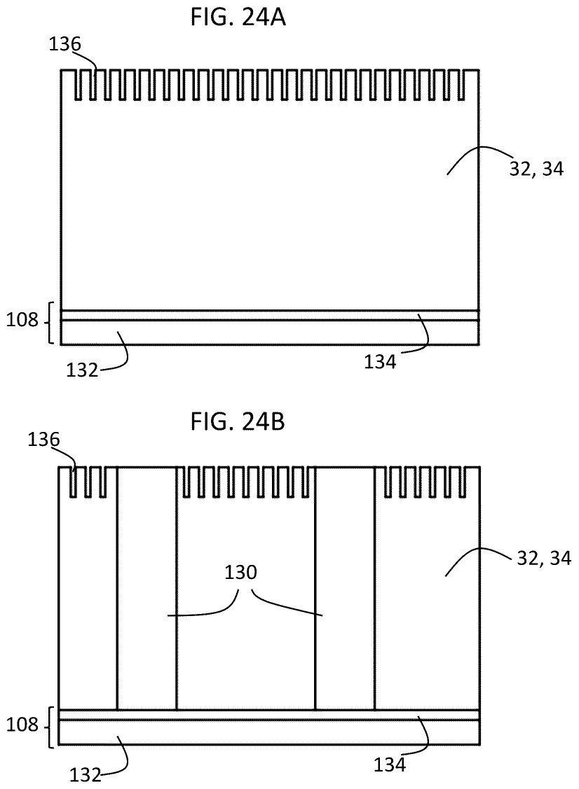

Reference is now made to FIGS. 24A and 24B, which are schematic illustrations of a covering material of capsule 20 (e.g., paper covering 34 and/or heating element 32), one or more slits 136 being formed in conducting elements (e.g., heating element 32) at band 108 of overlap of the covering material, in accordance with some applications of the present invention. For some applications, at the band of overlap, the metallic foil that typically comprises the heating element and/or other conducting elements (e.g., conductive coatings) may be doubled. For some applications, the paper covering is adhered to itself along a band of overlap, such as to form a cylindrical shape and such that the metallic foil forms a band of overlap having an inner layer of metallic foil and an outer layer of metallic foil. In some cases, this can generate hotspots. For some applications, along at least a portion of the band of overlap, slits 136 are made in the conducting elements (e.g., the metallic foil) in the circumferential direction, in order to increase resistance along the portion of the band of overlap. For some applications, along at least a portion of the band of overlap, the conducting elements (e.g., the metallic foil) is treated in some other manner, in order to increase resistance along the portion of the band of overlap. For some applications, at least a portion of the covering material includes inner lining 130 as shown in FIG. 24B, with the inner lining typically being as described above.

Referring again to FIGS. 19A-24B (which describe various outer coatings, inner linings, and apparatus and methods for forming a cylindrically-shaped capsule), it is noted that the scope of the present disclosure includes any one of the following capsule designs. In some applications, paper covering 34 covers at least a portion of the capsule. In some applications, the paper covering is adhered to itself along a band of overlap, such as to form a cylindrical shape, thereby making the capsule airtight (and thereby ensuring airflow in the axial direction of the cylindrical capsule).

For some applications, metallic foil (acting as heating element 32) is adhered to the inside of the paper covering. For some applications, the metallic foil overlaps with itself, as described hereinabove. For some applications, the extent of overlap of the paper covering and that of the metallic foil are not the same as each other. For some applications, the metallic foil does not overlap with itself at all. Typically, for such applications, the metallic foil still encompasses the full circumference of the capsule, by the two sides of the metallic foil contacting each other (but without overlapping with each other), such that a uniform resistance is provided by the metallic foil around the circumference of the capsule. For some such applications, the metallic foil is adhered to only a portion of the circumference of the paper covering, such that the paper covering overlaps with itself but the metallic foil does not (e.g., as shown in FIG. 19A). Typically, even in such cases, the paper covering is adhered to itself along the band of overlap, such as to form a cylindrical shape, thereby making the capsule airtight. For some applications, an inner lining (e.g., a strip of polyimide running along the length of portion 22 of the capsule) is used to hold the two sides of the metallic foil in place and to seal the capsule and make it airtight. For some applications, an inner lining is disposed along portions of the capsule at which the electrodes contact the metallic foil, in order to seal the capsule at these portions. For some applications, there is overlap between outer coatings or cover (e.g., the paper covering) and an inner lining, in order to ensure that the capsule is fully sealed.

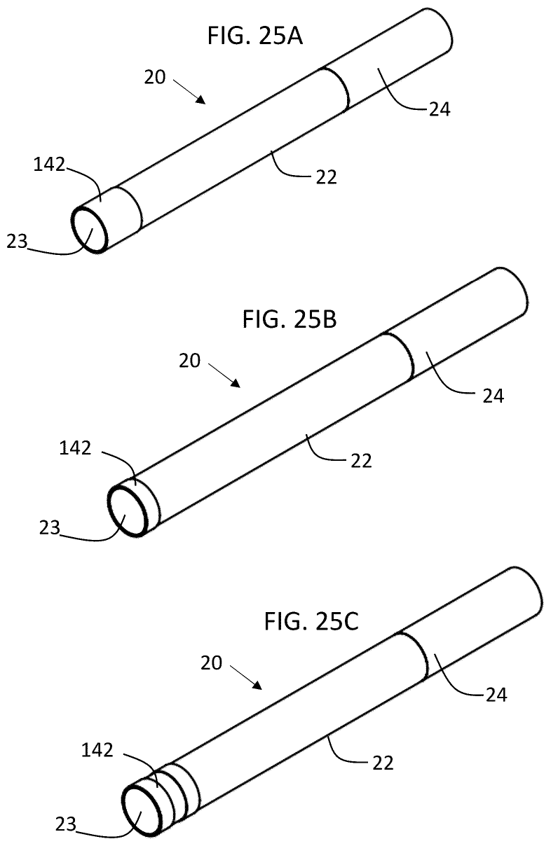

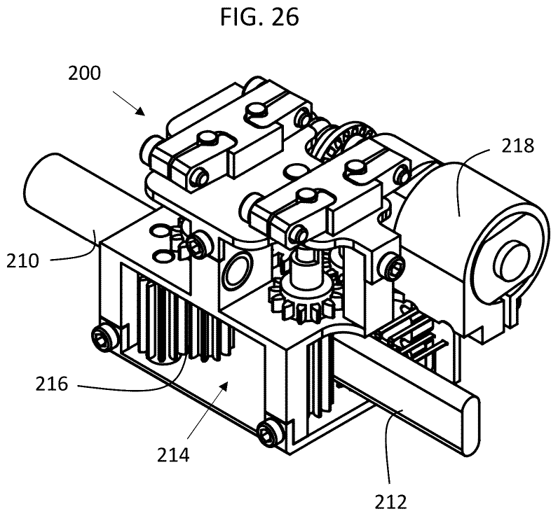

Reference is now made to FIGS. 25A, 25B, and 25C, which are schematic illustrations of capsule 20, the capsule including one or more identifying features 142, in accordance with some applications of the present invention. For some applications, smoking device 200 is configured to identify which type of capsule has been inserted and to operate in response to the type of capsule, for example, by heating the capsule to the vaporization temperature of the smoking material or according to a temperature profile that is suitable for the smoking material, controlling the amount of active agents that is vaporized, providing an output to the user regarding the category of capsule, etc. For some applications the identifying feature is a colored marking and the smoking device is configured to detect the color of the marking when the capsule is placed in the smoking device and/or during insertion of the capsule in the smoking device. For some applications, the identifying feature is a barcode, QR code, and/or a different type of patterned marking. For some applications, the identifying feature is a portion of the capsule that is configured to emit thermal radiation as the capsule is being heated. Typically, the smoking device includes an optical camera (e.g., a black-and-white camera) and/or a thermal camera that is configured to identify the aforementioned features. For some applications, the identifying feature is the resistance or a profile of resistance of the capsule. For example, the paper covering and/or a different insulating material may cover the metallic foil in a manner that defines a pattern of resistance that is identified by the smoking device. For some applications, the smoking device includes a sensor (such as an NFC antenna) that is configured to identify a package of capsules from which the capsule is sourced.

As noted above, for some applications, a single smoking device is configured for use with a first capsule type that contains a solid smoking material containing one or more active agents and for use with a second capsule type that contains a liquid material containing one or more active agents. When the capsule of the first capsule type is inserted into the smoking device, the smoking device is configured to vaporize one or more of the active agents contained within the solid smoking material by heating the capsule of the first capsule type, and when a capsule of the second capsule type is inserted into the smoking device, the smoking device is configured to vaporize at least some of the liquid vaping material by heating the capsule of the second capsule type.

It is noted that the smoking device is configured for use with each of the two capsule types separately at respective times. Thus, if in a first smoking session a user wishes to smoke from a solid smoking material (e.g., in a heat-not-burn manner) they would insert a capsule of the first capsule type into a capsule-receiving portion of the smoking device, and if in a separate smoking session they wish to vape from a liquid smoking material, they would insert a capsule of the second capsule type into the same capsule-receiving portion of the smoking device.

For some such applications, the above-described capsule identification techniques are used to automatically determine whether a capsule of the first or second capsule type is currently disposed in the smoking device. Alternatively, the user manually provides an input to the smoking device indicating whether a capsule of the first or second capsule type is currently disposed in the smoking device. The smoking device typically controls the heating of the capsule based upon the type of capsule that has been determined as currently being disposed in the device. For some applications, the smoking device controls the heating of the capsule in a similar manner regardless of the type of capsule that is currently disposed in the device.

Alternatively, for some applications, respective smoking devices are configured for use with the capsule type that contains a solid smoking material containing one or more active agents, or for use with the capsule type that contains a liquid material containing one or more active agents.

It is noted that although some applications of the present disclosure are described as being applied to a capsule that is provided to a user in a flattened configuration and/or is flattened by the smoking device, the scope of the present disclosure includes applying any one of the features of capsule 20 that are described herein to a cylindrical capsule that is configured to remain cylindrical even upon being inserted into the smoking device, mutatis mutandis. For example, any one of the features described with respect to the structure of the capsule, components of the capsule, coverings of the capsule, inner linings of the capsule, identifying features of the capsule, etc., are applicable to a cylindrical capsule that is configured to remain cylindrical even upon being inserted into the smoking device, mutatis mutandis.

Reference is again made to FIGS. 1C and 1D, which show smoking device 200, which is configured for use with capsule 20. Reference is also made to FIG. 26, which is a schematic illustration of smoking device 200 with its cover removed (for illustrative purposes), in accordance with some applications of the present invention. Typically, the smoking device includes a button 204 and an indicator light 206 (shown in FIGS. 1C and 1D), e.g., an LED light. For some applications, the smoking device includes additional user interface components, e.g., a vibrating component. Typically, the smoking device includes a power source 237, e.g., one or more batteries (shown in FIGS. 29C and 29D), which are typically rechargeable via a charging port that is built into the device. Typically, the smoking device includes a control component 233 (e.g., a microprocessor and/or a microchip, shown in FIGS. 29C and 29D) that is configured to control heating of the capsule, identify the capsule, detect insertion of the capsule, detect puffs of the user (and/or lengths and/or depths of puffs), detect the temperature of the smoking material, and control heating of the smoking material in response thereto, as described in detail hereinabove. For some applications, the smoking device includes one or more sensors, such as an infrared temperature sensor, a thermal camera, a temperature sensor (such as a contact temperature sensor that measures the temperature of the smoking material by contacting the smoking material), and/or thermocouple sensor. For some applications, the smoking device is configured to detect electrical resistance of the capsule.

As described hereinabove, for some applications, the smoking device includes a plurality of temperature sensors, e.g., a plurality of infrared temperature sensors. For some applications, the smoking device is configured to detect puffs, lengths of puffs, and/or depths of puffs of the user and to control the heating of the smoking material or perform other functions responsively thereto. For some applications, the smoking device is configured to identify the capsule and to perform function responsively thereto. For some applications, the smoking device includes a sensor configured to detect patterns or colors, an optical camera (e.g., a black-and-white camera), a thermal camera, a sensor configured to detect resistance or conduction of given portions of the capsule. For some applications, the smoking device includes a sensor (such as an NFC antenna) that is configured to identify a package of capsules from which the capsule has been taken.

In accordance with respective applications, the smoking device is configured to flatten capsule 20, or is not configured to change the shape of capsule 20. For some applications, the smoking device is configured to heat the capsule via electrical resistive heating. Alternatively or additionally, the smoking device is configured to heat the capsule via magnetic induction heating. FIG. 26 shows an example of smoking device that is configured to flatten capsules. As shown, the capsule is configured to be inserted via a cylindrical insertion port 210, but portion 22 of the capsule (or a portion thereof) is housed within a non-cylindrical housing 212 (e.g., a housing having an elliptical, rectangular, pill-shaped, or racetrack-shaped cross-sectional shape) during heating of the smoking material, as described hereinabove. For some applications, the smoking device includes one or more mechanical elements 214 (e.g., gear wheels 216 and a motor 218, as shown) that are configured to flatten the capsule. For some applications, the mechanical elements are configured to flatten the capsule by applying mechanical pressure to the sides of the capsule while the capsule is stationary. For some applications, the mechanical elements are configured to flatten the capsule by applying mechanical pressure to the sides of the capsule as the capsule moves from insertion port 210 into housing 212. For some applications, the smoking device includes a funnel, and is configured to flatten the capsule by passing the capsule through the funnel as the capsule moves from insertion port 210 into housing 212.

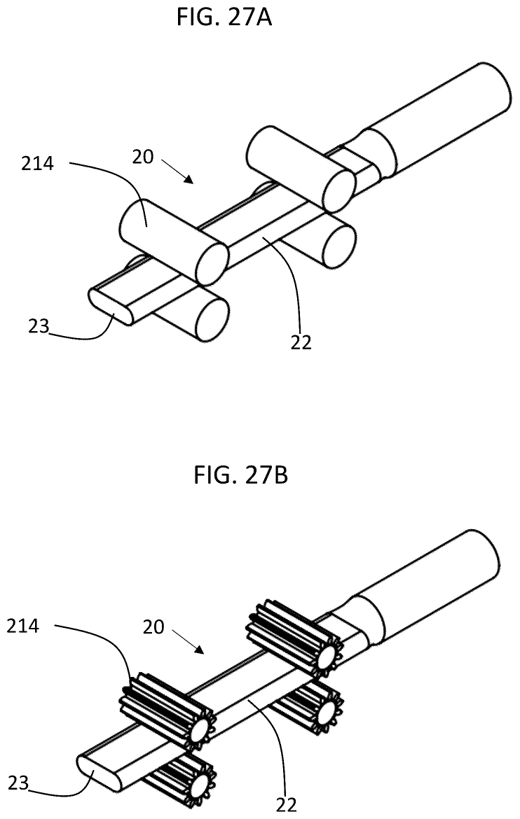

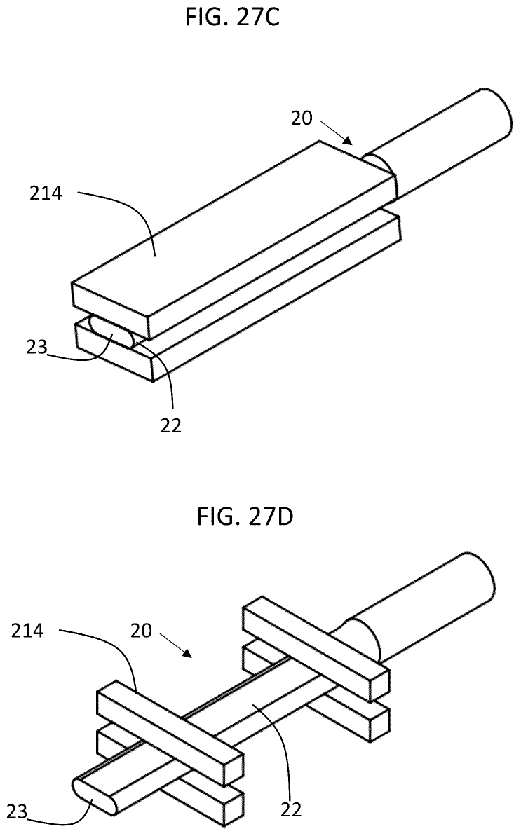

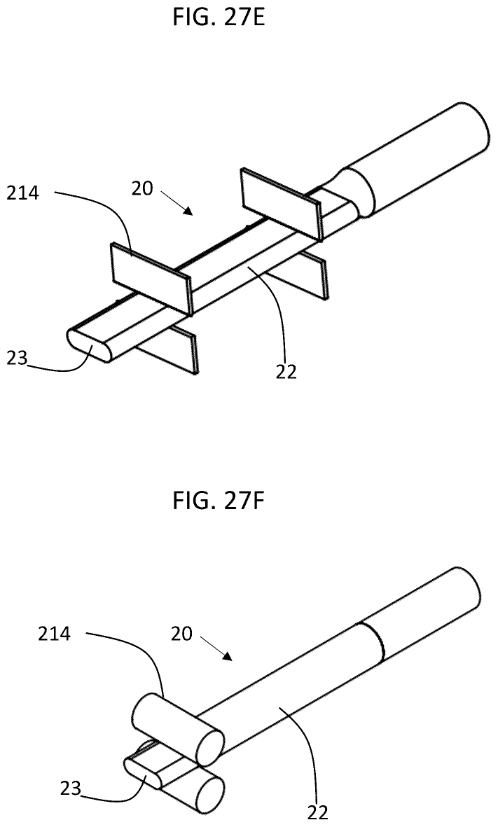

Reference is now made to FIGS. 27A, 27B, 27C, 27D, 27E, and 27F, which are schematic illustrations of mechanical elements 214 for flattening a portion of capsule 20, in accordance with some applications of the present invention. In accordance with respective embodiments, the mechanical elements may include one or more of wheels (FIG. 27A), gear wheels (27B), plates that are configured to apply even mechanical pressure along at least part of portion 22 of the capsule (FIG. 27C), cuboid elements that are configured to apply even mechanical pressure at discrete locations along of portion 22 of the capsule (FIG. 27D), and/or blade like elements (FIG. 27E). For some applications, the mechanical elements also function as electrodes and heat the smoking material via resistive heating of a heating element inside the capsule, as described in detail hereinabove. Thus, the electrodes serve a dual function of heating the smoking material via resistive heating of a heating element inside the capsule and of flattening a portion of the capsule via mechanical pressure.

For some applications, an area of contact between mechanical elements 214 and the capsule is minimized in order to reduce the loss of thermal energy from the capsule via this contact area. For some applications, thermally-insulating material is disposed between the mechanical elements and the capsule over at least a portion of the area of contact, in order to reduce the loss of thermal energy from the capsule via this contact.

For some applications, mechanical elements (such as roller wheels, as shown in FIG. 27F) are used to flatten at least a part of portion 22 of capsule 20, by rolling over the capsule as the capsule is being inserted into the smoking device. For some applications, the roller wheels assist in the axial insertion of the capsule.

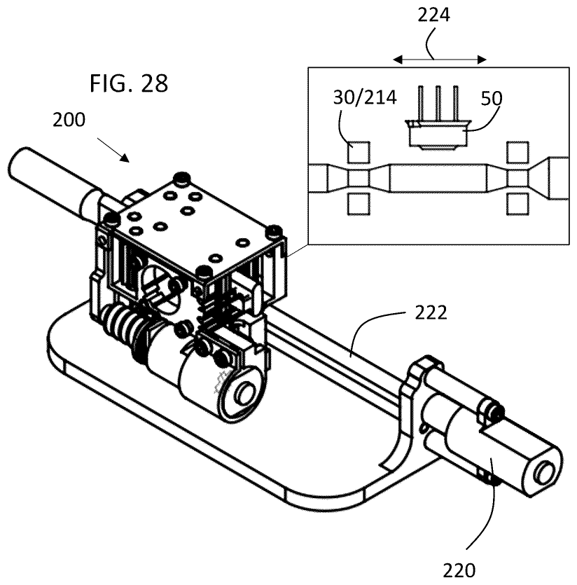

Reference is now made to FIG. 28, which is a schematic illustration of smoking device 200, the smoking device including electrodes 30 and/or mechanical elements 214 that are configured to move axially relative to capsule 20, in accordance with some applications of the present invention. For some applications, the smoking device includes a motor 220 which is configured to slide electrodes 30 and/or mechanical elements axially along a rail 222 relative to capsule 20. For some applications, the mechanical elements 214 flatten the capsule as they move over the capsule. For some applications, as the electrodes move, sensor 50 is moved with them, as indicated by arrow 224. The scope of the present disclosure includes electrodes that are configured to move axially relative to the capsule (e.g., using a generally similar mechanism to that shown in FIG. 28), one or more sensors that are configured to move axially relative to the capsule (e.g., using a generally similar mechanism to that shown in FIG. 28), or both one or more sensors and electrodes that are configured to move axially relative to the capsule (e.g., using a generally similar mechanism to that shown in FIG. 28). For some applications, the one or more sensors and electrodes are configured to move axially relative to the capsule together with each other (e.g., using a generally similar mechanism to that shown in FIG. 28). It is noted that in all such applications, the electrodes and/or sensors are configured to actively move relative to the capsule, and this is a separate function from that of the capsule being moved relative to the electrodes and/or the sensors (such that the electrodes and/or the sensors move passively relative to the capsule), e.g., during the insertion of the capsule.

Reference is now made to FIGS. 29A and 29B, which are schematic illustrations of smoking device 200, the smoking device including a mechanism 230 that is configured to bring electrodes 30 and/or mechanical elements 214 into pressurized contact with capsule 20, in accordance with some applications of the present invention. For some applications, the mechanism is configured to bring electrodes 30 into pressurized contact with capsule 20, in order to enhance electrical contact between the electrodes and the heating element of the capsule. Alternatively or additionally, mechanism 230 is configured to bring mechanical elements 214 into pressurized contact with capsule 20 in order to flatten a portion of the capsule. As noted above, for some applications, the electrodes function as the mechanical elements.

Reference is now made to FIGS. 29C and 29D, which are schematic illustrations of smoking device 200, the smoking device including a mechanism 230 that is configured to bring electrodes 30 and/or mechanical elements 214 into pressurized contact with capsule 20, in accordance with some applications of the present invention. For some applications, the mechanism is configured to bring electrodes 30 into pressurized contact with capsule 20, in order to enhance electrical contact between the electrodes and the heating element of the capsule. Alternatively or additionally, mechanism 230 is configured to bring mechanical elements 214 into pressurized contact with capsule 20 in order to flatten a portion of the capsule. As noted above, for some applications, the electrodes function as the mechanical elements. For some applications, mechanism 230 includes one or more compression springs 232 that are configured to generate a counterforce in response to being compressed. For some such applications, smoking device 200 includes a button 234 that is coupled to a gear track 236. (For some applications, button 234 is the same as button 204 (shown in FIG. 1C). Alternatively, buttons 234 and 204 are separate buttons from each other.) Typically, the smoking device is configured such that insertion of capsule 20 requires button 234 to be pressed (as indicated by arrow 235 in FIG. 29C). Further typically, the pressing of the button causes compression of the compression springs, such that upon release of the button, the compression springs bring the electrodes into pressurized contact with the capsule (i.e., the configuration shown in FIG. 29D). It is noted that the compression springs are not visible in FIG. 29D.

Typically, the smoking device includes a control component 233 (e.g., a control chip and/or a control microprocessor) and a power source 237 (e.g., one or more batteries), both of which are shown in FIGS. 29C and 29D. For some applications, the one or more batteries are chargeable and the smoking device includes a charging port for charging the one or more batteries.

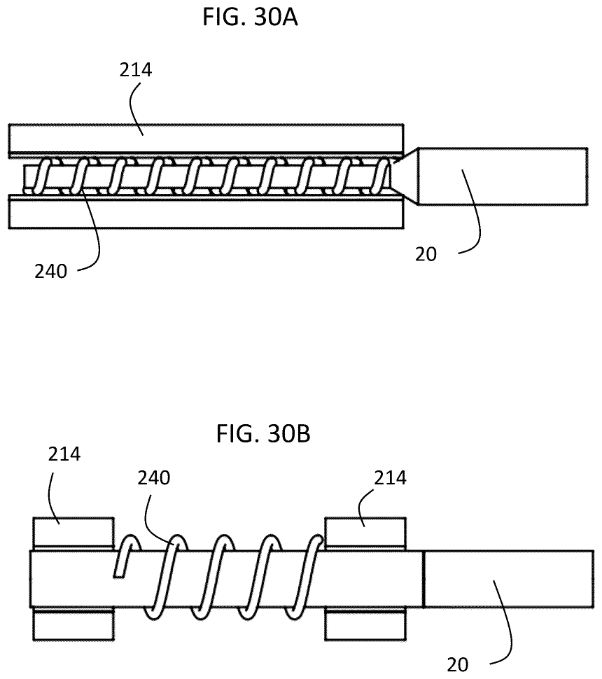

Reference is now made to FIGS. 30A and 30B, which are schematic illustrations of a coil 240 of smoking device 200 that is configured to be flattened by mechanical elements 214, in accordance with some applications of the present invention. As described hereinabove, for some applications, smoking device 200 includes a coil that is configured to generate an electromagnetic field. The coil is configured to heat one or more magnetically-heated materials (i.e., materials that are susceptible to being heated by a magnetic field (such as, magnetic materials and/or ferromagnetic materials)) within the capsule via magnetic induction. Typically, the control component of the smoking device drives an electric current through the coil in order to generate the magnetic field. In accordance with some applications, the magnetically-heated material is configured as a magnetically-heated rod 42 that is disposed along the length of the capsule (as shown in FIG. 7A), a magnetically-heated strip 44 that is disposed along the length of the capsule (as shown in FIG. 7B), a magnetically-heated tube 46 that is disposed along the length of the capsule (shown in FIG. 7C), and/or a plurality of magnetically-heated particles 48 (e.g., balls or beads) that are dispersed within the smoking material (as shown in FIG. 7D). Alternatively or additionally, a magnetically-heated material is disposed around the smoking material (e.g., underneath a paper covering), in a similar manner to that described with reference to the metallic foil that is heated via electrical resistive heating.

For some such applications, coil 240 has a circular cross section, and the coil is flattened by the mechanical elements 214 together with a portion of the capsule, subsequent to the portion of the capsule having been placed within the coil, as shown in FIG. 30A-30B. The circular-cross-section of the coil typically facilitates easy insertion of the capsule to within the coil, while the flattened configuration of the capsule (and the coil) during heating of the smoking material facilitates the heating of the smoking material. For some applications, the flattened configuration of the capsule during heating of the smoking material facilitates the heating of the smoking material by reducing the distance between the magnetically-heated particles and the smoking material, as described hereinabove. For some applications, the flattened configuration of the coil facilitates the heating of the smoking material by reducing the cross-sectional area of the coil, thereby increasing the magnetic flux density through the coil relative to a coil that has a larger cross-section at a similar electrical current.

For some applications, coil 240 is integrated into a sleeve or tube within smoking device 200. Alternatively or additionally, the coil includes an inner and/or an outer lining (e.g., a polyimide inner and/or outer coating).

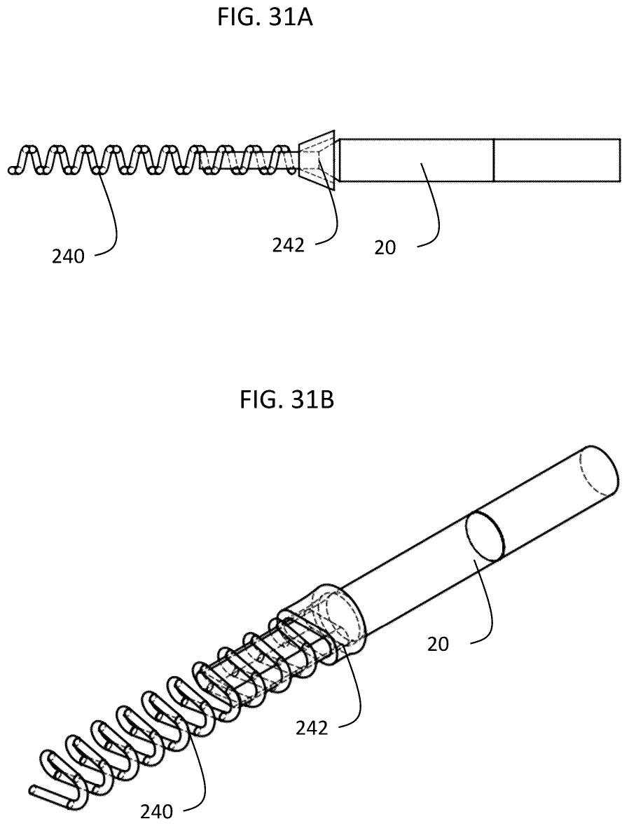

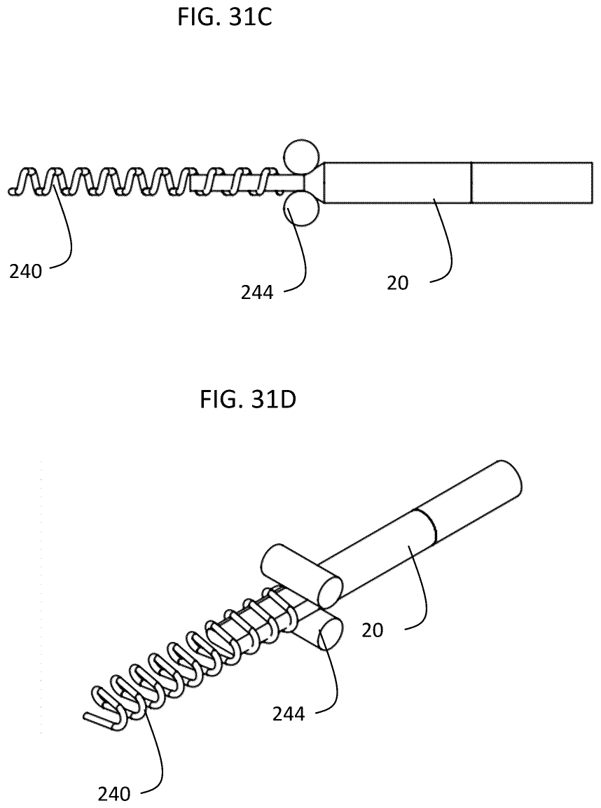

Reference is now made to FIGS. 31A, 31B, 31C, and 31D which are schematic illustrations of coil 240 of smoking device 200 that is pre-shaped in a flattened configuration (i.e., such that it is in the flattened configuration even in the absence of mechanical force acting on the coil), in accordance with some applications of the present invention. For some applications, a portion of the capsule is flattened as it is being inserted into the coil. For example, the portion of the capsule may be flattened via a funnel 242 (as shown in FIGS. 31A-1B), and or by roller wheels 244 (as shown in FIGS. 31C-31D). As described with reference to FIGS. 30A-30B, for some applications, the flattened configuration of the capsule during heating of the smoking material facilitates the heating of the smoking material by reducing the distance between the magnetically-heated particles and the smoking material. For some applications, the flattened configuration of the coil facilitates the heating of the smoking material by reducing the cross-sectional area of the coil, thereby increasing the magnetic flux density through the coil relative to a coil that has a larger cross-section at a similar electrical current.

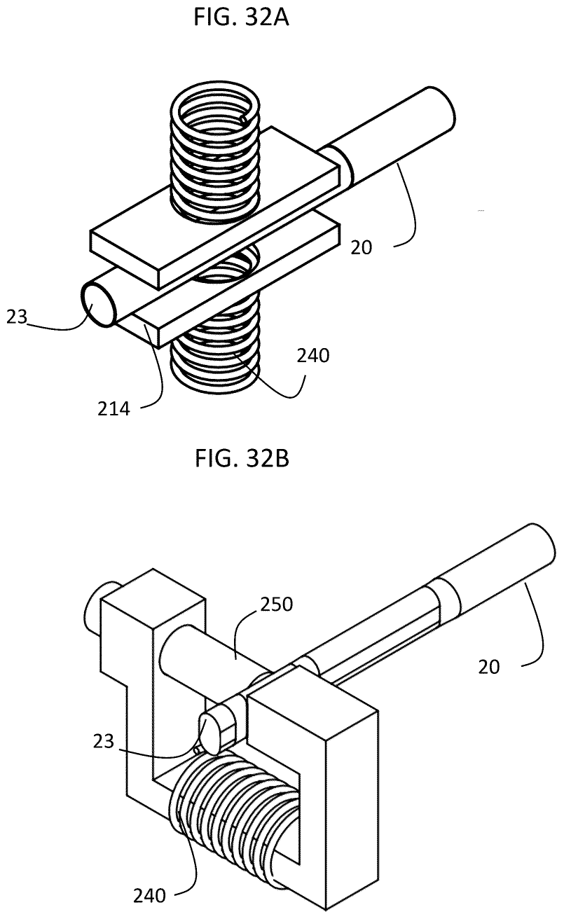

Reference is now made to FIGS. 32A and 32B, which are schematic illustrations of coil 240 of smoking device 200, in accordance with some applications of the present invention. For some applications, the capsule is not inserted into coil 240. For example, the axis of the coil may be perpendicular to the axis of the capsule and intersect the axis of the capsule (as shown in FIG. 32A), or the axis of the coil may be perpendicular with the axis of the capsule and not intersect the axis of the capsule (as shown in FIG. 32B). For some applications, a material 250 with high magnetic permeability directs the magnetic field to the capsule, as shown in FIG. 32B. For some applications, material 250 is shaped to define a magnetic circuit, with the capsule being inserted into a gap in the circuit. For some such applications, material 250 is configured to apply mechanical pressure to at least a portion of the capsule, thereby flattening the portion capsule, as shown in FIG. 32B. For some applications, the flattened configuration of the capsule during heating of the smoking material facilitates the heating of the smoking material by reducing the distance between the magnetically-heated particles and the smoking material, as described hereinabove. For some applications, by flattening the capsule, the gap in the magnetic circuit defined by material 250 is reduced, thereby increasing the magnetic permeability of the magnetic circuit and increasing magnetic flux through the capsule, relative to if the gap was larger.

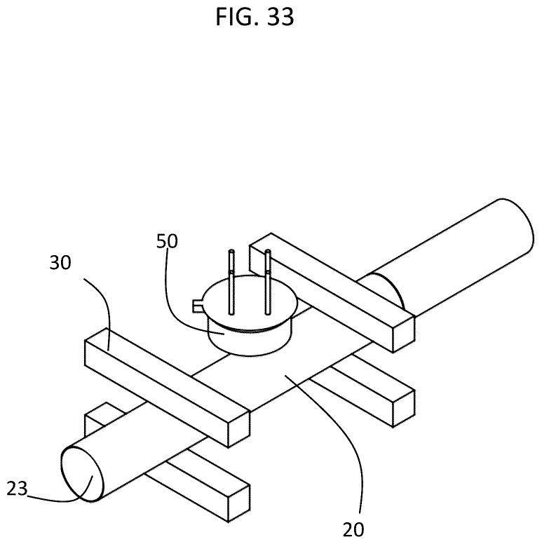

Reference is now made to FIG. 33, which is a schematic illustration of capsule 20 being heated, while the capsule is in a non-flattened, cylindrical shape, in accordance with some applications of the present invention. As noted hereinabove, although some applications of the present disclosure are described as being applied to a capsule that is provided to a user in a flattened configuration and/or is flattened by the smoking device, the scope of the present disclosure includes applying any one of the features of capsule 20 that are described herein to a cylindrical capsule that is configured to remain cylindrical even upon being inserted into the smoking device, mutatis mutandis. For example, any one of the features described with respect to the structure of the capsule, components of the capsule, coverings of the capsule, inner linings of the capsule, identifying features of the capsule, etc., are applicable to a cylindrical capsule that is configured to remain cylindrical even upon being inserted into the smoking device, mutatis mutandis.

Reference is now made to FIG. 34, which is a flowchart showing steps that are performed) by smoking device 200, in accordance with some applications of the present invention. Typically, users have different smoking preferences from each other and some users' preferences vary. Some users wish to smoke a full capsule during a relatively short period, while others may wish to puff only occasionally. For users who wish to smoke a full capsule during a relatively short period it is typically more appropriate to heat the smoking material to the vaporization temperature of the active agents for a predefined period of time, to enable instant and prolonged vaporization of the active agents. For users who wish to puff only occasionally it is typically more appropriate to heat the smoking material to the vaporization temperature of the active agents only when the user actually wishes to puff from the capsule, such as to preserve the active agents while allowing for delays between puffs. (It is noted that, in some cases, prolonged heating versus intermittent heating will also influence the nature of the vapors released from the smoking material (such as taste, intensity, amount of vapors, etc.), and respective users may have different preferences.

Therefore, for some applications, the control component receives an indication from the user indicating whether they wish to smoke the active agents in a first mode or a second mode. Typically, the first mode is suitable for users who wish to smoke a full capsule during a relatively short period, whereas the second mode is suitable for users who wish to puff occasionally. Typically, in response to receiving an indication that the user wishes to smoke the active agents in the first mode, the control component heats the smoking material to the vaporization temperature of the one or more active agents for a predefined period of time (e.g., a period of time of between 60 seconds and 600 seconds). Further typically, in response to receiving an indication that the user wishes to smoke the active agents in the second mode, the control component heats the smoking material to the vaporization temperature only while receiving an active input from the user that they wish for the smoking material to be heated. For some applications, the smoking device includes a heating button (e.g., button 204 shown in FIG. 1C) configured to be pressed by the user. The user pressing the button for a short press (i.e., for a duration that is less than a threshold duration (e.g., a threshold duration of between 0 seconds and 2 seconds)), is interpreted by the control component as meaning that the user wishes to smoke in the first mode, and the user pressing the button for a long press (i.e., for more than the threshold duration), is interpreted by the control component to mean that the user wishes to smoke the active agents in the second mode. For some applications, in the second mode, the heating is turned off either immediately upon release of the button, or after a short delay (e.g., a delay of between 0 seconds and 5 seconds). For some applications, the smoking device is configured such that during a smoking session, the user can switch from the first mode to the second mode by pressing the button for a long press (i.e., for more than the threshold duration), and/or from the second mode to the first mode by pressing the button for a short press (i.e., for less than the threshold duration).

For some applications, the control component is configured to preheat the smoking material to a temperature that is below the vaporization temperature of the one or more active agents, prior to receiving the indication from a user indicating whether they wish to smoke the active agents in a first mode or a second mode. For example, the control component is configured to preheat the smoking material to the temperature that is below the vaporization temperature of the one or more active agents automatically, in response to the capsule being inserted into the smoking device. Alternatively or additionally, the control component is configured to preheat the smoking material to the temperature that is below the vaporization temperature of the one or more active agents, in response to an input from the user (e.g., an initial push of button 204). For some applications, when operating in the second mode, the control component preheats the smoking material to the temperature that is below the vaporization temperature of the one or more active agents in between presses of the button by the user. Typically, preheating the smoking material to a temperature that is below the vaporization temperature of the one or more active agents allows the heating of the smoking material to the vaporization temperature to occur more quickly and/or more uniformly than if the smoking material is not preheated. Typically, the preheating does not release the active agents since the preheating is performed to a lower temperature than the vaporization temperature of the active agents. For some applications, the smoking device is configured to preheat the smoking material in the manner described in the present paragraph, even without being configured to perform both the first and second modes of heating.

Referring again to FIG. 34, some of the above-described steps are shown in the flowchart. For some applications, the smoking material is initially preheated. In response to the button being pressed, the heating is switched on. If the button is pressed for a long press, the heating continues so long as the button is still being pressed, whereas if the button is pressed for a short press, the heating in turned off after predefined delay of N seconds (e.g., a period of time of between 60 seconds and 600 seconds).

In accordance with some applications of the present invention, control component 233 of smoking device 200 is configured to detect (a) whether a capsule 20 has been inserted into the device, (b) whether a capsule has been removed from the device, (c) whether there is a fault with the capsule, (d) whether there is a fault with the smoking device, and/or (c) whether there is a problem with the electrical connection between electrodes 30 and the capsule (e.g., due to dirt or the paper covering coming between the electrodes and the metallic foil). For some applications, the control component generates an output to the user indicating the detection of one or more of the aforementioned occurrences.

For some applications, when the device is on, a test current is periodically driven through the electrodes, and the insertion and/or removal of a capsule from the smoking device is detected based on the response to the test current. Typically, if no capsule is present, there will be an incomplete circuit and the current will not flow from the negative electrode to the positive electrode, whereas if a capsule is present a current will flow from the negative electrode to the positive electrode and the capsule will provide a given resistance profile. For some applications, in response to detecting the insertion of the capsule, preheating of the capsule is initiated by the control component, e.g., as described hereinabove. For some applications, in response to detecting the removal of the capsule, the control component overrides an input from the user indicating that a heat cycle should be initiated (e.g., a push of button 204).

For some applications, the control component measures the resistance between the electrodes in response to the test current, in order to verify that it is within an acceptable range. (Purely by way of example, if the capsule is inserted and there are no faults, the capsule may be expected to provide a resistance of between 0.3 and 0.5 Ohm.) Alternatively or additionally, the control component measures an increase in temperature of the smoking material in response to the test current. (Purely by way of example, a 10 ms pulse may be expected to increase the temperature of the plant material by approximately 2-8 Celsius (e.g., approximately 5 Celsius) if the capsule is inserted and there are no faults.) For some applications, in response to detecting that the resistance and/or the temperature increase is not within a predetermined range, the control component determines that the capsule has been removed from the device, there is a fault with the capsule, there is a fault with the smoking device, and/or there is a problem with the electrical connection between the electrodes and the capsule (e.g., due to dirt or the paper covering coming between the electrodes and the metallic foil). For some applications, the control component measures the temperature change at a plurality of locations along the capsule and determines the source of the fault in response thereto. For example, if there is a hotspot at the contact between the electrode and the capsule, this may indicate a fault with the electrical contact between the electrode and the capsule (e.g., due to dirt or the paper covering coming between the electrodes and the metallic foil).

For some applications, generally similar apparatus techniques to those described hereinabove are application to a liquid material that is configured to be vaporized by the smoking device, mutatis mutandis. Some examples of capsules for use with such techniques are shown in FIGS. 35A-55B.

Reference is now made to FIGS. 35A, 35B, and 35C, which are schematic illustrations of respective views of a capsule 150 for use with a liquid material 152 that is configured to be vaporized by smoking device 200 (or a different smoking device), in accordance with some applications of the present invention. Typically, for such applications, the capsule is a “vaping” capsule and the smoking device acts as a “vaping device.” Thus, all examples of capsule 150 may be referred to herein as a vaping capsule and device 200 (or a different device designed solely for use with a vaping capsule) may be referred to as a vaping device. Device 200 is generally referred to herein as a smoking device, since it is typically also used with a capsule that is used for smoking (typically in a heat-not-burn manner).

As noted, for some applications, smoking device 200 (described hereinabove) is configured to be used both with capsules that contain a solid smoking material (such as a plant material, e.g., tobacco, for example, capsule 20, described hereinabove) and with capsules that contain a liquid material that is configured to be vaporized (such as capsule 150). Typically, the smoking device heats the solid smoking material in a heat-not-burn manner, as described hereinabove. For some applications, capsule 150 is configured to be used with a different smoking device from capsule 20. It is noted that unless explicitly stated otherwise, for some applications, features of capsule 20 described hereinabove (including but not limited to, the structures of the heating elements, the structure of the mouthpiece, coatings, linings, the mouthpiece, etc.) are incorporated into capsule 150, mutatis mutandis.

For some applications, the liquid material includes vegetable glycerin, propylene glycol, nicotine, nicotine salt and/or additional taste and/or scent materials.

Each of FIGS. 35A-35C shows the capsule disposed between electrodes 30. FIGS. 35A and 35C show respective cross-sectional views of the capsule and 35B shows an oblique view of the capsule with some of the covering layers peeled away for illustrative purposes. For some applications, liquid material 152 is held within a reservoir 154 that comprises an absorbent material 155 with the liquid material absorbed therein. Typically, the absorbent material is solid and/or flexible, is capable of withstanding the high temperatures that might develop during the vaporization process, and is safe for human inhalation. For example, the absorbent material may include cotton, hemp, wool, plastic material, cellulose material, paper, woven or non-woven fabrics, threads, etc. (In other instances of an “absorbent material” being described in the present disclosure, the term “absorbent material” should be interpreted as including any one of the aforementioned types of material or a combination thereof.) Typically, the reservoir defines an air inlet 156 therethrough, to facilitate the inflow of air to the capsule. For some such applications, a layer 160 of material extends from reservoir 154 around the circumference of the capsule. For some applications, the layer of material is made of a similar absorbent material to the absorbent material disposed within the reservoir. Typically, the layer of material has a thickness of more than 0.1 mm (e.g., more than 0.2 mm), and/or less than 3 mm (e.g., less than 1 mm), for example between 0.1 mm and 3 mm, or between 0.2 mm and 1 mm.

The layer of material is typically configured such that the liquid material flows from the reservoir along the layer of material via capillary forces. For some applications, a heating element 162 is disposed around the outside of the layer of material. Typically heating element 162 is a metallic foil, which is typically generally similar to metallic foil 32 described hereinabove. It is noted that since heating element 162 is typically a metallic foil, element 162 is also sometimes referred to as “metallic foil 162” or “foil 162.” The metallic foil is typically heated via the electrodes (via resistive heating), in a generally similar manner to that described hereinabove. Typically, the metallic foil thereby heats and vaporizes the liquid material within the layer of material. Typically, the capsule comprises a mouthpiece 164 (which is typically generally similar to mouthpiece 90 described hereinabove). Typically, the user puffs from the capsule via the mouthpiece.

Typically, only the liquid material that is absorbed within portions of layer 160 of material that are disposed under metallic foil 162 is vaporized. Thus, at any given time, only a portion of the liquid material is vaporized, while the remainder of the liquid material remains absorbed within reservoir 154 or within portions of layer 160 of material that are not disposed under metallic foil 162. As liquid material is vaporized from within portions of layer 160 of material that are disposed under metallic foil 162, additional liquid material flows to the portions of layer 160 of material that are disposed under metallic foil 162 via capillary forces, such that the supply of liquid material to be vaporized is automatically replenished.

In accordance with respective applications, capsule 150 is rigid or is flexible. For some applications, the capsule is configured to be flattened, for example, using the techniques described hereinabove. For example, the capsule may be flattened in order to enhance electrical contact between the electrodes and the metallic foil, by applying mechanical pressure to the capsule using the electrodes. For some applications, the capsule is flattened in order to generate a desired heating profile and/or a desired airflow profile. For some applications, the smoking device includes a non-contact temperature sensor (such as an infrared temperature sensor) as described hereinabove. For some such applications, the portion of the capsule at which the sensor is configured to sense the temperature (i.e., a portion of the capsule that is configured to be adjacent to the temperature sensor) is flattened such as to facilitate the temperature sensing (typically by creating a flat surface upon which to perform the temperature sensing). For some applications, the capsule is flattened in order to increase capillary flow through an absorbent material disposed within the capsule (such as layer 160 of material). It is noted that the aforementioned techniques associated with flattening a capsule are typically applicable to any one of the embodiments of capsule 20 and/or capsule 150 described herein.

For some applications, the capsule and the smoking device with which the capsule is configured to be used are configured such that the capsule is heated without being flattened. For some applications, capsules 20 and 150 are configured to be used with smoking device 200. For some applications, in cases in which capsule 20 (which contains solid smoking material) is being used with the smoking device 200, the smoking device is configured to flatten the capsule, whereas in cases in which capsule 150 (which contains liquid material) is being used with the smoking device 200, the smoking device is not configured to flatten the capsule. For some applications, the capsule type is identified (e.g., using the techniques described hereinabove), and a heating profile is applied based upon the identity of the capsule.

For some applications, the capsule defines an airway therethrough. Typically, the air inlet 156 and mouthpiece 164 each comprises a portion of the airway. For some applications, the capsule defines an interior region 166 that is surrounded by layer 160 of material, with the interior region comprising a portion of the airway. For some applications, vapor that is generated from the liquid material flows into interior region 166 of the capsule. A combination of the vapors and air (which enters the interior region via air inlet 156) flows from the interior region into the user's mouth via the mouthpiece. For some applications, the interior region is hollow. For some applications, one or more internal support components (which are typically non-porous, with low heat conductivity, not shown) are used in order to mechanically couple the liquid-flow layer to the metallic foil and/or to direct airflow heated location and then toward the mouthpiece.

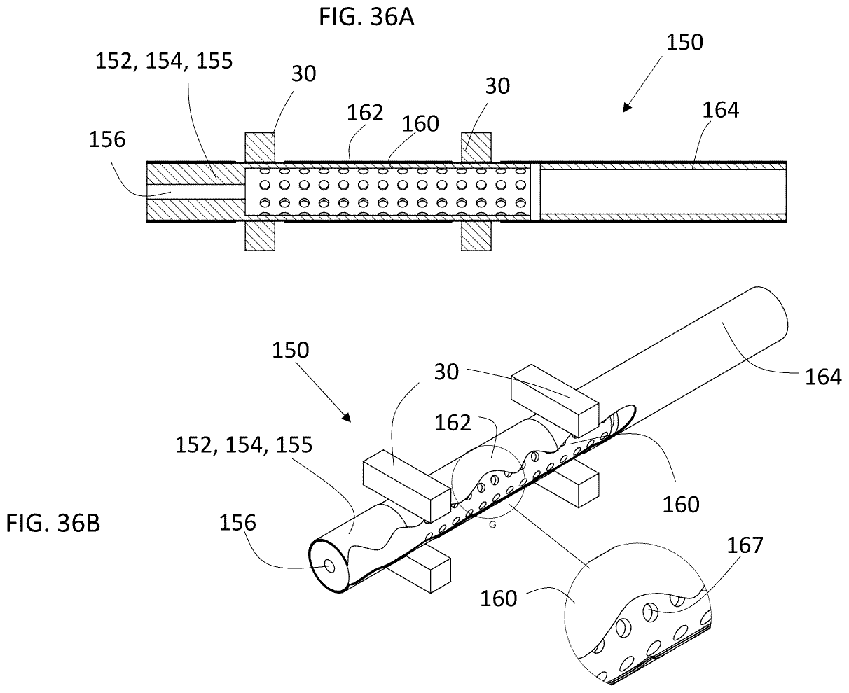

Reference is now made to FIGS. 36A and 36B, which are schematic illustrations of respective views of capsule 150 for use with a liquid material that is configured to be vaporized by a smoking device, the capsule including layer 160 of absorbent material with the layer of absorbent material defining holes 167 therethrough, in accordance with some applications of the present invention. Each of FIGS. 36A-36B shows the capsule disposed between electrodes 30. FIG. 36A shows a cross-sectional view of the capsule and FIG. 36B shows an oblique view of the capsule with some of the covering layers peeled away for illustrative purposes. Capsule 150 is generally similar to that shown in FIGS. 35A-35C except that in FIGS. 36A-36B the layer of material defines holes therethrough. For some applications, the holes are configured to create hot spots in order to vaporize the liquid at the hotspots. Alternatively or additionally, the holes are configured to provide a low (or zero) resistance path for the generated vapors into interior region 166. For some applications, the holes have diameters of more than 0.7 mm (e.g., more than 1 mm) and/or less than 3 mm (e.g., less than 2 mm), for example, between 0.7 mm and 3 mm, or between 1 mm and 2 mm.

Typically, only the liquid material that is disposed at the hotspots is vaporized. Thus, at any given time, only a portion of the liquid material is vaporized, while the remainder of the liquid material remains absorbed within layer 160 of absorbent material. As liquid material is vaporized from the hotspots, additional liquid material flows to the hotspots via capillary forces, such that the supply of liquid material to be vaporized is automatically replenished.

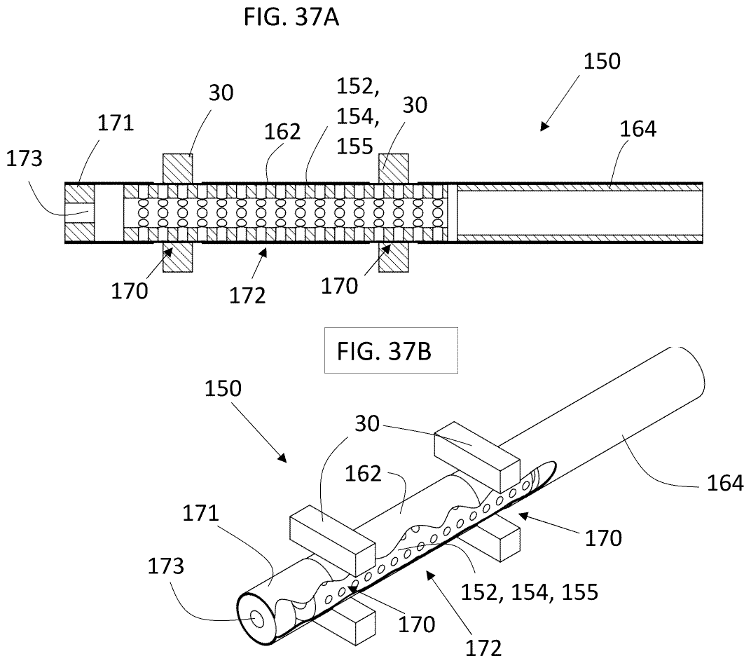

Reference is now made to FIGS. 37A and 37B, which are schematic illustrations of respective views of capsule 150 for use with liquid material 152 that is configured to be vaporized by a smoking device, the liquid material being absorbed within absorbent material 155 within reservoir 154, and only portions of the reservoir being configured to be heated, in accordance with some applications of the present invention. Each of FIGS. 37A-37B shows the capsule disposed between electrodes 30. FIG. 37A shows a cross-sectional view of the capsule and FIG. 37B shows an oblique view of the capsule with some of the covering layers peeled away for illustrative purposes. For some applications, reservoir 154 is disposed along a region of the capsule at which the metallic foil is disposed. For some such applications, the capsule includes a stopper or filter 171 at the opposite end of the capsule from mouthpiece 164, with the stopper or filter defining an air inlet 173 therethrough. Typically, the absorbent material within the reservoir has a thickness of more than 0.1 mm (e.g., more than 0.2 mm), and/or less than 3 mm (e.g., less than 1 mm), for example between 0.1 mm and 3 mm, or between 0.2 mm and 1 mm.

For some applications, electrodes 30 are configured to contact metallic foil 162 at a first set of locations 170, and metallic foil is configured to contact the absorbent material within the reservoir at a second set of regions 172. Typically, the absorbent material within the reservoir is only directly heated at the regions 172 at which the metallic foil contacts the reservoir. For some applications, within regions 172, the absorbent material within the reservoir defines holes therethrough to thereby limit the contact area between the metallic foil and the absorbent material. For some applications, respective regions of the metallic foil have respective properties, coatings, and/or inner linings, e.g., as is generally described hereinabove with reference to capsule 20. For some applications, localized heating (e.g., by heating at selected regions, and/or by heating an absorbent material defines holes therethrough to thereby limit the contact area between the metallic foil and the absorbent material) is used to limit the vaporization rate in order to enable a large number of small, fast generated puffs without heating all of the liquid material to vaporization temperatures.

Typically, only the liquid material that is absorbed within regions 172 is vaporized. Thus, at any given time, only a portion of the liquid material is vaporized, while the remainder of the liquid material remains absorbed within reservoir 154. As liquid material is vaporized from within regions 172, additional liquid material flows to regions 172 via capillary forces, such that the supply of liquid material to be vaporized is automatically replenished.

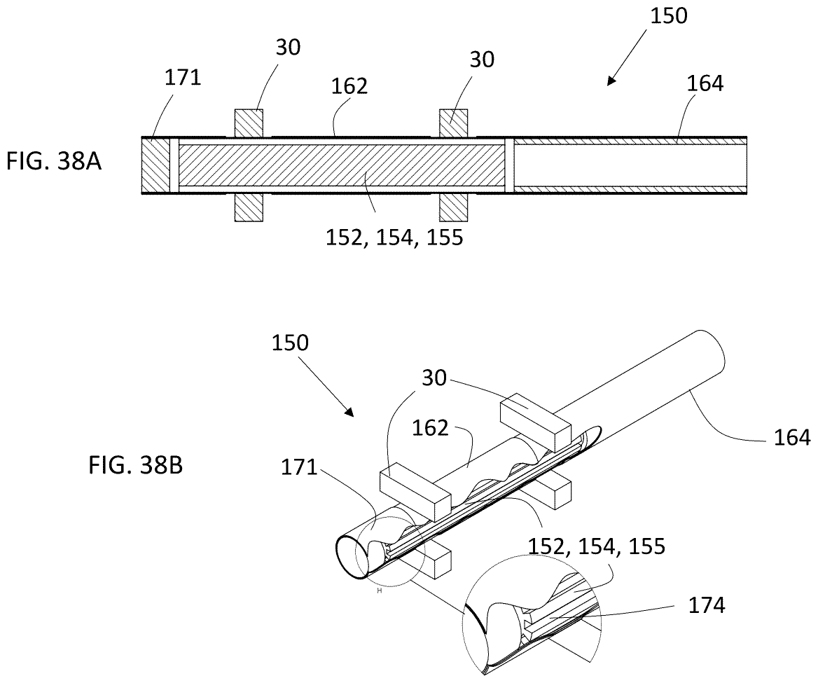

Reference is now made to FIGS. 38A and 38B, which are schematic illustrations of respective views of capsule 150 for use with liquid material 152 that is configured to be vaporized by a smoking device, the capsule including reservoir 154 of the liquid material absorbed within absorbent material 155, the absorbent material defining airflow channels 174 along its perimeter, in accordance with some applications of the present invention. Each of FIGS. 38A-38B shows the capsule disposed between electrodes 30. FIG. 38A shows a cross-sectional view of the capsule and FIG. 38B shows an oblique view of the capsule with some of the covering layers peeled away for illustrative purposes. Typically, the perimeter of the reservoir does not contact the metallic foil at circumferential locations at which the absorbent material defines the airflow channels. For some applications, in this manner heat transfer into the reservoir is limited, by localizing the vaporization to the contact area between the heated portion of the metallic foil and the absorbent material in which the liquid material is absorbed. Typically, as liquid material is vaporized, additional liquid material flows to regions of reservoir 154 that are in contact with the metallic foil via capillary forces, such that the supply of liquid material to be vaporized is automatically replenished.

For some applications, generally similar techniques and configurations to that described with reference to reservoir with respect to FIGS. 37A-38B are applied to layer 160 of absorbent material described with reference to FIGS. 35A-35C. For example, the layer of material may be heated only at selected regions, and the layer of material may be shaped to define airway flow channels around the outside or in the inside of the layer of material.

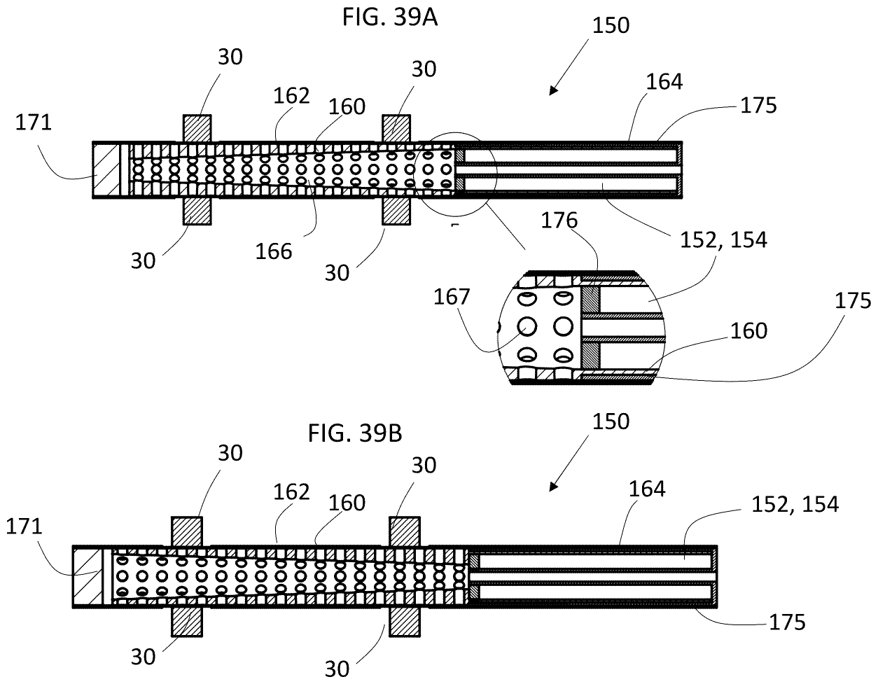

Reference is now made to FIGS. 39A and 39B, which are schematic illustrations of respective views of capsule 150 for use with liquid material 152 that is configured to be vaporized by a smoking device, the capsule including layer 160 of absorbent material, the layer having a non-uniform thickness, in accordance with some applications of the present invention. Each of FIGS. 39A-9B shows the capsule disposed between electrodes 30. FIGS. 39A and 39B show cross-sectional views of respective embodiments of the layer of material having a non-uniform thickness. Capsule 150 is generally similar to that shown in FIGS. 37A-37B, except for the following differences. For some applications, reservoir 154 is disposed within mouthpiece 164. For some such applications, the reservoir comprises an absorbent material with the liquid material absorbed therein (not shown in FIGS. 39A-9B). Alternatively or additionally, the reservoir comprises unabsorbed liquid material 152 contained within a solid housing 175, as shown. For some applications, the housing includes a stopper 176, to prevent the liquid material leaking from the reservoir. Typically, layer 160 of material extends from the reservoir along a portion of the device at which the layer of material is heated to thereby heat and vaporize the liquid material. For some applications, the thickness of the layer of material increases (typically in a gradual manner) in the direction leading away from the reservoir, as shown in FIG. 39A. For some applications, the thickness of the layer of material decreases (typically in a gradual manner) in the direction leading away from the reservoir, as shown in FIG. 39B. Typically, the thickness varies in order to control capillary flow from the reservoir and/or in order to control the heating of the layer of material at the location at which it contacts the metallic foil. For some applications, the layer of material defines holes 167 therethrough, as described hereinabove.

For some applications, generally similar techniques and configurations to that described with reference to layer 160 of absorbent material with respect to FIGS. 39A-39B are applied to reservoir of absorbent material described with reference to FIGS. 37A-38B.

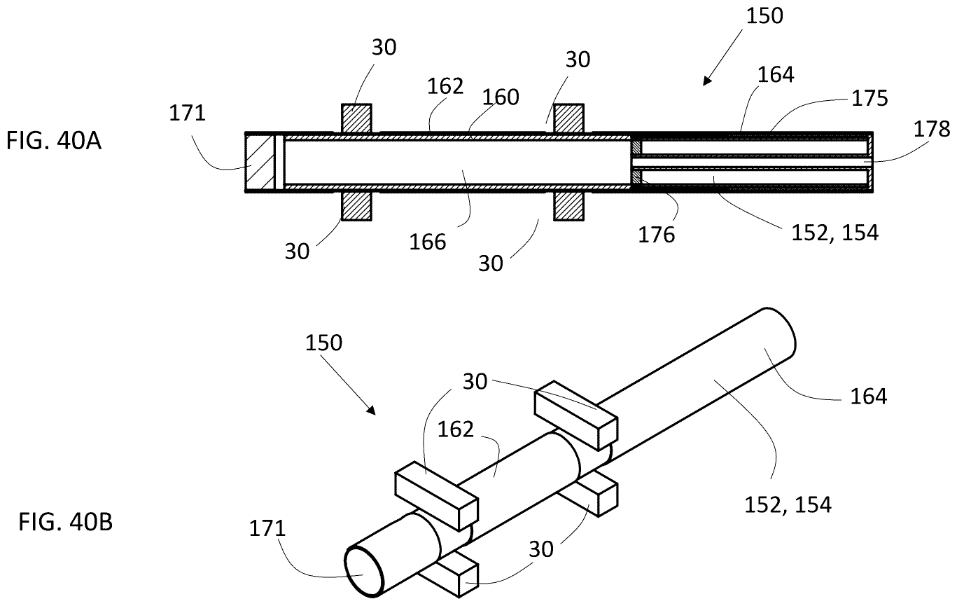

Reference is now made to FIGS. 40A and 40B, which are schematic illustrations of respective views of capsule 150 for use with a liquid material that is configured to be vaporized by a smoking device, the capsule including reservoir 154 disposed within mouthpiece 164 of the capsule, in accordance with some applications of the present invention. Each of FIGS. 40A-40B shows the capsule disposed between electrodes 30. FIG. 40A shows a cross-sectional view of the capsule and FIG. 40B shows an oblique view of the capsule. As described with reference to FIGS. 39A-9B, for some applications, the reservoir comprises unabsorbed liquid material 152 contained within a solid housing 175, as shown. For some applications, the housing includes a stopper 176, to prevent the liquid material leaking from the reservoir. Typically, layer 160 of material extends from the reservoir along a portion of the device at which the layer of material is heated to thereby heat and vaporize the liquid material. For some applications, the mouthpiece defines an airway 178 that passes through the reservoir, and through which the heated air and vapors are drawn from the capsule by the user. Typically, the relatively high temperature of the air and vapors passing through the airway heat the liquid (and air, if present) within the reservoir, thereby increasing the internal pressure within the reservoir, and, in turn, thereby increasing liquid flow out of the reservoir and along the layer of absorbent material. For some applications, the flow of the vapors and air through the reservoir cools the air and vapors before they enter the user's mouth.

It is noted that the scope of the present disclosure includes combining the various features of layer 160 of absorbent material and/or of reservoir 154 described with reference to FIGS. 35A-40B with each other. For example, the layer 160 of absorbent material may have holes therethrough, may only be heated at selected locations, may define airflow channels along its perimeter, may have a non-uniform thickness, etc. Similarly, reservoir 154 in any of the examples of capsule 150 described herein may include the liquid absorbed within absorbent material 155, or unabsorbed and housed within solid housing 175. In addition, the reservoir may be disposed within the mouthpiece (as shown in FIGS. 39A-40B, for example) or at a different location, such as toward the other end of the capsule from the mouthpiece (as shown in FIGS. 35A-36B, for example), or within the portion of the capsule that is heated (as shown in FIGS. 37A-38B, for example).

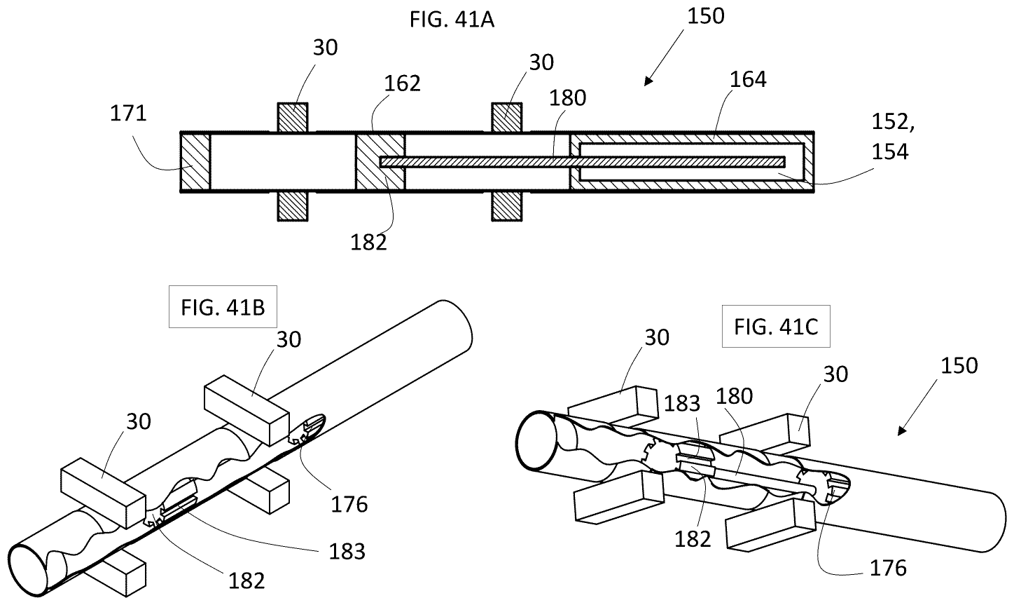

Reference is now made to FIGS. 41A, 41B, and 41C, which are schematic illustrations of respective views of capsule 150 for use with liquid material 152 that is configured to be vaporized by a smoking device, the capsule including a capillary-force-delivery element 180 configured to deliver the liquid material to heating element 182 via capillary forces from reservoir 154, in accordance with some applications of the present invention. Each of FIGS. 41A-41C shows the capsule disposed between electrodes 30. FIG. 41A shows a cross-sectional view of the capsule and FIG. 41B-41C show respective oblique views of the capsule with some of the covering layers peeled away for illustrative purposes. In accordance with respective applications, capillary-force-delivery element 180 is an absorbent material (e.g., as described hereinabove), a capillary tube, and/or an absorbent material disposed within a tube. Typically, capillary-force-delivery element 180 is configured to transport the liquid material by capillary means, pressure equalization, or any other applicable way of delivering a steady flow of liquid material to replace liquid material that has already been vaporized. The capillary-force-delivery element 180 extends from the reservoir to the heating element. For some applications, heating element 182 includes an absorbent material extends radially to the metallic foil from the location to which the capillary-force-delivery element 180 delivers the liquid material. Thus, upon being delivered to the heating element by the capillary-force-delivery element 180, the liquid material flows radially outwardly toward the metallic foil, where it is heated and vaporized. For some applications, the heating element defines grooves 183 on its perimeter. Typically, the grooves are configured to facilitate axial airflow past the heating element, with the airflow typically picking up the vaporized liquid material as it flows past the heating element.

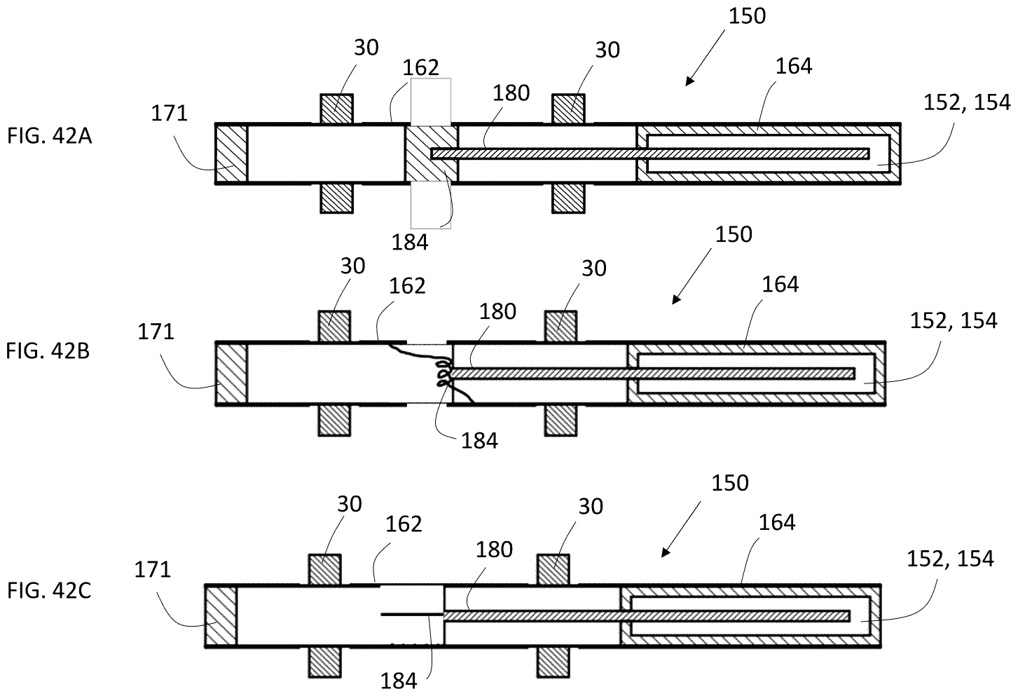

Reference is now made to FIGS. 42A, 42B, and 42C, which are schematic illustrations of respective views of capsule 150 for use with liquid material 152 that is configured to be vaporized by a smoking device, the capsule including capillary-force-delivery element 180 configured to deliver the liquid material to an internal heating element 184 via capillary forces from reservoir 154, in accordance with some applications of the present invention. Each of FIGS. 42A-42C shows the capsule disposed between electrodes 30. FIGS. 42A-42C show cross-sectional views of respective embodiments of the internal heating element. In accordance with respective applications, capillary-force-delivery element 180 is an absorbent material (e.g., as described hereinabove), a capillary tube, and/or an absorbent material disposed within a tube. The capillary-force-delivery element 180 extends from the reservoir to the internal heating element and delivers the liquid material from the reservoir to the internal heating element via capillary forces. As described hereinabove, typically, capillary-force-delivery element 180 is configured to transport the liquid material by capillary means, pressure equalization, or any other applicable way of delivering a steady flow of liquid material to replace liquid material that has already been vaporized.

For applications as shown in FIGS. 42A-42C, the internal heating element heats the liquid material from within the capsule (as an alternative or in addition to metallic foil directly heating the liquid material). Referring to FIG. 42B, for some applications, the internal heating element is a coil (e.g., a miniature coil). Referring to FIG. 42C, for some applications, the internal heating element is shaped as a strip, or a rod. Alternatively or additionally, the internal heating element is shaped as a mesh or in a different shape.

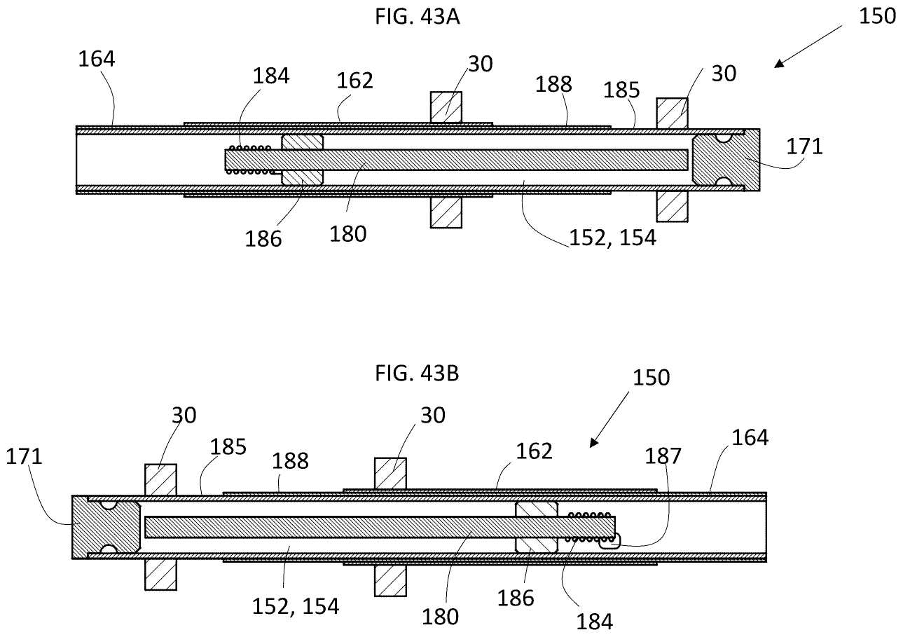

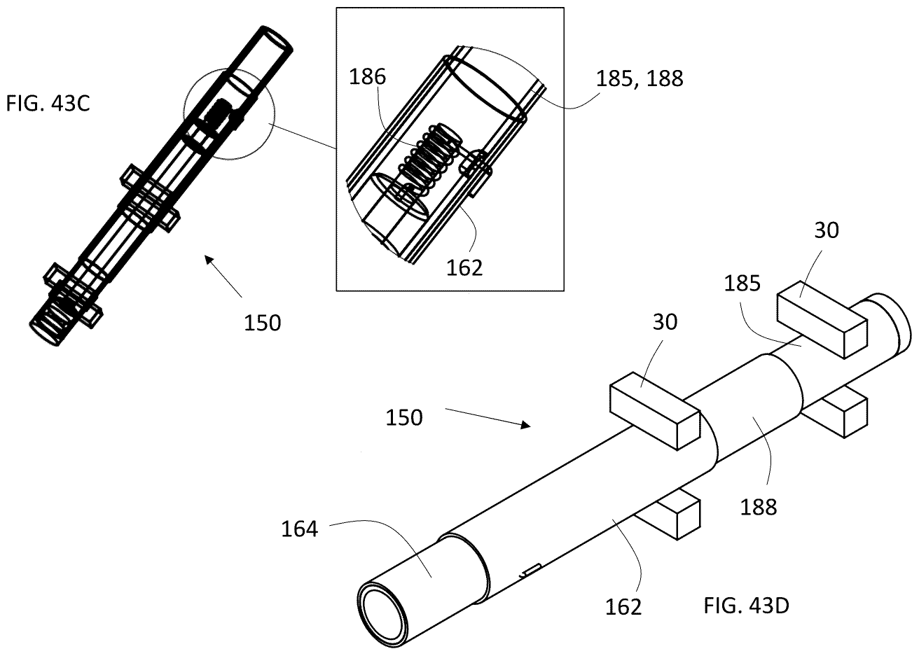

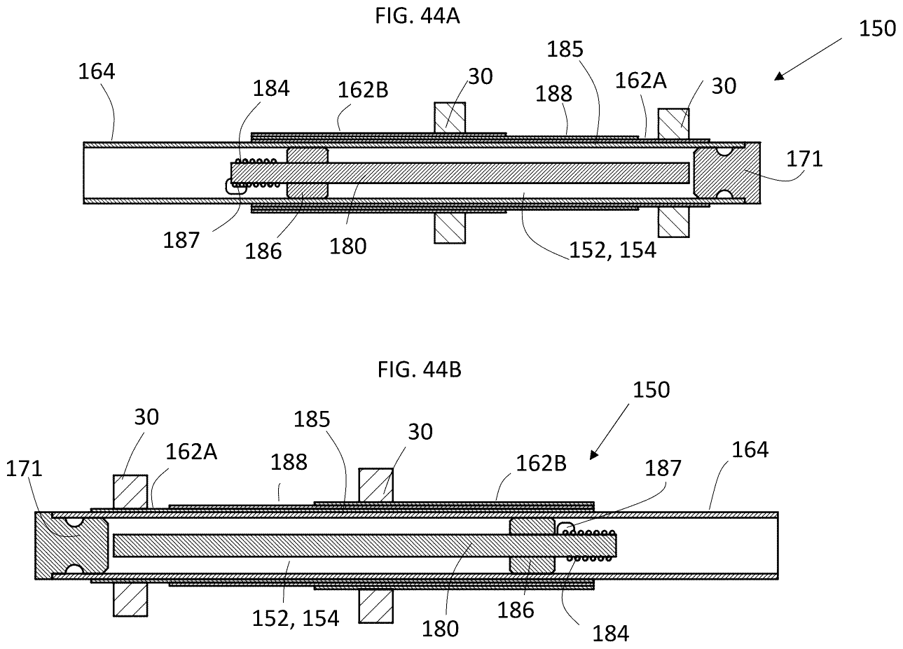

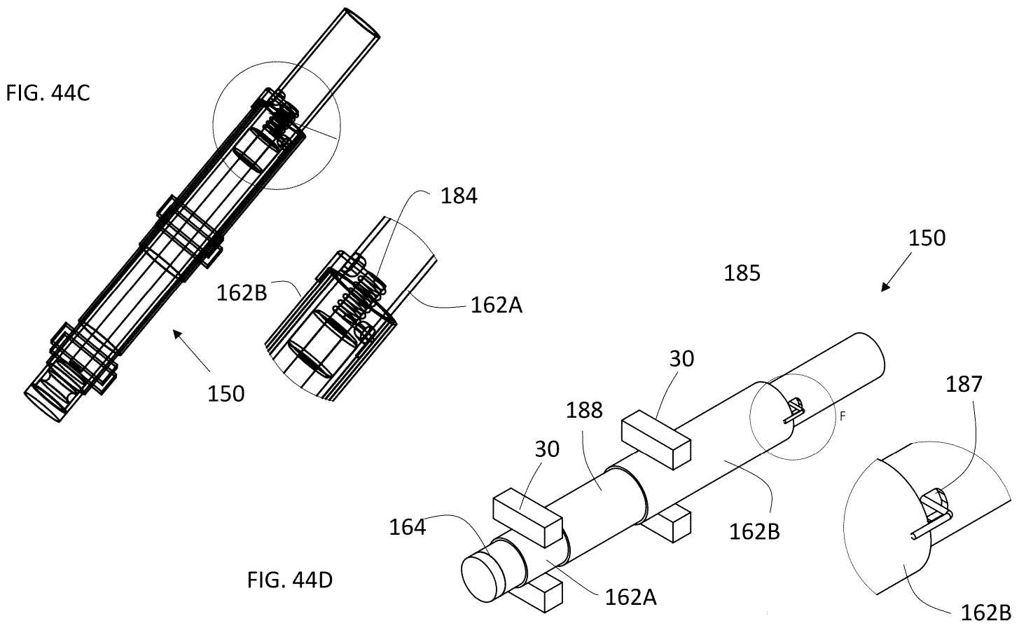

For some applications, the capsule includes metallic foil 162 and the internal heating element is connected to the electrodes via the metallic foil (although the foil itself is typically not used to directly heat the liquid material in such embodiments). For some applications, the internal heating element (also referred to herein as an “atomizer”) is heated via resistive heating (e.g., using techniques described herein). For some such applications, the internal heating element is a resistive element (i.e., an element comprising an electrically resistive material (for example, the internal heating element includes a metallic element)) and receives electrical current from electrodes 30 of the smoking device. Alternatively or additionally, the internal heating element is connected to the electrodes via internal wires. For some applications, the internal heating element is connected to the electrodes using techniques described hereinbelow with reference to FIGS. 43A-43D or with reference to FIGS. 44A-44D. Typically, the capsule is designed to enable flow of the generated vapors to the user.

For some applications, the internal heating element includes an electrically-resistive element (typically having intermediate electric resistance and ability to withstand high temperatures), such as a metallic coil, metallic wire, metallic mesh, metallic foil, surface-mount resistor or any other electrically-resistive element. For example, iron-nickel alloy, tungsten, iron-chromium-aluminum alloy, nickel chrome, stainless steel, nickel and/or titanium. Typically, the heating element is configured to be stable in air when hot. In some cases, techniques are applied to mitigate the risk of an insulating layer forming on the heating element as a result of the heating element becoming heated. For example, such techniques may be used when iron-chromium-aluminum alloy is used in the heating element, because iron-chromium-aluminum alloy forms a protective layer of aluminum oxide (an electrical insulator) when heated. For some such applications, the electrical connections are configured to dissipate heat, in order to cool the electrical contact point to a temperature below the temperature at which an insulating layer may be formed. For some applications, in order to prevent the heating element from continuing to heat after finishing the vaporization of all the vaporizing liquid, the heating element is configured to self-fuse, by over-heating and melting in case there is no liquid material to cool the heating element (due to the liquid material having vaporized).

For some applications, the internal heating element includes one or more magnetically-heated materials that are susceptible to being heated by a magnetic field (such as, magnetic materials and/or ferromagnetic materials), and is heated via a coil disposed within the smoking device, e.g., as described hereinabove. Typically, the induction-heated internal heating element is disposed within the capsule such as to be only partially in contact with the liquid material to be vaporized, in order to focus the heating and control the amount of vapors generated. Typically, the internal heating element is thermally coupled to at least a portion of the liquid material to be vaporized.

Reference is now made to FIGS. 43A, 43B, 43C, and 43D, which are schematic illustrations of respective views of capsule 150 for use with liquid material 152 that is configured to be vaporized by a smoking device, the capsule including capillary-force-delivery element 180 configured to deliver the liquid material to internal heating element 184, in accordance with some applications of the present invention. Each of FIGS. 43A-43D shows the capsule disposed between electrodes 30. FIGS. 43A and 43B show respective cross-sectional views of the capsule and FIGS. 43C-43D show respective oblique views of the capsule with FIG. 43C showing some portions as transparent, for illustrative purposes. For some applications, the capsule includes reservoir 154 with the reservoir comprising a housing 185 within which the liquid material is housed (in unabsorbed form and/or absorbed within an absorbent material. Typically stopper 171 (described hereinabove) and stopper 186 seal the liquid material within the reservoir. Capillary-force-delivery element 180 delivers the liquid material to internal heating element 184, as described with reference to FIGS. 42A-42C. Typically, capillary-force-delivery element 180 is configured to transport the liquid material by capillary means, pressure equalization, or any other applicable way of delivering a steady flow of liquid material to replace liquid material that has already been vaporized.

As described with reference to FIG. 42B, for some applications, the internal heating element is heated via resistive heating (e.g., using techniques described herein). For some such applications, the internal heating element includes an electrically resistive material (for example, the internal heating element is a metallic portion) and receives electrical current from electrodes 30. For some applications, the internal heating element is a coil (e.g., a miniature coil). For some applications, housing 185 of the capsule is conductive. Conductive housing 185 and metallic foil 162 are electrically insulated from each other via an insulating layer 188 and the capsule is configured such that, when disposed within the smoking device, one of the first and second electrodes is electrically coupled to the conductive housing and the other one of the first and second electrodes is coupled to the metallic foil. Typically, a first end of the coil is coupled to the conductive housing and a second end of the coil is coupled to the metallic foil, such that the first and second electrodes drive a current through the coil via the conductive housing and the metallic foil. For some applications, stopper 186 (which is disposed in the vicinity of the coil) is covered with a conductive material and electrically couples one end of the coil to the conductive housing. Typically, the other end of the coil extends to the metallic foil via a hole 187 in housing 185 and insulating layer 188.

For some applications, the conductive housing includes aluminum, copper, stainless steel, bronze, plastic coated with a conductive (e.g., metallic) layer, or any other type of pipe/tube/cylinder. For some applications, the conductive housing has a non-circular cross-sectional shape. Alternatively, the conductive housing has a circular cross-sectional shape. For some applications, insulating layer 188 includes a separate layer or an insulating coating, adhesive tape (for example, polyimide-FEP fluoropolymer substrate (e.g., Kapton®), double sided adhesive tape, and/or another type of insulating layer.

Reference is now made to FIGS. 44A, 44B, 44C, and 44D, which are schematic illustrations of respective views of capsule 150 for use with liquid material 152 that is configured to be vaporized by a smoking device, the capsule including capillary-force-delivery element 180 configured to deliver the liquid material to internal heating element 184, in accordance with some applications of the present invention. Each of FIGS. 44A-44D shows the capsule disposed between electrodes 30. FIGS. 44A and 44B show respective cross-sectional views of the capsule and FIGS. 44C-44D show respective oblique views of the capsule with FIG. 44C showing some portions as transparent, for illustrative purposes. FIGS. 44A-44D show a generally similar embodiment of capsule 150 to that shown in FIGS. 43A-43D, except for the following differences.

For some applications the capsule comprises first and second metallic foils 162A and 162B that are electrically insulated from each other via insulating layer 188 and which are electrically coupled to respective ends of the coil, and the capsule is configured such that, upon being inserted into the smoking device, one of the first and second electrodes is electrically coupled to the first metallic foil and the other one of the first and second electrodes is coupled to the second metallic foil. Typically, a first end of the coil is coupled to the first metallic foil and a second end of the coil is coupled to the second metallic foil, such that the first and second electrodes drive a current through the coil via the first and second metallic foils. For some such applications, housing 185 of the capsule is not conductive. Rather, the housing is typically made of a plastic, paper, or other material. In some cases, this reduces the manufacturing costs of the capsule and/or reduces the use of non-biodegradable materials in the manufacture of the capsule, relative to if a conductive housing is used. For some such applications, stopper 186 does not include a conductive coating. Typically, the ends of the coil extend to metallic foils 162A and 162B via hole 187 in the capsule housing and insulating layer 188.

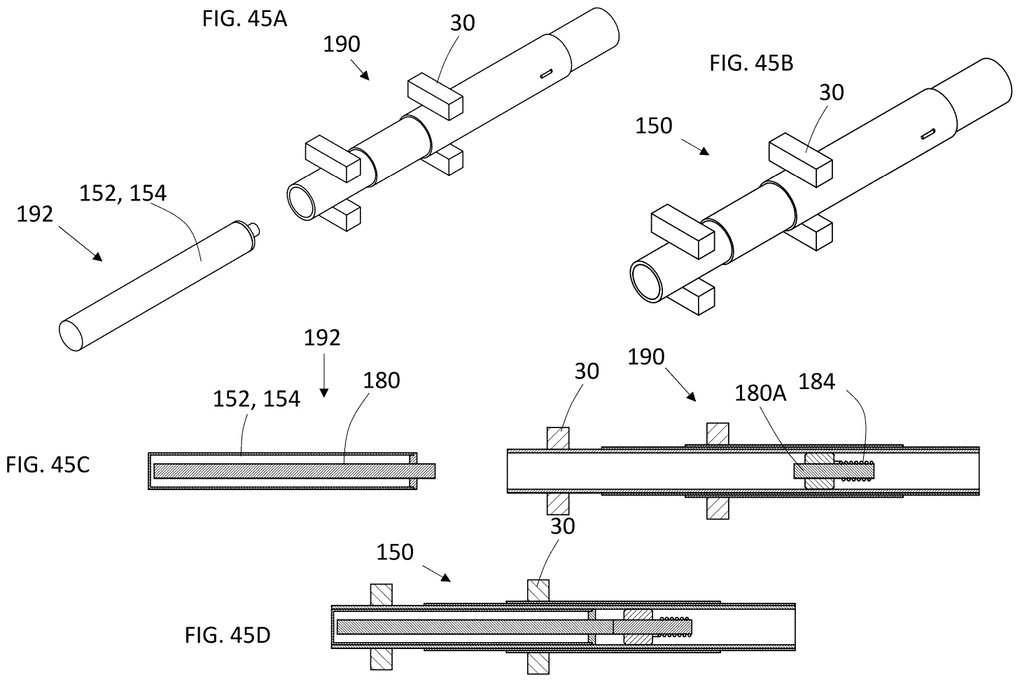

Reference is now made to FIGS. 45A, 45B, 45C, and 45D, which are schematic illustrations of respective views of capsule 150 for use with liquid material 152 that is configured to be vaporized by a smoking device, the capsule including a capillary-force-delivery element 180 configured to deliver the liquid material to internal heating element 184 and including a capsule housing 190 and a disposable portion 192, in accordance with some applications of the present invention. Each of FIGS. 45A-45D shows the capsule disposed between electrodes 30. FIGS. 45A-45B show oblique views of the capsule, respectively before and after the disposable portion has been inserted into the reusable portion, FIGS. 45C-45D show cross-sectional views of the capsule, respectively before and after the disposable portion has been inserted into the reusable portion.

Capsule 150 is generally similar to that shown in FIGS. 43A-43D, but in the embodiment shown in FIGS. 45A-45D, the capsule includes capsule housing 190 (which is typically reusable and) that typically includes the internal heating element (and/or other conductive portions that are configured to contact electrodes of the smoking device), and disposable portion 192 that includes reservoir 154 containing the liquid material, and typically includes capillary-flow-delivery element 180. The capsule housing typically receives the disposable capsule portion such as to form a capsule and such that the capillary-force-delivery element extends to the internal heating element, such as to transport the liquid material from the reservoir to the internal heating element via capillary forces. For some applications, a second portion 180A of the capillary-flow-delivery element is disposed within the reusable portion of the capsule, and the capsule is configured such that when the disposable portion of the capsule is inserted into the capsule housing, the liquid material flows to the second portion of the capillary-flow-delivery element 180 and then to the internal heating element via capillary forces. Alternatively, the entire capillary-flow-delivery element is disposed within disposable portion 192. Typically, including the reservoir in the disposable portion of the capsule, lengthens the period of time during which the housing of the capsule is usable, thereby reducing costs and environmental damage. For some applications, housing 190 of the capsule is built into the smoking device, and disposable portion 192 is inserted into the smoking device.

For some applications, the internal heating element 184 is also disposed within disposable portion 192 and is configured to become electrically coupled to portions of the housing upon the disposable portion being inserted into the housing. Upon the capsule being inserted into the smoking device, the internal heating element becomes electrically coupled to the electrodes of the smoking device via conductive portions of housing 190.

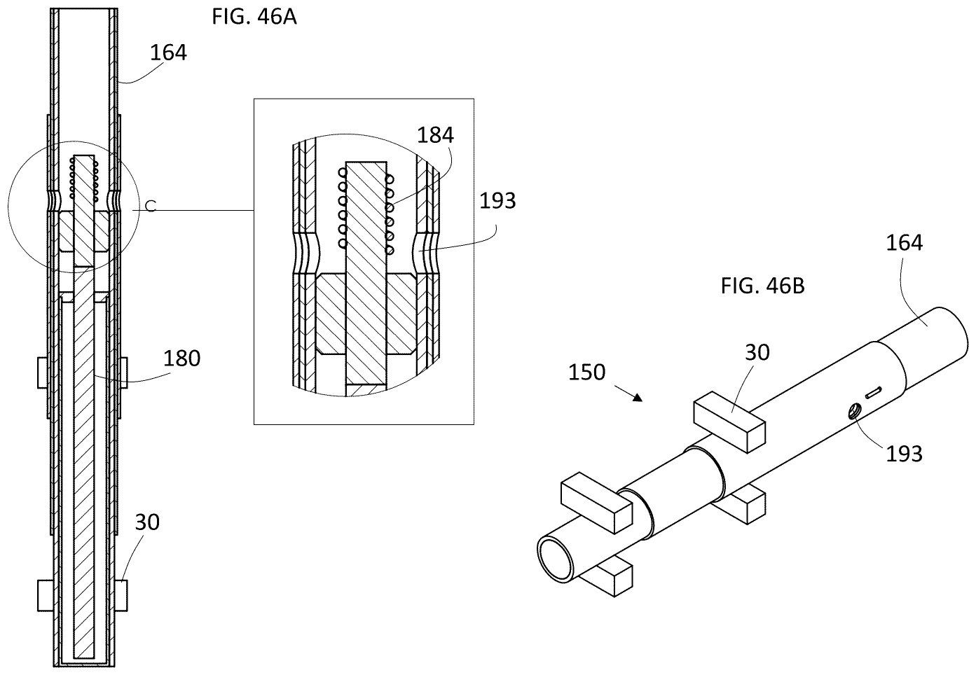

Reference is now made to FIGS. 46A and 46B, which are schematic illustrations of respective views of capsule 150 for use with a liquid material that is configured to be vaporized by a smoking device, the capsule including capillary-force-delivery element 180 configured to deliver the liquid material to internal heating element 184, and the capsule defining an opening 193 in close proximity to the internal heating element, in accordance with some applications of the present invention. Each of FIGS. 46A-46B shows the capsule disposed between electrodes 30. FIG. 46A shows a cross-sectional view of the capsule and FIG. 46B shows an oblique view. Capsule 150 is generally similar to that shown in FIGS. 43A-43D, but the capsule defines an opening 193 in close proximity to the internal heating element. As described hereinabove, for some applications, capsule 150 defines an airway through the entire capsule. Alternatively, for some applications, the internal heating element is disposed in close proximity to the mouthpiece (e.g., within 30 mm of the mouthpiece, for example within between 15 and 30 mm of the mouthpiece) and the opening is disposed in close proximity to the internal heating element (e.g., within 30 mm of the mouthpiece, for example within between 15 and 30 mm of the mouthpiece). The capsule typically defines an airway extending from the opening to the mouthpiece configured such that the vaporized liquid material enters the airway.

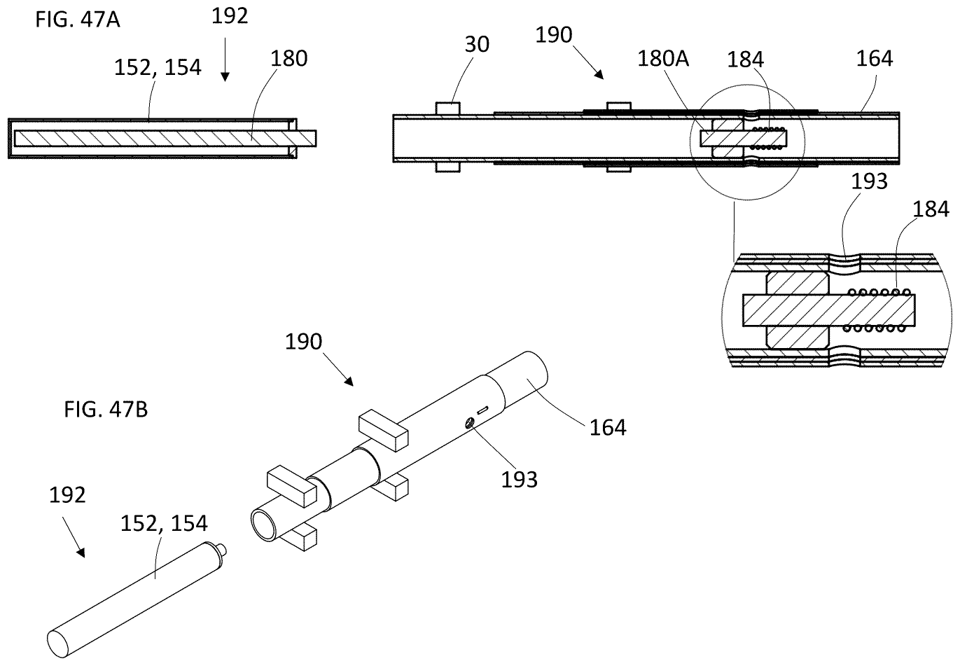

Reference is now made to FIGS. 47A and 47B, which are schematic illustrations of respective views of capsule 150 for use with liquid material 152 that is configured to be vaporized by a smoking device, in accordance with some applications of the present invention. Each of FIGS. 47A-47B shows the capsule disposed between electrodes 30. FIG. 47A shows a cross-sectional view of the capsule and FIG. 47B shows an oblique view. For some applications, the capsule including capillary-force-delivery element 180 configured to deliver the liquid material to internal heating element 184, and the capsule defines an opening 193 in close proximity to the internal heating element, as described with reference to FIGS. 46A-46B. For some such applications, the capsule includes capsule housing 190 (which is typically reusable and) that typically includes the internal heating element (and/or other conductive portions that are configured to contact electrodes of the smoking device), and disposable portion 192 that includes reservoir 154 containing the liquid material, and typically includes capillary-flow-delivery element 180, as described with reference to FIGS. 45A-45D. The capsule housing typically receives the disposable capsule portion such as to form a capsule and such that the capillary-force-delivery element extends to the internal heating element, such as to transport the liquid material from the reservoir to the internal heating element via capillary forces. For some applications, a second portion 180A of the capillary-flow-delivery element is disposed within the reusable portion of the capsule, and the capsule is configured such that when the disposable portion of the capsule is inserted into the capsule housing, the liquid material flows to the second portion of the capillary-flow-delivery element 180 and then to the internal heating element via capillary forces. Alternatively, the entire capillary-flow-delivery element is disposed within disposable portion 192. Typically, including the reservoir in the disposable portion of the capsule, lengthens the period of time during which the housing of the capsule is usable, thereby reducing costs and environmental damage. For some applications, housing 190 of the capsule is built into the smoking device, and disposable portion 192 is inserted into the smoking device.

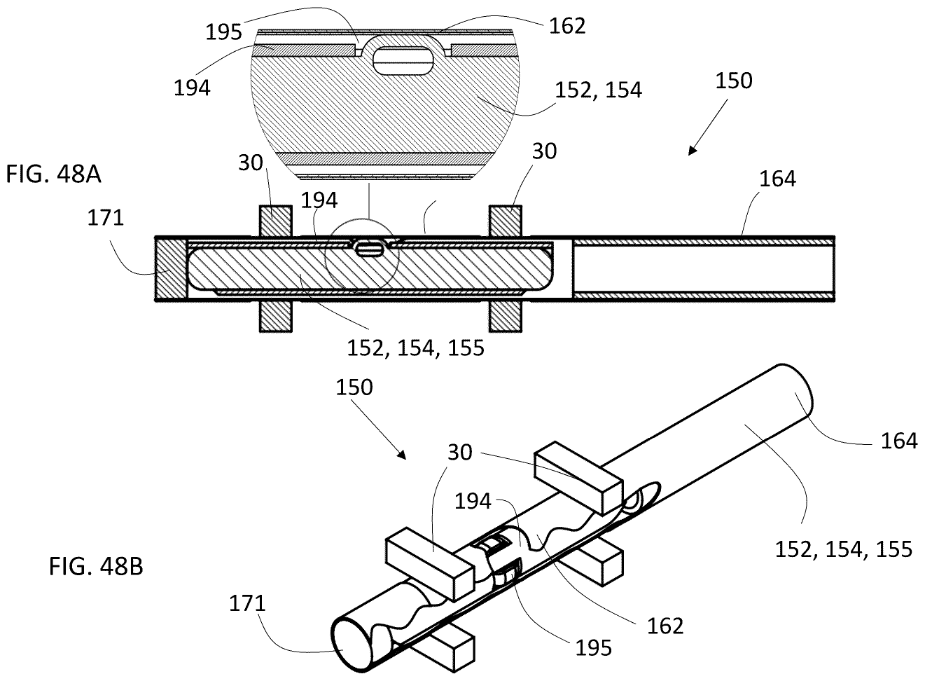

Reference is now made to FIGS. 48A and 48B, which are schematic illustrations of respective views of capsule 150 for use with liquid material 152 that is configured to be vaporized by a smoking device, the capsule including a housing 194 that houses reservoir 154 of absorbent material 155 that has the liquid material absorbed therein, in accordance with some applications of the present invention. Each of FIGS. 48A-48B shows the capsule disposed between electrodes 30. FIG. 48A shows a cross-sectional view of the capsule and FIG. 48B shows an oblique view. Typically, the housing is an electrical insulator and is impermeable to the liquid material. Further typically, the housing defines one or more lateral windows 195. The absorbent material is configured such that the liquid material flows to the lateral windows via capillary forces. Typically, at the lateral windows the liquid material within the absorbent material is exposed to metallic foil 162 of the capsule, and the liquid material is thereby vaporized.

Typically, only the liquid material from within the portion of the absorbent material that is exposed to the metallic foil 162 (i.e., at the lateral windows) is vaporized. Thus, at any given time, only a portion of the liquid material is vaporized, while the remainder of the liquid material remains absorbed within reservoir 154. As liquid material is vaporized from within the portion of the absorbent material that is exposed to the metallic foil 162, additional liquid material flows from within reservoir 154 to the portion of the absorbent material that is exposed to the metallic foil 162 (i.e., at the lateral windows) via capillary forces, such that the supply of liquid material to be vaporized is automatically replenished.

For some applications, housing 194 is a cylindrical container (e.g., a plastic, cylindrical container). In accordance with respective applications, the cylindrical container is flexible or rigid. As described hereinabove, for some applications, the capsule is configured to be flattened, for example in order to facilitate temperature sensing and/or in order to enhance capillary flow through the absorbent material. For some such applications, housing 194 is flexible to facilitate the flattening of the capsule. Typically, housing 194 has a smaller diameter than metallic foil 162 in order to enable air flow along the axial direction of the capsule. For some applications, the capsule includes an airway therethrough. For some such applications, air enters the airway via filter or stopper 171. For example, the filter or stopper may define an air inlet opening therethrough, as described hereinabove.

For some applications, housing 194 defines a plurality of lateral windows at which the absorbent material is exposed to metallic foil 162 of the capsule, for example as shown in FIG. 48B. For some applications, housing 194 defines a single lateral window at which the absorbent material is exposed to metallic foil 162 of the capsule. For some applications, at the one or more lateral windows, threads or fibers of the absorbent material are separated from the rest of absorbent material, to thereby contact the metallic foil. For some applications, the one or more lateral windows the capsule defines a slotted surface in order to facilitate air flow and/or vapor generation. Typically, the metallic foil contacts the electrodes at locations that are remote from each of the one or more lateral windows.

Typically, apart from at the one or more lateral windows, housing 194 is impermeable. For some applications, apart from at the one or more lateral windows, housing 194 is at least partially permeable, such that the liquid material flows through the housing in a controlled manner to be heated and vaporized by the metallic foil.

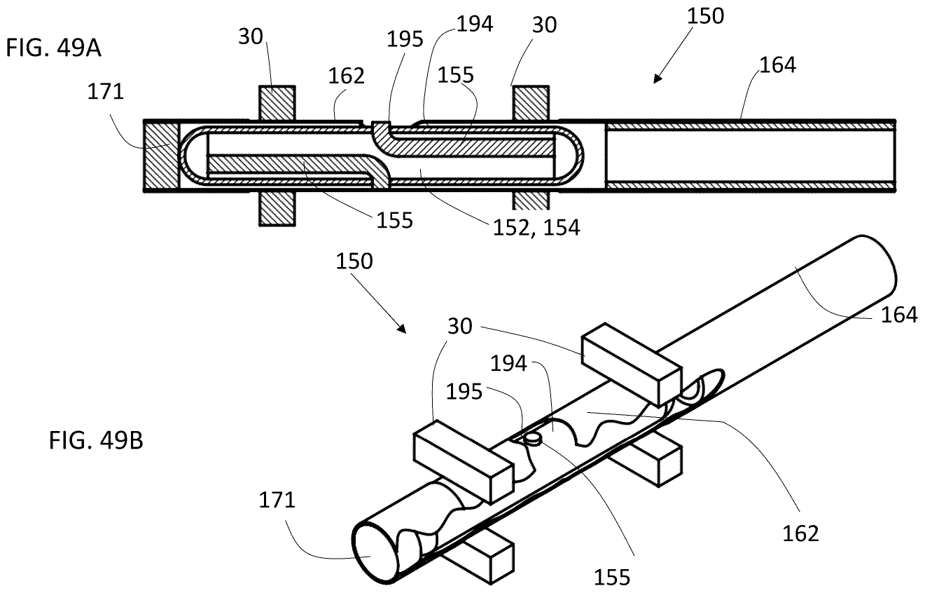

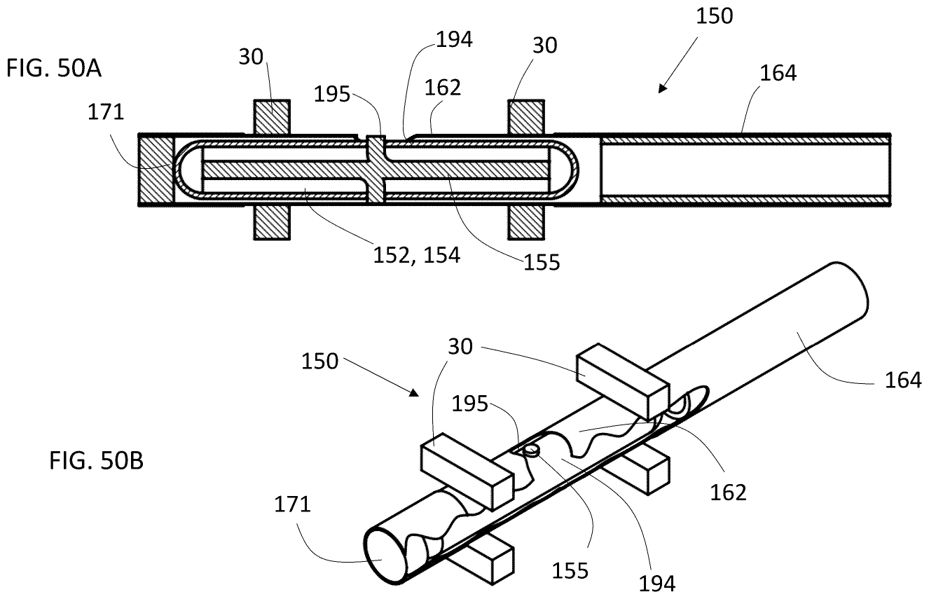

Reference is now made to FIGS. 49A and 49B, as well as FIGS. 50A and 50B, which are schematic illustrations of respective views of capsule 150 for use with liquid material 152 that is configured to be vaporized by a smoking device, the capsule including a housing 194 that houses reservoir 154 of the liquid material, in accordance with some applications of the present invention. Each of FIGS. 49A-9B and 50A-50B shows the capsule disposed between electrodes 30. FIGS. 49A and 50A show cross-sectional views of respective embodiments of the capsule and FIGS. 49B and 50B show oblique views of respective embodiments of the capsule, with some layers being peeled away for illustrative purposes. Typically, the housing is an electrical insulator and is impermeable to the liquid material. Further typically, the housing defines one or more lateral windows 195. (As described hereinabove, for some applications, the housing is partially permeable to the liquid material.) For some applications, absorbent material 155 is disposed within the reservoir with the absorbent material extending from the reservoir to the one or more lateral windows, the absorbent material being configured to transport the liquid material from the reservoir to the one or more lateral windows via capillary forces. Typically, at the lateral windows the liquid material within the absorbent material is exposed to metallic foil 162 of the capsule, and the liquid material is thereby vaporized. Typically, the metallic foil contacts the electrodes at locations that are remote from each of the one or more lateral windows. For some applications, the capsule includes an airway therethrough. For some such applications, air enters the airway via filter or stopper 171. For example, the filter or stopper may define an air inlet opening therethrough, as described hereinabove.

Typically, only the liquid material from within the portion of the absorbent material 155 that is exposed to the metallic foil 162 (i.e., at the lateral windows) is vaporized. Thus, at any given time, only a portion of the liquid material is vaporized, while the remainder of the liquid material remains absorbed within reservoir 154 or absorbent material 155. As liquid material is vaporized from within the portion of the absorbent material that is exposed to the metallic foil 162, additional liquid material flows from within reservoir 154 or absorbent material 155 to the portion of the absorbent material that is exposed to the metallic foil 162 (i.e., at the lateral windows) via capillary forces, such that the supply of liquid material to be vaporized is automatically replenished.

The examples of capsule 150 shown in FIGS. 49A-9B and 50A-50B respectively are examples in which the absorbent material is shaped such as to enhance capillary flow of the liquid material toward the lateral windows, in accordance with some applications of the present invention.

FIGS. 35A-50B show several embodiments of capsule 150, which is configured to contain a liquid material that is vaporized by a smoking device, such as smoking device 200 and/or a different smoking device. With reference to all of the examples of capsule 150 described with reference to FIGS. 35A-50B the following is noted. In accordance with respective applications, capsule 150 is rigid or is flexible. For some applications, the capsule is configured to be flattened, for example, using the techniques described hereinabove. For example, the capsule may be flattened in order to enhance electrical contact between the electrodes and the metallic foil, by applying mechanical pressure to the capsule using the electrodes. For some applications, the capsule is flattened in order to generate a desired heating profile and/or a desired airflow profile. For some applications, the smoking device includes a non-contact temperature sensor (such as an infrared temperature sensor) as described hereinabove. For some such applications, the portion of the capsule at which the sensor is configured to sense the temperature (i.e., a portion of the capsule that is configured to be adjacent to the temperature sensor) is flattened such as to facilitate the temperature sensing (typically by creating a flat surface upon which to perform the temperature sensing). For some applications, the capsule is flattened in order to increase capillary flow through an absorbent material disposed within the capsule (such as layer 160 of material, reservoir 154 of the material, and/or material that comprises a portion of capillary-flow-delivery element 180). For some applications in which capsule 150 is configured to be flattened the capsule includes one or more collapse-prevention elements, e.g., as described hereinabove with reference to FIGS. 9A-16B, mutatis mutandis. For some applications in which capsule 150 is configured to be flattened the capsule includes one or more elements that act as springs (e.g., an elastic housing that is generally similar to a collapse-prevention element 60 described hereinabove with reference to FIG. 14) configured such that in response to pressure being applied to the housing (for example by electrodes 30 and/or by other compression elements as described hereinabove), the capsule becomes flattened by a predetermined amount. Typically, for such applications, the capsule is configured such that compression of the capsule is sufficient to enhance capillary flow through absorbent material within the capsule and/or to ensure good electrical contact between the electrodes and the metallic foil, but such that the capsule has not been compressed to such an extent that there is insufficient airflow through the capsule. It is noted that the aforementioned techniques associated with flattening a capsule are typically applicable to any one of the embodiments of capsule 20 and/or capsule 150 described herein.

With reference to all of the examples of capsule 150 described with reference to FIGS. 35A-50B the following is additionally noted. For some applications, the capsule is configured such that airflow through the capsule is substantially in an axial direction along a length of the capsule, e.g., as described hereinabove with reference to capsule 20 mutatis mutandis. For some applications, the capsule is shaped to define a cross-sectional shape having a ratio of more than 2:1 between a long side of the cross-sectional shape and a short side of the cross-sectional shape, e.g., as described hereinabove with reference to capsule 20 mutatis mutandis. For some applications, the capsule includes a metallic foil that is configured to be heated via resistive heating by the first electrode driving a current to the second electrode through the metallic foil, such as to vaporize liquid material, e.g., as described hereinabove with reference to capsule 20 mutatis mutandis. For some applications, metallic foil of the capsule (e.g., metallic foil 162, 162A, or 162B) has a thickness of between 1 micron and 20 microns. For some applications, the metallic foil has a thickness of between 3 microns and 10 microns, e.g., as described hereinabove with reference to capsule 20 mutatis mutandis. For some applications, the metallic foil is configured to be heated via resistive heating by the first electrode driving a current to the second electrode along a length of more than 5 mm (e.g., more than 15 mm) in an axial direction along the metallic foil, e.g., as described hereinabove with reference to capsule 20 mutatis mutandis. For some applications, the capsule further comprises a paper covering that covers the metallic foil, the paper covering defining openings via which the electrodes are configured to make electrical contact with the metallic foil, e.g., as described hereinabove with reference to capsule 20 mutatis mutandis. For some applications, the metallic foil comprises a plurality of regions, each of the regions having a respective, different electrical resistance profile, such that upon a given current being driven through the metallic foil each of the regions heats to a respective, different temperature, e.g., as described hereinabove with reference to capsule 20 mutatis mutandis. For some applications, the capsule further comprises an electrical-contact coating that coats the metallic foil at locations at which the electrodes are configured to contact the capsule, e.g., as described hereinabove with reference to capsule 20 mutatis mutandis. For some applications, the metallic foil has a first configuration at locations at which the electrodes are configured to contact the metallic foil, and a second configuration along a region in which the metallic foil heats the liquid material that is between the locations at which the electrodes are configured to contact the metallic foil, e.g., as described hereinabove with reference to capsule 20 mutatis mutandis. For some applications, the capsule further comprises an inner lining that lines an inside of the metallic foil, the inner lining being configured to diffuse heat that is generated by the metallic foil, e.g., as described hereinabove with reference to capsule 20 mutatis mutandis. For some applications, the smoking device includes one or more batteries, and wherein an overall resistance to the current that is provided by the capsule is configured to substantially match an internal resistance of the one or more batteries of the smoking device, e.g., as described hereinabove with reference to capsule 20 mutatis mutandis. For some applications, at least a portion of the capsule is configured to be flattened by the smoking device prior to a layer of absorbent material being heated by the smoking device, e.g., as described hereinabove with reference to capsule 20 mutatis mutandis. For some applications, the layer of absorbent material is configured such that the flattening of the portion of the capsule increases capillary flow of the liquid material through the layer of absorbent material, e.g., as described hereinabove with reference to capsule 20 mutatis mutandis. For some applications, the capsule has a circular cross-sectional shape and is configured to be flattened to define a non-circular cross-sectional shape, e.g., as described hereinabove with reference to capsule 20 mutatis mutandis. For some applications, the capsule is configured to be flattened such as to define a cross-sectional shape having a ratio of more than 2:1 between a long side of the cross-sectional shape and a short side of the cross-sectional shape, e.g., as described hereinabove with reference to capsule 20 mutatis mutandis. For some applications, the capsule comprises an elongate capsule having a length of between 15 mm and 150 mm, e.g., as described hereinabove with reference to capsule 20 mutatis mutandis. For some applications, the elongate capsule has a length of between 50 mm and 90 mm, e.g., as described hereinabove with reference to capsule 20 mutatis mutandis. Electrical current is typically supplied to the capsule as a result of a user input (for example a press of a button) or automatically by a use of a puff detector, e.g., as described hereinabove with reference to capsule 20 mutatis mutandis. Power supply is typically by means of a constant voltage, direct connection to battery voltage, current limitation or any other method, e.g., as described hereinabove with reference to capsule 20 mutatis mutandis.

For some applications, only certain regions of capsule 150 are heated. For example, capsule 150 may include any one of the coatings, metallic foil configurations, inner linings, paper covering, etc. described hereinabove with reference to capsule 20, mutatis mutandis, configured in such a way that the metallic foil only heats certain regions of layer 160 of absorbent material 155, and/or only heats certain regions of reservoir 154.

Mouthpiece 164 of capsule 150 is typically generally similar to mouthpiece 90 of capsule 20. Mouthpiece 164 is typically round as in a traditional combustion cigarette, or is designed with different shapes. For some applications, the mouthpiece is manufactured as a separate removable or unremovable part. For some applications, the mouthpiece at least in part assists in concealing the electrical connections between a heating element and additional conductive components, such as a conductive housing and/or metallic foil. For some applications, the mouthpiece is configured to facilitate the electrical connections between a heating element and additional conductive components, such as a conductive housing and/or metallic foil. In some cases the mouthpiece can include inlet openings designed to control the amount of air flowing into the capsule or to control the resistance to the user drawing from the capsule, e.g., as described hereinabove with reference to FIGS. 18D-18F.

For some applications, the capsule is selectively coated with an external layer of paper and/or other materials for insulation and/or esthetic reasons, e.g., as described hereinabove. As noted hereinabove, unless explicitly stated otherwise, for some applications, features of capsule 20 described hereinabove (including but not limited to, the structures of the heating elements, the structure of the mouthpiece, coatings, linings, the mouthpiece, etc.) are incorporated into capsule 150, mutatis mutandis.

Typically, when smoking device 200 is used with capsule 150, the smoking device has a generally similar configuration to that described hereinabove. Further typically, the above described inputs, outputs, and heating algorithms (e.g., the flowchart shown in FIG. 34, and techniques described with reference to FIG. 34) that are described as being implemented by smoking device 200 are typically implemented when smoking device 200 is used with capsule 150, mutatis mutandis.

For some applications, the smoking device includes a non-contact temperature sensor (such as an infrared temperature sensor), as described hereinabove. For some applications, when either capsule 20 or capsule 150 is used with a smoking device, the smoking device is configured to detect the temperature of the capsule and to control heating of the capsule responsively thereto. For some applications, when the smoking device is used with capsule 150 (which contains a liquid material), the smoking device is configured to heat the capsule by applying predetermined amounts of power to resistively heat the capsule, and without detecting the temperature of the capsule. For example, during an initial preheating phase of the capsule the control component may provide a predetermined amount of power to the capsule. Subsequently, whenever the control component detects that the user is drawing from the capsule, a predetermined amount of power is supplied in order to vaporize the piqued material. For some applications, the control component determines the amount of power to be supplied based on parameters of the user's puffs that are detected by the control component (e.g., using the techniques described hereinabove).

It is noted that the term “metallic” as used herein in the description and in the claims should be interpreted to include a material that includes a metal and/or an alloy, such as iron-nickel alloy, tungsten, iron-chromium-aluminum alloy, nickel chrome, stainless steel, nickel and/or titanium.

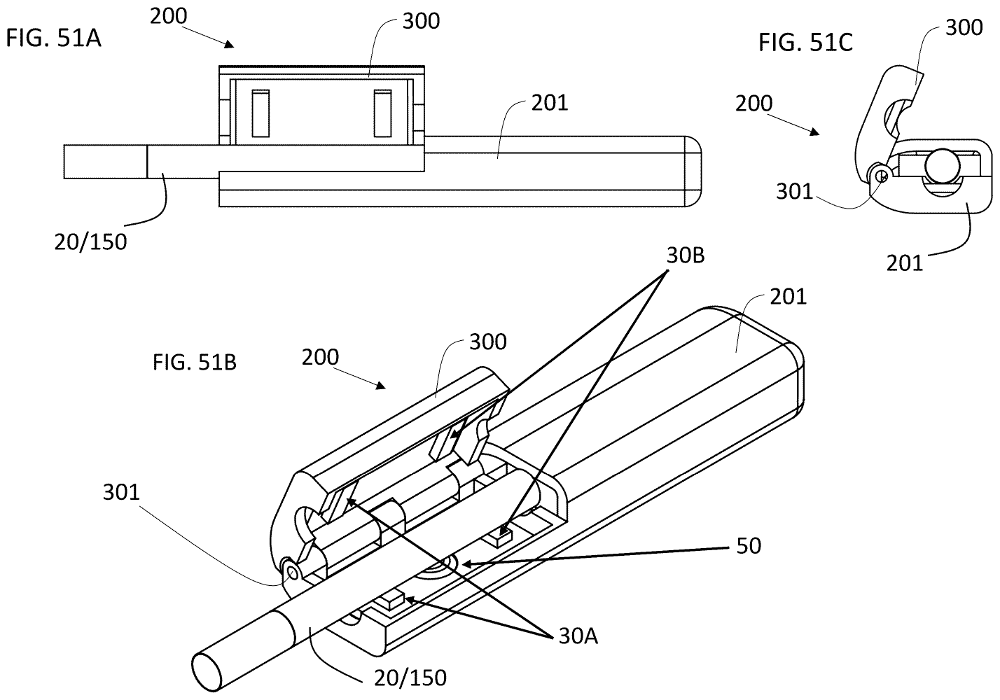

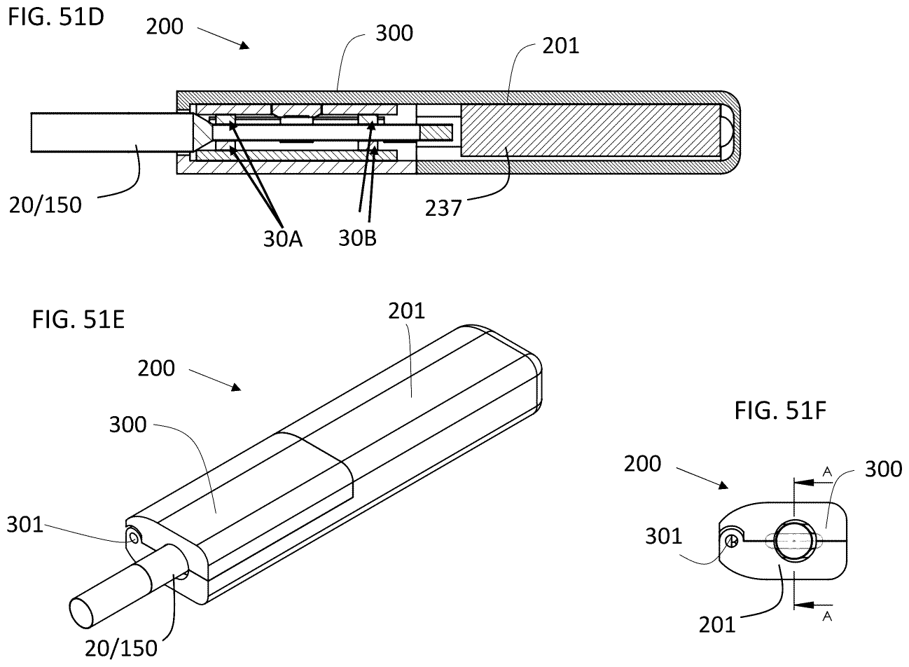

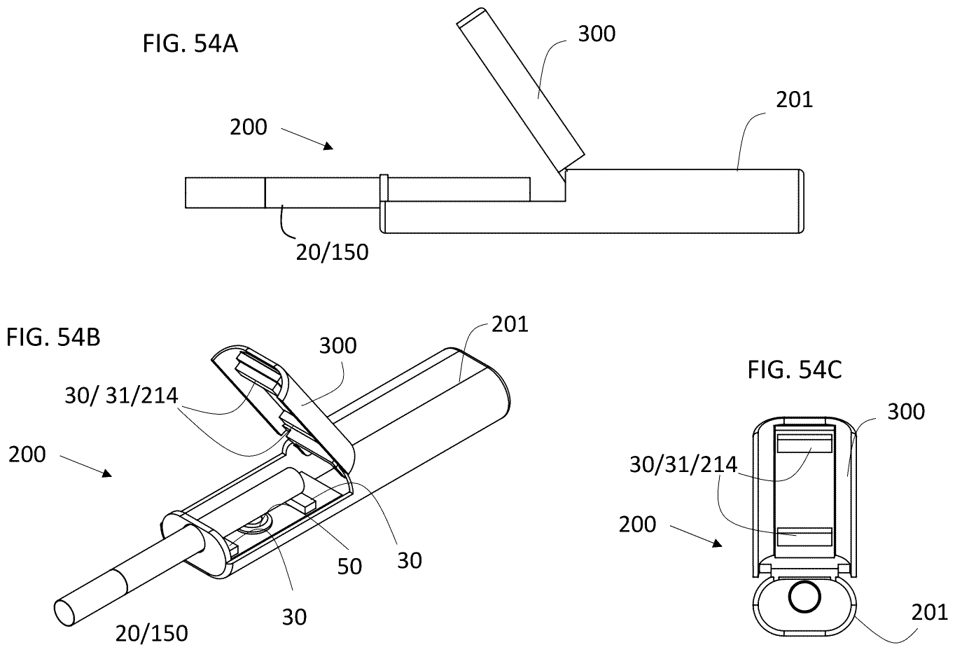

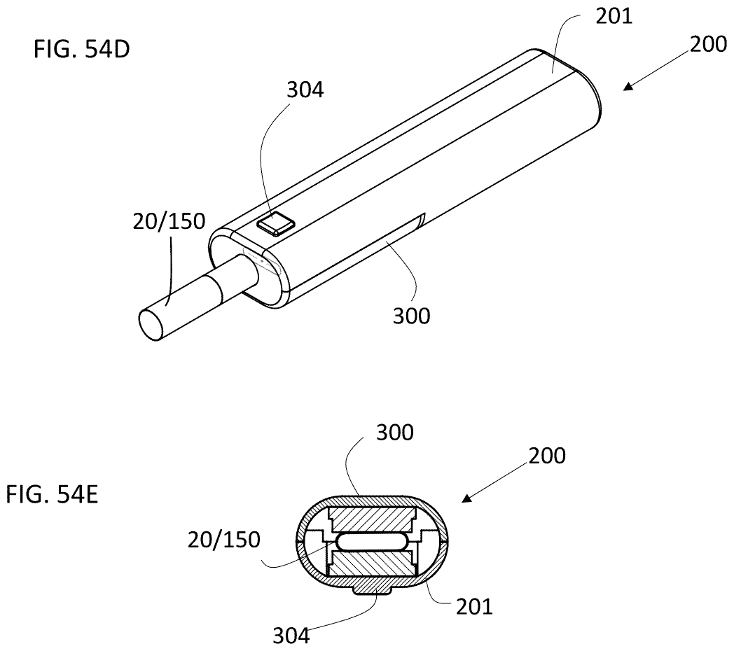

Reference is now made FIGS. 51A, 51B, and 51C are schematic illustrations of respective views of smoking device 200 that includes a housing 201 and a flap 300 that is openable with respect to the housing, with the flap in an open position, in accordance with some applications of the present invention. Smoking device 200 is configured to receive capsule 20 and/or capsule 150, the capsules typically being as described hereinabove. FIG. 51A shows a side view of the smoking device, FIG. 51B shows an oblique view and FIG. 51C shows a lateral cross-sectional view. Reference is also made to FIGS. 51D, 51E, and 51F, which are schematic illustrations of respective views of the smoking device of FIGS. 51A-51C, with the flap in a closed position, in accordance with some applications of the present invention. FIG. 51D shows a longitudinal cross-sectional view of the smoking device, FIG. 51E shows an oblique view and FIG. 51F shows a lateral cross-sectional view. For some applications flap 300 is hingedly coupled with respect to a housing 201 of the smoking device, via a hinge 301. In the example shown in FIGS. 51A-51F, the flap opens along a direction that is parallel with the longitudinal axis of the capsule (when the capsule is disposed within the smoking device). Alternatively, the flap opens along a direction that is perpendicular to the longitudinal axis of the capsule (when the capsule is disposed within the smoking device), as shown in FIGS. 54A-54E. Typically, the flap is configured to facilitate insertion of the capsule into the housing by opening with respect to the housing. For some applications, the flap is configured to hold metallic foil 32 (described hereinabove) of the capsule in electrical contact with the electrodes of the smoking device by closing with respect to the housing. Alternatively or additionally, the flap is configured to flatten at least a portion of the capsule by closing with respect to the housing. For some applications, a generally similar smoking device (which includes flap 300) is used to flatten a capsule that is configured to be heated via magnetic induction (e.g., as described hereinabove). For some such applications, by being closed, the flap is configured to flatten a coil (e.g., coil 240) that is disposed within the smoking device and that is configured to heat the capsule via magnetic induction. For some applications, the smoking device includes a locking mechanism (such as a snap mechanism, a latch, etc., not shown) that keeps the flap closed and maintains mechanical pressure on the capsule.

In the example shown in FIGS. 51A-51F, respective sets 30A and 30B of electrodes are disposed at respective axial locations along the capsule, with a first electrode in each set being housed within housing 201 and a second electrode from each set being disposed within flap 300. Typically, for such applications, each electrode within each set of electrodes is electrically connected to power source 237, which supplies power as needed to heat up the capsule to vaporization temperature. The first set of electrodes typically drives a current to the second set of electrodes (or vice versa) axially along the metallic foil of the capsule.

As shown in FIG. 51B, typically, the smoking device includes temperature sensor 50, which is typically as described hereinabove.

For some applications, a switch or other type of detection component is used to detect the state of the flap, e.g., open/closed states of the flap. For some applications, in response to the control component detecting the closing of the flap, the control component interprets this as an indication that a new capsule was inserted by the user (and initiates pre-heating of the capsule for example). Or for example, in response to the control component detecting the opening of the flap, the control component stops or disables heating of the capsule.

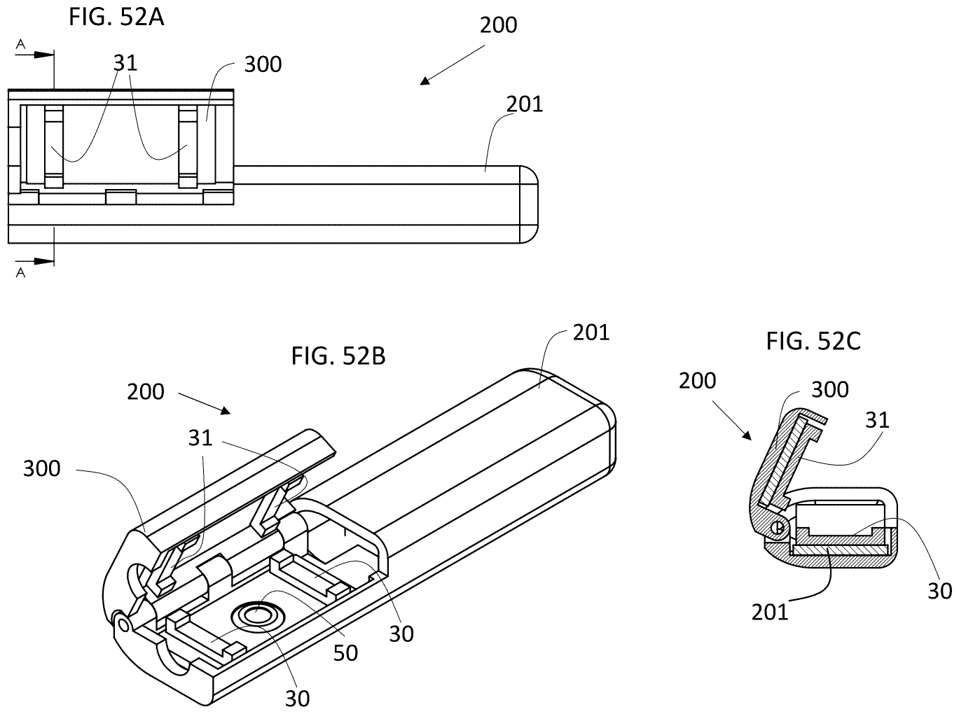

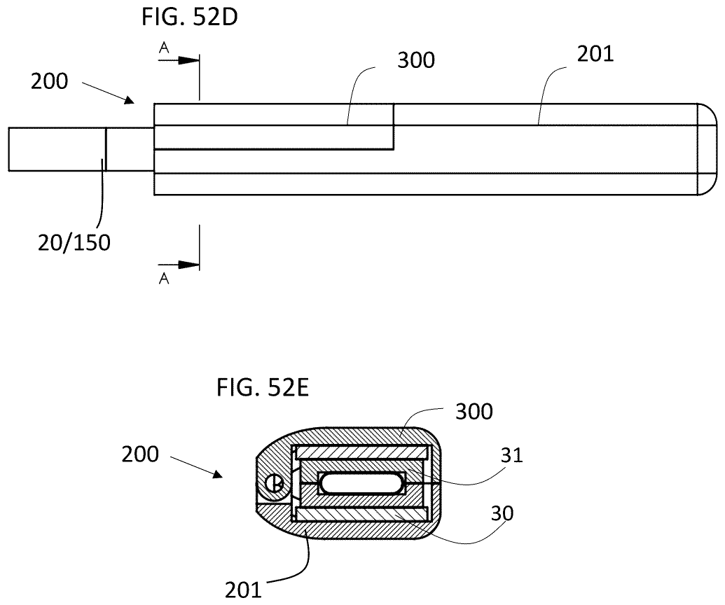

Reference is now made to FIGS. 52A, 52B, and 52C, which are schematic illustrations of respective views of a smoking device 200 that includes a housing 201 and a flap 300 that is openable with respect to the housing, with the flap in an open position, in accordance with some additional applications of the present invention. Smoking device 200 is configured to receive capsule 20 and/or capsule 150, the capsules typically being as described hereinabove. FIG. 52A shows a side view of the smoking device, FIG. 52B shows an oblique view, and FIG. 52C shows a lateral cross-sectional view. Reference is also FIGS. 52D and 52E, which are schematic illustrations of respective views of the smoking device of FIGS. 52A-52C with the flap in a closed position, in accordance with some applications of the present invention. FIG. 52D shows a side view of the smoking device and FIG. 52E shows a lateral cross-sectional view. Smoking device 200 is generally similar to that shown in FIGS. 51A-51F, except for the following differences.

For some applications, at least first and second electrodes 30 are fixedly coupled to housing 201. For some such applications, at least first and second electrical contacts 31 are housed within flap 300. Typically, for such applications the electrodes are electrically connected to power source 237 (which supplies power as needed to heat up the capsule to vaporization temperature), but the electrical contacts do not receive power directly from power source 237. Further typically, the flap is configured to place the first and second electrical contacts into electrical contact with the first and second electrodes respectively, by closing with respect to the housing. Thus, when the flap is closed typically current is driven along the metallic foil via both the first and second electrodes and via the first and second electrical contacts. Typically, configuring the smoking device in this manner reduces the number of components that the smoking device houses relative to embodiments in which a plurality of electrodes within each set of electrodes are supplied with power separately (e.g., as described with reference to FIGS. 51A-51F).

For some such applications, the capsule includes two heating elements (e.g., two separate pieces of metallic foil), one on each side of the capsule. In this case, the electrodes and electrical contacts are typically used to electrically connect between the two heating elements and/or the two sides of the capsule. It is noted that the scope of the present disclosure includes applying the described example of electrodes and electrical contacts to different types of capsules 20/150 (as described herein) that are supplied with an electrical power supply from a smoking device. Such capsules may include a single or multiple integrated heating elements. For some applications, the electrical connection between the electrodes and electrical contacts is flexible and/or spring-like, for example, one of the electrodes or electrical contacts in each set of electrodes and electrical contacts may be a leaf and/or coil spring, e.g., as described hereinbelow. For some applications, the electrodes or electrical contacts in each set of electrodes and electrical contacts are permanently connected to each other, via an electro-mechanical connection (e.g., via the hinge mechanism, a spring mechanism or any other non-wired electro-mechanical connection). For some applications, at least one of the electrodes is connected to housing 201 via a spring. For some applications, at least one of the electrodes is connected to housing 201 via a hinge.

For some applications, as an alternative or in addition to, first and second electrical contacts 31, the flap houses mechanical (non-electrically-conducting) elements 214 (described hereinabove) that are configured to hold the metallic foil of the capsule in electrical contact with the two or more electrodes 30 by flap 300 closing with respect to housing 201. Typically, for such applications, only electrodes 30 drive current along the capsule. For some applications, the capsule includes one or more coatings (e.g., electrical contact coating 120, described hereinabove) at a region at which the capsule is configured to contact electrodes 30, which is configured to conduct the current from the side of the capsule that directly contacts the electrodes (i.e., the side adjacent to housing 201) to the other side of the capsule (i.e., the side adjacent to flap 300).

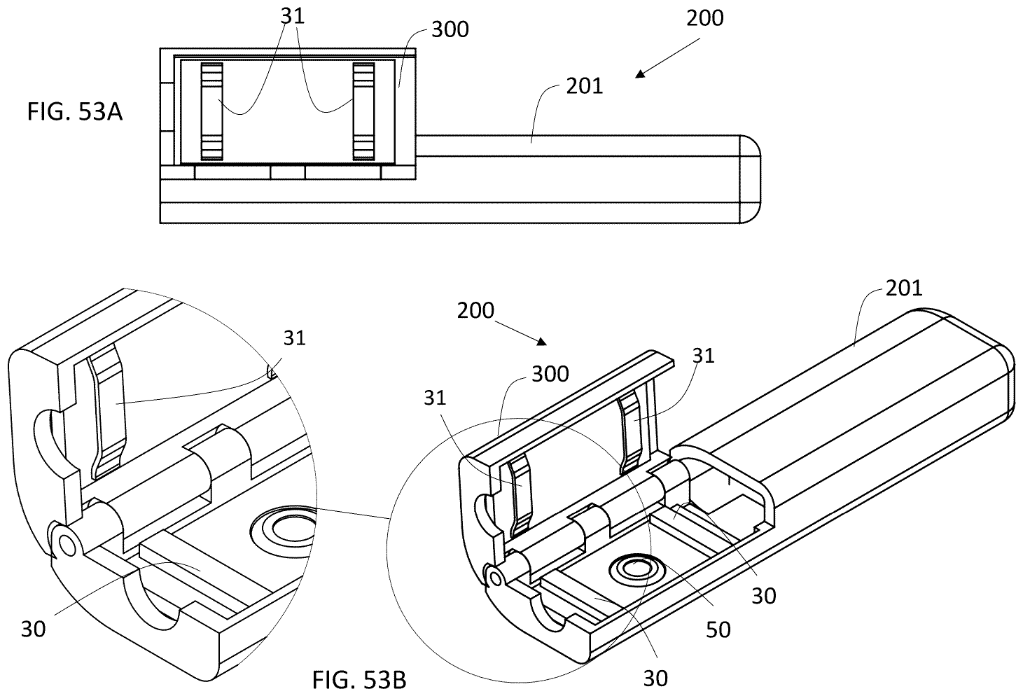

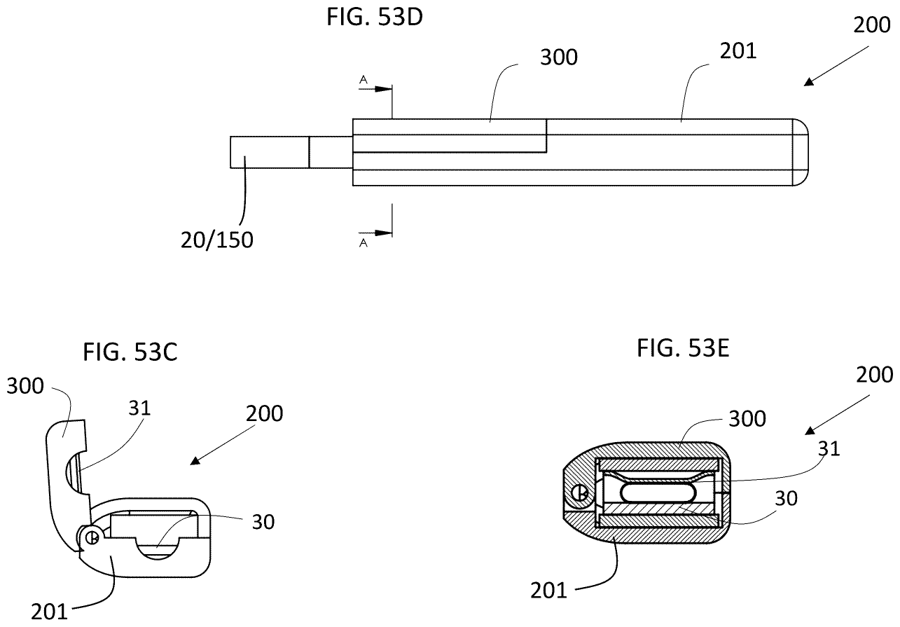

Reference is now made to FIGS. 53A, 53B, and 53C, which are schematic illustrations of respective views of a smoking device 200 that includes a housing 201 and a flap 300 that is openable with respect to the housing, with the flap in an open position, in accordance with some additional applications of the present invention. Smoking device 200 is configured to receive capsule 20 and/or capsule 150, the capsules typically being as described hereinabove. FIG. 53A shows a side view of the smoking device, FIG. 53B shows an oblique view, and FIG. 53C shows an end view. Reference is also made to FIGS. 53D and 53E, which are schematic illustrations of respective views of the smoking device of FIGS. 53A-53C, with the flap in a closed position, in accordance with some applications of the present invention. FIG. 53D shows a side view of the smoking device and FIG. 53E shows a lateral cross-sectional view. Smoking device 200 is generally similar to that shown in FIGS. 52A-52E, except for the following differences.

For some applications, as shown in FIGS. 53A-53E, one or more of the electrical contacts 31 (which are housed within flap 300 as described hereinabove) is configured as a spring (e.g., a leaf-spring, as shown) or is spring loaded. Alternatively or additionally, one or more of electrodes 30 (which are housed within housing 201 as described hereinabove) is configured as a spring (e.g., a leaf-spring, as shown) or is spring loaded. Typically, the electrical contact and/or the electrode is biased such as to exert mechanical pressure upon the capsule. Typically, the use of such an electrical contact and/or electrode enables the device to adjust the mechanical pressure that is applied by the electrical contacts and/or electrodes to different types of capsules, for example, rigid capsules and flexible capsules. The use of a spring or spring-loaded electrical contact and/or electrode typically improves the electrical connection due to constant mechanical pressure applied by the electrode on the capsule when engaged.

As shown, for some applications, an electrical contact and/or an electrode from each set of electrical contacts and electrodes is configured as a spring (and/or is spring loaded), such as to enable the device to adjust the mechanical pressure to different types of capsules, for example, rigid capsules and flexible capsules. The use of a spring and/or spring-loaded electrical contact and/or electrode typically improves the electrical connection between the electrical contact and/or electrode and metallic foil due to the constant mechanical pressure applied by the electrode on the capsule when engaged.

For some applications, the smoking device includes a non-electrically conducting mechanical element that is configured as a spring and/or is spring-loaded such as to enable the device to adjust the mechanical pressure to different types of capsules, for example, rigid capsules and flexible capsules.

Reference is now made to FIGS. 54A, 54B, and 54C, which are schematic illustrations of respective views of a smoking device 200 that includes a housing 201 and a flap 300 that is openable with respect to the housing, with the flap in an open position, in accordance with some applications of the present invention. Smoking device 200 is configured to receive capsule 20 and/or capsule 150, the capsules typically being as described hereinabove. FIG. 54A shows a side view of the smoking device, FIG. 54B shows an oblique view and FIG. 54C shows an end view. Reference is also FIGS. 54D and 54E, which are schematic illustrations of respective views of the smoking device of FIGS. 54A-54C with the flap in a closed position, in accordance with some applications of the present invention. FIG. 54D shows an oblique view of the smoking device and FIG. 54E shows a lateral cross-sectional view.

Smoking device 200 is generally similar to that shown in FIGS. 51A-51F, except for the following differences. Whereas in the example shown in FIGS. 51A-51F, the flap opens along a direction that is parallel with the longitudinal axis of the capsule (when the capsule is disposed within the smoking device), in the example shown in FIGS. 54A-54E, the flap opens along a direction that is perpendicular to the longitudinal axis of the capsule (when the capsule is disposed within the smoking device). As described hereinabove, for some applications, the smoking device includes a locking mechanism (such as a snap mechanism, a latch, etc., not shown) that keeps the flap closed and maintains mechanical pressure on the capsule. For some applications, a button 304 is configured such as to open the flap upon being pressed by the user. In accordance with respective applications, the flap houses electrodes 30, electrical contacts 31, and/or mechanical elements 214 configured to exert pressure on the capsule.

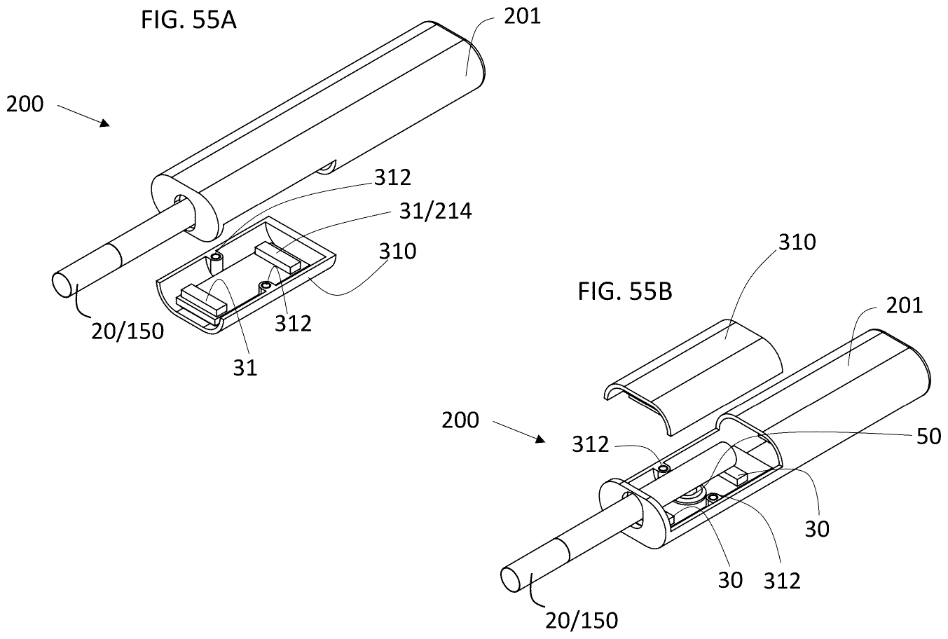

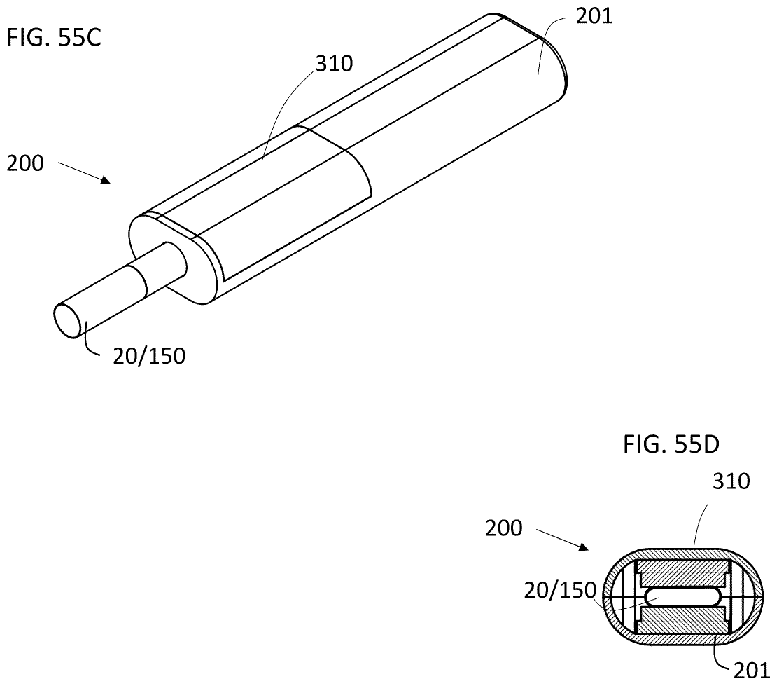

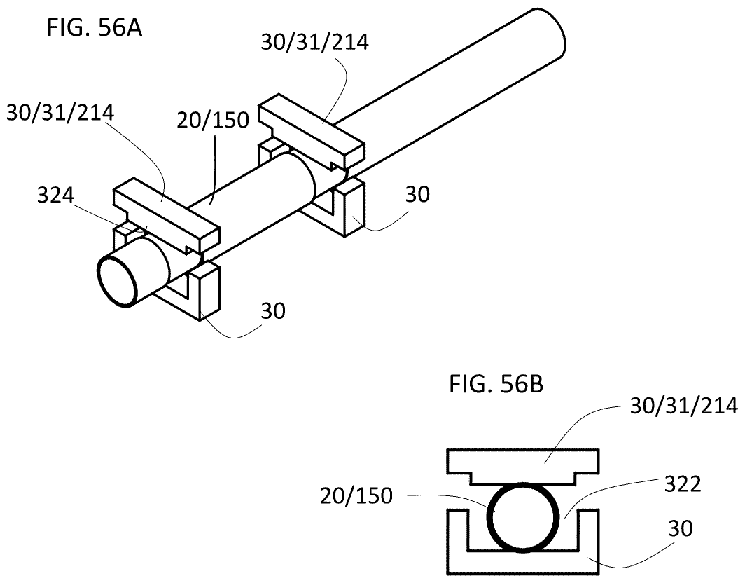

Reference is now made to FIGS. 55A and 55B, which are schematic illustrations of respective views of a smoking device 200 that includes housing 201 and a cover 310 that is reversibly couplable to the housing, with the cover decoupled from the housing, in accordance with some additional applications of the present invention. Smoking device 200 is configured to receive capsule 20 and/or capsule 150, the capsules typically being as described hereinabove. FIGS. 55A and 55B show oblique views of, respectively, upper and lower sides of the smoking device. Reference is also FIGS. 55C and 55D, which are schematic illustrations of respective views of the smoking device of FIGS. 55A-55B with the cover coupled to the housing, in accordance with some applications of the present invention. FIG. 55C shows an oblique view of the smoking device and FIG. 55D shows a lateral cross-sectional view. For some applications, housing 201 and cover 310 includes magnets 312 that are configured to maintain the cover in a coupled state with respect to the housing (in the absence of a force being applied (e.g., by the user) to remove the cover from the housing. Typically, housing 201 is generally similar to housing 201 described with reference to FIGS. 51A-51F. For example, housing 201 typically houses electrodes 30, as described hereinabove. In accordance with respective applications, cover 310 houses electrical contacts 31, and/or mechanical elements 214 configured to exert pressure on the capsule. Typically, the cover is configured to facilitate insertion of the capsule into the housing by being decoupled from the housing. For some applications, the cover is configured to hold metallic foil 32 (described hereinabove, or metallic foil 162 in the case of a capsule as described with reference to FIGS. 35A-50B) of the capsule in electrical contact with the electrodes of the smoking device by being coupled to the housing. Alternatively or additionally, the cover is configured to flatten at least a portion of the capsule by being coupled to the housing. For some applications, a generally similar smoking device (which includes cover 310) is used to flatten a capsule that is configured to be heated via magnetic induction (e.g., as described hereinabove). For some such applications, by being coupled to the housing, the cover is configured to flatten a coil (e.g., coil 240) that is disposed within the smoking device and that is configured to heat the capsule via magnetic induction.

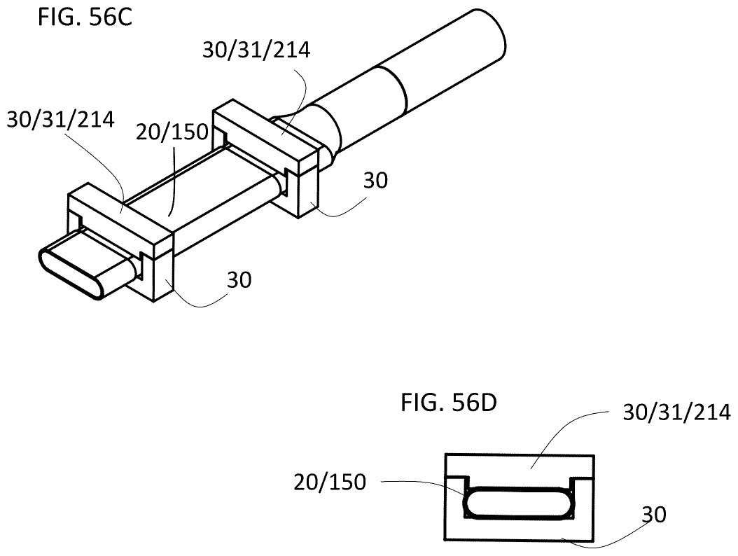

Reference is now made to FIGS. 56A and 56B which are schematic illustrations of electrodes 30, electrical contacts 31, and/or mechanical elements 214 that are configured to flatten capsule 20 and/or capsule 150, in accordance with some applications of the present invention. Electrodes 30, electrical contacts 31, and/or mechanical elements 214 are configured for use with capsule 20 and/or capsule 150, the capsules typically being as described hereinabove. FIG. 56A shows an oblique view of electrodes 30, electrical contacts 31, and/or mechanical elements 214 and the capsule and 56B shows a lateral cross-sectional view. As described hereinabove, typically at least first and second electrodes 30 are coupled to housing 201 (housing not shown in FIGS. 56A-56B). For some applications, electrodes 30, electrical contacts 31, and/or mechanical elements 214 are disposed within flap 300 or cover 310 (not shown in FIGS. 56A-56B). For some applications, the electrodes 30, electrical contacts 31, and/or mechanical elements 214 are configured to keep the capsule centered with respect to the first and second electrodes 30 that are coupled to housing 201. For example, the electrodes 30, electrical contacts 31, and/or mechanical elements 214 may be shaped to define a protrusion 324 that conforms with a cavity 322 defined by the electrodes that are coupled to the housing. FIGS. 56A and 56B show electrodes 30, electrical contacts 31, and/or mechanical elements 214 before electrodes 30, electrical contacts 31, and/or mechanical elements 214 have been used to flatten the capsule. Reference is also made to FIGS. 56C-56D, which show electrodes 30, electrical contacts 31, and/or mechanical elements 214 after electrodes 30, electrical contacts 31, and/or mechanical elements 214 have been used to flatten the capsule. For some applications, by being shaped as described, electrodes 30, electrical contacts 31, and/or mechanical elements 214 are further configured to prevent the capsule from sliding out of its position during the flattening.

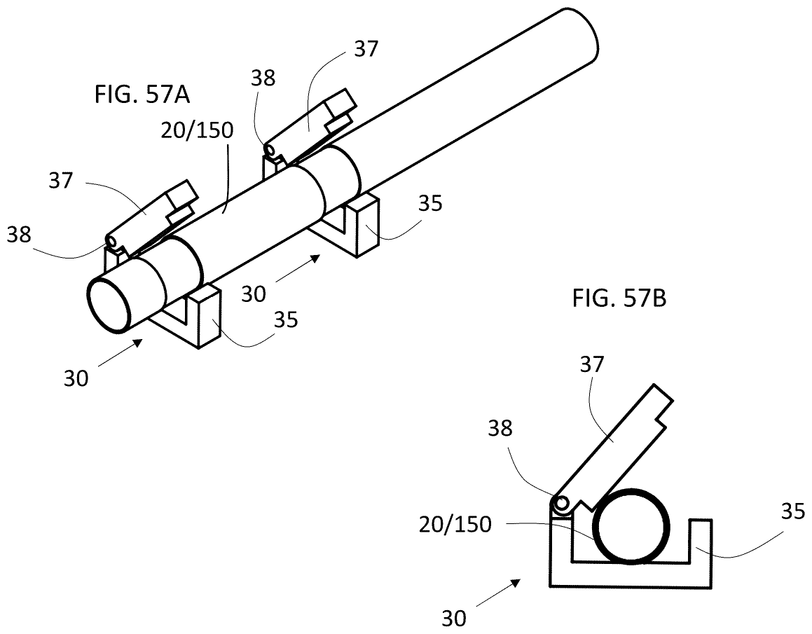

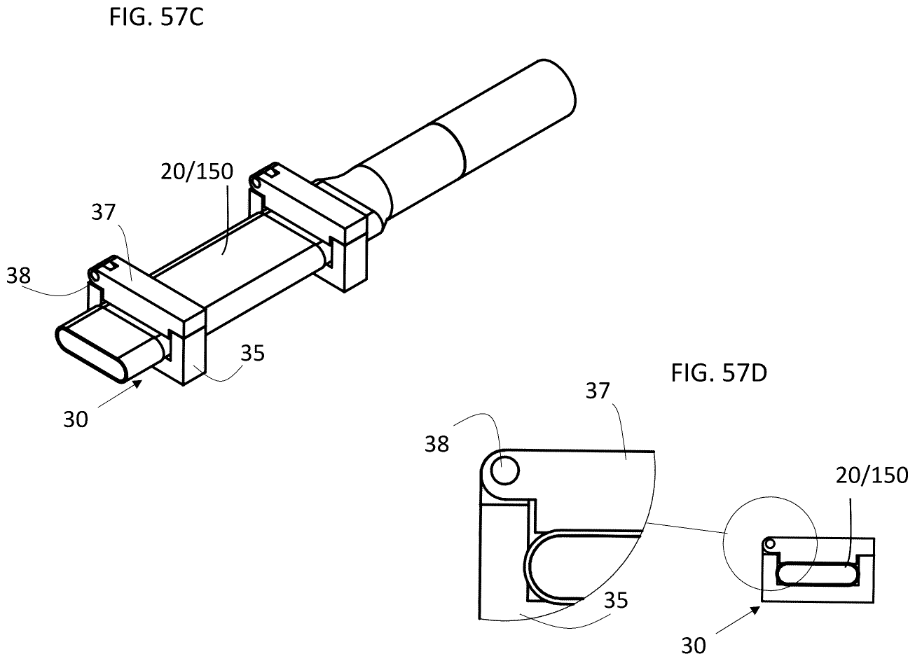

Reference is now made to FIGS. 57A and 57B, which are schematic illustrations of hinged electrodes 30, in accordance with some applications of the present invention. Electrodes 30 are configured for use with capsule 20 and/or capsule 150, the capsules typically being as described hereinabove. FIG. 57A shows an oblique view of electrodes 30 and the capsule and 57B shows a lateral cross-sectional view. For some applications, each electrode 30 includes a first portion 35 (which is typically housed in housing 201, shown in FIGS. 51A-51F) and a second portion 37 (which is typically housed in flap 300, also shown in FIGS. 51A-51F), the second portion being coupled to the first portion via a hinge 38. For some applications, the electrodes are configured to flatten the capsule. Typically, the first portion of the electrode is configured to contact a first side of the capsule, and the second portion of the electrode is configured to contact a second side of the capsule. FIGS. 57A and 57B show electrodes 30 before electrodes 30 have been used to flatten the capsule. Reference is also made to FIGS. 57C-57D, which show electrodes 30 after electrodes 30 have been used to flatten the capsule.

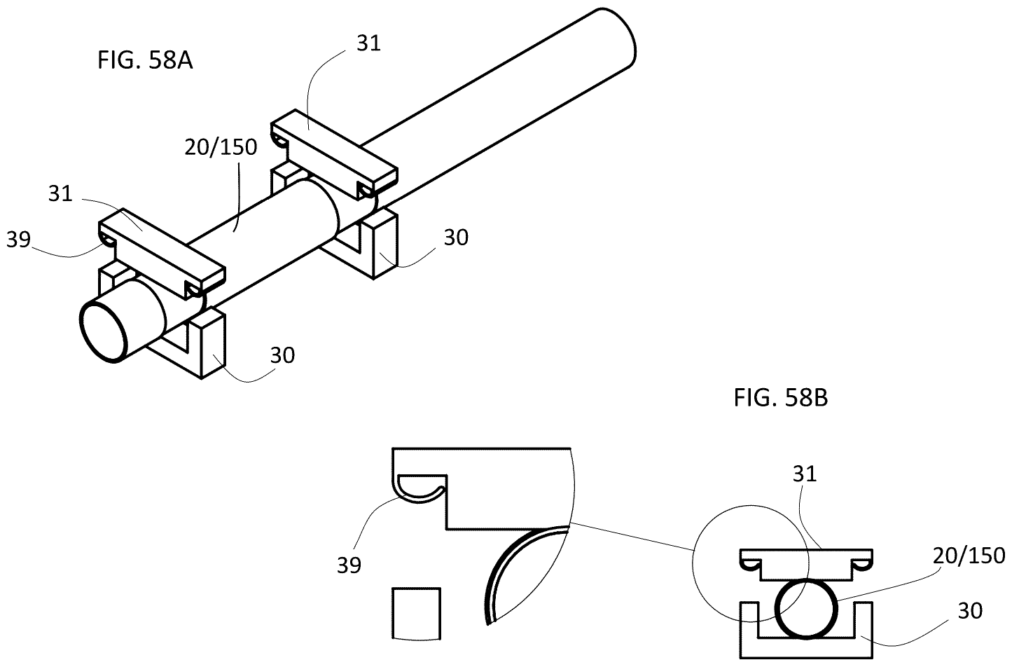

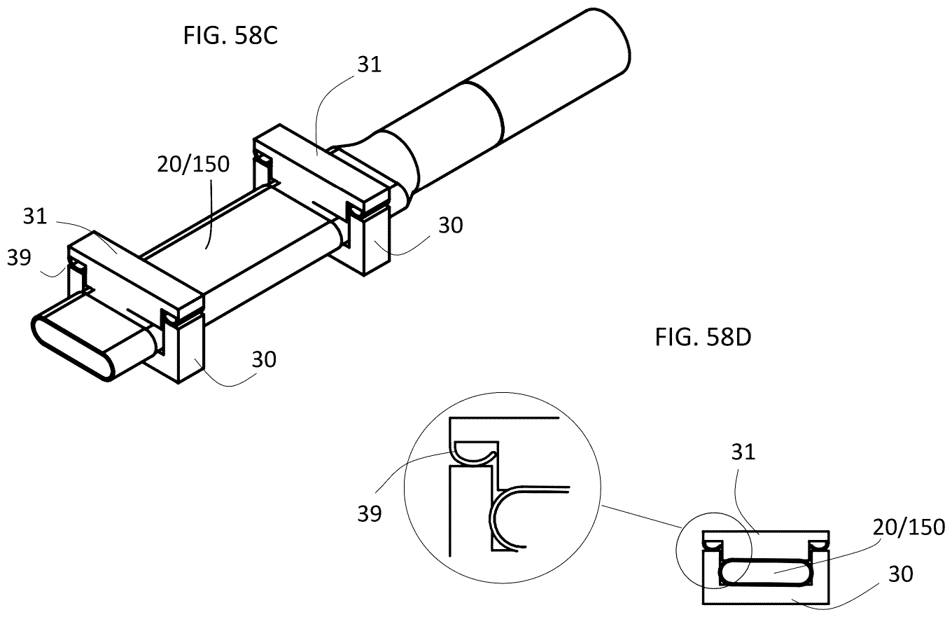

Reference is now made to FIGS. 58A and 58B, which are schematic illustrations of electrodes 30 and electrical contacts 31 that are configured to electrically contact each other via a conductive spring 39, in accordance with some applications of the present invention. Electrodes 30 and electrical contacts 31 are configured for use with capsule 20 and/or capsule 150, the capsules typically being as described hereinabove. FIG. 58A shows an oblique view of electrodes 30, electrical contacts 31 and the capsule, and 58B shows a lateral cross-sectional view. For some applications, the electrodes are housed in housing 201 (shown in FIGS. 51A-51F) and the electrical contacts are housed on flap 300 (shown in FIGS. 51A-54E) and/or cover 310 (shown in FIGS. 55A-55D). For some applications, the electrodes and electrical contacts are configured to flatten the capsule. For some applications, the conductive spring prevents the electrodes and electrical contacts from mechanically interfering with each other during flattening of the capsule. For some applications, the conductive spring is configured to provide a good electrical connection between electrical contacts and electrodes. FIGS. 58A and 58B show electrodes 30 and electrical contacts 31 before electrodes 30 and electrical contacts 31 have been used to flatten the capsule. Reference is also made to FIGS. 58C-58D, which show electrodes 30 and electrical contacts 31 after electrodes 30 and electrical contacts 31 have been used to flatten the capsule.

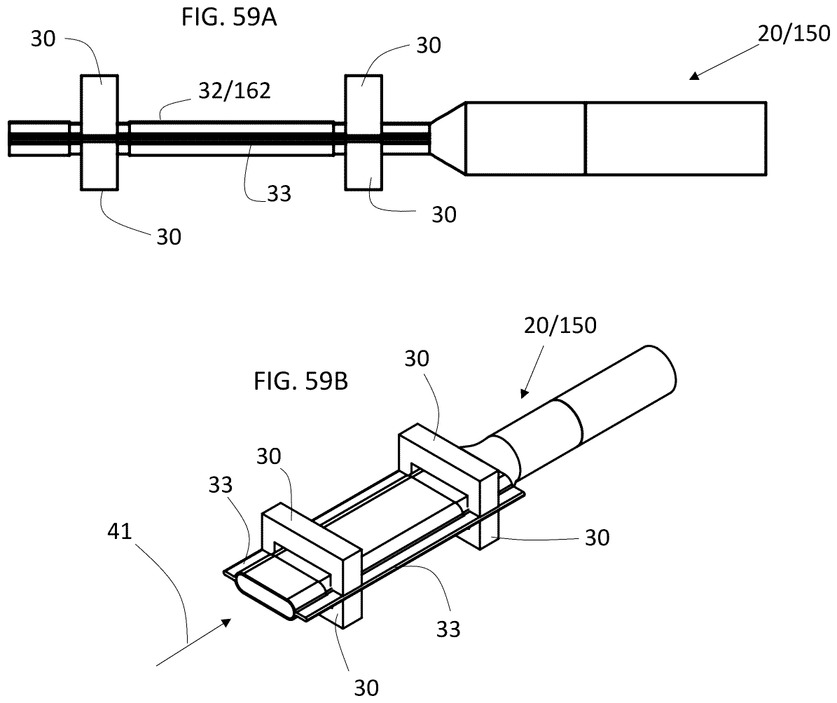

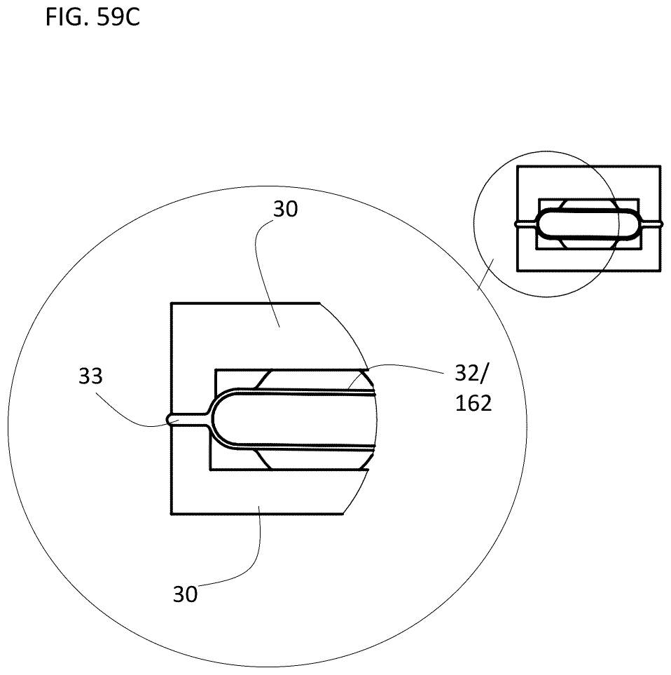

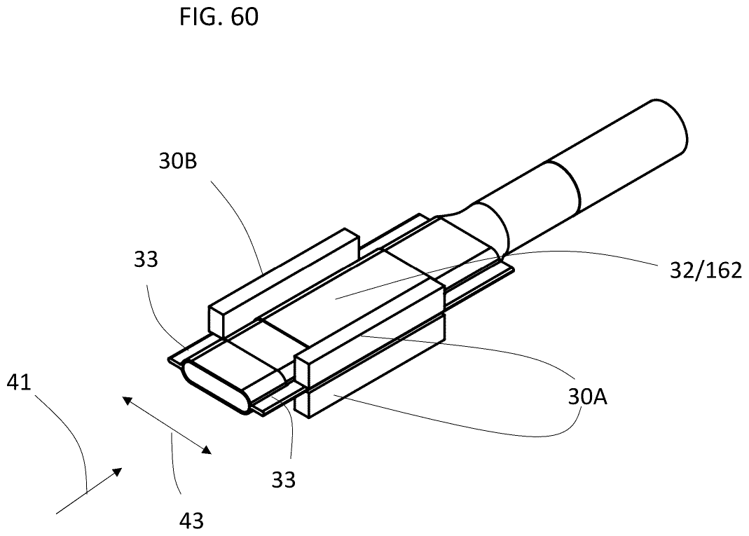

Reference is now made to FIGS. 59A, 59B and 59C, which are schematic illustrations of respective views of capsule 20 or capsule 150, the capsule including metallic foil 32 or 162 surrounding smoking material, the metallic foil being shaped to define lateral winged projections 33 that are configured to contact electrodes 30 of the smoking device, in accordance with some applications of the present invention. FIG. 59A shows a side view of the capsule and the electrodes, FIG. 59B shows an oblique view and FIG. 59C shows a lateral cross-sectional view. For some applications, at lateral locations corresponding to the winged projections, upper and lower electrodes (or lower electrodes and upper electrical contacts 31, or lower electrodes and upper mechanical elements 214) are brought into close proximity with each other, but at a radially central location, the upper and lower electrodes (or lower electrodes and upper electrical contacts 31, or lower electrodes and upper mechanical elements 214) define a cavity between them, such that at the radially central location the capsule does not collapse even after it is flattened. For some such applications, the capsule does not include any collapse-prevention elements (such as those described hereinabove). For some such applications, the capsule is manufactured to define a generally circular cross-sectional shape (other than at the winged projections) and is configured to be flattened by the smoking device, in accordance with the techniques described herein. Alternatively, the capsule is manufactured to define a flattened cross-sectional shape, as described hereinabove. In the embodiment shown in FIGS. 59A-9C typically the direction in which the current is driven along the capsule is in the axial direction (as indicated by arrow 41), which is typically the same as the direction of airflow through the capsule. Reference is also made to FIG. 60, which is a schematic illustration of a configuration of electrodes that is configured to drive a current laterally across the capsule (in the direction of arrow 43), i.e. perpendicularly to the direction of airflow through the capsule (indicated by arrow 41), in accordance with some applications of the present invention. Typically, for such applications, selective heating is applied to the capsule, with the heating that is applied at respective axial locations being defined by the locations and/or sizes of the electrodes. For some applications, respective electrode pairs are disposed at respective axial locations. For some such applications, respective electrode pairs are used to apply respective heating profiles to respective axial locations along the capsule.

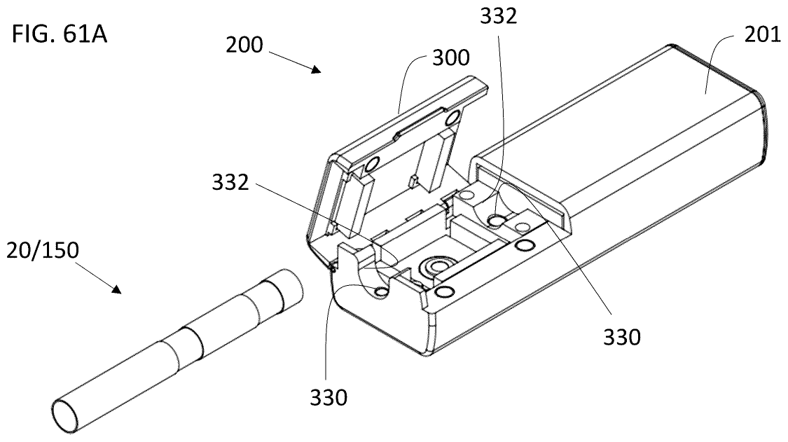

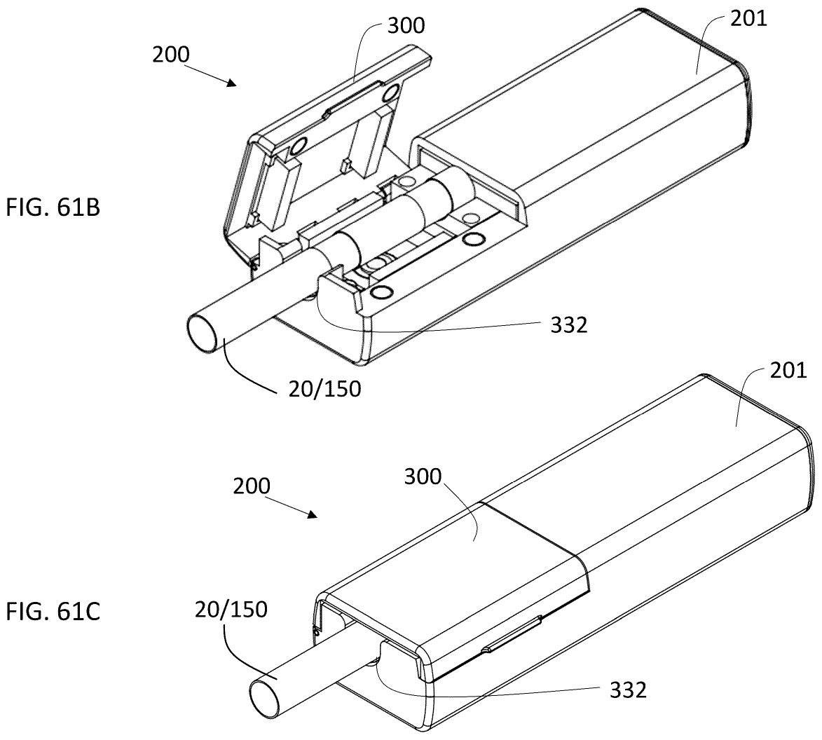

Reference is now made to FIGS. 61A, 61B, and 61C, which are schematic illustrations of respective views of smoking device 200, the smoking device including housing 201, a flap 300 that is openable with respect to the housing, and magnets 330, in accordance with some applications of the present invention. Smoking device 200 is configured to receive capsule 20 and/or capsule 150, the capsules typically being as described hereinabove. FIG. 61A shows the smoking device prior to the capsule having been inserted into the smoking device, FIG. 61B shows the smoking device with the capsule inserted and with the flap in an open position, and FIG. 61C shows the smoking device with the flap in the closed position and with the capsule disposed within the smoking device, in accordance with some applications of the present invention. Smoking device 200 and the functionalities thereof are typically generally similar to those described hereinabove. In addition, flap 300 typically functions in a generally similar manner to that described hereinabove, for example with reference to FIGS. 51A-53E.

For some applications, smoking device 200 includes one or more magnets 330 and the capsule includes a ferromagnetic and/or a magnetic material. Typically, the combination of the magnets within the smoking device and the ferromagnetic and/or magnetic material within the capsule assists the user in correctly positioning the capsule within the smoking device, by the magnets within the smoking device attracting the ferromagnetic and/or magnetic material within the capsule, such as to correctly position the capsule within the smoking device.

For some applications, the capsule includes an internal magnet. For some applications, the capsule includes the ferromagnetic material within at least at one section, a plurality of sections, or along the full length of the capsule. For some applications, the ferromagnetic material is placed along the longitudinal axis of the capsule, around the perimeter of the capsule, and/or at a different location within the capsule. For some applications, metallic foil 32 is made out of a ferromagnetic metal and serves a dual task; namely to provide resistive heating of the smoking material and to assist the user in correctly positioning the capsule within the smoking device.

For some applications, the smoking device defines one or more rounded grooves 332. The rounded grooves are typically shaped and sized to conform with the radial cross-sectional shape of the capsule, such that the capsule fits within the grooves. For some applications the magnet 330 is disposed at the trough of the groove, as shown. For some applications, the smoking device defines two such rounded grooves 332 and a respective magnet is disposed at the troughs of each of the grooves, as shown. It is noted that typically, the portions of the smoking device that flatten the capsule (e.g., electrodes 30, electrical contacts 31, and/or mechanical elements 214) are disposed at axial locations that are between the two rounded grooves. Thus, even after the capsule is flattened, the portions of the capsule that are within the rounded grooves remain rounded and continue to fit the grooves.

For some applications, electrical connections (e.g., electrical contacts) and/or electrodes of the smoking device are themselves made of a magnetic material that, in addition to facilitating the conduction of current into the capsule, assist the user in correctly positioning the capsule within the smoking device in the manner described hereinabove. For some applications, electrodes 30 include a magnet and an electrically conductive material. For some such applications, this combination of materials synergistically provides magneticity and low electrical resistance of the electrode.

As described hereinabove, the combination of the magnets within the smoking device and the ferromagnetic and/or magnetic material within the capsule typically assists the user in correctly positioning the capsule within the smoking device. Typically, the correct positioning of the capsule within the smoking device is such that the capsule is aligned with electrodes 30, electrical contacts 31, and/or mechanical elements 214. As shown in FIG. 61B, once the capsule has been correctly positioned within the smoking device but flap 300 is still open, the magnetic attraction between the capsule and the smoking device typically prevents the capsule from moving with respect to the smoking device (or falling out of the smoking device).

Subsequently, the user typically closes flap 300 (as shown in FIG. 61C). Typically, closing flap 300 flattens the capsule and facilitates a good electrical connection between the smoking device and the capsule, in the manner described hereinabove. Further typically, closing the flap holds the capsule firmly in place within the smoking device.

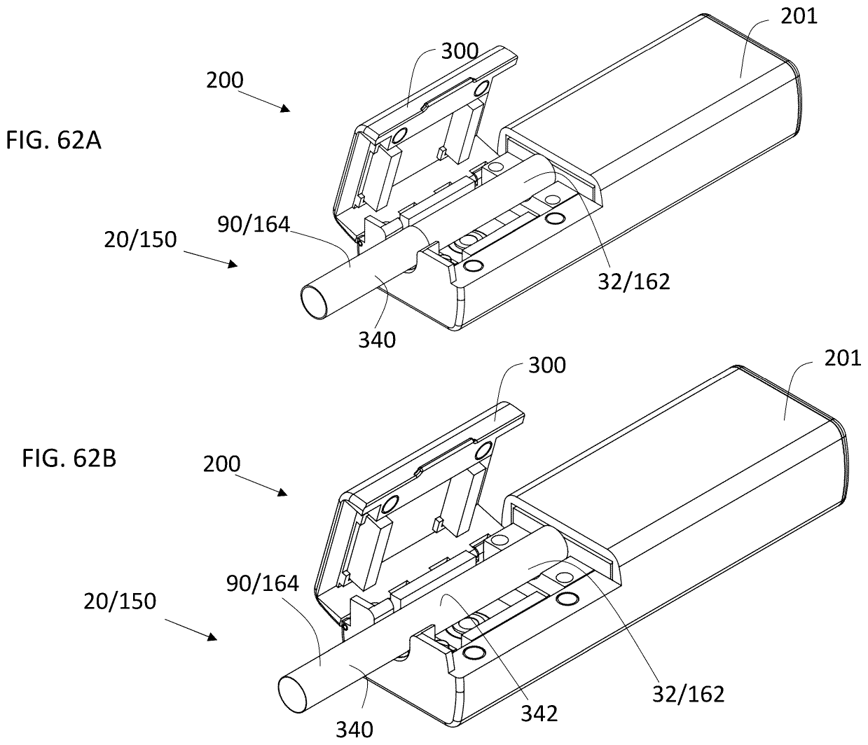

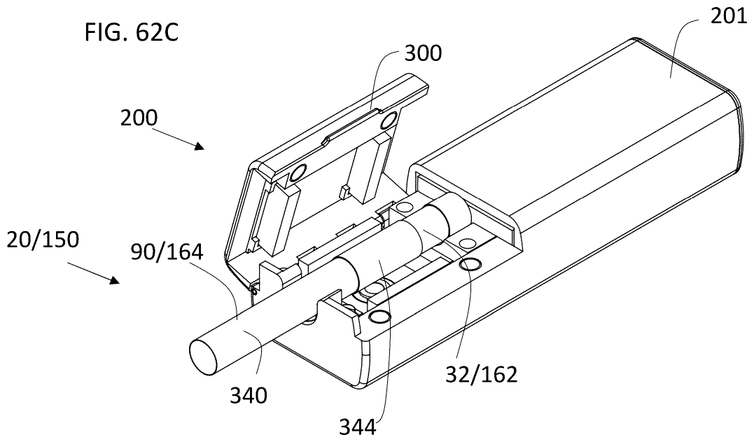

Reference is now made to FIGS. 62A, 62B, and 62C, which are schematic illustrations of respective views of capsules 20/150 that are configured to facilitate sensing of when a user has placed mouthpiece 90/164 of the capsule within their mouth, in accordance with some applications of the present invention. Typically, the features of the capsules described with reference to FIGS. 62A-62C are applicable both to capsule 20 (which is typically configured for used within a solid, e.g., a plant, smoking material) and capsule 150 (which is typically configured for use with a liquid smoking material that is vaporized), the capsules typically being as described hereinabove. For some applications, the capsules are configured to facilitate automatic detection by the smoking device (e.g., control component 233 of the smoking device described hereinabove) that the user is placing their mouth on the capsule mouthpiece.

For some applications, in response to detecting that the user is placing their mouth on the capsule mouthpiece, the control component initiates pre-heating of the capsule (e.g., as described hereinabove). For some applications, in response to detecting that the user is placing their mouth on the capsule mouthpiece, the control component initiates heating the capsule so that the user can smoke (or vape) immediately without any additional actions (for example, pressing a button) being required by the user. For some applications, in response to detecting that the user is placing their mouth on the capsule mouthpiece, the control component heats the capsule only for the duration of time that the user's mouth continues to be placed on the mouthpiece. Alternatively, in response to detecting that the user is placing their mouth on the capsule mouthpiece, the control component heats the capsule for a predefined time duration.

For some applications, in order to detect that the user has placed their mouth on the mouthpiece, the capsule includes a conductive element 340 (e.g., a mouthpiece metallic foil) at the location of the mouthpiece. Typically, when disposed within the smoking device, the conductive element is electrically connected to the control component of the device, such as to enable the detection of the user's mouth on the mouthpiece by the control component measuring changes in electric resistance, capacitance, or any other electrical property that is indicative of the user's mouth on the mouthpiece.

For some applications, at least a portion of the cover of smoking device 200 is electrically conductive. (For example, the portion of the cover itself may be electrically conductive or may be coated with a conductive coating or paint.) Typically, the electrically-conductive portion of the device cover is electrically connected to the control component. For some applications, the control component detects when the user's mouth is on the mouthpiece by detecting the closing of an electrical circuit from the mouthpiece of the capsule to the cover of the device via the user's body. For example, the control component may detect the closing of the above-described electrical circuit by detecting changes in capacitance or resistivity.

As described hereinabove, for some applications, in order to detect that the user has placed their mouth on the mouthpiece, the capsule includes conductive element 340 at the location of the mouthpiece. For some applications, the conductive element is a mouthpiece metallic foil that is separate from magnetic foil 32 or 162 described hereinabove. Alternatively, the capsule includes a single metallic foil 342 that is used for resistive heating of the capsule (i.e., a function of metallic foil 32 or 162 described hereinabove) and for detecting the user mouth on the mouthpiece (i.e., a function of conductive element 340). For some such applications, the metallic foil is placed along the full length of the capsule so it covers both the mouthpiece and the locations of electrodes 30. (This is shown in FIG. 62B, which shows the capsule in the absence of a paper covering material for illustrative purposes.) For some such applications, the electrical electrodes that are used to heat the capsule are also used in order to electrically detect that the mouth of the user is placed on the mouthpiece.

Referring to FIG. 62C, for some applications, the capsule includes a first metallic foil that is disposed at the location of the mouthpiece and that is used as conductive element 340 (to detect the user's mouth on the mouthpiece) and metallic foil 32 or 162 as a separate metallic foil that is electrically isolated from the first metallic foil. For example, there may be an electrically-insulating ring 344 (e.g., a paper ring) disposed between the two metallic foils. (FIG. 62C shows the capsule in the absence of a paper covering material for illustrative purposes.) Typically, the first metallic foil is electrically connected to the control component separately from metallic foil 32 or 162. Typically, the first metallic foil is electrically connected to the control component in the manner described hereinabove.

For some applications (not shown), a plurality of conductive elements 340 (e.g., metallic foils) are disposed within the mouthpiece. For some applications, the control component is configured to detect that the user's mouth is on the mouthpiece by detecting a change in electrical properties between the foils, for example, change in resistance or/and capacitance due to the user placing their mouth on the mouthpiece.

Referring again to FIG. 61C, typically, closing flap 300 flattens the capsule and facilitates a good electrical connection between the smoking device and the capsule, in the manner described hereinabove. Further typically, closing the flap holds the capsule firmly in place within the smoking device. For some applications, closing the flap creates an electrical and/or a capacitive connection between the smoking device and the conductive element 340 (e.g., metallic foil) within the mouthpiece of the capsule. For example, closing the flap may create an electrical and/or a capacitive connection between the smoking device and the conductive element via a dedicated electrode, via piercing with an electrical contact, and/or by pressing a capacitor plate against paper covering material of the capsule.

Typically, the apparatus and methods described with reference to FIGS. 51A-62C may be combined with any of the apparatus and methods described hereinabove.

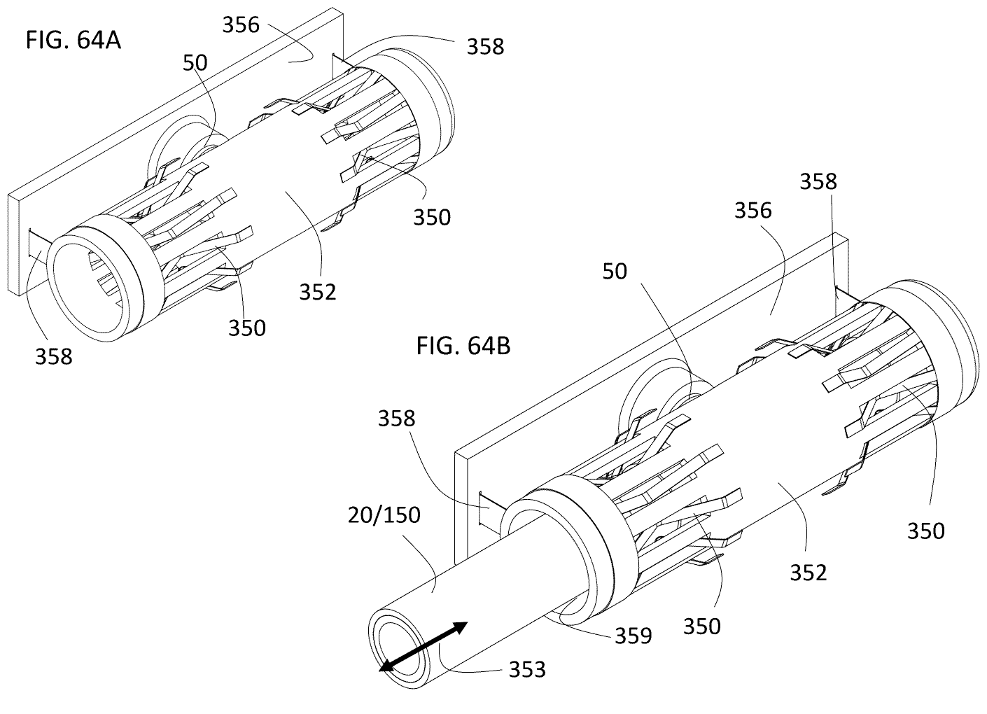

Reference is now made to FIGS. 63A and 63B, which are schematic illustrations of spring electrodes 350, which are configured to be disposed around the circumference of a capsule-receiving chamber (shown in FIGS. 64A and 64B) of smoking device 200 at two or more axial locations, in accordance with some applications of the present invention. As noted, for some applications, smoking device 200 is configured to be used both with capsules that contain a solid smoking material (such as a plant material, e.g., tobacco, for example, capsule 20, described hereinabove) and with capsules that contain a liquid material that is configured to be vaporized (such as capsule 150, described hereinabove). Typically, the smoking device heats the solid smoking material in a heat-not-burn manner, as described hereinabove. FIG. 63A shows the springs before the capsule has been inserted, while FIG. 63B shows the springs after the capsule has been inserted.

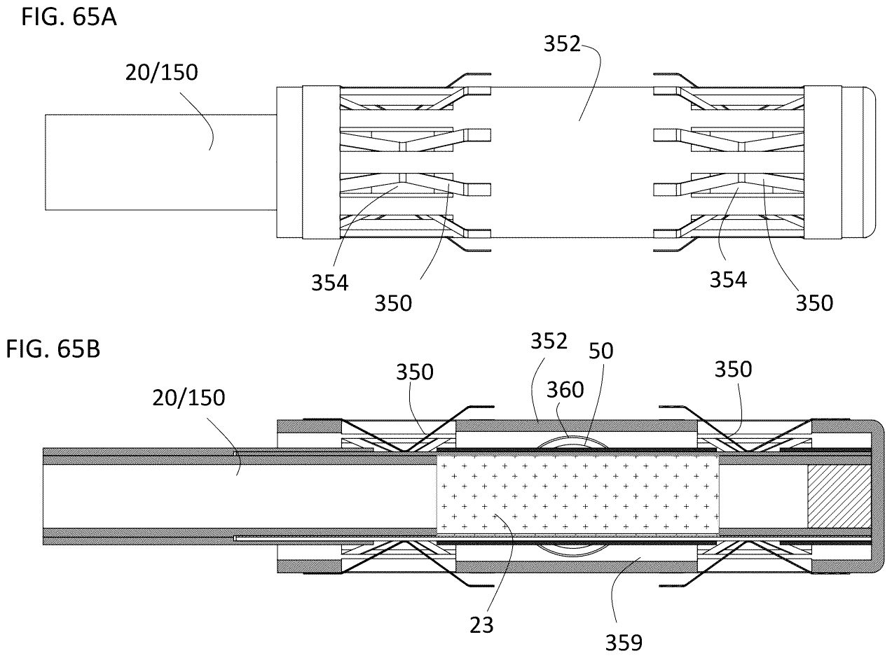

Reference is also made to FIGS. 64A and 64B, which are schematic illustrations of spring electrodes 350 disposed around the circumference of capsule-receiving chamber 352 of smoking device 200 at two or more axial locations, in accordance with some applications of the present invention. FIG. 64A shows capsule-receiving chamber 352 before the capsule has been inserted, while FIG. 64B shows capsule-receiving chamber 352 after the capsule has been inserted, with arrow 353 indicating insertion and removal of the capsule. Reference is further made to FIGS. 65A and 65B, which are schematic illustrations of capsule 20/150 disposed within capsule-receiving chamber 352 of smoking device 200, in accordance with some applications of the present invention.

Typically, the spring electrodes are configured to drive an electrical current along heating element 32 or 162, which is typically a metallic foil (e.g., stainless steel foil, nickel-titanium foil, titanium foil, copper foil, aluminum foil, steel foil), which is typically disposed within capsule 20 and/or capsule 150. Spring electrodes 350 are disposed around the circumference of capsule-receiving chamber 352 of smoking device 200 at two or more axial locations and typically drive the electrical current from a set of spring electrodes disposed at a first axial location along the length of the capsule to a set of electrodes disposed at a second axial location. The metallic foil becomes resistively heated, thereby heating the smoking material (e.g., the plant material or the liquid material) within the capsule. Typically, the smoking device heats the solid smoking material in a heat-not-burn manner, as described hereinabove.

Spring electrodes 350 are typically designed to enable easy insertion and extraction of 20 and/or capsule 150 by simple insertion along the axial direction of the capsule. The electrodes are typically compliant such that they are configured to allow the capsule to slide through them during insertion and extraction without damaging (e.g., tearing) the capsule. Typically, upon the capsule having been received within the capsule-receiving chamber the spring electrodes make electrical contact with the capsule.

Spring electrodes 350 are typically distributed uniformly around the circumference of capsule-receiving chamber 352 such as to provide an equal distribution of electrical current around the circumference of the capsule in order to equalize heat generation around the capsule circumference.

Spring electrodes 350 are typically shaped so as to have a low thermal conductivity design (e.g., by having narrow, long shapes). For example, the ratio of the length to the width of each of the spring electrodes is more than 5:1, e.g., more than 10:1, or more than 15:1. In this manner, heat loss through the electrodes and heating up of the smoking device itself are typically minimized.

For some applications, in order to increase the surface contact between the electrodes and the capsule, at the axial locations where the electrodes touch the capsule (e.g., the metallic foil of the capsule), the electrodes are widened (relative to the widths of the electrodes at other locations along the electrodes). Typically, this increases contact area between the electrodes and the capsule (e.g., the metallic foil of the capsule), thereby providing better electrical connection and/or lower contact resistance relative to if the electrodes were not widened, ceteris paribus.

For some applications, in order to increase the surface between the electrodes and the capsule, the electrodes are curved or bent such that at the axial position where the electrodes touch the capsule (e.g., the metallic foil of the capsule), the electrodes encompass a circle having a diameter that is similar to (or slightly less than) the diameter of the capsule at that axial position. Typically, this increases contact with the capsule (e.g., the metallic foil of the capsule) for better electrical connection and/or lower contact resistance relative to if the electrodes were not curved or bent in this manner, ceteris paribus.

Spring electrodes 350 are typically designed to enable easy insertion and extraction of a cleaning brush as well as capsule 20/150 without getting caught in the springs or damaging them, and without requiring any additional mechanism. For example, as shown in FIG. 65A, each of spring electrodes is coupled to capsule-receiving chamber 352 at a first end and then protrudes into the inside of the capsule-receiving chamber via a slit 354 in the capsule-receiving chamber. At its second end, the spring typically extends along the outside of capsule-receiving chamber such that the spring does not get pulled into the capsule-receiving chamber (e.g., as a result of cleaning with a cleaning brush), as shown.

Typically, a printed circuit board 356 is disposed in close proximity to spring electrodes, as shown in FIGS. 64A-64B. For some applications, electrical connectors 358 extend from the printed circuit board to the spring electrodes.

Capsule-receiving chamber 352 is typically configured to reduce conductive heat transfer to the body of the smoking device. For example, the capsule-receiving chamber is sized to define a larger diameter than that of the capsule, such that when the capsule is disposed within the capsule-receiving chamber there is an air gap 359 (shown in FIGS. 64B and 65B) between the capsule and the capsule-receiving chamber. For some applications, the air gap provides thermal insulation between the capsule and the body of the smoking device, thereby reducing heating of the body of the smoking device and consequential energy loss, relative to if no air gap were defined, ceteris paribus. As noted hereinabove, typically, in order to increase the surface between the electrodes and the capsule, the electrodes are curved or bent such that at the axial location where the electrodes touch the capsule (e.g., the metallic foil of the capsule), the electrodes encompass a circle having a diameter that is similar to (or slightly less than) the diameter of the capsule at that axial location. Thus, even though there is an air gap between the capsule-receiving chamber and the capsule, there is still good electrical contact between the spring electrodes and the capsule.

For some applications, the smoking device includes sensor 50 (which is typically a non-contact temperature sensor (such as an infrared temperature sensor)) for sensing the temperature of the smoking material within the capsule, as described hereinabove. As shown in FIG. 65B, for some applications, the capsule-receiving chamber defines an opening 360 via which the sensor senses the temperature of smoking material 23 within the capsule.

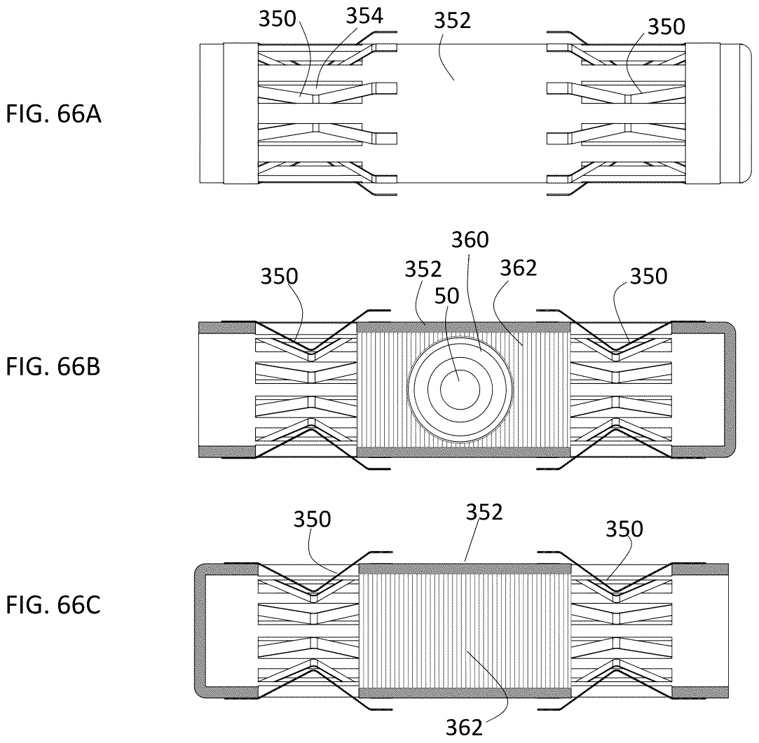

Reference is now made to FIGS. 66A, 66B, and 66C, which are additional schematic illustrations of capsule-receiving chamber 352 of smoking device 200, in accordance with some applications of the present invention. FIGS. 66B and 66C show longitudinal cross-sectional views of the capsule-receiving chamber, with the capsule-receiving chamber having been flipped around its short end between the view shown in FIG. 66B and that shown in FIG. 66C. For some applications, the capsule-receiving chamber is configured to reduce radiation of heat from the capsule to the body of the smoking device, for example, by using a heat-reflecting coating 362 on the inner wall of the capsule-receiving chamber. The heat-reflecting coating is typically a metallic coating and/or foil, which acts as a mirror with respect to the radiated heat. Typically, the heat-reflecting coating is configured to increase the heating efficiency of the device by directing radiated heat back to the capsule. Thus the heat-reflecting coating typically both reduces heating of the body of the smoking device and increases the heating efficiency of the device (which is some cases enhances the battery life of the smoking device).

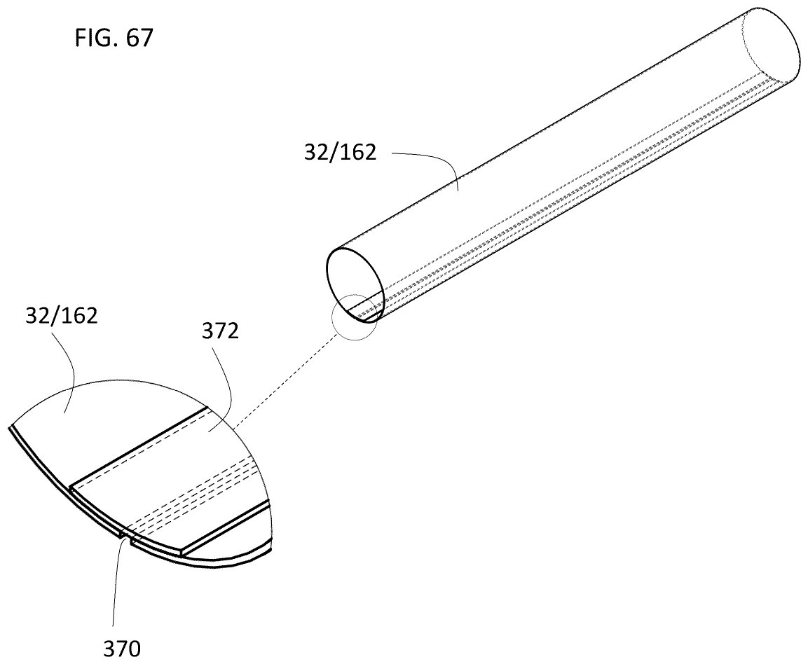

Reference is now made to FIG. 67, which is a schematic illustration of heating element 32 or 162 of a capsule 20 or 150, in accordance with some applications of the present invention. Reference is also made to FIGS. 68A, 68B, 68C, and 68D, which are schematic illustrations of capsule 20/150, in accordance with some applications of the present invention. As described hereinabove, capsule 20/150 typically includes heating element 32/162, which is typically a metallic foil (e.g., stainless steel foil, nickel-titanium foil, titanium foil, copper foil, aluminum foil, steel foil). For some applications, paper covering 34 covers at least a portion of the capsule. In some applications, the paper covering is adhered to itself along a band of overlap, such as to form a cylindrical shape, thereby making the capsule airtight (and thereby ensuring airflow in the axial direction of the cylindrical capsule). For some applications, the capsule includes a filter 171.

For some applications, metallic foil (acting as heating element 32/162) is adhered to the inside of the paper covering. For some applications, the metallic foil overlaps with itself, as described hereinabove. For some applications, the extent of overlap of the paper covering and that of the metallic foil are not the same as each other. For some applications, the metallic foil does not overlap with itself at all, as shown in FIG. 67. Typically, for such applications, the metallic foil still encompasses the full circumference of the capsule, by the two sides of the metallic foil contacting each other (but without overlapping with each other), such that a uniform resistance is provided by the metallic foil around the circumference of the capsule. For some applications, there is a gap 370 between the two edges of the foil, but the gap is small enough that it does not affect the uniformity of the resistance that is provided by the metallic foil around the circumference of the capsule in a substantial manner. For example, the gap may be less than 1 mm, or less than 0.5 mm. For some applications, an inner lining strip 372 is used to hold the two sides of the metallic foil in place and to seal the capsule and make it airtight. Typically, the inner lining strip is a strip of heat-resistant adhesive (e.g., a strip of polyimide) running along the length of a portion of the capsule.

Typically, at regions 374 at which the electrodes are configured to contact the capsule, paper covering 34 does not cover metallic foil 32/162, such that the metallic foil is exposed to the electrodes and the electrodes are able to make electrical contact with the metallic foil.

As shown in FIGS. 68C-68D, for some applications, at least within regions 374 at which the electrodes are configured to contact the capsule, the capsule includes collapse-prevention elements 376. For some applications, the capsule includes collapse-prevention elements 376 only within regions 374 at which the electrodes are configured to contact the capsule. For some applications, collapse-prevention elements 376 are similar to those described hereinabove. Typically, collapse-prevention elements 376 are configured to enable good electrical connection between the electrodes and the metallic foil even in the event that there is volume loss that occurs upon vaporization of the smoking material within the capsule. For some applications, collapse-prevention elements 376 are tubular elements. For some such applications, collapse-prevention elements 376 include a combination of hard and soft layers of material. For some applications, an outer layer of collapse-prevention elements 376 is softer (i.e., more compressible) than an inner layer of collapse-prevention elements 376. Typically, the compressibility of the outer layer of collapse-prevention elements 376 allows the spring electrodes to push the foil into the compressible outer layer thereby increasing the surface area of electrical connection between the electrodes and the metallic foil.

### EXAMPLES

In accordance with the above disclosure, the following examples of applications of the present invention are provided. It is noted that the scope of the present disclosure includes combining any of the following examples with each other and/or with any other examples of applications of the present invention that are described hereinabove.

Example 1. Apparatus for use with a smoking device that includes at least first and second electrodes, the apparatus comprising:
a capsule comprising:
   an absorbent material having a liquid material containing one or more active agents absorbed therein;
   a housing disposed around the absorbent material, the housing being an electrical insulator, and the housing defining one or more lateral windows; and
   metallic foil surrounding the housing, the metallic foil being configured to be heated via resistive heating by the first electrode driving a current to the second electrode through the metallic foil, such as to vaporize liquid material within the absorbent material that is disposed at the one or more lateral windows.

Example 2. The apparatus according to example 1, wherein the housing is impermeable to the liquid material, apart from at the one or more lateral windows.

Example 3. The apparatus according to example 1, wherein the housing is partially permeable to the liquid material, apart from at the one or more lateral windows.

Example 4. The apparatus according to example 1, wherein the capsule is configured such that the metallic foil contacts the first and second electrodes at locations that are remote from each of the one or more lateral windows.

Example 5. The apparatus according to example 1, wherein the capsule is configured such that airflow through the capsule is substantially in an axial direction along a length of the capsule. Example 6. The apparatus according to example 1, wherein the capsule further comprises a paper covering that covers the metallic foil, the paper covering defining openings via which the electrodes are configured to make electrical contact with the metallic foil.

Example 7. The apparatus according to example 1, wherein the metallic foil comprises a plurality of regions, each of the regions having a respective, different electrical resistance profile, such that upon a given current being driven through the metallic foil each of the regions heats to a respective, different temperature.

Example 8. The apparatus according to example 1, wherein the capsule further comprises an electrical-contact coating that coats the metallic foil at locations at which the electrodes are configured to contact the capsule.

Example 9. The apparatus according to example 1, wherein the metallic foil has a first configuration at locations at which the electrodes are configured to contact the metallic foil, and a second configuration along a region in which the metallic foil contact the layer of absorbent material that is between the locations at which the electrodes are configured to contact the metallic foil.

Example 10. The apparatus according to example 1, wherein the capsule further comprises an inner lining that lines an inside of the metallic foil, the inner lining being configured to diffuse heat that is generated by the metallic foil.

Example 11. The apparatus according to example 1, wherein the smoking device includes one or more batteries, and wherein an overall resistance to the current that is provided by the capsule is configured to substantially match an internal resistance of the one or more batteries of the smoking device.

Example 12. The apparatus according to example 1, wherein the capsule is shaped to define a cross-sectional shape having a ratio of more than 2:1 between a long side of the cross-sectional shape and a short side of the cross-sectional shape.

Example 13. The apparatus according to any one of examples 1-12, wherein at least a portion of the capsule is configured to be flattened by the smoking device prior to the metallic foil being heated by the smoking device.

Example 14. The apparatus according to example 13, wherein the capsule has a circular cross-sectional shape and is configured to be flattened to define a non-circular cross-sectional shape.

Example 15. The apparatus according to example 13, wherein the capsule is configured to be flattened such as to define a cross-sectional shape having a ratio of more than 2:1 between a long side of the cross-sectional shape and a short side of the cross-sectional shape.

Example 16. The apparatus according to example 13, wherein the absorbent material is configured such that the liquid material flows toward the one or more lateral windows via capillary flow.

Example 17. The apparatus according to example 16, wherein the absorbent material is configured such that the flattening of the portion of the capsule increases capillary flow of the liquid material through the absorbent material.

Example 18. The apparatus according to any one of examples 1-12, wherein the metallic foil has a thickness of between 1 micron and 20 microns.

Example 19. The apparatus according to example 18, wherein the metallic foil has a thickness of between 3 microns and 10 microns.

Example 20. The apparatus according to any one of examples 1-12, wherein the metallic foil is configured to be heated via resistive heating by the first electrode driving a current to the second electrode along a length of more than 5 mm in an axial direction along the metallic foil.

Example 21. The apparatus according to example 20, wherein the metallic foil is configured to be heated via resistive heating by the first electrode driving a current to the second electrode along a length of more than 15 mm in the axial direction along the metallic foil.

Example 22. The apparatus according to any one of examples 1-12, wherein the capsule comprises an elongate capsule having a length of between 15 mm and 150 mm.

Example 23. The apparatus according to example 22, wherein the elongate capsule has a length of between 50 mm and 90 mm.

Example 24. Apparatus for use with a smoking device that includes at least first and second electrodes, the apparatus comprising:
a capsule comprising:
   a reservoir containing a liquid material containing one or more active agents absorbed therein;
   a housing disposed around the absorbent material, the housing being an electrical insulator, and the housing defining one or more lateral windows;
   an absorbent material extending from the reservoir to the one or more lateral windows, the absorbent material being configured to transport the liquid material from the reservoir to the one or more lateral windows via capillary forces; and
   metallic foil surrounding the housing, the metallic foil being configured to be heated via resistive heating by the first electrode driving a current to the second electrode through the metallic foil, such as to vaporize liquid material within the absorbent material that is disposed at the one or more lateral windows.

Example 25. The apparatus according to example 24, wherein the housing is impermeable to the liquid material, apart from at the one or more lateral windows.

Example 26. The apparatus according to example 24, wherein the housing is partially permeable to the liquid material, apart from at the one or more lateral windows.

Example 27. The apparatus according to example 24, wherein the capsule is configured such that the metallic foil contacts the first and second electrodes at locations that are remote from each of the one or more lateral windows.

Example 28. The apparatus according to example 24, wherein the capsule is configured such that airflow through the capsule is substantially in an axial direction along a length of the capsule.

Example 29. The apparatus according to example 24, wherein the capsule further comprises a paper covering that covers the metallic foil, the paper covering defining openings via which the electrodes are configured to make electrical contact with the metallic foil.

Example 30. The apparatus according to example 24, wherein the metallic foil comprises a plurality of regions, each of the regions having a respective, different electrical resistance profile, such that upon a given current being driven through the metallic foil each of the regions heats to a respective, different temperature.

Example 31. The apparatus according to example 24, wherein the capsule further comprises an electrical-contact coating that coats the metallic foil at locations at which the electrodes are configured to contact the capsule.

Example 32. The apparatus according to example 24, wherein the metallic foil has a first configuration at locations at which the electrodes are configured to contact the metallic foil, and a second configuration along a region in which the metallic foil contact the layer of absorbent material that is between the locations at which the electrodes are configured to contact the metallic foil.

Example 33. The apparatus according to example 24, wherein the capsule further comprises an inner lining that lines an inside of the metallic foil, the inner lining being configured to diffuse heat that is generated by the metallic foil.

Example 34. The apparatus according to example 24, wherein the smoking device includes one or more batteries, and wherein an overall resistance to the current that is provided by the capsule is configured to substantially match an internal resistance of the one or more batteries of the smoking device.

Example 35. The apparatus according to example 24, wherein the capsule is shaped to define a cross-sectional shape having a ratio of more than 2:1 between a long side of the cross-sectional shape and a short side of the cross-sectional shape.

Example 36. The apparatus according to any one of examples 24-35, wherein at least a portion of the capsule is configured to be flattened by the smoking device prior to the metallic foil being heated by the smoking device.

Example 37. The apparatus according to example 36, wherein the capsule has a circular cross-sectional shape and is configured to be flattened to define a non-circular cross-sectional shape.

Example 38. The apparatus according to example 36, wherein the capsule is configured to be flattened such as to define a cross-sectional shape having a ratio of more than 2:1 between a long side of the cross-sectional shape and a short side of the cross-sectional shape.

Example 39. The apparatus according to example 36, wherein the absorbent material is configured such that the flattening of the portion of the capsule increases capillary flow of the liquid material through the absorbent material.

Example 40. The apparatus according to any one of examples 24-35, wherein the metallic foil has a thickness of between 1 micron and 20 microns.

Example 41. The apparatus according to example 40, wherein the metallic foil has a thickness of between 3 microns and 10 microns.

Example 42. The apparatus according to any one of examples 24-35, wherein the metallic foil is configured to be heated via resistive heating by the first electrode driving a current to the second electrode along a length of more than 5 mm in an axial direction along the metallic foil.

Example 43. The apparatus according to example 42, wherein the metallic foil is configured to be heated via resistive heating by the first electrode driving a current to the second electrode along a length of more than 15 mm in the axial direction along the metallic foil.

Example 44. The apparatus according to any one of examples 24-35, wherein the capsule comprises an elongate capsule having a length of between 15 mm and 150 mm.

Example 45. The apparatus according to example 44, wherein the elongate capsule has a length of between 50 mm and 90 mm.

Example 46. Apparatus for use with a smoking device that includes a non-contact temperature sensor, the apparatus comprising:
an elongate capsule comprising:
   a smoking material containing one or more active agents; and
   one or more heating elements disposed within the capsule, the one or more heating elements being configured to vaporize one or more of the active agents from within the smoking material, by the one or more heating elements being heated by the smoking device,
   wherein, at least when the one or more heating elements are being heated by the smoking device, a portion of the capsule that is configured to be adjacent to the temperature sensor is configured to have a flattened cross-sectional shape such as to facilitate temperature sensing of the capsule by the non-contact temperature sensor.

Example 47. The apparatus according to example 46, wherein the elongate capsule is configured for use with a smoking device comprising an infrared temperature sensor.

Example 48. The apparatus according to example 46, wherein at the portion of the capsule that is configured to be adjacent to the temperature sensor the capsule comprises a coating having an emissivity value of at least 0.5.

Example 49. The apparatus according to example 46, wherein, at least when the one or more heating elements are being heated by the smoking device, the portion of the capsule is configured such as to define a flattened cross-sectional shape having a ratio of more than 2:1 between a long side of the cross-sectional shape and a short side of the cross-sectional shape.

Example 50. The apparatus according to example 46, wherein the elongate capsule is manufactured such that the portion of the capsule that is configured to be adjacent to the temperature sensor is configured to have a flattened cross-sectional shape.

Example 51. The apparatus according to example 46, wherein the one or more heating elements comprise one or more magnetically-heated materials that are susceptible to being heated by a magnetic field.

Example 52. The apparatus according to example 46, wherein the smoking material comprises a plant-based smoking material and the one or more of the active agents are configured to be vaporized from within the plant-based smoking material by heating the plant-based smoking material.

Example 53. The apparatus according to any one of examples 46-52, wherein the smoking material comprises a liquid material and the one or more of the active agents are configured to be vaporized from within the liquid material by the liquid material being vaporized.

Example 54. The apparatus according to example 53, wherein the flattened cross-sectional shape of the portion of the capsule is configured to drive the liquid material toward a region within the capsule at which the liquid material is vaporized.

Example 55. The apparatus according to any one of examples 46-52, wherein the elongate capsule is manufactured such as to define a cylindrical shape and wherein the portion of the capsule is configured to be flattened by the smoking device, prior to the one or more heating elements being heated by the smoking device.

Example 56. The apparatus according to example 55, wherein the one or more heating elements comprise one or more magnetically-heated materials that are susceptible to being heated by a magnetic field.

Example 57. The apparatus according to example 56, wherein the portion of the capsule is configured to be inserted into a coil that has a non-circular cross-sectional shape.

Example 58. The apparatus according to example 56, wherein the portion of the capsule is configured to be flattened while the portion of the capsule is disposed within a coil.

Example 59. The apparatus according to example 55, wherein the one or more heating elements comprise a metallic foil that is configured to be heated via resistive heating.

Example 60. The apparatus according to example 59, wherein the smoking device includes two or more electrodes that are configured to drive an electrical current through the metallic foil, and wherein the capsule is configured to be flattened by the two or more electrodes.

Example 61. The apparatus according to example 59, wherein at the portion of the capsule that is configured to be adjacent to the temperature sensor, the metallic foil is treated such as to have an emissivity value of at least 0.5.

Example 62. The apparatus according to any one of examples 46-52, wherein the one or more heating elements comprise a metallic foil that is configured to be heated via resistive heating.

Example 63. The apparatus according to example 62, wherein the metallic foil has a thickness of between 1 micron and 20 microns.

Example 64. The apparatus according to example 63, wherein the metallic foil has a thickness of between 3 microns and 10 microns.

Example 65. The apparatus according to any one of examples 46-52, wherein the elongate capsule has a length of between 15 mm and 150 mm.

Example 66. The apparatus according to example 65, wherein the elongate capsule has a length of between 50 mm and 90 mm.

Example 67. Apparatus for use with a capsule that contains a smoking material containing one or more active agents, the apparatus comprising:
a smoking device configured to vaporize one or more of the active agents from within the smoking material by heating the smoking material, the smoking device:
comprising at least one non-contact sensor configured to detect temperature of the smoking material within the capsule; and
being configured to flatten a portion of the capsule that is configured to be adjacent to the non-contact sensor.

Example 68. The apparatus according to example 67, wherein the smoking device is configured to flatten the portion of the capsule that is configured to be adjacent to the non-contact sensor such that the portion of the capsule that is configured to be adjacent to the non-contact sensor defines a cross-sectional shape having a ratio of more than 2:1 between a long side of the cross-sectional shape and a short side of the cross-sectional shape.

Example 69. The apparatus according to example 67, wherein the smoking device comprises mechanical elements that are configured to flatten the portion of the capsule that is configured to be adjacent to the non-contact sensor by applying mechanical pressure to the capsule.

Example 70. The apparatus according to example 67, wherein the non-contact sensor comprises an infrared temperature sensor.

Example 71. The apparatus according to example 67, wherein the smoking device is configured for use with a capsule that contains a plant-based smoking material and the smoking device is configured vaporize one or more of the active agents from within the plant-based smoking material by heating the plant-based smoking material.

Example 72. The apparatus according to example 67, wherein the smoking device comprises a control component configured to:
receive an indication from a user indicating whether they wish to smoke the active agents in a first mode or a second mode;
in response to receiving an indication that the user wishes to smoke the active agents in the first mode, heat the smoking material to a vaporization temperature of the one or more active agents for a predefined period of time; and
in response to receiving an indication that the user wishes to smoke the active agents in the second mode, only heat the smoking material to the vaporization temperature while receiving an active input from the user that they wish for the smoking material to be heated.

Example 73. The apparatus according to any one of examples 67-72, wherein the smoking device is configured for use with a capsule that contains a liquid material and the smoking device is configured to vaporize one or more of the active agents from within the liquid material by vaporizing the liquid material.

Example 74. The apparatus according to example 73, wherein the smoking device is configured to drive the liquid material toward a region within the capsule at which the liquid material is vaporized by flattening the portion of the capsule that is configured to be adjacent to the non-contact sensor.

Example 75. The apparatus according to any one of examples 67-72, wherein the smoking device comprises a control component configured to determine a temperature of the smoking material based upon the temperature detected by the sensor.

Example 76. The apparatus according to example 75, wherein the control component is configured to control heating of the smoking material in response to the determined temperature of the smoking material.

Example 77. The apparatus according to example 76, wherein the control component is configured to control heating of the smoking material such as to maintain the smoking material within a predefined temperature range.

Example 78. The apparatus according to any one of examples 67-72, wherein the smoking device comprises two or more electrodes that are configured to heat the smoking material by generating resistive heating within the capsule by driving a current through a portion of the capsule.

Example 79. The apparatus according to example 78, wherein the smoking device comprises a mechanism configured to bring the electrodes into pressurized contact with the capsule, in order to enhance electrical contact between the electrodes and the capsule.

Example 80. The apparatus according to example 78, wherein the smoking device is configured to receive an elongate capsule, wherein during the heating of the smoking material, the smoking device is configured to house the capsule such that airflow through the capsule is substantially along a length of the elongate capsule, and wherein a first one of the electrodes is configured to drive a current toward a second one of the electrodes along a length of more than 5 mm in an axial direction along a length of the capsule.

Example 81. The apparatus according to example 80, wherein the first one of the electrodes is configured to drive the current toward the second one of the electrodes along a length of more than 15 mm in the axial direction along the length of the capsule.

Example 82. The apparatus according to example 78, wherein the smoking device is configured to receive a capsule that includes a metallic foil surrounding the smoking material, and the electrodes are configured to drive the current through the metallic foil.

Example 83. The apparatus according to example 82, wherein the smoking device is configured to receive a capsule that includes a metallic foil surrounding the smoking material and a paper covering that covers the metallic foil, and wherein the electrodes are needle shaped and are configured to make electrical contact with the metallic foil by piercing through the paper covering.

Example 84. The apparatus according to any one of examples 67-72, wherein the smoking device comprises a coil that is configured to heat the smoking material by generating a magnetic field such as to heat the capsule via magnetic induction.

Example 85. The apparatus according to example 84, wherein the coil is configured to be flattened while the portion of the capsule that is configured to be adjacent to the non-contact sensor is disposed within the coil.

Example 86. The apparatus according to example 84, wherein the coil is shaped to define a non-circular cross-sectional shape even before the portion of the capsule that is configured to be adjacent to the non-contact sensor is introduced to within the coil, and wherein the smoking device is configured to flatten the portion of the capsule that is configured to be adjacent to the non-contact sensor prior to the portion of the capsule that is configured to be adjacent to the non-contact sensor being introduced to within the coil.

Example 87. The apparatus according to any one of examples 67-72, wherein the smoking device is configured to receive a cylindrically-shaped elongate capsule having a length of between 15 mm and 150 mm.

Example 88. The apparatus according to example 87, wherein the smoking device is configured to receive a cylindrically-shaped elongate capsule having a length of between 50 mm and 90 mm.

Example 89. Apparatus for use with a smoking device, the apparatus comprising:
a capsule comprising:
   a smoking material containing one or more active agents;
   one or more heating elements disposed within the capsule, the one or more heating elements being configured to vaporize one or more of the active agents from within the smoking material, by the one or more heating elements being heated by the smoking device; and
   a mouthpiece defining an opening therethrough, the mouthpiece comprising a first portion that is shaped cylindrically via which a user is configured to draw vaporized active agents from the capsule into a mouth of the user, and a second portion being shaped as a cone with a narrow end of the cone adjacent to the smoking material such as to prevent solid matter from passing from the capsule into the user's mouth.

Example 90. The apparatus according to example 89, wherein the mouthpiece comprises paper that is shaped to define the first and second portions of the mouthpiece.

Example 91. The apparatus according to example 89, wherein the second portion of the mouthpiece is shaped such that a diameter of the opening through the mouthpiece at the narrow end of the cone is between 1 mm and 3 mm.

Example 92. The apparatus according to example 89, wherein the second portion of the mouthpiece is sized such as to provide a desired level of resistance to airflow through the mouthpiece.

Example 93. The apparatus according to example 89, wherein the one or more heating elements comprise one or more magnetically-heated materials that are susceptible to being heated by a magnetic field.

Example 94. The apparatus according to example 89, wherein the smoking material comprises a plant-based smoking material and the one or more of the active agents are configured to be vaporized from within the plant-based smoking material by heating the plant-based smoking material.

Example 95. The apparatus according to example 89, wherein the smoking material comprises a liquid material and the one or more of the active agents are configured to be vaporized from within the liquid material by the liquid material being vaporized.

Example 96. The apparatus according to example 89, wherein the one or more heating elements comprise one or more magnetically-heated materials that are susceptible to being heated by a magnetic field.

Example 97. The apparatus according to any one of examples 89-96, wherein the elongate capsule is manufactured such as to define a cylindrical shape and wherein a portion of the capsule is configured to be flattened by the smoking device, prior to the one or more heating elements being heated by the smoking device.

Example 98. The apparatus according to example 97, wherein the one or more heating elements comprise one or more magnetically-heated materials that are susceptible to being heated by a magnetic field.

Example 99. The apparatus according to example 98, wherein the portion of the capsule is configured to be inserted into a coil that has a non-circular cross-sectional shape.

Example 100. The apparatus according to example 98, wherein the portion of the capsule is configured to be flattened while the portion of the capsule is disposed within a coil.

Example 101. The apparatus according to example 97, wherein the one or more heating elements comprise a metallic foil that is configured to be heated via resistive heating.

Example 102. The apparatus according to example 101, wherein the smoking device includes two or more electrodes that are configured to drive an electrical current through the metallic foil, and wherein the capsule is configured to be flattened by the two or more electrodes.

Example 103. The apparatus according to any one of examples 89-96, wherein the one or more heating elements comprise a metallic foil that is configured to be heated via resistive heating.

Example 104. The apparatus according to example 103, wherein the metallic foil has a thickness of between 1 micron and 20 microns.

Example 105. The apparatus according to example 104, wherein the metallic foil has a thickness of between 3 microns and 10 microns.

Example 106. The apparatus according to any one of examples 89-96, wherein the capsule comprises an elongate capsule having a length of between 15 mm and 150 mm.

Example 107. The apparatus according to example 106, wherein the elongate capsule has a length of between 50 mm and 90 mm.

Example 108. Apparatus for use with a smoking device that includes at least first and second electrodes, the apparatus comprising:
a capsule defining an airway therethrough, the capsule comprising:
   a first axial portion comprising a reservoir containing a liquid material containing one or more active agents;
   a second axial portion comprising:
      a layer of absorbent material configured such that liquid material flows along the layer from the reservoir via capillary forces; and
      metallic foil surrounding the layer of absorbent material, the metallic foil being configured to be heated via resistive heating by the first electrode driving a current to the second electrode through the metallic foil, such as to vaporize liquid material within the layer of absorbent material.

Example 109. The apparatus according to example 108, wherein the layer of absorbent material has a non-uniform thickness, with the thickness of the layer of absorbent material varying along a length of the second axial portion of the capsule.

Example 110. The apparatus according to example 108, wherein the layer of absorbent material defines holes therethrough to facilitate airflow from through the layer of absorbent material into the airway.

Example 111. The apparatus according to example 108, wherein the metallic foil contacts the layer of absorbent material only at selected regions, and only the selected regions of the layer of absorbent material are configured by be heated by the metallic foil.

Example 112. The apparatus according to example 108, wherein the layer of absorbent material is shaped to define one or more airflow passages along a perimeter of the layer of absorbent material.

Example 113. The apparatus according to example 108, wherein the reservoir comprises a reservoir of absorbent material that has absorbed the liquid material.

Example 114. The apparatus according to example 108, wherein the reservoir comprises a solid housing containing the liquid material in an unabsorbed form.

Example 115. The apparatus according to example 108, wherein the capsule further comprises a third axial portion comprising a mouthpiece configured such that a user can draw the vaporized liquid material from the capsule via the mouthpiece, wherein the second axial portion is disposed between the first axial portion and the second axial portion.

Example 116. The apparatus according to example 108, wherein the first axial portion is shaped to define a mouthpiece configured such that a user can draw the vaporized liquid material from the capsule via the mouthpiece, wherein the second axial portion is disposed between the first axial portion and the second axial portion.

Example 117. The apparatus according to example 108, wherein the metallic foil is configured to be heated via resistive heating by the first electrode driving a current to the second electrode along a length of more than 5 mm in an axial direction along the metallic foil.

Example 118. The apparatus according to example 108, wherein the capsule is configured such that airflow through the capsule is substantially in an axial direction along a length of the capsule.

Example 119. The apparatus according to example 108, wherein the metallic foil is configured to be heated via resistive heating by the first electrode driving a current to the second electrode along a length of more than 15 mm in the axial direction along the metallic foil.

Example 120. The apparatus according to example 108, wherein the capsule further comprises a paper covering that covers the metallic foil, the paper covering defining openings via which the electrodes are configured to make electrical contact with the metallic foil.

Example 121. The apparatus according to example 108, wherein the metallic foil comprises a plurality of regions, each of the regions having a respective, different electrical resistance profile, such that upon a given current being driven through the metallic foil each of the regions heats to a respective, different temperature.

Example 122. The apparatus according to example 108, wherein the capsule further comprises an electrical-contact coating that coats the metallic foil at locations at which the electrodes are configured to contact the capsule.

Example 123. The apparatus according to example 108, wherein the metallic foil has a first configuration at locations at which the electrodes are configured to contact the metallic foil, and a second configuration along a region in which the metallic foil contact the layer of absorbent material that is between the locations at which the electrodes are configured to contact the metallic foil.

Example 124. The apparatus according to example 108, wherein the capsule further comprises an inner lining that lines an inside of the metallic foil, the inner lining being configured to diffuse heat that is generated by the metallic foil.

Example 125. The apparatus according to example 108, wherein the smoking device includes one or more batteries, and wherein an overall resistance to the current that is provided by the capsule is configured to substantially match an internal resistance of the one or more batteries of the smoking device.

Example 126. The apparatus according to example 108, wherein the capsule is shaped to define a cross-sectional shape having a ratio of more than 2:1 between a long side of the cross-sectional shape and a short side of the cross-sectional shape.

Example 127. The apparatus according to any one of examples 108-126, wherein at least a portion of the capsule is configured to be flattened by the smoking device prior to the metallic foil being heated by the smoking device.

Example 128. The apparatus according to example 127, wherein the layer of absorbent material is configured such that the flattening of the portion of the capsule increases capillary flow of the liquid material through the layer of absorbent material.

Example 129. The apparatus according to example 127, wherein the capsule has a circular cross-sectional shape and is configured to be flattened to define a non-circular cross-sectional shape.

Example 130. The apparatus according to example 127, wherein the capsule is configured to be flattened such as to define a cross-sectional shape having a ratio of more than 2:1 between a long side of the cross-sectional shape and a short side of the cross-sectional shape.

Example 131. The apparatus according to any one of examples 108-126, wherein the metallic foil has a thickness of between 1 micron and 20 microns.

Example 132. The apparatus according to example 131, wherein the metallic foil has a thickness of between 3 microns and 10 microns.

Example 133. The apparatus according to any one of examples 108-126, wherein the layer of absorbent material has a thickness of between 0.1 mm and 3 mm.

Example 134. The apparatus according to example 133, wherein the layer of absorbent material has a thickness of between 0.2 mm and 1 mm.

Example 135. The apparatus according to any one of examples 108-126, wherein the capsule comprises an elongate capsule having a length of between 15 mm and 150 mm.

Example 136. The apparatus according to example 135, wherein the elongate capsule has a length of between 50 mm and 90 mm.

Example 137. Apparatus for use with a smoking device, the apparatus comprising:
a capsule defining an airway therethrough, the capsule comprising:
   a first axial portion comprising a reservoir containing a liquid material containing one or more active agents;
   a second axial portion comprising a layer of absorbent material configured such that liquid material flows along the layer from the reservoir via capillary forces, wherein:
      the layer of absorbent material is configured by be heated by the smoking device, such as to vaporize liquid material within the layer of absorbent material; and
      the layer of absorbent material defines holes therethrough to facilitate airflow from through the layer of into the airway.

Example 138. The apparatus according to example 137, wherein the layer of absorbent material has a non-uniform thickness, with the thickness of the layer of absorbent material varying along a length of the second axial portion of the capsule.

Example 139. The apparatus according to example 137, wherein only selected regions of the layer of absorbent material are configured by be heated by the smoking device, such as to vaporize liquid material within the layer of absorbent material.

Example 140. The apparatus according to example 137, wherein the layer of absorbent material is shaped to define one or more airflow passages along a perimeter of the layer of absorbent material.

Example 141. The apparatus according to example 137, wherein the reservoir comprises a reservoir of absorbent material that has absorbed the liquid material.

Example 142. The apparatus according to example 137, wherein the reservoir comprises a solid housing containing the liquid material in an unabsorbed form.

Example 143. The apparatus according to example 137, wherein the capsule further comprises a third axial portion comprising a mouthpiece configured such that a user can draw the vaporized liquid material from the capsule via the mouthpiece, wherein the second axial portion is disposed between the first axial portion and the second axial portion.

Example 144. The apparatus according to example 137, wherein the first axial portion is shaped to define a mouthpiece configured such that a user can draw the vaporized liquid material from the capsule via the mouthpiece, wherein the second axial portion is disposed between the first axial portion and the second axial portion.

Example 145. The apparatus according to example 137, wherein the capsule is configured such that airflow through the capsule is substantially in an axial direction along a length of the capsule.

Example 146. The apparatus according to example 137, wherein the capsule is shaped to define a cross-sectional shape having a ratio of more than 2:1 between a long side of the cross-sectional shape and a short side of the cross-sectional shape.

Example 147. The apparatus according to any one of examples 137-146, wherein the smoking device includes first and second electrodes, wherein the capsule comprises a metallic foil surrounding the layer of absorbent material, and wherein the metallic foil is configured to be heated via resistive heating by the first electrode driving a current to the second electrode through the metallic foil, such as to vaporize liquid material within the layer of absorbent material.

Example 148. The apparatus according to example 147, wherein the metallic foil is configured to be heated via resistive heating by the first electrode driving a current to the second electrode along a length of more than 5 mm in an axial direction along the metallic foil.

Example 149. The apparatus according to example 147, wherein the metallic foil is configured to be heated via resistive heating by the first electrode driving a current to the second electrode along a length of more than 15 mm in the axial direction along the metallic foil.

Example 150. The apparatus according to example 147, wherein the capsule further comprises a paper covering that covers the metallic foil, the paper covering defining openings via which the electrodes are configured to make electrical contact with the metallic foil.

Example 151. The apparatus according to example 147, wherein the metallic foil comprises a plurality of regions, each of the regions having a respective, different electrical resistance profile, such that upon a given current being driven through the metallic foil each of the regions heats to a respective, different temperature.

Example 152. The apparatus according to example 147, wherein the capsule further comprises an electrical-contact coating that coats the metallic foil at locations at which the electrodes are configured to contact the capsule.

Example 153. The apparatus according to example 147, wherein the metallic foil has a first configuration at locations at which the electrodes are configured to contact the metallic foil, and a second configuration along a region in which the metallic foil contact the layer of absorbent material that is between the locations at which the electrodes are configured to contact the metallic foil.

Example 154. The apparatus according to example 147, wherein the capsule further comprises an inner lining that lines an inside of the metallic foil, the inner lining being configured to diffuse heat that is generated by the metallic foil.

Example 155. The apparatus according to example 147, wherein the smoking device includes one or more batteries, and wherein an overall resistance to the current that is provided by the capsule is configured to substantially match an internal resistance of the one or more batteries of the smoking device.

Example 156. The apparatus according to any one of examples 137-146, wherein the metallic foil has a thickness of between 1 micron and 20 microns.

Example 157. The apparatus according to example 156, wherein the metallic foil has a thickness of between 3 microns and 10 microns.

Example 158. The apparatus according to any one of examples 137-146, wherein at least a portion of the capsule is configured to be flattened by the smoking device prior to the layer of absorbent material being heated by the smoking device.

Example 159. The apparatus according to example 158, wherein the layer of absorbent material is configured such that the flattening of the portion of the capsule increases capillary flow of the liquid material through the layer of absorbent material.

Example 160. The apparatus according to example 158, wherein the capsule has a circular cross-sectional shape and is configured to be flattened to define a non-circular cross-sectional shape.

Example 161. The apparatus according to example 158, wherein the capsule is configured to be flattened such as to define a cross-sectional shape having a ratio of more than 2:1 between a long side of the cross-sectional shape and a short side of the cross-sectional shape.

Example 162. The apparatus according to any one of examples 137-146, wherein the layer of absorbent material has a thickness of between 0.1 mm and 3 mm.

Example 163. The apparatus according to example 162, wherein the layer of absorbent material has a thickness of between 0.2 mm and 1 mm.

Example 164. The apparatus according to any one of examples 137-146, wherein the layer of absorbent material defines holes therethrough with the holes having diameters of between 0.7 mm and 3 mm.

Example 165. The apparatus according to example 164, wherein the layer of absorbent material defines holes therethrough with the holes having diameters of between 1 mm and 2 mm.

Example 166. The apparatus according to any one of examples 137-146, wherein the capsule comprises an elongate capsule having a length of between 15 mm and 150 mm.

Example 167. The apparatus according to example 166, wherein the elongate capsule has a length of between 50 mm and 90 mm.

Example 168. Apparatus for use with a smoking device that includes at least first and second electrodes, the apparatus comprising:
a capsule defining an airway therethrough, the capsule comprising:
a reservoir comprising a liquid material containing one or more active agents, the liquid material being absorbed within an absorbent material; and
metallic foil surrounding the reservoir, the metallic foil being configured to be heated via resistive heating by the first electrode driving a current to the second electrode through the metallic foil, such as to vaporize liquid material within the absorbent material within the reservoir,
   wherein only selected regions of the absorbent material within the reservoir are configured by be heated by the smoking device, such as to vaporize liquid material within the absorbent material within the reservoir.

Example 169. The apparatus according to example 168, wherein the absorbent material within the reservoir has a non-uniform thickness, with the thickness of the layer of absorbent material varying along a length of the reservoir.

Example 170. The apparatus according to example 168, wherein the absorbent material within the reservoir defines holes therethrough to facilitate airflow from through the layer of absorbent material into the airway.

Example 171. The apparatus according to example 168, wherein the absorbent material within the reservoir is shaped to define one or more airflow passages along a perimeter of the absorbent material within the reservoir.

Example 172. The apparatus according to example 168, wherein the capsule is configured such that airflow through the capsule is substantially in an axial direction along a length of the capsule.

Example 173. The apparatus according to example 168, wherein the capsule is shaped to define a cross-sectional shape having a ratio of more than 2:1 between a long side of the cross-sectional shape and a short side of the cross-sectional shape.

Example 174. The apparatus according to example 168, wherein the capsule further comprises a paper covering that covers the metallic foil, the paper covering defining openings via which the electrodes are configured to make electrical contact with the metallic foil.

Example 175. The apparatus according to example 168, wherein the metallic foil comprises a plurality of regions, each of the regions having a respective, different electrical resistance profile, such that upon a given current being driven through the metallic foil each of the regions heats to a respective, different temperature.

Example 176. The apparatus according to example 168, wherein the capsule further comprises an electrical-contact coating that coats the metallic foil at locations at which the electrodes are configured to contact the capsule.

Example 177. The apparatus according to example 168, wherein the metallic foil has a first configuration at locations at which the electrodes are configured to contact the metallic foil, and a second configuration along a region in which the metallic foil contacts the layer of absorbent material that is between the locations at which the electrodes are configured to contact the metallic foil.

Example 178. The apparatus according to example 168, wherein the capsule further comprises an inner lining that lines an inside of the metallic foil, the inner lining being configured to diffuse heat that is generated by the metallic foil.

Example 179. The apparatus according to example 168, wherein the smoking device includes one or more batteries, and wherein an overall resistance to the current that is provided by the capsule is configured to substantially match an internal resistance of the one or more batteries of the smoking device.

Example 180. The apparatus according to any one of examples 168-179, wherein the metallic foil is configured to be heated via resistive heating by the first electrode driving a current to the second electrode along a length of more than 5 mm in an axial direction along the metallic foil.

Example 181. The apparatus according to example 180, wherein the metallic foil is configured to be heated via resistive heating by the first electrode driving a current to the second electrode along a length of more than 15 mm in the axial direction along the metallic foil.

Example 182. The apparatus according to any one of examples 168-179, wherein at least a portion of the capsule is configured to be flattened by the smoking device prior to the layer of absorbent material being heated by the smoking device.

Example 183. The apparatus according to example 182, wherein absorbent material within the reservoir is configured such that the flattening of the portion of the capsule increases capillary flow of the liquid material through the absorbent material within the reservoir.

Example 184. The apparatus according to example 182, wherein the capsule has a circular cross-sectional shape and is configured to be flattened to define a non-circular cross-sectional shape.

Example 185. The apparatus according to example 182, wherein the capsule is configured to be flattened such as to define a cross-sectional shape having a ratio of more than 2:1 between a long side of the cross-sectional shape and a short side of the cross-sectional shape.

Example 186. The apparatus according to any one of examples 168-179, wherein the metallic foil has a thickness of between 1 micron and 20 microns.

Example 187. The apparatus according to example 186, wherein the metallic foil has a thickness of between 3 microns and 10 microns.

Example 188. The apparatus according to any one of examples 168-179, wherein the absorbent material within the reservoir has a thickness of between 0.1 mm and 3 mm.

Example 189. The apparatus according to example 188, wherein the absorbent material within the reservoir has a thickness of between 0.2 mm and 1 mm.

Example 190. The apparatus according to any one of examples 168-179, wherein the capsule comprises an elongate capsule having a length of between 15 mm and 150 mm.

Example 191. The apparatus according to example 190, wherein the elongate capsule has a length of between 50 mm and 90 mm.

Example 192. Apparatus for use with a smoking device that includes at least first and second electrodes, the apparatus comprising:
a capsule defining an airway therethrough, the capsule comprising:
a reservoir comprising a liquid material containing one or more active agents, the liquid material being absorbed within an absorbent material; and
metallic foil surrounding the reservoir, the metallic foil being configured to be heated via resistive heating by the first electrode driving a current to the second electrode through the metallic foil, such as to vaporize liquid material within the absorbent material within the reservoir,
the absorbent material within the reservoir being shaped to define one or more airflow channels along a perimeter of the layer of absorbent material.

Example 193. The apparatus according to example 192, wherein the absorbent material within the reservoir has a non-uniform thickness, with the thickness of the absorbent material within the reservoir varying along a length of the reservoir.

Example 194. The apparatus according to example 192, wherein the absorbent material within the reservoir defines holes therethrough to facilitate airflow through the reservoir into the airway.

Example 195. The apparatus according to example 192, wherein only selected regions of the absorbent material within the reservoir are configured by be heated by the metallic foil, such as to vaporize liquid material within the absorbent material within the reservoir.

Example 196. The apparatus according to example 192, wherein the capsule is configured such that airflow through the capsule is substantially in an axial direction along a length of the capsule.

Example 197. The apparatus according to example 192, wherein the capsule is shaped to define a cross-sectional shape having a ratio of more than 2:1 between a long side of the cross-sectional shape and a short side of the cross-sectional shape.

Example 198. The apparatus according to example 192, wherein the capsule further comprises a paper covering that covers the metallic foil, the paper covering defining openings via which the electrodes are configured to make electrical contact with the metallic foil.

Example 199. The apparatus according to example 192, wherein the metallic foil comprises a plurality of regions, each of the regions having a respective, different electrical resistance profile, such that upon a given current being driven through the metallic foil each of the regions heats to a respective, different temperature.

Example 200. The apparatus according to example 192, wherein the capsule further comprises an electrical-contact coating that coats the metallic foil at locations at which the electrodes are configured to contact the capsule.

Example 201. The apparatus according to example 192, wherein the metallic foil has a first configuration at locations at which the electrodes are configured to contact the metallic foil, and a second configuration along a region in which the metallic foil contacts the layer of absorbent material that is between the locations at which the electrodes are configured to contact the metallic foil.

Example 202. The apparatus according to example 192, wherein the capsule further comprises an inner lining that lines an inside of the metallic foil, the inner lining being configured to diffuse heat that is generated by the metallic foil.

Example 203. The apparatus according to example 192, wherein the smoking device includes one or more batteries, and wherein an overall resistance to the current that is provided by the capsule is configured to substantially match an internal resistance of the one or more batteries of the smoking device.

Example 204. The apparatus according to any one of examples 192-203, wherein the metallic foil is configured to be heated via resistive heating by the first electrode driving a current to the second electrode along a length of more than 5 mm in an axial direction along the metallic foil.

Example 205. The apparatus according to example 204, wherein the metallic foil is configured to be heated via resistive heating by the first electrode driving a current to the second electrode along a length of more than 15 mm in the axial direction along the metallic foil.

Example 206. The apparatus according to any one of examples 192-203, wherein at least a portion of the capsule is configured to be flattened by the smoking device prior to absorbent material within the reservoir being heated by the smoking device.

Example 207. The apparatus according to example 206, wherein the absorbent material within the reservoir is configured such that the flattening of the portion of the capsule increases capillary flow of the liquid material through the absorbent material within the reservoir.

Example 208. The apparatus according to example 206, wherein the capsule has a circular cross-sectional shape and is configured to be flattened to define a non-circular cross-sectional shape.

Example 209. The apparatus according to example 206, wherein the capsule is configured to be flattened such as to define a cross-sectional shape having a ratio of more than 2:1 between a long side of the cross-sectional shape and a short side of the cross-sectional shape.

Example 210. The apparatus according to any one of examples 192-203, wherein the metallic foil has a thickness of between 1 micron and 20 microns.

Example 211. The apparatus according to example 210, wherein the metallic foil has a thickness of between 3 microns and 10 microns.

Example 212. The apparatus according to any one of examples 192-203, wherein the absorbent material within the reservoir has a thickness of between 0.1 mm and 3 mm.

Example 213. The apparatus according to example 212, wherein the absorbent material within the reservoir has a thickness of between 0.2 mm and 1 mm.

Example 214. The apparatus according to any one of examples 192-203, wherein the capsule comprises an elongate capsule having a length of between 15 mm and 150 mm.

Example 215. The apparatus according to example 214, wherein the elongate capsule has a length of between 50 mm and 90 mm.

Example 216. Apparatus for use with a smoking device includes first and second electrodes, the apparatus comprising:
a capsule comprising:
   a reservoir containing a liquid material containing one or more active agents;
   an internal heating element disposed within the capsule the heating element being configured to be heated by the smoking device and to thereby vaporize the liquid material, the internal heating element comprising an electrically-resistive element that is configured to be heated via resistive heating by the first electrode driving a current to the second electrode through the electrically-resistive element; and
   a capillary-force-delivery element extending from the reservoir to the internal heating element configured to transport the liquid material from the reservoir to the internal heating element via capillary forces.

Example 217. The apparatus according to example 216, wherein the capsule comprises a reusable housing, and a disposable component comprising the reservoir and at least a portion of the capillary-force-delivery element.

Example 218. The apparatus according to example 216, wherein the capillary-force-delivery element comprises an absorbent material.

Example 219. The apparatus according to example 216, wherein the capillary-force-delivery element comprises a capillary tube.

Example 220. The apparatus according to example 216, wherein the capsule define an airway therethrough and wherein the capsule is configured such that the vaporized liquid material enters the airway.

Example 221. The apparatus according to example 216, wherein the capsule further comprises a mouthpiece, the capsule defines an opening that is disposed adjacent to the internal heating element, and the capsule defines an airway extending from the opening to the mouthpiece configured such that the vaporized liquid material enters the airway.

Example 222. The apparatus according to example 216, wherein the reservoir comprises a reservoir of absorbent material that has absorbed the liquid material.

Example 223. The apparatus according to example 216, wherein the reservoir comprises a solid housing containing the liquid material in an unabsorbed form.

Example 224. The apparatus according to example 216, wherein the capsule further comprises a mouthpiece configured such that a user can draw the vaporized liquid material from the capsule via the mouthpiece, wherein the reservoir is disposed within the mouthpiece.

Example 225. The apparatus according to example 216, wherein the capsule is configured such that airflow through the capsule is substantially in an axial direction along a length of the capsule.

Example 226. The apparatus according to example 216, wherein the capsule is shaped to define a cross-sectional shape having a ratio of more than 2:1 between a long side of the cross-sectional shape and a short side of the cross-sectional shape.

Example 227. The apparatus according to example 216, wherein the electrically-resistive element comprises a coil.

Example 228. The apparatus according to example 216, wherein the electrically-resistive element comprises a metallic element.

Example 229. The apparatus according to any one of examples 216-228, wherein the capsule comprises a conductive housing and a metallic foil that are electrically insulated from each other and which are electrically coupled to respective ends of the resistive element, wherein the capsule is configured such that, when the capsule is disposed within the smoking device, one of the first and second electrodes is electrically coupled to the conductive housing and the other one of the first and second electrodes is coupled to the metallic foil.

Example 230. The apparatus according to example 229, wherein the metallic foil has a thickness of between 1 micron and 20 microns.

Example 231. The apparatus according to example 230, wherein the metallic foil has a thickness of between 3 microns and 10 microns.

Example 232. The apparatus according to any one of examples 216-228, wherein the capsule comprises first and second metallic foils that are electrically insulated from each other and which are electrically coupled to respective ends of the electrically-resistive element, wherein the capsule is configured such that, when the capsule is disposed within the smoking device, one of the first and second electrodes is electrically coupled to the first metallic foil and the other one of the first and second electrodes is coupled to the second metallic foil.

Example 233. The apparatus according to example 232, wherein each of the first and second metallic foils has a thickness of between 1 micron and 20 microns.

Example 234. The apparatus according to example 233, wherein each of the first and second metallic foils has a thickness of between 3 microns and 10 microns.

Example 235. The apparatus according to any one of examples 216-228, wherein at least a portion of the capsule is configured to be flattened by the smoking device prior to the heating element being heated by the smoking device.

Example 236. The apparatus according to example 235, wherein the capsule has a circular cross-sectional shape and is configured to be flattened to define a non-circular cross-sectional shape.

Example 237. The apparatus according to example 235, wherein the capsule is configured to be flattened such as to define a cross-sectional shape having a ratio of more than 2:1 between a long side of the cross-sectional shape and a short side of the cross-sectional shape.

Example 238. The apparatus according to any one of examples 216-228, wherein the capsule comprises an elongate capsule having a length of between 15 mm and 150 mm.

Example 239. The apparatus according to example 238, wherein the elongate capsule has a length of between 50 mm and 90 mm.

Example 240. Apparatus for use with a smoking device, a capsule housing, and an internal heating element, the apparatus comprising:
a disposable capsule portion configured to be inserted into the capsule housing to thereby form a capsule, the disposable capsule portion comprising:
   a reservoir containing a liquid material containing one or more active agents; and
   a capillary-force-delivery element extending from the reservoir, the capillary-force-delivery element being configured such that, upon the disposable capsule portion being inserted into the capsule housing, the capillary-force-delivery element extends to the internal heating element and transports the liquid material from the reservoir to the internal heating element via capillary forces.

Example 241. The apparatus according to example 240, wherein the disposable capsule portion is configured for use with an internal heating element disposed within the capsule housing.

Example 242. The apparatus according to example 240, wherein the disposable capsule portion is configured for use with a capsule housing that is built into the smoking device.

Example 243. The apparatus according to example 240, wherein the disposable capsule portion is configured for use with a capsule housing that is not built into the smoking device.

Example 244. The apparatus according to example 240, wherein the capillary-force-delivery element comprises an absorbent material.

Example 245. The apparatus according to example 240, wherein the capillary-force-delivery element comprises a capillary tube.

Example 246. The apparatus according to example 240, wherein the reservoir comprises a reservoir of absorbent material that has absorbed the liquid material.

Example 247. The apparatus according to example 240, wherein the reservoir comprises a solid housing containing the liquid material in an unabsorbed form.

Example 248. The apparatus according to example 240, wherein the disposable capsule portion is configured, upon being inserted into the capsule housing, to thereby form a capsule configured such that airflow through the capsule is substantially in an axial direction along a length of the capsule.

Example 249. The apparatus according to example 240, wherein the disposable capsule portion is configured, upon being inserted into the capsule housing, to thereby form a capsule defining a cross-sectional shape having a ratio of more than 2:1 between a long side of the cross-sectional shape and a short side of the cross-sectional shape.

Example 250. The apparatus according to example 240, wherein the disposable capsule portion is configured for use with an internal heating element that comprises one or more magnetically-heated materials that are susceptible to being heated by a magnetic field.

Example 251. The apparatus according to example 240, wherein the smoking device includes first and second electrodes, wherein the disposable capsule portion is configured for use with an internal heating element that includes an electrically-resistive element that is configured to be heated via resistive heating by the first electrode driving a current to the second electrode through the electrically-resistive element.

Example 252. The apparatus according to example 240, wherein the disposable capsule portion is configured, upon being inserted into the capsule housing, to thereby form a capsule at least a portion of which is configured to be flattened by the smoking device prior to the heating element being heated by the smoking device.

Example 253. The apparatus according to any one of examples 240-252, wherein the disposable capsule portion is configured, upon being inserted into the capsule housing, to thereby form an elongate capsule having a length of between 15 mm and 150 mm.

Example 254. The apparatus according to example 253, the disposable capsule portion is configured, upon being inserted into the capsule housing, to thereby form an elongate capsule having a length of between 50 mm and 90 mm.

Example 255. The apparatus according to any one of examples 240-252, further comprising the internal heating element, wherein the internal heating element is disposed within the disposable capsule portion.

Example 256. The apparatus according to example 255, wherein the internal heating element comprises one or more magnetically-heated materials that are susceptible to being heated by a magnetic field.

Example 257. The apparatus according to example 255, wherein the internal heating element comprises an electrically-resistive element that is configured to be heated via resistive heating by the first electrode driving a current to the second electrode through the electrically-resistive element.

Example 258. The apparatus according to example 257, wherein the electrically-resistive element comprises a coil.

Example 259. The apparatus according to example 257, wherein the electrically-resistive element comprises a metallic element.

Example 260. The apparatus according to example 257, wherein the disposable capsule portion is configured for use with a conductive housing and a metallic foil that are electrically insulated from each other and which are electrically coupled to respective ends of the resistive element, wherein the capsule formed by inserting the disposable capsule portion into the capsule housing is configured such that, when the capsule is disposed within the smoking device, one of the first and second electrodes is electrically coupled to the conductive housing and the other one of the first and second electrodes is coupled to the metallic foil.

Example 261. The apparatus according to example 257, wherein the disposable capsule portion is configured for use with a capsule housing that includes first and second metallic foils that are electrically insulated from each other and which are electrically coupled to respective ends of the electrically-resistive element, wherein the capsule formed by inserting the disposable capsule portion into the capsule housing is configured such that, when the capsule is disposed within the smoking device, one of the first and second electrodes is electrically coupled to the first metallic foil and the other one of the first and second electrodes is coupled to the second metallic foil.

Example 262. Apparatus for use with a smoking device that includes first and second electrodes, an internal heating element, and a disposable capsule portion that includes a reservoir containing a liquid material containing one or more active agents and a capillary-force-delivery element extending from the reservoir, the apparatus comprising:
a capsule housing,
the capsule housing being configured to receive the disposable capsule portion such as to form a capsule in which the capillary-force-delivery element extends to the internal heating element, such as to transport the liquid material from the reservoir to the internal heating element via capillary forces,
the capsule housing comprising a first conductive portion and a second conductive portion that are electrically coupled to each other via the internal heating element, and
the capsule housing being configured such that when the capsule formed by the capsule housing receiving the disposable capsule portion is disposed within the smoking device, the first and second electrodes heat the internal heating element via resistive heating to thereby vaporize the liquid material, by driving a current between the first and second conductive portions.

Example 263. The apparatus according to example 262, wherein the capsule housing is configured for use with a disposable capsule portion that contains the internal heating element.

Example 264. The apparatus according to example 262, wherein the capsule housing is built into the smoking device.

Example 265. The apparatus according to example 262, wherein the capsule housing is not built into the smoking device.

Example 266. The apparatus according to example 262, wherein the capsule housing is configured to receive the disposable capsule portion such as to form a capsule that defines an airway therethrough and wherein the capsule is configured such that the vaporized liquid material enters the airway.

Example 267. The apparatus according to example 262, wherein the capsule housing further comprises a mouthpiece, the capsule housing defines an opening that is disposed adjacent to the internal heating element, and the capsule housing is configured to receive the disposable capsule portion such as to form a capsule that defines an airway extending from the opening to the mouthpiece configured such that the vaporized liquid material enters the airway.

Example 268. The apparatus according to example 262, wherein the capsule housing is configured to receive the disposable capsule portion such as to form a capsule configured such that airflow through the capsule is substantially in an axial direction along a length of the capsule.

Example 269. The apparatus according to example 262, wherein the capsule housing is configured to receive the disposable capsule portion such as to form a capsule shaped to define a cross-sectional shape having a ratio of more than 2:1 between a long side of the cross-sectional shape and a short side of the cross-sectional shape.

Example 270. The apparatus according to example 262, wherein the capsule housing is configured to receive the disposable capsule portion such as to form a capsule at least a portion which is configured to be flattened by the smoking device prior to the internal heating element being heated by the smoking device.

Example 271. The apparatus according to example 262, wherein the internal heating element comprises an electrically-resistive coil.

Example 272. The apparatus according to example 262, wherein the internal heating element comprises a metallic element.

Example 273. The apparatus according to example 262, further comprising the internal heating element, wherein the internal heating element is disposed within the capsule housing.

Example 274. The apparatus according to example 262, wherein the heating element comprises one or more magnetically-heated materials that are susceptible to being heated by a magnetic field.

Example 275. The apparatus according to any one of examples 262-274, wherein the first and second conductive portions comprise a conductive housing of the capsule housing and a metallic foil that are electrically insulated from each other and which are electrically coupled to respective ends of the internal heating element.

Example 276. The apparatus according to example 275, wherein the metallic foil has a thickness of between 1 micron and 20 microns.

Example 277. The apparatus according to example 276, wherein the metallic foil has a thickness of between 3 microns and 10 microns.

Example 278. The apparatus according to any one of examples 262-274, wherein the first and second conductive portions comprise first and second metallic foils that are electrically insulated from each other and which are electrically coupled to respective ends of the internal heating element.

Example 279. The apparatus according to example 278, wherein each of the first and second metallic foils has a thickness of between 1 micron and 20 microns.

Example 280. The apparatus according to example 279, wherein each of the first and second metallic foils has a thickness of between 3 microns and 10 microns.

Example 281. The apparatus according to any one of examples 262-274, wherein the capsule housing is configured to receive the disposable capsule portion such as to form an elongate capsule having a length of between 15 mm and 150 mm.

Example 282. The apparatus according to example 281, wherein the capsule housing is configured to receive the disposable capsule portion such as to form an elongate capsule has a length of between 50 mm and 90 mm.

Example 283. Apparatus for use with a smoking device, the apparatus comprising:
a capsule comprising:
   an absorbent material having a liquid material containing one or more active agents absorbed therein; and
   one or more heating elements disposed within the capsule, the one or more heating elements being configured to vaporize one or more of the active agents from within the smoking material, by the one or more heating elements being heated by the smoking device,
   wherein, at least when the one or more heating elements are being heated by the smoking device, a portion of the capsule containing the absorbent material is configured to be flattened by the smoking device to thereby increase flow of the liquid material through the absorbent material and toward the one or more heating elements, relative to if the portion of the capsule is not flattened.

Example 284. The apparatus according to example 283, wherein the capsule further comprises a reservoir configured to house the liquid material, and wherein the absorbent material comprises absorbent material extending from the reservoir to the one or more heating elements.

Example 285. The apparatus according to example 283, wherein the absorbent material comprises a reservoir of absorbent material in which the liquid material is absorbed.

Example 286. The apparatus according to example 283, wherein, at least when the one or more heating elements are being heated by the smoking device, the portion of the capsule containing the absorbent material is configured such as to define a flattened cross-sectional shape having a ratio of more than 2:1 between a long side of the cross-sectional shape and a short side of the cross-sectional shape.

Example 287. The apparatus according to example 283, wherein the one or more heating elements comprise one or more magnetically-heated materials that are susceptible to being heated by a magnetic field.

Example 288. The apparatus according to example 283, wherein the elongate capsule is manufactured such as to define a cylindrical shape and wherein the portion of the capsule containing the absorbent material is configured to be flattened by the smoking device, prior to the one or more heating elements being heated by the smoking device.

Example 289. The apparatus according to any one of examples 283-288, wherein the one or more heating elements comprise one or more magnetically-heated materials that are susceptible to being heated by a magnetic field.

Example 290. The apparatus according to example 289, wherein the portion of the capsule containing the absorbent material is configured to be inserted into a coil that has a non-circular cross-sectional shape.

Example 291. The apparatus according to example 289, wherein the portion of the capsule containing the absorbent material is configured to be flattened while the portion of the capsule is disposed within a coil.

Example 292. The apparatus according to any one of examples 283-288, wherein the one or more heating elements comprise a metallic foil that is configured to be heated via resistive heating. Example 293. The apparatus according to example 292, wherein the smoking device includes two or more electrodes that are configured to drive an electrical current through the metallic foil, and wherein the capsule is configured to be flattened by the two or more electrodes.

Example 294. The apparatus according to example 292, wherein the metallic foil has a thickness of between 1 micron and 20 microns.

Example 295. The apparatus according to example 294, wherein the metallic foil has a thickness of between 3 microns and 10 microns.

Example 296. The apparatus according to any one of examples 283-288, wherein the elongate capsule has a length of between 15 mm and 150 mm.

Example 297. The apparatus according to example 296, wherein the elongate capsule has a length of between 50 mm and 90 mm.

Example 298. Apparatus for use with a capsule that contains one or more heating elements, and an absorbent material having a liquid material containing one or more active agents absorbed therein, the apparatus comprising:
a smoking device comprising:
   a capsule housing configured to receive the capsule;
   two or more electrodes configured to vaporize the liquid material within the capsule by heating one or more heating elements within the capsule via resistive heating,
   wherein prior to the two or more electrodes heating the one or more heating elements within the capsule, the smoking device is configured to flatten a portion of the capsule containing the absorbent material to thereby increase flow of the liquid material through the absorbent material and toward the one or more heating elements.

Example 299. The apparatus according to example 298, wherein the smoking device comprises mechanical elements that are configured to flatten the portion of the capsule that is configured to be adjacent to the non-contact sensor by applying mechanical pressure to the capsule.

Example 300. The apparatus according to example 298, wherein the smoking device comprises a control component configured to:
receive an indication from a user indicating whether they wish to smoke the active agents in a first mode or a second mode;
in response to receiving an indication that the user wishes to smoke the active agents in the first mode, heat the smoking material to a vaporization temperature of the one or more active agents for a predefined period of time; and
in response to receiving an indication that the user wishes to smoke the active agents in the second mode, only heat the smoking material to the vaporization temperature while receiving an active input from the user that they wish for the smoking material to be heated.

Example 301. The apparatus according to example 298, wherein the smoking device comprises a mechanism configured to bring the electrodes into pressurized contact with the capsule, in order to enhance electrical contact between the electrodes and the capsule.

Example 302. The apparatus according to any one of examples 298-301, wherein the smoking device comprises a temperature sensor and a control component configured to determine a temperature of the liquid material based upon the temperature detected by the sensor.

Example 303. The apparatus according to example 302, wherein the control component is configured to control heating of the smoking material in response to the determined temperature of the liquid material.

Example 304. The apparatus according to example 303, wherein the control component is configured to control heating of the smoking material such as to maintain the liquid material within a predefined temperature range.

Example 305. The apparatus according to any one of examples 298-301, wherein the smoking device is configured to receive an elongate capsule, wherein during the heating of the smoking material, the smoking device is configured to house the capsule such that airflow through the capsule is substantially along a length of the elongate capsule, and wherein a first one of the electrodes is configured to drive a current toward a second one of the electrodes along a length of more than 5 mm in an axial direction along a length of the capsule.

Example 306. The apparatus according to example 305, wherein the first one of the electrodes is configured to drive the current toward the second one of the electrodes along a length of more than 15 mm in the axial direction along the length of the capsule.

Example 307. The apparatus according to any one of examples 298-301, wherein the smoking device is configured to receive a capsule that includes, as its heating element, a metallic foil surrounding the smoking material, and the electrodes are configured to drive the current through the metallic foil.

Example 308. The apparatus according to example 307, wherein the smoking device is configured to receive a capsule that includes a metallic foil surrounding the smoking material and a paper covering that covers the metallic foil, and wherein the electrodes are needle shaped and are configured to make electrical contact with the metallic foil by piercing through the paper covering. Example 309. The apparatus according to any one of examples 298-301, wherein the smoking device is configured to receive a cylindrically-shaped elongate capsule having a length of between 15 mm and 150 mm.

Example 310. The apparatus according to example 309, wherein the smoking device is configured to receive a cylindrically-shaped elongate capsule having a length of between 50 mm and 90 mm.

Example 311. Apparatus for use with a smoking device, the apparatus comprising:
a capsule configured to be placed inside the smoking device comprising:
   a smoking material containing one or more active agents;
   one or more heating elements disposed within the capsule, the one or more heating elements being configured to vaporize one or more of the active agents from within the smoking material, by the one or more heating elements being heated by the smoking device; and
   a mouthpiece comprising a conductive element and configured such that when the capsule is disposed within the smoking device and a user places their mouth on the mouthpiece an electrical property of the mouthpiece changes that is indicative of the user's mouth being on the mouthpiece.

Example 312. The apparatus according to example 311, wherein the mouthpiece comprises a plurality of conductive elements, and wherein the conductive elements are configured such that an electrical property of the mouthpiece varies in response to the user's mouth being placed on the mouthpiece.

Example 313. The apparatus according to example 311, wherein the smoking device includes a cover, and wherein the conductive element is configured such that, when the capsule is disposed within the smoking device and a user places their mouth on the mouthpiece at the same time as holding the smoking device, an electrical circuit is closed via the mouthpiece and a cover of the smoking device.

Example 314. The apparatus according to example 311, wherein the smoking material comprises a plant-based smoking material and the one or more of the active agents are configured to be vaporized from within the plant-based smoking material by heating the plant-based smoking material.

Example 315. The apparatus according to example 311, wherein the smoking material comprises a liquid material and the one or more of the active agents are configured to be vaporized from within the liquid material by the liquid material being vaporized.

Example 316. The apparatus according to example 311, wherein the one or more heating elements comprise one or more magnetically-heated materials that are susceptible to being heated by a magnetic field.

Example 317. The apparatus according to example 311, wherein the elongate capsule is manufactured such as to define a cylindrical shape and wherein a portion of the capsule is configured to be flattened by the smoking device, prior to the one or more heating elements being heated by the smoking device.

Example 318. The apparatus according to any one of examples 311-317, wherein the conductive element comprises a metallic foil within the mouthpiece.

Example 319. The apparatus according to example 318, wherein the one or more heating elements comprise a metallic foil disposed around the smoking material that is configured to be heated via resistive heating.

Example 320. The apparatus according to example 319, wherein the metallic foil within the mouthpiece and the metallic foil disposed around the smoking material comprises a single metallic foil.

Example 321. The apparatus according to example 319, wherein the metallic foil within the mouthpiece and the metallic foil disposed around the smoking material are separate from each other.

Example 322. The apparatus according to example 321, further comprising an electrically-insulating ring disposed between the metallic foil within the mouthpiece and the metallic foil disposed around the smoking material.

Example 323. The apparatus according to any one of examples 311-317, wherein the one or more heating elements comprise a metallic foil that is configured to be heated via resistive heating.

Example 324. The apparatus according to example 323, wherein the metallic foil has a thickness of between 1 micron and 20 microns.

Example 325. The apparatus according to example 324, wherein the metallic foil has a thickness of between 3 microns and 10 microns.

Example 326. The apparatus according to any one of examples 311-317, wherein the capsule comprises an elongate capsule having a length of between 15 mm and 150 mm.

Example 327. The apparatus according to example 326, wherein the capsule has a length of between 50 mm and 90 mm.

Example 328. Apparatus for use with a capsule that contains a smoking material containing one or more active agents and a metallic foil, the capsule including a mouthpiece with a conductive element, the apparatus comprising:
a smoking device configured to receive the capsule, the smoking device comprising:
   two or more electrodes that are configured to vaporize one or more of the active agents from within the smoking material by heating the smoking material, by driving a current into the metallic foil; and
   a control component configured to detect that a user's mouth is placed on the mouthpiece by detecting an electrical parameter of the conductive element.

Example 329. The apparatus according to example 328, wherein the control component is configured to control the driving of the current into the metallic foil in response to detecting that the user's mouth is placed on the mouthpiece.

Example 330. The apparatus according to example 328, wherein the smoking device comprises a cover at least a portion of which is electrically conductive and wherein the control component is configured to detect that the user's mouth is on the mouthpiece by detecting the closing of an electrical circuit from the mouthpiece of the capsule to the cover of the device.

Example 331. The apparatus according to example 328, wherein the smoking device is configured for use with a capsule that contains a plant-based smoking material and the smoking device is configured vaporize one or more of the active agents from within the plant-based smoking material by heating the plant-based smoking material.

Example 332. The apparatus according to example 328, wherein the smoking device is configured for use with a capsule that contains a liquid material and the smoking device is configured to vaporize one or more of the active agents from within the liquid material by vaporizing the liquid material.

Example 333. The apparatus according to example 328, wherein the smoking device is configured:
for use with a first capsule that contains a solid smoking material containing one or more active agents and for use with a second capsule that contains a liquid material containing one or more active agents, both the first and second capsules including a mouthpiece with a conductive element;
when the first capsule is inserted into the smoking device, to vaporize one or more of the active agents contained within the solid smoking material by heating the first capsule; and
when the second capsule is inserted into the smoking device, to vaporize at least some of the liquid vaping material by heating the second capsule.

Example 334. Apparatus for use with a capsule that contains a smoking material containing one or more active agents and a metallic foil, the apparatus comprising:
a smoking device configured to receive the capsule, the smoking device comprising:
   a capsule-receiving chamber configured to receive the capsule;
   a first set of spring electrodes disposed around a circumference of the capsule-receiving chamber at a first axial location;
   a second set of spring electrodes disposed around a circumference of the capsule-receiving chamber at a second axial location; and
   a control component configured to heat the smoking material by driving an electrical current from the first set of spring electrodes to the second set of spring electrodes along the metallic foil.

Example 335. The apparatus according to example 334, wherein the spring electrodes are configured to be compliant such that, during insertion of the capsule into the capsule-receiving chamber, the spring electrodes allow the capsule to be slid through them without the capsule being damaged, and such that upon the capsule having been received within the capsule-receiving chamber the spring electrodes make electrical contact with the capsule.

Example 336. The apparatus according to example 334, wherein at each of the first and second axial locations, the spring electrodes are distributed uniformly around the circumference of capsule-receiving chamber such as to provide an equal distribution of electrical current around the circumference of the capsule.

Example 337. The apparatus according to example 334, wherein each of the spring electrodes has a narrow long shape such that the spring electrode has low thermal conductivity.

Example 338. The apparatus according to example 334, wherein each of the spring electrodes is widened at a location at which the spring electrode is configured to electrically contact the capsule relative to other locations along the length of the spring electrode.

Example 339. The apparatus according to example 334, wherein the capsule-receiving chamber defines a plurality of slits, each of the slits corresponding to a respective spring electrode, and wherein each of spring electrodes is coupled to the capsule-receiving chamber at a first end, then protrudes inside of the capsule-receiving chamber via its corresponding slit in the capsule-receiving chamber, wherein at its second end, the spring extends along an outside of the capsule-receiving chamber.

Example 340. The apparatus according to any one of examples 334-339, wherein the capsule-receiving housing is sized to define a larger diameter than that of the capsule, such that when the capsule is disposed within the capsule-receiving chamber there is an air gap between the capsule and the capsule-receiving chamber.

Example 341. The apparatus according to example 340, wherein, within each of the first and second sets of spring electrodes, each of the spring electrodes is bent at an axial position at which the spring electrode is configured to electrically contact the capsule such that the electrodes encompass a circle having a diameter that equal to or less than the diameter of the portion of the capsule that is configured to be disposed at the axial position.

Example 342. Apparatus for use with a capsule that contains a smoking material containing one or more active agents and a metallic foil, the apparatus comprising:
a smoking device configured to receive the capsule, the smoking device comprising:
   a capsule-receiving chamber configured to receive the capsule, the capsule-receiving housing being sized to define a larger diameter than that of the capsule, such that when the capsule is disposed within the capsule-receiving chamber there is an air gap between the capsule and the capsule-receiving chamber;
   at least first and second spring electrodes disposed at first and second axial locations within the capsule-receiving chamber, the spring electrodes curving from the capsule-receiving chamber to within the capsule receiving chamber such that the electrodes are configured to make electrical contact with the capsule at respective axial positions along the capsule, when the capsule is inserted into the capsule-receiving chamber; and
   a control component configured to heat the smoking material by driving an electrical current from the first spring electrode to the second spring electrode along the metallic foil.

Example 343. The apparatus according to example 342, wherein the air gap is configured to provide thermal insulation between the capsule and a body of the smoking device, thereby reducing heating of the body of the smoking device and consequential energy loss, relative to if no air gap were defined.

Example 344. The apparatus according to example 342, wherein the spring electrodes are configured to be compliant such that during insertion of the capsule into the capsule-receiving chamber, the spring electrodes allow the capsule to be slid through them without the capsule being damaged, and such that upon the capsule having been received within the capsule-receiving chamber the spring electrodes make electrical contact with the capsule.

Example 345. The apparatus according to example 342, wherein each of the spring electrodes has a narrow long shape such that the spring electrode has low thermal conductivity.

Example 346. The apparatus according to example 342, wherein each of the spring electrodes is widened at the position at which the spring electrode is configured to electrically contact the capsule relative to other locations along the length of the spring electrode.

Example 347. The apparatus according to example 342, wherein the capsule-receiving chamber defines a plurality of slits, each of the slits corresponding to a respective spring electrode, and wherein each of spring electrodes is coupled to the capsule-receiving chamber at a first end, then protrudes inside of the capsule-receiving chamber via its corresponding slit in the capsule-receiving chamber, wherein at its second end, the spring extends along an outside of the capsule-receiving chamber.

Example 348. The apparatus according to any one of examples 342-347, wherein the first spring electrode comprises a first set of spring electrodes disposed around a circumference of the capsule-receiving chamber at the first axial location, and the second spring electrode comprises a second set of spring electrodes disposed around a circumference of the capsule-receiving chamber at the second axial location.

Example 349. The apparatus according to example 348, wherein at each of the first and second axial locations, the spring electrodes are distributed uniformly around the circumference of capsule-receiving chamber such as to provide an equal distribution of electrical current around a circumference of the capsule.

Example 350. The apparatus according to example 349, wherein within each of the first and second sets of spring electrodes, each of the spring electrodes is bent at the axial position at which the spring electrode is configured to electrically contact the capsule such that the electrodes encompass a circle having a diameter that equal to or less than the diameter of the portion of the capsule that is configured to be disposed at the axial position.

Example 351. The apparatus according to any one of examples 342-347, wherein the capsule-receiving chamber is configured to reduce radiation of heat from the capsule to a body of the smoking device.

Example 352. The apparatus according to example 351, wherein an inner wall of the capsule-receiving chamber is coated with a heat-reflecting coating.

Example 353. An apparatus for use with a smoking device that includes at least first and second electrodes, the apparatus comprising:
a capsule comprising:
   a smoking material containing one or more active agents; and
   metallic foil disposed around the smoking material, the metallic foil being configured to be heated via resistive heating by the electrodes driving a current into the metallic foil; and
   a paper covering that covers the metallic foil, wherein in the circumferential direction of the capsule:
      the paper covering is adhered to itself along a band of overlap, such as to form a cylindrical shape, and
      the metallic foil does not overlap with itself, and there is a gap of less than 1 mm between two sides of the metallic foil; and
   an inner lining strip that is adhered to the two side of the metallic foil so as to seal the capsule between the two side of the metallic foil.

Example 354. The apparatus according to example 353, wherein the gap is less than 0.5 mm.

Example 355. The apparatus according to example 353, wherein there is no gap between the two side of the metallic foil, such that the two sides of the metallic foil touch each other.

Example 356. The apparatus according to example 353, wherein the metallic foil comprises a plurality of regions, each of the regions having a respective, different electrical resistance profile, such that upon a given current being driven through the metallic foil each of the regions heats to a respective, different temperature.

Example 357. The apparatus according to example 353, wherein the capsule further comprises an electrical-contact coating that coats the metallic foil at locations at which the electrodes are configured to contact the capsule.

Example 358. The apparatus according to example 353, wherein the metallic foil has a first configuration at locations at which the electrodes are configured to contact the metallic foil, and a second configuration along a region in which the metallic foil surrounds the smoking material that is between the locations at which the electrodes are configured to contact the metallic foil.

Example 359. The apparatus according to example 353, wherein the capsule further comprises an inner lining that lines an inside of the metallic foil, the inner lining being configured to diffuse heat that is generated by the metallic foil.

Example 360. The apparatus according to example 353, wherein the paper covering defines openings via which the electrodes are configured to make electrical contact with the metallic foil.

Example 361. The apparatus according to example 353, wherein at least a portion of the capsule is configured to be flattened by the smoking device prior to the one or more heating elements being heated by the smoking device.

Example 362. The apparatus according to any one of examples 353-361, wherein the inner lining strip comprises a heat-resistant adhesive strip.

Example 363. The apparatus according to example 362, wherein the inner lining strip comprises a polyimide adhesive strip.

Example 364. The apparatus according to any one of examples 353-361, wherein the capsule comprises an elongate capsule having a length of between 15 mm and 150 mm.

Example 365. The apparatus according to example 364, wherein the elongate capsule has a length of between 50 mm and 90 mm.

Example 366. The apparatus according to example 364, wherein the capsule is configured such that airflow through the capsule is substantially in an axial direction along a length of the capsule.

Example 367. The apparatus according to example 364, wherein the metallic foil is configured to be heated via resistive heating by the first electrode driving a current to the second electrode along a length of more than 5 mm in an axial direction along the metallic foil.

Example 368. The apparatus according to example 367, wherein the capsule is configured such that airflow through the capsule is substantially in the axial direction along a length of the capsule.

Example 369. The apparatus according to any one of examples 353-361, wherein the metallic foil has a thickness of between 1 micron and 20 microns.

Example 370. The apparatus according to example 369, wherein the metallic foil has a thickness of between 3 microns and 10 microns.

Example 371. The apparatus according to any one of examples 353-361, wherein the capsule further comprises at least one collapse-prevention element configured to facilitate electrical contact between the electrodes and the metallic foil, by preventing the capsule from collapsing.

Example 372. The apparatus according to example 371, wherein the first and second electrodes are configured to contact the capsule at respective first and second axial locations along the capsule, and wherein the collapse-prevention element comprises first and second collapse-prevention elements disposed, respectively, at the first and second axial locations along the capsule.

Example 373. The apparatus according to example 372, wherein the paper covering defines openings at the first and second axial locations along the capsule, via which the electrodes are configured to make electrical contact with the metallic foil.

Example 374. The apparatus according to example 372, wherein the collapse-prevention elements comprise tubular collapse-prevention elements.

Example 375. The apparatus according to example 372, wherein the collapse-prevention elements each comprise an inner layer and an outer layer, and wherein the outer layer is more compressible than the inner layer.

Example 376. The apparatus according to example 375, wherein the compressibility of the outer layer is configured to allows the electrodes to push the foil into the outer layer thereby increasing a surface area of electrical connection between the electrodes and the metallic foil.

Example 377. Apparatus for use with a capsule that contains a smoking material containing one or more active agents, the smoking material being covered with a metallic foil, the apparatus comprising:
a smoking device configured to receive the capsule, the smoking device comprising:
   a housing;
   two or more electrodes fixedly coupled to the housing the two or more electrodes being configured to vaporize one or more of the active agents from within the smoking material by heating the smoking material, by driving a current into the metallic foil; and
   a flap that is hingedly coupled to the housing, the flap being configured:
      to facilitate insertion of the capsule into the housing by opening with respect to the housing; and
      to hold the metallic foil of the capsule in electrical contact with the two or more electrodes by closing with respect to the housing.

Example 378. Apparatus for use with a capsule that contains a smoking material containing one or more active agents, the apparatus comprising:
a smoking device configured to receive the capsule, the smoking device comprising:
   a housing;
   a flap that is hingedly coupled to the housing, the flap being configured:
      to facilitate insertion of the capsule into the housing by opening with respect to the housing; and
      to flatten at least a portion of the capsule by closing with respect to the housing.

Example 379. Apparatus for use with a capsule that contains a smoking material containing one or more active agents, the apparatus comprising:
a smoking device configured to receive the capsule, the smoking device comprising:
   a housing;
   at least first and second electrodes fixedly coupled to the housing the first and second electrodes being configured to vaporize one or more of the active agents from within the smoking material by heating the smoking material, by driving a current into the capsule; and
   a flap that is hingedly coupled to the housing, the flap comprising at least first and second electrical contacts, the flap being configured:
      to facilitate insertion of the capsule into the housing by opening with respect to the housing; and
      to place the first and second electrical contacts into electrical contact with the first and second electrodes respectively, by closing with respect to the housing.

Example 380. Apparatus for use with a capsule that contains a smoking material containing one or more active agents, the smoking material being covered with a metallic foil, the apparatus comprising:
a smoking device configured to receive the capsule, the smoking device comprising:
   a housing;
   two or more electrodes fixedly coupled to the housing the two or more electrodes being configured to vaporize one or more of the active agents from within the smoking material by heating the smoking material, by driving a current into the metallic foil; and
   a cover that is reversibly couplable to the housing, the cover being configured:
      to facilitate insertion of the capsule into the housing by being decoupled from the housing; and
      to hold the metallic foil of the capsule in electrical contact with the two or more electrodes by being coupled to the housing.

Example 381. Apparatus for use with a capsule that contains a smoking material containing one or more active agents, the apparatus comprising:
a smoking device configured to receive the capsule, the smoking device comprising:
   a housing; and
   a cover that is reversibly couplable to the housing, the cover being configured:
      to facilitate insertion of the capsule into the housing by being decoupled from the housing; and
      to flatten at least a portion of the capsule by being coupled to the housing.

Example 382. Apparatus for use with a capsule that contains a smoking material containing one or more active agents, the apparatus comprising:
a smoking device configured to receive the capsule, the smoking device comprising:
   a housing;
   at least first and second electrodes fixedly coupled to the housing the first and second electrodes being configured to vaporize one or more of the active agents from within the smoking material by heating the smoking material, by driving a current into the capsule; and
   a cover that is reversibly couplable to the housing, the cover comprising at least first and second electrical contacts and the cover being configured:
      to facilitate insertion of the capsule into the housing by being decoupled from the housing; and
      to place the first and second electrical contacts into electrical contact with the first and second electrodes respectively by being coupled to the housing.

Example 383. Apparatus for use with a smoking device that includes two or more electrodes, the apparatus comprising:
an elongate capsule comprising:
   a smoking material containing one or more active agents; and
   metallic foil surrounding the smoking material, the metallic foil being configured to be heated via resistive heating by electrodes driving a current through the metallic foil,
   the metallic foil being shaped to define lateral winged projections that are configured to contact the first and second electrodes.

The present application is related to:

International application PCT/IB2023/052518 to Raichman, filed Mar. 15, 2023, entitled “Smoking capsule with flattened profile”;

International application PCT/IB2023/052519 to Raichman, filed Mar. 15, 2023, entitled “Smoking capsule with resistive heating element”;

International application PCT/IB2023/052520 to Raichman, filed Mar. 15, 2023, entitled “Coating for smoking capsule”;

International application PCT/IB2023/052521 to Raichman, filed Mar. 15, 2023, entitled “Smoking device with flattening function”;

International application PCT/IB2023/052523 to Raichman, filed Mar. 15, 2023, entitled “Smoking device with flattening electrodes”;

International application PCT/IB2023/052526 to Raichman, filed Mar. 15, 2023, entitled “Smoking device with inductive heating coil”;

each of which PCT applications claims priority from U.S. Provisional Patent Application 63/438,643 to Raichman, filed Jan. 12, 2023, entitled “Smoking device and capsule for use therewith.”

All of the above-referenced applications are incorporated herein by reference. The scope of the present disclosure includes combining the methods and apparatus described herein with the methods and apparatus described in any one of the above-referenced PCT applications.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. An apparatus for use with a smoking device that includes at least first and second electrodes, the apparatus comprising:
a capsule comprising:
a smoking material containing one or more active agents; and
metallic foil disposed around the smoking material, the metallic foil being configured to be heated via resistive heating by the electrodes driving a current into the metallic foil; and
a paper covering that covers the metallic foil, wherein in the circumferential direction of the capsule:
the paper covering is adhered to itself along a band of overlap, such as to form a cylindrical shape, and
the metallic foil does not overlap with itself, and there is a gap of less than 1 mm between two sides of the metallic foil; and
an inner lining strip that is adhered to the two sides of the metallic foil so as to seal the capsule between the two sides of the metallic foil.

2. The apparatus according to claim 1, wherein the gap is less than 0.5 mm.

3. The apparatus according to claim 1, wherein the metallic foil comprises a plurality of regions, each of the regions having a respective, different electrical resistance profile, such that upon a given current being driven through the metallic foil each of the regions heats to a respective, different temperature.

4. The apparatus according to claim 1, wherein the capsule further comprises an electrical-contact coating that coats the metallic foil at locations at which the electrodes are configured to contact the capsule.

5. The apparatus according to claim 1, wherein the metallic foil has a first configuration at locations at which the electrodes are configured to contact the metallic foil, and a second configuration along a region in which the metallic foil surrounds the smoking material that is between the locations at which the electrodes are configured to contact the metallic foil.

6. The apparatus according to claim 1, wherein the capsule further comprises an inner lining that lines an inside of the metallic foil, the inner lining being configured to diffuse heat that is generated by the metallic foil.

7. The apparatus according to claim 1, wherein the paper covering defines openings via which the electrodes are configured to make electrical contact with the metallic foil.

8. The apparatus according to claim 1, wherein at least a portion of the capsule is configured to be flattened by the smoking device prior to the one or more heating elements being heated by the smoking device.

9. The apparatus according to claim 1, wherein the inner lining strip comprises a heat-resistant adhesive strip.

10. The apparatus according to claim 1, wherein the metallic foil has a thickness of between 1 micron and 20 microns.

11. The apparatus according to claim 1, wherein the capsule comprises an elongate capsule having a length of between 15 mm and 150 mm.

12. The apparatus according to claim 11, wherein the capsule is configured such that airflow through the capsule is substantially in an axial direction along a length of the capsule.

13. The apparatus according to claim 11, wherein the metallic foil is configured to be heated via resistive heating by the first electrode driving a current to the second electrode along a length of more than 5 mm in an axial direction along the metallic foil.

14. The apparatus according to claim 1, wherein the capsule further comprises at least one collapse-prevention element configured to facilitate electrical contact between the electrodes and the metallic foil, by preventing the capsule from collapsing.

15. The apparatus according to claim 14, wherein the first and second electrodes are configured to contact the capsule at respective first and second axial locations along the capsule, and wherein the collapse-prevention element comprises first and second collapse-prevention elements disposed, respectively, at the first and second axial locations along the capsule.

16. The apparatus according to claim 15, wherein the paper covering defines openings at the first and second axial locations along the capsule, via which the electrodes are configured to make electrical contact with the metallic foil.

17. The apparatus according to claim 15, wherein the collapse-prevention elements each comprise an inner layer and an outer layer, and wherein the outer layer is more compressible than the inner layer.

18. The apparatus according to claim 17, wherein the compressibility of the outer layer is configured to allow the electrodes to push the foil into the outer layer thereby increasing a surface area of electrical connection between the electrodes and the metallic foil.

19. The apparatus according to claim 14, wherein the collapse-prevention element comprises one or more tubular collapse-prevention elements.

20. The apparatus according to claim 19, wherein the first and second electrodes are configured to contact the capsule at respective first and second axial locations along the capsule, and wherein the tubular collapse-prevention elements comprises first and second tubular collapse-prevention elements disposed, respectively, at the first and second axial locations along the capsule.
